(19) United States
(12) Patent Application Publication
(10) Pub. No.: US 2026/0329544 A1
(43) Pub. Date: Oct. 22, 2026

(54) QRNG with PRNG utilization and vertical entropy source

(71) Applicant: ELMOS Semiconductor SE, Dortmund (DE)

(72) Inventors: Thomas Rotter, Neunkirchen am Brand (DE); Julia KÖLBEL, Dortmund (DE); Ann-Sophie Bulter, Emsdetten (DE); Bernd Burchard, Essen (DE)

(73) Assignee: ELMOS Semiconductor SE, Dortmund (DE)

(21) Appl. No.: 19/117,523

(22) PCT Filed: Sep. 26, 2023
(86) PCT No.: PCT/DE2023/100717

§ 371 Date: Apr. 1, 2025

(30) Foreign Application Priority Data
Oct. 4, 2022 (DE) 10 2022 125 574.3
Sep. 20, 2023 (DE) 10 2023 125 543.6

(51) Int. Cl. G06F 7/58; G06F 21/75

(52) U.S. Cl. CPC G06F 7/588; G06F 21/755

(57) ABSTRACT

A quantum process-based generator for true random numbers (QRNG) comprises an entropy source and at least one time-to-pseudorandom number converter. The QRNG is implemented on a semiconductor substrate and includes a vertical entropy source with at least one photon source and photon detector. The photon source and detector are arranged in a vertical direction within the semiconductor substrate to enhance integration and security. The system detects attacks on the entropy source using an observation diode. The generator incorporates a watchdog and a voltage monitor to ensure operational integrity. The QRNG provides high-entropy random numbers suitable for cryptographic applications, ensuring statistical unpredictability. The integration of photon sources and detectors in a monolithic semiconductor structure improves efficiency, security, and robustness against tampering. Various embodiments include additional monitoring components to detect and prevent unauthorized interference, optimizing the QRNG for secure data encryption and system authentication.

### CROSS-REFERENCE TO RELATED APPLICATIONS

This patent application is a national stage of and claims priority to international patent application number PCT/DE2023/100717 filed on Sep. 26, 2023 and which claims the priorities of the German patent application DE 10 2022 125 574.3 dated Oct. 4, 2022, and the German patent application DE 10 2023 125 543.6 dated Sep. 20, 2023, the entire disclosures of each of which are incorporated herein by reference.

### TECHNICAL FIELD

The present disclosure relates to quantum-based random number generators (QRNGs) and secure data processing, particularly monolithic semiconductor QRNGs with photon-based entropy sources for cryptographic applications. It further concerns circuit architectures that enhance security, detect attacks on entropy sources, and ensure reliable random number generation in secure computing and communications.

### BACKGROUND

Random number generators (RNGs) are essential components in various applications, including cryptography, secure communications, and scientific simulations. Conventional pseudo-random number generators (PRNGs) rely on deterministic algorithms, making them susceptible to predictability and security vulnerabilities. True random number generators (TRNGs), particularly those based on quantum processes, offer superior entropy and unpredictability, making them ideal for high-security applications.

Existing quantum random number generators (QRNGs) suffer from challenges such as low quantum yield, poor integration capabilities, and susceptibility to external interference. Furthermore, traditional implementations require large chip areas and are often difficult to integrate into monolithic semiconductor structures. The automotive, financial, and computing industries face increasing threats from data interception, hardware attacks, and cryptographic weaknesses, necessitating enhanced security measures for RNGs.

To address these challenges, there is a need for a compact, highly efficient, and tamper-resistant QRNG that can be seamlessly integrated into semiconductor circuits while maintaining high entropy and security against external attacks.

The automotive and other industries are increasingly exposed to a wide variety of piracy attacks. The counterfeiters copy the spare parts and products of the industrial producers concerned and generally use their brand names. Another point of attack is the data transfer within the products and/or the data transfer to the product and back.

The entropy properties of common random number generators for such systems are typically inadequate. Quantum process-based generators for true random numbers (Quantum Random Number Generator: QRNG) are known from the state of the art, but they are difficult to integrate or have a poor quantum yield.

In particular, the technical teaching of EP 3 529 694 B1 is known from the prior art, in which the time duration between pulses of an entropy source consisting of two SPAD diodes is used. The disadvantage of the technical teaching of EP 3 529 694 B1 is the low quantum efficiency in the transfer of photons from the first SPAD diode operating as a silicon diode to the second SPAD diode operating as a photodiode. The document presented here therefore quotes sections of the explanations of the authors and inventors in EP 3 529 694 B1. The document presented here uses the technical teaching of EP 3 529 694 B1 and builds on the technical teaching of WO 2023 072 956 A1, the technical teaching of which the document presented here repeats in connection with the solution of the problem.

“A typical example of the first case is computer science, which requires the generation of a certain number of random initial states that serve as a description of the initial state of the simulation.”

For this type of application, it is generally necessary that the initial configurations are not strictly correlated with each other, but can be reproduced in a deterministic way, for example to check the effects of variations on the codes performing the simulations. For this reason, these sequences are more correctly referred to as pseudo-random numbers (PRN), as they are defined by complex algorithms starting from an initial value. In other words, given an initial random number, known in technical jargon as a “seed”, a formula, however complex, will always reproduce the same sequence of random numbers. The corresponding generators are known as pseudo-random number generators (PRNG).

In the second case, however, i.e. when random numbers are used in cryptographic techniques to perform e.g. banking operations, the approach described above seems to be weak, as it must be ensured that the generated sequences are absolutely unpredictable in order to guarantee the security of highly sensitive information. In this case, the most secure approach is to generate random numbers from a generation process that must be truly random and must not allow any prediction of the generated sequence. These generators are called True Random Number Generators (TRNG). In particular, quantum mechanisms, such as the generation of photons by a light source, are among the best-studied methods for obtaining said sequences of true random numbers and rely on the indeterminacy of the measured event, which is one of the properties of the quantum system itself.

From the point of view of information theory, the degree of unpredictability of the random numbers generated by the two techniques mentioned above can be expressed by the parameter “entropy”, which is known as the uncertainty or information present in a random variable.

Furthermore, it is important to emphasize that the National Institute of Standards and Technology (NIST), in its guideline NIST SP800-22, specifies about fifteen statistical tests that can be used to determine whether or not a particular random number generator has a sufficient level of entropy.

As mentioned above, the use of PRNGs for cryptographic purposes is unfavorable, not only because certain algorithms have weaknesses that may not become apparent until some time after their introduction, but also because a malicious intruder who could recover the seed from which all random sequences are generated could predict all subsequent outputs based on the same seed with absolute certainty.

A solution based on physical phenomena, and in particular quantum phenomena, is therefore much more suitable, given the inherent unpredictability of these events, even for people who know the algorithms used in detail and have a high computing capacity. However, while the algorithms used to generate pseudo-random numbers can be chosen to produce sequences with certain statistical properties that can be determined with absolute certainty due to their deterministic nature, the random numbers obtained from physical phenomena are subject to practical limitations due, for example, to variations in the production quality of the equipment, variations in the power supply, environmental factors such as external fields and temperature variations. These deviations from the ideal case generally cause a deviation from a statistically uniform distribution that is independent of the events that can be measured in a sample space. As a result, it is even possible to observe a reduction in the entropy of the aforementioned true random number generators.

To avoid this drawback, said True Random Number Generators use a further step, called post-processing, which is performed after the extraction of the random code sequence, starting from the specific physical phenomenon. This post-processing step indeed improves the uniformity of the probability distribution of the random code sequence. However, the disadvantage is that this post-processing step has an impact on the bit rate that the generator can guarantee.

As already mentioned, it is also known that one of the physical phenomena most used to generate truly random numbers is quantum photonics. For this reason, these generators, which belong to the macro category of TRNGs, are also referred to by the acronym QRNG (Quantum Random Number Generator). In these generators, an attenuated light source produces a few photons (low value of the detected photon flux 2), which are detected by one or more single photon detectors, each of which is known by the acronym SPAD (Single Photon Avalanche Diode). Furthermore, the system comprises corresponding electronic circuits downstream of the above-mentioned SPADs, consisting of auxiliary circuits and generally of one or more TDCs (Time to Digital Converters) or counters capable of extracting a random sequence of bits from each of the SPADs by measuring the arrival time of the detected photons or by counting them.

In these generators, the light source and the detector(s) are separate devices that must be suitably coupled and shielded. However, the disadvantage is that this design is not immune to the influence of uncontrolled external environmental factors. Furthermore, the fact that the light source and the detector(s) are separate devices that are coupled together in sequence makes the entire random number generator highly susceptible to any kind of interference or tampering.

Another disadvantage is that this implementation entails high costs for the device, as the two devices have to be optically aligned.

Existing generators cover various applications, e.g., portable USB devices that deliver only a few hundred kbit/s, large electronic systems that can guarantee a bit rate of hundreds of Mbit/s, etc. These generators may detect the “arrival time” or the number of photons hitting the sensitive surface of the SPAD detector(s). An example of a known quantum random number generator based on time of arrival can be found in the international publication WO 2016 016 741 A1.

In particular, the technique based on the so-called arrival time has been proposed to measure the time that elapses between the moment when a photon comes into contact with a single SPAD and the moment when the subsequent photon comes into contact with the same SPAD. Although a high bit rate can be achieved with this technique, it has a significant distortion because, as already explained, the photon source obeys the Poisson process.

To overcome this disadvantage, the prior art proposes to act directly on the photon source to control the flow of photons generated by this source. In particular, this operation involves modifying the pilot current of the photon source in order to make its statistical distribution as uniform as possible over time.

The disadvantage of this approach, however, is that a special electronic circuit must be built into the random number generator that can control the photon source, as explained above, which increases the complexity and size of the generator itself.”

In many areas of science and technology, random events and the determination of probabilities play a particularly prominent role. For example, Monte Carlo simulations and secure encryption methods are based to a large extent on the provision of random numbers. A distinction is generally made between so-called pseudo-random numbers and true random numbers. While the former are generated using deterministic formulas by pseudo random number generators (PRNGs) and are therefore not absolutely random, non-deterministic true random number generators (TRNGs) are generally based on real unpredictable processes such as thermal or atmospheric noise and not on artificially generated patterns of deterministic algorithms. However, depending on the underlying random element, the results of such non-deterministic random number generators based on external parameters can still tend slightly towards higher or even numbers due to weak correlations, for example, and thus enable at least partial predictability of the random numbers generated in this way.

Quantum random number generators (QRNGs), on the other hand, as a special subgroup of TRNGs, are based on fundamental quantum processes for random number generation and are therefore, at least theoretically, not linked to other external factors and effects that influence the statistics. Quantum random number generators are therefore currently the best available source of truly random numbers. Current digital QNRGs can deliver entropy rates (i.e. a sequence of bit values with maximum randomness or entropy) of up to several hundred Mbps. The random numbers generated are required both for conventional encryption methods and for a large number of quantum computing and quantum cryptography methods to ensure secure key exchange (Secure/Quantum Key Distribution, SKD/QKD). Non-manipulable and fast QRNGs are therefore absolutely essential for generating secure keys in cryptography.

A large number of QRNGs are realized as photonic QRNGs due to their particularly simple feasibility with the help of random properties of photons. A simple concept for the generation of random numbers is the behavior of a photon that is either reflected or transmitted at a semitransparent beam splitter independently of other photons. Another approach is to use the random arrival times of photons on a single photon detector. This distribution effect, which is based on intrinsic photon statistics of the photons of an associated photon source that cannot be calculated deterministically in principle, can also be used to provide true random numbers. The arrival times of photons on a single photon detector generally exhibit an exponential distribution.

Typically, in a single photon detector (SPD), a detector pulse is first generated by a single incident photon, which is converted in a time-to-digital converter (TDC) into a time-stamped digital representation of the detection event and can be further processed accordingly. The photon and entropy sources used in QRNGs are usually laser diodes (LDs) or simple light emitting diodes (LEDs) that have been attenuated to the single photon level and whose emitted photons can then be recorded as a time-resolved SPD via one or more particularly sensitive single photon avalanche diodes (SPADs). Such photon sources providing only single or only a few photons at a time are also referred to as single photon sources (SPS) in the context of this application. However, these do not necessarily have to be genuine single photon emitters, for example based on a single isolated two-level system.

SPADs are a type of photodetector similar to photo diodes (PDs) and avalanche photo diodes (APDs), but with a significantly higher sensitivity in comparison. The SPADs can be read out and evaluated digitally-even within a common integrated circuit. If such a integrated detector circuit is excited by individual photons, only one electron-hole pair is primarily generated in the sensorically active area (absorption area) for each excited photon, with the excited electrons being drawn to the cathode and the excited holes to the anode by electric fields. In a SPAD, the charge carriers drift through a so-called avalanche region, within which a charge avalanche is generated by increased impact ionization. These are therefore highly sensitive photon-receiving elements which, when activated, can provide a high charge quantity (approx. 105-106 electrons) with high temporal resolution.

A SPAD is typically operated in Geiger mode above its breakdown voltage, whereby a single photon is detected via the generated charge avalanche and then registered as a single event. To reduce the dead time occurring during registration, active or passive suppression or quenching of further charge carrier amplification can take place immediately after the onset of avalanche formation. In addition to the SPAD, the integrated circuit can also include a so-called single-photon counter (SPC), which generally provides a direct statistical evaluation of the temporal distribution of the individual detected single-photon events instead of a direct output of a single detector pulse.

A statistical evaluation carried out in parallel to the random number generation can be used, for example, to further secure the generation against possible attacks on the random number generation process. Particularly in the case of non-integrated photonic QRNGs made up of individual components, the required transmission paths within the system offer a wide range of attack possibilities. For this reason, such systems are realized as compactly as possible and isolated from their external environment to increase security. In addition to avoiding potential attack scenarios, a further advantage of such compact QRNGs is that natural influences that may affect random number generation from outside the system can also be minimized as far as possible. Correspondingly compact QRNGs based on photon noise are therefore usually provided as hybrid integrated systems.

Also known from EP 3 529 694 B1 is an integrated quantum random number generator (iQRNG) comprising a PLC and one or more SPDs, in which the PLC and the SPD(s) are arranged fully integrated in CMOS technology in a single semiconductor substrate in such a way that they are directly adjacent to one another (see FIG. 1 with associated figure description). The SPS is provided by a suitably doped p-n junction so that it generates a photon current to be detected when the photon source is suitably biased in the forward or reverse direction. In particular, the SPDs should be SPADs, which are preferably produced by common manufacturing processes with the SPSs and have the same chemical structure.

The joint integration means that the photon current generated by the PLC can flow directly to an adjacent SPAD through optical crosstalk within one and the same semiconductor material and does not first have to overcome or tunnel through a possibly empty coupling gap that physically separates the two components, as is the case with other hybrid integrated QRNGs known from the prior art. The integrated “side-by-side” configuration makes the QRNG presented in the publication more compact and structurally less complex than hybrid QRNGs of the same functional type. In addition, thanks to the integration of all components, the random number generator is significantly more robust and more immune to external environmental influences and attempts at manipulation by external attackers.

However, it is still possible in principle to interfere with, influence and/or observe the random number generation process during the ongoing operation of the QRNG with significantly increased effort. Since the iQRNG disclosed in the publication essentially has a planar structure, individual photons could certainly be tapped from above or below the level of the substrate or additionally introduced.

The horizontal side-by-side arrangement of the structures is also not ideal in terms of efficiency and the space required. The efficiency is limited in particular by the required lateral distance between the SPS and the SPAD and the associated high absorption of photons in the semiconductor material. Without special precautions, the photons emitted by the PLC are also emitted largely undirected into the material surrounding the PLC, so that only some of the photons generated can be detected by an associated SPAD. Although several SPADs can be arranged around a single SPS, so that the efficiency and thus the digital entropy rate can be increased by joint evaluation of the SPADs connected in this way, the area consumption of such an iQRNG increases considerably. On the other hand, even with a single emitter-detector pair, it must be ensured that the undetected photons do not spread uncontrollably within the substrate and cause interference elsewhere in the substrate. The associated lateral blocking areas therefore also lead to an increase in the effective area consumption of the iQRNG.

An iQRNG also realized in CMOS technology (HV-CMOS) with a corresponding arrangement of a photon source and a single photon detector next to each other is also known from Khanmohammadi et al. (Khanmohammadi, Abbas, et al. “A monolithic silicon quantum random number generator based on measurement of photon detection time.” IEEE Photonics Journal 7.5 (2015): 1-13). A Si LED as photon source, which is formed in a circular n-well close to the surface between a central n++ region as cathode and several p++ regions arranged in a ring around it as anode, is enclosed in a circular ring by a SPAD as single photon detector (see FIG. 2 with associated figure description). The photons emitted by the SPS are thus detected on all sides in the plane, which increases the efficiency compared to the iQRNG known from EP 3 52 694 B1 with reduced space consumption. The PLC is thus directly integrated into the SPAD. However, individual photons can also be emitted into the substrate or extracted from its surface. The injection of corresponding photons from an attacker to influence the statistics is also possible in this way.

For at least this reason, there is a need for further miniaturization of integrated QRNGs compared to the state of the art in order to further increase safety and reduce space consumption. The iQRNG should be largely protected against external attacks and have the highest possible efficiency and lowest possible substrate losses.

### SUMMARY

The present disclosure relates to a quantum-based true random number generator (QRNG) for generating high-entropy random numbers suitable for secure applications. The QRNG comprises an entropy source that generates a signal, which is processed by a time-to-pseudo-random number converter (TPRC) to produce random bits and random numbers. In one aspect, this disclosure provides a microcontroller incorporating at least one QRNG as an integrated random number generator, particularly for encryption and cryptographic applications. This disclosure further includes an improved true random number generator (TRNG) that enhances entropy extraction using quantum processes combined with pseudo-random number generators (PRNGs) for refining the entropy output.

Additionally, the disclosure relates to a data processing device incorporating a quantum-based random number generator, ensuring secure and reliable random number generation for applications requiring high levels of randomness and tamper resistance.

### BRIEF DESCRIPTION OF THE DRAWINGS

FIG. 1 shows a schematic block diagram of a data processing device and a controlled system.

FIG. 2 shows a schematic block diagram of a circuit for deactivating a test interface of the device of FIG. 1.

FIG. 3 shows a diagram illustrating a process for verification of digital signatures.

FIG. 4 shows a flowchart illustrating use of HASH functions in storing and retrieving data from a DRAM of the device of FIG. 1.

FIG. 5 shows a cross-section of a proposed SPAD diode.

FIG. 6 shows a combination of two proposed SPAD diodes in cross-section.

FIG. 7 shows a combination of two proposed SPAD diodes in cross-section, with several insulation layers forming an optical waveguide.

FIG. 8 shows an integration of the SPAD diodes and the optical fiber into an evaluation and operating circuit.

FIG. 9 corresponds to FIG. 8, which is now supplemented by monitoring circuits.

FIG. 10 shows a typical output signal of the second SPAD diode.

FIG. 11 shows an exemplary oscillogram of the voltage signal of an entropy source.

FIG. 12 shows the schematic sequence of a server-client communication using a proposed quantum random number generator.

FIG. 13 shows a schematic sequence of the KeyExchangeServer( ) and KeyExchangeClient( ) functions.

FIG. 14 shows a schematic sequence of the setPrimes( ) function.

FIG. 15 shows a schematic sequence of the function setE( )

FIG. 16 shows a schematic sequence of the findD( ) function.

FIG. 17 shows a schematic sequence of a secure transmission of quantum-based random numbers between a first processor of the computer, in particular in the form of an integrated circuit according to the proposal, of a server and a first processor of the computer, in particular in the form of a further integrated circuit according to the proposal, of a client.

FIG. 18 shows a proposed method for generating a quantum random number.

FIG. 19 shows another exemplary proposal for a one-piece, monolithic integrated circuit.

FIG. 20 shows a device similar to the device in FIGS. 8 and 9.

FIG. 21 shows an example of a time-to-random number converter.

FIG. 22 shows a diagram representing the detection of pulses on the voltage signal of the entropy source.

FIG. 23 shows an exemplary voltage transformer for supplying the entropy source with a sufficient operating voltage of the supply voltage line VENT of the entropy source with respect to the reference potential line GND at the reference potential.

FIG. 24 shows an example of a rough layout of an imaginary integrated circuit, for example a microcontroller, with a proposed quantum random number generator in top view to illustrate the placement of a quantum random number generator in whole or in part in the pad frame or a proposed entropy source in the pad frame.

FIG. 25 shows a schematic view of a first embodiment of a quantum random number generator according to the state of the art.

FIG. 26 shows a schematic representation of a second embodiment of a horizontal entropy source according to the prior art in a side view;

FIG. 27 shows a schematic representation of a BCD substrate prepared using a method for providing low-lying p-n junctions in a BCD process and a TCAD representation of the resulting dopant distribution;

FIG. 28 shows a schematic representation of an exemplary first embodiment of an entropy source.

FIG. 29 shows a schematic representation of an exemplary second embodiment of an entropy source.

FIG. 30 shows a schematic representation of an exemplary third embodiment of an entropy source.

FIG. 31 shows a graphical representation of the dependence of the SPAD current (SPAD Current (A)) as a function of the Zener reverse voltage (V) at different SPAD reverse voltages (less than, equal to, greater than the breakdown voltage VBD) within an entropy source 401.

FIG. 32 shows a graphical representation of the dependence of the ratio between SPAD current and Zener current as a function of the Zener reverse voltage (V) at different SPAD reverse voltages (less than, equal to, greater than the breakdown voltage VBD) within an entropy source.

### DETAILED DESCRIPTION

The present disclosure aims to overcome all the above-mentioned disadvantages.

In particular, it is an object of the disclosure to provide a generator of true random numbers that allows a high degree of entropy to be guaranteed so that it passes at least the statistical tests defined by NIST.

A further aim of the disclosure is to provide a generator for true random numbers, which makes it possible to achieve an even higher bit rate when generating random sequences of bits and to ensure the randomness of the measurement result even if the entropy source fails.

A further aim of the disclosure is to provide a true random number generator which has a more compact, more robust and less complex structure than the random number generators known in the prior art, so that this random number generator can be accommodated in the pad edge of a monolithic integrated semiconductor circuit.

A further aim of the disclosure is to provide a true random number generator that offers a high degree of security against any attempt to forcibly alter or manipulate its internal components.

A further aim of the disclosure is to provide a true random number generator that provides a high level of security to detect and report any attempt to forcibly alter or tamper with its internal components.

A further, but no less important, aim of the disclosure is to provide a genuine random number generator which is more economical than the generators of the known prior art.

The device of the independent claim solves this problem. Further embodiments are the subject of the subclaims.

The task according to the disclosure of providing a compact entropy source 411 which goes beyond the prior art is solved by the objects of independent patent claims. Preferred further embodiments are the subject of further subclaims.

The automotive and other industries are increasingly exposed to a wide variety of piracy attacks. The counterfeiters copy the spare parts and products of the industrial producers concerned and generally use their brand names. Another point of attack is the data transfer within the products and/or the data transfer to the product and back.

The entropy properties of common random number generators for such systems are typically inadequate. Quantum process-based generators for true random numbers (Quantum Random Number Generator: QRNG) are known from the state of the art, but they are difficult to integrate or have a poor quantum yield.

It is known in the prior art to provide an integrated circuit that includes, among other features, a processor. In some applications, it is necessary to ensure that the processed data, including the executable code, cannot be modified by unauthorized persons accessing data stored outside the integrated circuit or, if such access occurs, that it cannot occur undetected.

In a first embodiment, the quantum process-based generator for true random numbers according to the disclosure has an entropy source and is set up to evaluate a signal from the entropy source by means of at least one time-to-pseudo-random number converter and to generate one or more random bits as a function of the signal from the entropy source.

In a second independent embodiment for which independent protection is claimed, the quantum process-based generator for real random numbers according to the disclosure is implemented in one piece on a semiconductor substrate with a surface and has a vertical entropy source with at least one photon source with at least one photon detector. For the purposes of the present document, the surface of the semiconductor substrate is defined as a horizontal plane with a first direction in the plane (1st plane vector) and a second direction in the plane (2nd plane vector) which is different from the first direction in the plane. The photon source and the photon detector are arranged with respect to the first and second directions in the horizontal plane of the surface of the semiconductor substrate in a vertical direction to the first and second directions in the plane in the semiconductor substrate. In this broad independent embodiment of the disclosure, the quantum process-based generator for true random numbers is arranged to generate one or more random bits in dependence on the one signal of the entropy source.

In a third independent embodiment for which independent protection is claimed, the quantum process-based generator for true random numbers according to the disclosure comprises an entropy source in a semiconductor substrate having a surface and having a rear side opposite the surface on the other side of the semiconductor substrate, and means for detecting an attack on the entropy source by means of photons, wherein this attack can in particular be an attack from a rear side of the semiconductor substrate.

In a variant of the third independent embodiment, these means for detecting an attack on the entropy source by means of photons may comprise an observation diode.

In variants of the three independent embodiments, the quantum process-based generator can include a watchdog.

In variants of the three independent embodiments, the quantum process-based generator may comprise a voltage monitor (423).

In variants of the disclosure, the watchdog and/or the voltage monitor may be arranged to monitor the quantum process-based generator for an attack or a disturbance by means of said means for detecting an attack on the entropy source by means of photons, in particular by means of the observation diode.

In variants of the disclosure, the at least two device parts of the quantum process-based generator for real random numbers can be designed in one piece on a common semiconductor substrate as a one-piece quantum process-based generator.

In variants of the disclosure, the quantum process-based generator for true random numbers may be arranged to generate at least one random number from a plurality of random bits and to provide or utilize the at least one random number.

In variants of the disclosure, the logical values in the temporal sequence of the pseudorandom bits of a time-to-pseudorandom number generator (TPRG), i.e. the actual pseudorandom bit sequence of the time-to-pseudorandom number generator (TPRG), of the quantum process-based generator depend on one or more quantum random bits and/or one or more quantum random numbers, which are typically operating parameters of the time-to-pseudorandom number generator (TPRG).

In variants of the disclosure, the watchdog is set up to monitor the correct functioning of the quantum process-based generator for real random numbers.

In variants of the disclosure, the watchdog is set up to measure the randomness of the generated quantum random bits in the form of one or more measured values and to compare each of them with a respective tolerance interval or a respective threshold value, and to infer a respective error in the event of a respective deviation of the respective measured value from the respective tolerance interval or the respective threshold value.

In variants of the disclosure, the watchdog is arranged to monitor a correct function of the time-to-pseudo-random number converter (TPRC) of the at least one time-to-pseudo-random number generator (TPRG) of the quantum process-based generator and/or to monitor a behavior in the form of the temporal statistics of the logic values in the temporal sequence of the pseudo-random bits of the time-to-pseudo-random number converter (TPRC) and to record them in the form of statistical measured values and, in the event of deviations of the statistical measured values from the expected behavior, to record them in the form of statistical measured values to pseudo-random number converter (TPRC) and to record it in the form of statistical measured values and, in the event of deviations of the statistical measured values from the expected behavior, to detect and/or signal an error in the form of these measured values leaving permitted measured value ranges.

In variants of the disclosure, the quantum process-based generator for true random numbers with its at least two device parts is manufactured in one piece as part of an integrated circuit.

In variants of the disclosure, the integrated circuit with the quantum process-based generator for true random numbers is manufactured in a BCD technology.

In variants of the disclosure, the integrated circuit comprising the quantum process-based true random number generator comprises a voltage converter for supplying the entropy source of the quantum process-based true random number generator, wherein the voltage converter then comprises one or more DMOS transistors for increasing the dielectric strength.

In variants of the disclosure, the integrated circuit comprises a circuit such as a microcontroller, a microprocessor, a memory, a DRAM, an SRAM, a RAM, a volatile memory, an OTP memory, an EEPROM, a flash memory, an MRAM, an FRAM, a sensor evaluation circuit, a control circuit for an automotive control circuit, a graphics controller, an evaluation circuit for a biometric sensor or an input device, a control circuit, a chip card circuit, an RFID circuit, a physical circuit of a cell phone or a smartphone, a circuit of an access control system, a circuit with a coded recording of operating parameters, a circuit of an access control system, a circuit of a security system of electronic fuses, a radio system circuit, a communication circuit, a circuit of an encryption and/or decryption system, a circuit of an individualization system, a circuit of a game device, a circuit of a simulation system, a circuit of a computer system, a circuit of a noise source, a circuit with a device for generating and/or using a spreading code, a circuit with a device for generating and/or using a random number for individualizing the circuit, a circuit with a device for generating and/or using a random number for test purposes, in particular for self-test purposes and/or in particular for purposes of testing an application circuit of which the circuit is a part. The document presented here thus discloses a microcontroller, a microprocessor, a memory, a DRAM, an SRAM, a RAM, a volatile memory, an OTP memory, an EEPROM, a flash memory, an MRAM, an FRAM, a sensor evaluation circuit, a control circuit for an automotive control circuit, a graphics controller, an evaluation circuit for a biometric sensor or an input device, a control circuit, a chip card circuit, an RFID circuit, a physical circuit of a cell phone or a smartphone, a circuit of an access control system, a circuit with a coded recording of operating parameters, a circuit of an access control system, a circuit of a security system of electronic fuses, a radio system circuit, a communication circuit, a circuit of an encryption and/or decryption system, a circuit of an individualization system, a circuit of a game device, a circuit of a simulation system, a circuit of a computer system, a circuit of a noise source, a circuit with a device for generating and/or using a spreading code, a circuit with a device for generating and/or using a random number for individualizing the circuit, a circuit with a device for generating and/or using a random number for test purposes, in particular for self-test purposes and/or in particular for purposes of testing an application circuit of which the circuit is a part, with a quantum process-based generator for real random numbers according to the disclosure and/or the use of random bits and/or random numbers of the quantum process-based generator for real random numbers according to the disclosure in a microcontroller, a microprocessor, a memory, a DRAM, an SRAM, a RAM, a volatile memory, an OTP memory, an EEPROM, a flash memory, an MRAM, an FRAM, a sensor evaluation circuit, a control circuit for an automotive control circuit, a graphic controller, an evaluation circuit for a biometric sensor or an input device, a control circuit, a chip card circuit, an RFID circuit, a physical circuit of a cell phone or a smartphone, a circuit of an access control system, a circuit with an encoded record of operating parameters, an access control system circuit, an electronic security system circuit, a radio system circuit, a communication circuit, an encryption and/or decryption system circuit, an individualization system circuit, a game device circuit, a simulation system circuit, a computer system circuit, a noise source circuit, a circuit with a device for generating and/or using a spreading code, a circuit with a device for generating and/or using a random number for individualizing the circuit, a circuit with a device for generating and/or using a random number for test purposes, in particular for self-test purposes and/or in particular for purposes of testing an application circuit of which the circuit is a part.

In variations of the disclosure, the integrated circuit has (internal interfaces as specialized circuitry at a cryptographic boundary between a control device and other parts of the microelectronic integrated circuit that are classified as non-secure or less secure, and the quantum process-based true random number generator is located within the cryptographic boundary between the control device and the other parts of the microelectronic integrated circuit.

In variants of the disclosure, the entropy source comprises a photon source and a photon detector, wherein the photon source is arranged to emit photons as a quantum signal when supplied with electrical energy, and wherein the photon source is optically coupled to the photon detector. In this variant of the disclosure, the photon detector is set up to at least partially receive the quantum signal of the photon source and to generate an output signal of the entropy source or a precursor signal thereof.

In one variant of the disclosure, the photon source comprises a silicon LED, in particular a Zener-avLED or a SPAD diode.

In variants of the disclosure, the quantum process-based generator is placed in whole or in part in a pad frame between connection pads of the integrated circuit on the die of said integrated circuit, wherein at least the entropy source is placed in the pad frame between the connection pads of the integrated circuit on the die of said integrated circuit.

In variants of the disclosure, the entropy source of the quantum process-based generator is encapsulated, in particular by means of metal layers and/or silicide layers and vias, except for signal feedthroughs through this encapsulation from at least one side, better from at least two sides, better from at least three sides, better from at least four sides, better from at least five sides.

According to one aspect of the present disclosure, there is provided a device comprising: a preferably unitary, preferably monolithic, micro-integrated circuit comprising one or more processors (10-1, 10-2) and one or more non-volatile memories preferably storing at least one security code; a first preferably read/write memory external to or within the integrated circuit storing data, the data being preferably cryptographically protected in a first format; and preferably a second read/write memory external to or within the integrated circuit for storing data; wherein the device is arranged to transfer data from the first memory to the second memory via a device of the integrated circuit for access by the processor from the second memory; the integrated circuit is arranged to validate, during the transfer, the data read from the first memory using a security code stored in the non-volatile memory and, when the data is validated, to apply cryptographic protection in a second format to the validated data using a security code stored in the non-volatile memory and to store the data protected in the second format in the second memory. Thereby, the proposed device utilizes a quantum technology-based micro-integrated random number generator (QRNG 28) for encryption. Such a random number generator provides a true random number since the random number generation process is based on an unpredictable quantum process.

By transmitting data through the integrated circuit devices and using the integrated circuit devices to validate data and protect the transmitted data, security is maintained as validation is performed within the integrated circuit and protection is applied.

Cryptographic protection of the data in the first and second memory based on one or more security codes in the non-volatile memory of the integrated circuit secures the data.

In one embodiment, only validated data from the first memory is processed, and when data is read by the processor from the second memory, only validated data from the second memory is processed.

In one embodiment, the second memory is a random access memory (RAM) for the processor, which allows the processor to store and retrieve individual words that are individually protected, as opposed to the first memory, which is a read-only memory (ROM) and which only allows read access to a data set.

The disclosure also provides a data processing apparatus comprising:

An integrated circuit comprising a processor, a non-volatile memory storing at least one security code, a hash calculator and an interface at the boundary of the integrated circuit; and a memory within or external to the integrated circuit for storing data for use by the processor the memory, when external to the integrated circuit, being preferably coupled to the processor via an interface at the boundary of the integrated circuit for receiving data, for example in the form of data words, from the processor and supplying data words to the processor. The processor and the hash calculator are arranged to perform the steps of
a. Calculating the hash using a hash function for each data word depending on a security code stored in the non-volatile memory and storing the hash in conjunction with the data word,
b. retrieving stored data words from memory, recalculating a hash function for each retrieved data word using the security code and comparing the recalculated hash value with the stored hash value, and
c. Allow the retrieved data word to be processed by the data processing system only if the newly calculated hashes and the stored hashes have a previously defined relationship.

Examples of the proposal are now described by way of example with reference to the accompanying drawings.

A true random number generator (quantum random number generator 28) according to the disclosure comprises a photon source 54 with a flux of detected photons λ transported horizontally in an optical waveguide 44 58, one or more photon detectors 55, preferably single photon detectors (SPADs), and electronic sampling means (403, 2022, 402, 403, 404.2) operatively connected to the one or more photon detectors 55 to generate a bit sequence of quantum random bits 411 (random bit sequence) based on the number of photons detected in the photon detectors 55.

Said true random number generator, hereinafter referred to as quantum random number generator 28 (QRNG), is characterized in that the photon source 54 and the photon detector(s) 55 are arranged as close as possible to each other and optically directly or indirectly coupled and integrated in a single semiconductor substrate 49. Preferably, the photon source 54 and the photon detector(s) 55 are fabricated in a common semiconductor substrate 49 in a CMOS technology, preferably a BCD technology. In an example, the photon source 54 comprises a silicon LED and/or a silicon laser. For example, the photon source 54 may comprise a first SPAD diode 54. For example, the photon detector 55 may comprise a photodiode, For example, the photon detector 55 may comprise a second SPAD diode 55.

The quantum random number generator 28 according to the disclosure can comprise a photon source 54 with a detected photon flux equal to A

It cannot be ruled out that the quantum random number generator 28 in an alternative embodiment comprises more than one photon source 54. However, this has the disadvantage of requiring a larger chip area.

According to an example of the proposal, the proposed quantum random number generator 28 preferably further comprises an array of one or more photon detectors 55.

Preferably, but not necessarily, each of these photon detectors 55 is a single photon detector 55. When realizing one or more photon detectors 55 as reverse biased PN diodes in a semiconductor substrate 49 with a bias voltage close to the breakdown voltage of the respective PN diode and a limitation of the breakdown current of the respective PN diode, one generally speaks of single photon avalanche photo diodes, which the document presented herein also designates with the acronym SPAD.

As mentioned above, a single photon detector 55 is capable of detecting and providing as output information on the incidence of a single photon in its sensitive volume and possibly on the arrival time of the latter within an observation window of a predetermined duration.

Between two successive observation windows, each photon detector 55 (each second SPAD diode 55) undergoes a phase of restoration of the initial conditions, which the document presented hereafter refers to as dead time. During the dead time of a second SPAD diode 55, this second SPAD 55 can no longer reliably detect any further subsequent photon.

Typically, in the array of SPAD-type photon detectors 54, each respective SPAD diode 55 operates independently and in parallel with the other SPAD diodes 55. Typically, the array of SPAD diodes 55 has a single common output for reading the respective signal generated externally by the same array of SPAD diodes 55.

The typical advantage of an arrangement of closely spaced SPAD diodes 55 is typically that the solid angle of the photons 58 generated by the photon source 55 is increased and that any dead times are reduced, thereby increasing the generation rate of the quantum random bits 411 of the quantum random number generator 28 and thus the rate of the quantum random data words 418 themselves. This in turn enables the encryption of larger amounts of data.

While the technical teaching of EP 3 529 694 B1 still a coupling via the semiconductor substrate 49, the technical teaching presented here proposes a first improved coupling of the photon source, for example the first SPAD diode 54 and/or the silicon LED, with the photon detector 55, here, for example, with the second SPAD diode 55, via a light-optical system, for example an optical waveguide 44, which should have a significantly lower absorption rate than the common semiconductor substrate 49 in which the photon source 54 and the photon detector 55 are manufactured. As a result, the generation rate of the quantum random bits 411 of the quantum random number generator 28 again increases dramatically compared to a device according to the technical teaching of EP 3 529 694 B1.

However, it cannot be excluded that according to an alternative embodiment of the proposal, the quantum random number generator 28 always comprises an array of second SPAD diodes 55 as an array of photon detectors 55, but each SPAD diode 55, respectively each photon detector 55 are independent from the others, which means that these device parts can each individually generate a respective signal to the outside, which is typically each independent from the signals of the other SPAD diodes 55, respectively from the other photon detectors 55. According to another embodiment of the proposed quantum random number generator 28, the arrangement may be divided into subgroups of SPAD diodes 55 and/or subgroups of photon detectors 55, each subgroup comprising a predetermined number of SPAD diodes 55 and/or photon detectors 55, preferably each connected in parallel with each other such that they each generate a single signal outwardly with respect to the entropy source 401 of the quantum random number generator 28.

In the latter case, each of the subsets of SPAD diodes 55 or photon detectors 55 may be to the outside world of the entropy source 401 of the quantum random number generator 28 independently of the other subsets of SPAD diodes or photon detectors.

This independence has the advantage that the extraction of the binary random sequences of quantum random bits 411 from the quantum random number generator 28 can be parallelized, which further increases the bit rate of the quantum random number generator 28 by space multiplexing.

According to another embodiment, the quantum random number generator 28 of the proposal may also comprise only exactly one second SPAD diode 55 or also only exactly one photon detector 55.

Again, as mentioned above, a further embodiment of the quantum random number generator 28 may comprise a plurality of photon sources 54 or silicon LEDs 54 or first SPAD diodes 54, each optically connected to an array of photon detectors 55 or second SPAD diodes 55 via an optical system (44) external to the semiconductor substrate 49. Preferably, said optical system 44 comprises micro-optical device components. Preferably, these micro-optical device parts comprise one or more optical waveguides 44 and/or one or more specular layers 53 and/or specular and/or optically refracting structures 53. Preferably, the optical waveguide 44 is fabricated in the metallization stack on the semiconductor substrate 49 of the microelectronic circuit, which typically comprises the photon source or silicon LED 54 or first SPAD diode 54 and the photon detector 55 or second SPAD diode 55. The optical system—for example the optical waveguide 44—the photon sources 54 and the photon detectors 55 are therefore preferably part of the one-piece quantum random number generator 28.

In other words, if the combination of a photon source 55 and/or a silicon LED 54 and/or a SPAD diode 54 on the one hand with one or more photon detectors 55 and/or one or more SPAD diodes 55 on the other hand defines pixels as defined herein, the one embodiment of the entropy source 401 of the proposed quantum random number generator 28 may be considered, for example, as a pixel matrix that allows the process of extracting random numbers to be parallelized.

As far as the photon source 54 or the silicon LED 54 or the first SPAD diode 54 is concerned, according to an example, this also preferably comprises one or more SPAD diodes 54. In this case, both the arrangement of the photon detectors 54 or of the second SPAD diodes 54, which serve as receivers, as well as the photon sources 54 or the silicon LEDs 54, which preferably comprise one or more SPAD diodes 54, are configured and polarized in such a way that they operate in the so-called Geiger mode with the same polarization voltage.

As mentioned above, the quantum random number generator 28 of the proposal preferably also comprises electronic sensing means (403, 2022, 402, 403, 404.2) preferably operatively to the common output 417 for reading the signal 405 generated by the array of photon detectors 54 and/or the second SPAD diodes 54.

It is conceivable that in another embodiment, one or more of the respective electronic sampling means (2022, 402, 403, 404.2) may instead be provided for each respective photon detector 54 or each respective second SPAD diode 54, respectively, each belonging to the array, while individual electronic sampling means of the electronic sampling means (2022, 402, 403, 404.2) are provided for the respective individual photon detector 54 or for the respective individual second SPAD diode 54, respectively. Finally, in one embodiment, some or more respective sampling means of the electronic sampling means (2022, 402, 403, 404.2,) may be provided for each pixel, the sampling signals (407, 407) of which are combined into a common quantum random bit data stream 411 by means of electronic post-processing.

The document presented here proposes to manufacture these electronic scanning means (403, 2022, 402, 403, 404.2) together or at least in large parts with the photon sources 54 or silicon LEDs 54 or first SPAD diodes 54 and together with the photon detectors 55 or the second SPAD diodes 55 in a common semiconductor substrate 49 as a one-piece micro-integrated circuit. The document presented here proposes to electrically interconnect these electronic sensing means (403, 2022, 402, 403, 404.2) together with the photon sources 54 or silicon LEDs 54 or first SPAD diodes 54 and together with the photon detectors 55 or second SPAD diodes 55 via the metallization stack of the thus fabricated one-piece micro-integrated circuit on the surface of the semiconductor substrate 49 by means of metallic electrical conductors. The document presented here proposes to optically interconnect these photon sources 54 or silicon LEDs 54 or first SPAD diodes 54 and with the photon detectors 55 or second SPAD diodes 55 via the metallization stack of the one-piece micro-integrated circuit thus fabricated on the surface of the semiconductor substrate 49 by means of dielectric optical waveguides 44. The metallization stack of the one-piece micro-integrated circuit thus fabricated on the surface of the semiconductor substrate 49 typically comprises patterned metal layers that typically form the electrical conductive paths (141, 142) in different planes of the metallization stack. The metallization stack of the thus fabricated one-piece micro-integrated circuit on the surface of the semiconductor substrate 49 typically comprises electrical insulation layers between these patterned metallization layers (141, 142), which electrically insulate the electrical conductors (141, 142) formed in the patterned metallization layers between different metallization planes from each other. The electrical insulation layers of the metallization stack of the one-piece micro-integrated circuit thus fabricated on the surface of the semiconductor substrate typically comprise electrical vias 140 between the electrical leads (141, 142) of the patterned metallization layers, which electrically connect (vias) the electrical leads (141, 142) formed in the patterned metallization layers between these different metallization planes to each other. The metallization stack of the thus fabricated one-piece micro-integrated circuit on the surface of the semiconductor substrate 49 typically comprises optically transparent electrical insulation layers between these patterned metallization layers. As a result, one or more electrical insulation layers can assume the function of an optical light waveguide 44 for the photons of the first SPAD diode 54 or the photon source 54 or the silicon LED 54 during their transport to the second SPAD diode 55 or the photon detector 55. Preferably, the relevant insulation layers are structured for this purpose.

In any case, the electronic sensing means (403, 2022, 402, 403, 404.2) of such a one-piece microelectronic circuit are preferably configured to implement a predefined logical procedure or computer or hardware implemented algorithm for extracting a binary sequence of quantum random bits 411 based on the arrival times of the photons at the level of the respective photon detectors 55 or SPAD diodes 55. Some preferred examples of the logical extraction method are described in detail below in the document provided herein.

According to a proposal, in the quantum random number generator 28, the photon source 54 or the silicon LED 54 or the first SPAD diode 54 and the array of photon detectors 55 or of second SPAD diodes 55 or the single SPAD detector 54 are arranged next to or below each other and preferably close to each other with a short optical connection for optical coupling via an optical path that is as short as possible and integrated into a single semiconductor substrate 49 as a microelectro-optical system.

This results in the photon current λ generated by the photon source 54 or the silicon LED 54 or the first SPAD diode 54, for example, flowing through the optical waveguide 44 in the metallization stack of the microelectronic circuit towards the photon detectors 55 or second SPAD diodes 55 arranged in the preferably nearby arrangement (a phenomenon actually known as “optical crosstalk”). second SPAD diodes 55 (a phenomenon actually known as “optical crosstalk”), unlike in the known random number generators where the same photons flow through the empty coupling gap between the two components which are physically separated from each other, i.e. typically not integrally fabricated with the sensing means on a semiconductor substrate 49.

Advantageously, this integrated configuration makes the quantum random number generator 28 of the proposal of the present document more compact and structurally less complex than the random number generators of the known type.

Thanks to the one-piece integration of all components of the quantum random number generator 28, it is also more robust and immune to external environmental influences and any attempts at manipulation by malicious persons.

A metal cover 142 made of a preferably soft metallic and/or an electrically highly conductive material, for example a gold layer on an iron layer, can shield the entropy source. Preferably, an electrical connection, which may also comprise vias (e.g. 140), connects the metal cover 142 to a defined electrical potential, for example a ground line or a supply voltage line.

This integrated configuration and thus the direct and/or indirect coupling between the photon source 54 or the silicon LED 54 or the first SPAD diode 54, on the one hand, and the photon detector(s) 55 or the second SPAD diodes 55, on the other hand, are advantageous compared to the solutions in which, for example, discrete beam splitters are used, since they enable uniform illumination of the photon detectors 55 or the second SPAD diodes 55 without having to ensure that the beam splitter is always perfectly aligned.

According to the example, the photon source 54 and/or the silicon LED 54 and/or the first SPAD diode 54 and the array of photon detectors 55 and/or the second SPAD diodes 55 are fabricated on the semiconductor substrate 49 in the same fabrication steps, so that the elements have the same chemical-physical structure with respect to the doping profiles. More specifically, as mentioned above, even the photon source 54 or the silicon LED 54 or the first SPAD diode 54 can be fabricated with the same chemical-physical structure as another photon detector 55 or another second SPAD diode 55. The photon source 54 or the silicon LED 54 or the first SPAD diode 54 is completely identical in design and realization to the photon detectors 55 or the second SPAD detectors 55 belonging to the array, except for usual variations of components on a wafer, in certain embodiments of the proposal.

This has the advantage that the manufacturing costs of the various components of the proposed quantum random number generator 28 can be drastically reduced, since it is possible to manufacture one or more photon sources 54 or silicon LEDs 54 or first SPAD diodes 54 and/or one or more photon detectors 55 or SPAD diodes 55 on the same semiconductor substrate 49 without having to change, in particular increase, the number of manufacturing steps. The manufacturing costs thus remain approximately the same.

According to an example, the semiconductor substrate 49 is a silicon substrate 49.

However, it cannot be excluded that in various examples of the disclosure the semiconductor substrate 49 is made of a semiconductor material other than silicon in order to increase the efficiency of the emitter-source coupling. In this context, the document presented here particularly mentions the use of direct semiconductors with a direct transition for the electrons without a lattice bump for pulse change.

As regards the arrangement of the photon detectors 55 or second SPAD diodes 55, it is known that preferably each of them comprises mainly a favorably doped p-n junction, so that the phenomenon known in the art as “avalanching” may occur when the same photon detector 55 or SPAD diode 55, which is favorably polarized, is exposed to the impact of a photon in its photon-sensitive volume.

The photon source 54 or silicon LED 54 or first SPAD diode 54 is also defined by a suitably doped p-n junction in such a way that the detected photon flux 2 is generated when the photon source 54 or silicon LED 54 or first SPAD diode 54 is suitably biased in the forward direction or (better) in the reverse direction. If a first SPAD diode 54 is polarized in the reverse direction, this results in a pulsed dark current of the diode current, the so-called dark current, which is associated with a pulsed emission of photons that can be detected by the photon detector 54 or the second SPAD diode 55.

In particular, according to an example of the disclosure, the photon source 54 or silicon LED 54 or first SPAD diode 54 is configured to obtain an emission spectrum of the detected photon flux 2 that is mainly between 800 nm and 1000 nm. In this spectrum, the efficiency of each photon detector 55 or second SPAD diode 55 cannot be considered excessively high and is less than 10%. Therefore, it is estimated that to obtain a detection rate of, for example, about 500,000 counts/see, a usable photon rate (photon flux reaching the sensitive volume of the photon detector 55 or second SPAD diode 55 or photon detectors 55 or second SPAD diodes 55 from the photon source 54 or silicon LED 54 or first SPAD diode 54) of more than 5,000,000 ph/sec is required.

Returning to the fabrication of the quantum random number generator 28, the fact that the structures of the photon source 54 or the silicon LED 54 or the first SPAD diode 54 both have a p-n junction as a main feature confirms the advantage described above, i.e. the possibility of performing the same fabrication steps for the photon source 54 or the silicon LED 54 or the first SPAD diode 54 and the photon detectors 55 or the second SPAD diodes 55.

Preferably, but not necessarily, according to the example of the disclosure, the photon source 54 or the silicon LED 54 or the first SPAD diode 54 and the photon detectors 55 or the second SPAD diodes 55 obtained by the same manufacturing steps have the same chemical-physical structure. However, it cannot be excluded that in different embodiments of the quantum random number generator 28 according to the disclosure, the photon source 54 or the silicon LED 54 or the first SPAD diode 54 and the photon detectors 55 or the second SPAD diodes 55 may be produced with different chemical-physical structures, in particular with different sizes and/or different doping levels, even if they are obtained by the same manufacturing steps.

As far as the technology for integrating these components into the semiconductor substrate 49 is concerned, according to the example of the disclosure, this is the CMOS or CMOS-compatible technology of microfabrication of microintegrated circuits. So-called BCD technologies are also particularly preferred for the manufacture of the proposed one-piece microelectronic circuit of the quantum random number generator 28.

BCT technologies are key technologies for integrated power circuits. A BCD technology is characterized by the combination of bipolar electronic components (e.g. bipolar transistors and/or PN diodes) with CMOS components (e.g. CMOS transistors or CCD arrays) with DMOS components (e.g. a DMOS transistor).

The DMOS transistor typically comprises a double-diffusion structure in which the p-region and the n-region serve as lines. It is a type of DMOS power transistor developed for radio frequency (RF) applications. It can be operated with relatively high supply voltages of 50 to 100 V and is characterized by high reliability, peak performance and robustness. A DMOS transistor (Double-Diffused Metal-Oxide-Semiconductor transistor) is a crucial element in integrated microelectronic circuits. In contrast to conventional CMOS transistors, a DMOS transistor is characterized by specific features that define its function and areas of application.

A DMOS transistor has a special structure. In this structure, doping regions with different electrical charge carrier concentrations are present in the semiconductor material. These doping regions enable the DMOS transistor to switch higher powers and offer a lower on-resistance compared to CMOS transistors. These properties are particularly advantageous in high-power applications. In the present case, DMOS transistors are suitable for use in the voltage converters 91 of the monolithic integrated circuit. At the same time, BCD technologies enable the compact fabrication of the first SPAD diodes for the photon sources 54 and the second SPAD diodes 55 the photon detectors 55. Since the first SPAD diodes 54 typically require a higher supply voltage when used as photon sources 54, the voltage converters 91 very often comprise a charge pump or the like to supply the first SPAD diodes 54 with the required high supply voltage. Said DMOS transistors are particularly suitable for these charge pumps in the voltage converters 91 of the one-piece micro-integrated circuit of the quantum random number generator 28. Therefore, a co-integration of the entropy source 401 with at least one DMOS transistor or several DMOS transistors on a common semiconductor substrate 49 is particularly advantageous. Preferably, therefore, a voltage converter 91 of a one-piece microelectronic integrated circuit of a quantum random number generator 28 comprises at least one, more preferably several DMOS transistors. Preferably, the DMOS transistors of a respective voltage converter 91 of a one-piece microelectronic integrated circuit of a quantum random number generator 28 are located in a half-bridge or an H-bridge circuit within this voltage converter 91. Preferably, in the case of a half-bridge, an energy storage device, for example a capacitor, is connected to the output node of this half-bridge by means of a terminal and can then be recharged by this. Preferably, in the case of an H-bridge, an energy store, for example a capacitor, is connected with a first terminal to the output node of the first half-bridge of the H-bridge and is connected with a second terminal to the output node of the second half-bridge of the H-bridge and can then be recharged by this. Preferably, such a voltage converter 91 then comprises an electronically controlled transfer switch which, after switching up the voltage at one terminal of the capacitor, can connect the other terminal to a photon source 54 or a silicon LED 54 or a first SPAD diode 54. This step-up technique for the supply voltage can also be multi-stage in order to achieve larger voltage boosts. A further voltage converter 91 and an energy storage device, for example a further capacitor, can be connected downstream and upstream of the entropy source 401 and/or the photon source 54 and/or the silicon LED 54 and/or the first SPAD diode 54 in order to stabilize the supply voltage of the photon source 54 and/or the silicon LED 54 and/or the first SPAD diode 54. Preferably, the half bridge and/or the H-bridge and/or the transfer switches of the voltage converter 91 comprise DMOS transistors in order to be able to provide higher supply voltages and thus the quantum random bit data rate of the quantum random bits 411, since the increase in the supply voltage leads to an increase in the pulse density of the entropy source.

Another characteristic feature of a DMOS transistor is its ability to handle higher voltages, which makes it ideal for applications with high voltage ranges. This aspect distinguishes it from CMOS transistors, which are generally designed for lower voltages.

The word BCD technology stands for Bipolar-CMOS-DMOS technology. BCD technology is a family of silicon processes that combine the strengths of three different process technologies on a single chip, enabling compact one-piece quantum random number generators in the form of a single micro-integrated circuit 2.

The advantage of the CMOS microfabrication technique, more precisely the BCD microfabrication technique, is that it is also possible to integrate the scanning means (403, 2022, 402, 403, 404.2) for the output signals of the array of photon detectors 55 or the second SPAD diodes 55 into the semiconductor substrate 49.

An example of a possible quantum random number generator 28 of the proposal obtained by the BCD microfabrication technique preferably utilizes a p 100 type doped substrate/epitaxial structure. The fabrication process typically creates a deep n-well in the p 100 type doped substrate/epitaxial structure and the interconnects defining the photon source 54 or the silicon LED 54 or the first SPAD diode 54, respectively, are fabricated with a p+ type implant 102. To avoid electric fields that are higher at the edges of the sensitive area than in the center thereof, “guard ring” structures are preferably provided to form a ring of p-well around the p+ implant 47.

However, it cannot be excluded that in various embodiments of the disclosure, the technique used to manufacture the photon source 54 and/or the silicon LED and/or the first SPAD diode 54 may be a custom type technique. The advantage of this last solution is that the manufacturing steps of the quantum random number generator 28 according to the disclosure can be optimized to obtain the photon source 55 and/or the silicon LED 55 and/or the second SPAD diode 55.

According to an example implementation of a quantum random number generator 28 using a customized fabrication technique, the photon detectors 55 or the second SPAD diodes 55 and the photon source 54 or the silicon LED 54 or the first SPAD diode 54 may be integrated into a doped epitaxial structure/substrate of type p, with a so-called “flat implant” and an enhancement implant in the epitaxial structure/substrate, the first SPAD diode 54 can be integrated into a doped epitaxial structure/substrate of type p, wherein a so-called “flat” implant and an enhancement implant are defined in the epitaxial structure, wherein the “flat” implant is more superficial, of type n+ and concentric to the epitaxial structure, but having a smaller extension, and the enrichment implant is of type p− and has a lower doping, but in any case a higher doping than that of the epitaxial structure.

In this way, a so-called “virtual guard ring” structure is created. In order to avoid problems related to “charge crosstalk” or “charge injection” caused by the common epitaxial structure of the two implants, it is possible to separate either the photon source 55 or the silicon LED 55 or the SPAD diodes 55 and the photon detector(s) 54 or the silicon LED 54 or the first SPAD diodes 54 by spacing them appropriately, or to create deep trenches, so-called trenches. silicon LED 54 or first SPAD diodes 54 by arranging them at suitable distances, or to create deep trenches, so-called trenches, at which surround both the area of the photon source 54 or silicon LED 54 or first SPAD diode 54 and the area of the photon detector(s) 55 or second SPAD 55. Finally, it is possible to create an auxiliary connection which, if suitably biased, captures the excess charge that may be transferred from the photon source 54 and/or silicon LED 54 and/or first SPAD diode 54 to the photon detector(s) 55 and/or second SPAD diode 55 and/or second SPAD diodes 55. The creation of trenches would also reduce optical crosstalk, which again is a desired feature. However, this reduction does not exceed a percentage in the order of 30-50%, so it is acceptable if it has the benefit of completely eliminating the problem.

As explained above, the proposed quantum random number generator 28 is configured such that the photon source 54 and/or the silicon LED 54 and/or the first SPAD diode 54 can be selectively biased in the forward direction or in the reverse direction to generate the detected photon flux 2.

In the case of reverse bias, photoluminescence is used in the avalanche formation in the photon source 54, in this case the silicon LED 54 or the first SPAD diode 54, which occurs in a controlled manner but at quantum mechanically random time intervals.

With a forward bias, the photons generated behave very similarly to a reverse bias, and the generation efficiency (photons per electric charge passed) is relatively similar or higher, but with a forward bias the power dissipation can be reduced compared to a reverse bias because a lower voltage is applied.

To give an order of magnitude, a forward biased photon source 54 or silicon LED 54 or first SPAD diode 54 requires a voltage of a few volts, while a reverse biased photon source requires a voltage of several tens of volts. In developing the technical teachings of the present document, it has been recognized that the use of DMOS transistors is particularly advantageous for the co-integrability of preferably all relevant electronic components of a quantum random number generator 28. Such DMOS transistors make it possible to provide a voltage of several tens of volts for operating the reverse photon sources 54, i.e. in this case the reverse biased silicon LEDs 54 or first SPAD diodes 54, by a voltage converter 91, which in the sense of the document presented here can comprise any form of suitable voltage converter 91 in terms of content and which is preferably in the semiconductor substrate 49 of the one-piece microelectronic integrated circuit of the quantum random number generator 28 presented here. In elaborating the technical teaching of the present document, it has thus been realized that for the co-integratability of these DMOS transistors with the other relevant electronic components of the quantum random number generator 28 presented herein, the use of a BCD semiconductor technology is particularly advantageous for the fabrication of the quantum random number generator 28 presented herein. Thus, the document presented herein proposes a quantum random number generator 28 comprising a voltage converter 91 comprising one or more DMOS transistors and an entropy source 401 comprising one or more photon sources 54 and/or silicon LEDs 54 and/or first SPAD diodes 54 and one or more photon detectors 55 and/or second SPAD diodes 55 and preferably one or more processors (10-1, 10-2) and/or one or more data bus interfaces 64 and/or one or more volatile and/or non-volatile memories (30, 6, 16, 8) and/or a test interface 12.

A forward biased photon source 54 or silicon LED 54 or first SPAD diode 54 in one device embodiment would therefore advantageously allow to also reduce the space required to electrically isolate the photon source 54 or silicon LED 54 or first SPAD diode 54 itself from the array of photon detectors 55 or second SPAD diodes 54. As a result, the forward photon source 54 and/or silicon LED 54 and/or first SPAD diode 54 advantageously allows for a more compact design of the quantum random number generator 28 and lower cost due to the smaller amount of semiconductor material used to fabricate the generator itself. However, since the structure and manufacturing technique of the photon source 54 or silicon LED 54 or first SPAD diode 54 and the photon detectors 55 or second SPAD diodes 55 are similar or even identical, the advantage of reverse biasing is that the same voltage can be used to bias both components.

This last device variant makes it possible to reduce the complexity and overall dimensions of both the structure and the external circuitry that may still be required: Namely, the photon source 54 or silicon LED 54 or first SPAD diode 54 and the photon detectors 55 or second SPAD diodes 55 can the same semiconductor substrate 49, since they have a common connection. As a result, they can be arranged close to each other (one above the other and/or next to each other) in the semiconductor substrate 49, which reduces the space occupied and at the same time improves their optical coupling.

In any case, the low efficiency of the photoluminescence process in generating fewer photons argues in favor of “quantum detection”, since the photon detector(s) 55 or second SPAD diode(s) 55 is/are by definition sensitive to a single photon.

As mentioned above, in the example of the proposal, the electronic sensing means (403, 2022, 402, 403, 404.2) are also integrally integrated into the semiconductor substrate 49 together with the photon source 54 or silicon LED 54 or first SPAD diode 54 and the array of photon detectors 55 or second SPAD diodes 55.

In this case, the electronic sensing means (403, 2022, 402, 403, 404.2) may be configured not only to read the signal or signals 405 generated by the array of photon detectors 55 or second SPAD diodes 55, respectively, but also to directly and easily control the operating conditions of one or more photon sources 54 or one or more silicon LEDs 54 or one or more first SPAD diodes 54, respectively, and to control any bias parameters by means of parameter modification of one of said voltage converters 91 for energizing one or more photon sources 54 or one or more first SPAD diodes 54, respectively, one or more first SPAD diodes 54 and to directly and easily control the operating conditions of one or more photon sources 54 or one or more silicon LEDs 54 or one or more first SPAD diodes 54 and to correct any bias parameters by changing parameters of one of said voltage converters 91 for energizing one or more photon sources 54 or one or more silicon LEDs 54 or one or more first SPAD diodes 54 or to activate or deactivate one or more photon sources 54 or one or more silicon LEDs 54 or one or more first SPAD diodes 54 to obtain the desired photon flux or the desired random bit rate of the quantum random bits 411.

In this case, the electronic sensing means (403, 2022, 402, 403, 404.2) may be configured to directly and easily control the operating conditions of one or more photon detectors 55 or one or more second SPAD diodes 54, and to correct any bias parameters by means of parameter modification of one of said voltage converters 91 for energizing one or more photon detectors 55 or one or more second SPAD diodes 55, or to activate or deactivate one or more photon detectors 55 or one or more second SPAD diodes 55 to obtain the desired receivable portion of the photon flux or the desired one or more second SPAD diodes 55 or activate or deactivate one or more photon detectors 55 or one or more second SPAD diodes 55 in order to obtain the desired receivable portion of the photon flux or the desired random bit rate of the quantum random bits 411.

According to an example of the proposal of the present document, the quantum random number generator 28 is preferably provided with a light protection filter or cover, for example a metal layer (53, 142), at the level of the top surface of the semiconductor substrate 49. In particular, preferably but not necessarily, the light protection filter comprises a metallization layer (53, 142) which can be produced directly during the production process, for example by the sequence of process steps of a BCD technology, for example as last metallization layer. This metal layer (53, 142) does not necessarily have to be the last to be produced. It is typically sufficient if the relevant device parts of the entropy source 401 are covered. Preferably, further device parts of the one-piece, micro-integrated circuit of the quantum random number generator 28 are covered with this metal cover (53, 142), so that it also these circuit parts from manipulation by means of electromagnetic radiation and/or thermal, local stress and/or by means of magnetic fields and/or other interventions by influencing physical parameters of such, other circuit parts of the quantum random number generator 28. This protection should preferably in particular protect the memories (e.g. 404.9, 30, 6, 8, 16, 22, 20) and/or the processor (10-1, 10-2) and/or the monitoring devices-such as watchdog 404.5, ADC 403, the voltage monitor 413, —the amplifier 402, the finite state machine 404.8 This solution has the function of shielding the photon detector(s) 55 or second SPAD diodes 55 or the other circuit parts of the quantum random number generator 28 from external light and other physical interference signals. This solution thus also has the function making the photon detector(s) 55 or second SPAD diodes 55 sensitive only to the photons that pass through the semiconductor substrate 49 to the photon detectors 55 or second SPAD diodes 55 due to crosstalk from the photon source 54 or silicon LED 54 or first SPAD diode 54. In addition, the metallization layer (53, 142) also has the function of improving the coupling of the photons emitted by the semiconductor substrate 49, in particular the silicon substrate. For this purpose, the metallization layer 53 reflects the electromagnetic radiation generated by the same photon source 54 or silicon LED 54 or first SPAD diode 54 back into the isolation layers of the metallization stack on the semiconductor substrate 49 after it exits the semiconductor material of the semiconductor substrate 49, so that these photons cannot leave the micro-optical system of the one-piece microelectronic circuit of the quantum random number generator 28. This increases the number of photons reaching the photon detector(s) 55 or the second SPAD diode(s) 55. This in turn increases the random bit data rate of the quantum random bits 411 of the quantum random number generator 28. This thus strengthens the optical coupling between the photon source 54 or silicon LED 54 or first SPAD diode 54 on the one hand and the array of photon detectors 55 or second SPAD diodes 55 on the other hand.

In addition, the metal cover 53 of the optical waveguide 44 in the metallization stack of the microelectronic circuit on the semiconductor substrate 49 advantageously also has the function of protecting the quantum random number generator 28 from any attempts by malicious persons to interfere with the functionality of the system of the device according to the proposal.

Consequently, the presence of the metallization in the form of a metal cover (53, 143) makes it possible to ensure greater security and reliability of the random numbers generated by the quantum random number generator 28 according to the disclosure.

Finally, the proposed quantum random number generator 28 may optionally also comprise electronic post-processing means (404.3, 404.4, 404.8) configured to receive as input the binary sequences extracted by the electronic sampling means (403, 2022, 402, 403, 404.2), which are in turn to the array of photon detectors 55 or second SPAD diodes 55.

Said electronic post-processing means (404.3, 404.4, 404.8) are preferably configured to process said binary sequences 409, 415 so as to perform a so-called “whitening” operation. This last word designates a plurality of compression operations which serve to improve the statistical properties of the binary sequences (415, 409) generated. As a result, it is advantageous that this further post-processing step makes it possible to increase the entropy level of the proposed quantum random number generator 28.

As mentioned above, the sampling means (403, 2022, 402, 403, 404.2) connected according to the preferred embodiment to the array of photon detectors 55 or second SPAD diodes 55, or alternatively to a subset of the photon detectors 55 or second SPAD diodes 55, or even to a single pixel, are configured to implement a logic extraction method designed to extract a binary sequence of random bits (409). second SPAD diodes 55, or even to a single pixel, are configured to implement a logic extraction method designed to extract a binary sequence of random bits (409, 415) based on the number of photons detected in the array of photon detectors 55 or second SPAD diodes 55, in the subset, in the single one of the photon detectors 55 or second SPAD diodes 55, or even in the single pixel. Proposedly, a first logical extraction method implemented by the sampling means (2022, 402, 403, 404.2) of the proposed quantum random number generator 28 comprises dividing the observation window of each photon detector 55 or each second SPAD diode 55 into a plurality of consecutive observation sub-windows Tw of typically the same duration. If the entropy extraction generates a pulse on its output line 405, a synchronization stage (403, 2022) synchronizes the pulse with the system clock 2106 of the quantum random number generator 28. One observation subwindow Tw typically corresponds to the temporal period duration of the system clock 2106.

According to the methods commonly used in the prior art, the post-processing means would now typically have to determine the arrival times of the photons detected at the photon detectors 55 or the second SPAD diodes 55 in relation to a reference time as a digital numerical value by means of a time counter. However, this has the disadvantage that an attacker may be able to manipulate this time via a so-called side channel, without it being possible to specify how this could be done. In the context of the document presented here, it is now assumed that the attacker succeeds in carrying out this manipulation in an unknown way. The attacker would then be able to manipulate the supposed “random bits”, which would give them a deterministic character that could possibly enable encryption and/or locks to be broken. The proposal presented here prevents this.

The one-piece microelectronic integrated circuit of the quantum random number generator 28 typically generates these successive observation sub-windows Tw starting from the system clock 2106. An observation window Tw as defined herein may, for example, start with a first edge of the system clock 2106 in a first edge direction, which may be rising or falling, and end with the next immediately following edge of the system clock 2106 of the same edge direction (rising or falling). The duty cycle of this system clock 2106 typically defines the time in which the photon detectors 55 or the second SPAD diode 55 is at the level of the dead time (system clock 2106=H [=high level]).

The special feature of the method proposed here for entropy extraction at the level of each subwindow Tw is the generation of a first pseudorandom number which corresponds to the arrival time of a second photon of the photon source 54 or the silicon LED 54 or the first SPAD diode 54 at a photon detector 55 or a second SPAD diode 55 relative to the arrival time of a preferably immediately preceding first photon of the photon source 54 or the silicon LED 54 or the first SPAD diode 54 at a photon detector 55 or a second SPAD diode 55. of the silicon LED 54 or the first SPAD diode 54 at a photon detector 55 or a second SPAD diode 55, respectively. The device of the one-piece microelectronic integrated circuit of the proposed quantum random number generator 28 proposed herein generates this first pseudorandom number by means of a time to pseudorandom number converter (TPRC). Such a time-to-random-number converter (TPRC) can also be composed of several stages. For example, the time to pseudo-random number converter (TPRC, 404.3) may comprise an analog instrument, a time to analog converter (TAC), which would then be followed by an analog to pseudo-random number converter (APRC) in the data path to again result in a time to pseudo-random number converter (TPRC, 404.3) in sum.

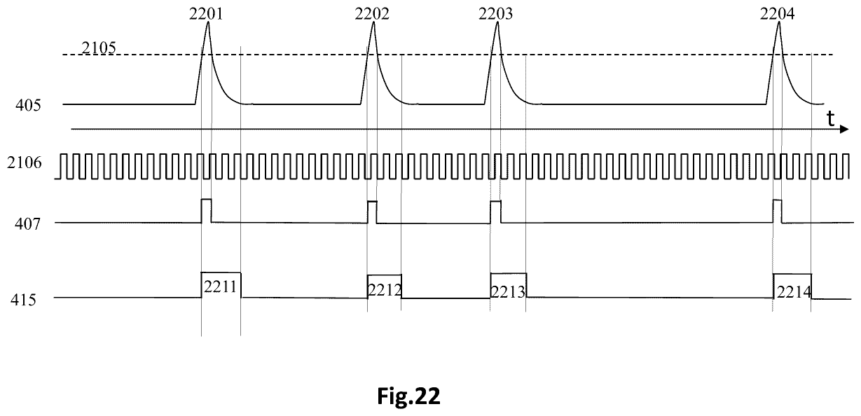

The diagram shown in FIG. 22 represents the detection of the pulses (2201, 2202, 2203, 2204) on the voltage signal 405 of the entropy source 401. The entropy source 401 preferably comprises the one or more photon sources 54 or the one or more silicon LEDs 54 or the one or more SPAD diodes 54 and the light transmission path 44 therebetween. The entropy source 401 is preferably fabricated in or on the semiconductor substrate 49 and thus preferably part of the micro-integrated circuit of the quantum random number generator 28. The output signal 405 of the entropy source 401 is typically said voltage signal 405 of the entropy source 401. The voltage signal 405 of the entropy source 401 is preferably the signal of one or more photon detectors 55 or one or more second SPAD diodes 55 of the entropy source 401.

The voltage signal 405 shows exemplary pulses 2201, 2202, 2203, 2104 for random events of the voltage signal 405. These may be spontaneous voltage pulses of the photon detector 55 or the second SPAD diode 55 of the entropy source 401, which are not related to the activity of the photon source 54 or the silicon LED 54 or the first SPAD diode 54 of the entropy source 401. However, the pulses 2201, 2202, 2203, 2204 of the photon detector 55 or the second SPAD diode 55 of the entropy source 401 may also be based on stimulated emission that causes the detection of a photon of the one or more photon sources 54 or the one or more silicon LEDs 54 or the one or more SPAD diodes 54 by the photon detector 55 or by the second SPAD diode 55 of the entropy source 401.

The time interval is random. However, after a photon has been received by the photon detector 55 or by the second SPAD diode 55 of the entropy source 401, a dead time occurs in which the photon detector 55 or the second SPAD diode 55 of the entropy source 401 is no longer capable of receiving. If the magnitude of the voltage signal 405 of the entropy source 401 exceeds a threshold value 2105, an analog-to-digital converter (ADC, 403), here an exemplary one-bit analog-to-digital converter 403, generates a signal,

pulse stretching circuit, which is preferably part of the one-piece microelectronic circuit, on a single-synchronized voltage signal 415, a pulse having a minimum length of n clocks of a system clock 2106 of the quantum random number generator 28, which is preferably one of the system clocks of the one-piece microintegrated circuit.

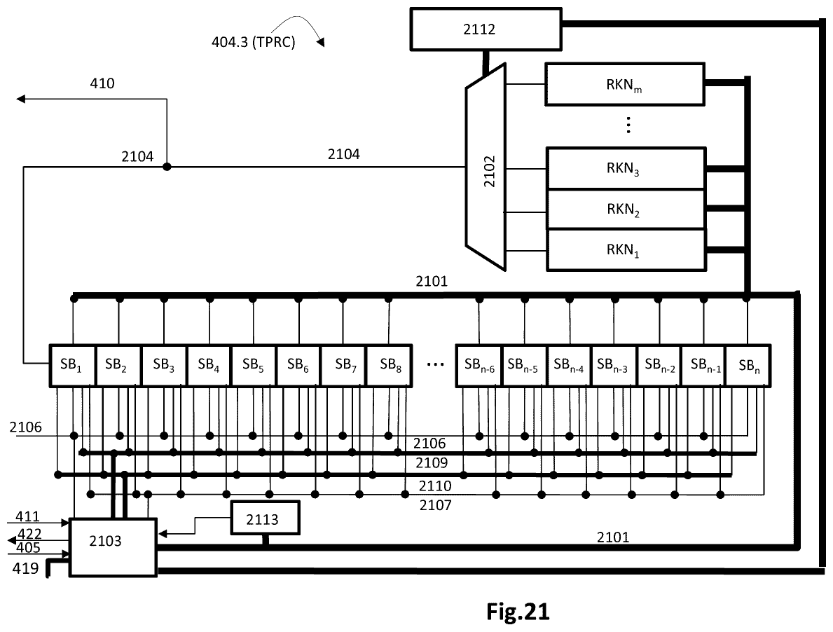

In the example in FIG. 21, for example, this pulse extension circuit is constructed in such a way that it goes to a first logic level for at least three subsequent clock pulses and then falls back to the next event at the second logic level, in this example with the falling edge of the third clock pulse. Instead of three clock pulses, a to n clock pulses can be used, where an integer is a positive number.

In the example of FIG. 21, the falling edges of the pulses 2211, 2212, 2213, 2214 of the single-synchronized voltage signal 415 represent the single-synchronized signals of the entropy source 401.

With a falling edge of a first pulse 2211 of the single-synchronized voltage signal 415, the time-to-pseudorandom number converter (TPRC) resets a pseudorandom number generator, for example, to a predefined seed value. For example, the pseudo-random number generator of the time-to-pseudo-random number converter (TPRC) can be a feedback shift register that shifts its values one position to the left or right with each clock pulse of the system clock 2106, depending on the design, and feeds the feedback value of the feedback polynomial back into the released bit.

It is important that, starting with the start value of the pseudo-random number generator (seed value), exactly one pseudo-random number of the pseudo-random number generator is bijectively assigned to each clock pulse of the system clock 2106 from the falling edge. In other words, it must be possible to infer the temporal position of the relevant clock of the system clock 2106 after the falling edge of the single-synchronized voltage signal 415 from the value of the pseudorandom number.

With the next falling edge of the second pulse 2212 synchronized voltage signal 415, a first pseudorandom number register takes over the last state of the pseudorandom number generator and the time to pseudorandom number converter (TPRC) preferably resets the pseudorandom number generator to the predefined seed value.

With the next falling edge of the third pulse 2213 synchronized voltage signal 415, a second pseudorandom number register takes over the last state of the pseudorandom number generator and the time to pseudorandom number converter (TPRC) preferably resets the pseudorandom number generator to the predefined seed value. The entropy extraction 401 compares the value in the first pseudorandom number register with the value in the second pseudorandom number register. For example, if the first value in the first pseudorandom number register is greater than the second value in the second pseudorandom number register, the entropy extraction 404.4 may generate a quantum random bit 411 having a first logic level. For example, if the second value in the first pseudorandom number register is greater than the second value in the second pseudorandom number register, entropy extraction 404.4 may generate a quantum random bit 411 having a second logic level that is different from the first level.

With the next falling edge of the fourth pulse 2214 of the single-synchronized voltage signal 415, the first pseudorandom number register takes over the previous value of the second pseudorandom number register and the second pseudorandom number register instead takes over the last state of the pseudorandom number generator and the time to pseudorandom number converter (TPRC) preferably resets the pseudorandom number generator to the predefined seed value. The entropy extraction 401 then again compares the value in the first pseudorandom number register with the value in the second pseudorandom number register. If the first value in the first pseudorandom number register is greater than the second value in the second pseudorandom number register, the entropy extraction 404.4 can, for example, generate a further new and here second quantum random bit 411 with a first logic level. If the second value in the first pseudorandom number register is greater than the second value in the second pseudorandom number register, the entropy extraction 404.4 can, for example, generate a further new and here second quantum random bit 411 with a second logical level that is different from the first level.

In this way, the quantum random number generator 28 can continue this process of quantum random bit generation and thus generate a continuous stream of quantum random bits 411, albeit with a phase noise.

The key idea here is to use a pseudo-random number generator instead of a digital counter as in the prior art, which generates the first and second values. The advantage is that even if a disturbance is successfully imprinted in the single-synchronized voltage signal 415, the randomness of the quantum random bit 411 is only marginally disturbed, since the attacker would also have to know the feedback polynomial.

To prevent this, it is useful if, for example, the quantum random number generator 28 changes the feedback polynomial of the linear feedback shift register of the pseudorandom number generator of the time to pseudorandom number converter 404.3 (TPRC) after a number m of random quantum bits 411 has been completely determined as a function of one or more previously determined random quantum bits 411.

In order to prevent this, it is also useful if, for example, the quantum random number generator 28 changes the shift register length n of the linear feedback shift register of the pseudorandom number generator of the time-to-pseudorandom number converter 404.3 (TPRC) after a number k of quantum random bits 411 has been completely determined as a function of one or more previously determined quantum random bits 411. For this purpose, it is useful if the shift register controller 2103 of the time to pseudorandom number converter 404.3 (TPRC) or a processor (10-1, 10-2) rewrites the value of the feedback polynomial selection register 2112 for this purpose. The value stored in the feedback polynomial selection register 2112 preferably controls the feedback multiplexer 2102 of the time to pseudorandom number converter 404.3 (TPRC). Thus, the value stored in the feedback polynomial selection register 2112 preferably selects which feedback polynomial of the m feedback polynomial circuits RKN₁ to RKNₘ determines the logic value of the shift register reload value line 2104 of the time-to-pseudo-random number converter 404.3 (TPRC). Preferably, by means of a line 2022 for preventing the utilization of a quantum random bit 411 by the finite state machine 404.8, the shift register controller 2103 of the time-to-pseudo-random number converter 404.3 (TPRC) or one of the processors (10-1, 10-2) or any other device prevents finite state machine (finite state machine) 404.8 from passing a generated quantum random bit 411 when that quantum random bit 411 is used for the feedback polynomial selection register 2112. This prevents double use and thus increases security. Instead, preferably the shift register controller 2103 of the time to pseudorandom number converter 404.3 (TPRC) or the processor (10-1, 10-2) or the other device use this quantum random bit 411 for generating a random data word to be stored in the feedback polynomial selection register 2112. This has the advantage that the feedback polynomial of the m feedback polynomial circuits RKN₁ to RKNₘ selected by the feedback polynomial selection register 2112 is completely random. Thus, it is no longer possible for an attacker to inject a deterministic bit data stream in place of the data bit stream of the quantum random bits 411, even if an attack on the entropy source 401 is successful.

In order to further harden the proposed microintegrated quantum random number generator 28, it is also useful if, for example, the quantum random number generator 28 changes the seed value of the linear feedback shift register of the pseudorandom number generator of the time-to-pseudorandom number converter 404.3 (TPRC) after a number p of random quantum bits 411 has been fully determined as a function of one or more previously determined quantum random bits 411. For this purpose, it is useful if the shift register controller 2103 of the time to pseudorandom number converter 404.3 (TPRC) or a processor (10-1, 10-2) rewrites the value of a seed reload register in the shift register controller 2103 of the time to pseudorandom number converter 404.3 (TPRC) with quantum random bits 411 for this purpose. The bit width of the one seed reload register in the shift register controller 2103 of the time-to-pseudo-random number converter 404.3 (TPRC) preferably corresponds to the number n of shift register bits SB₁ to SBₙ of the time-to-pseudo-random number converter 404.3 (TPRC). The shift register controller 2103 of the time-to-pseudo-random number converter 404.3 (TPRC) preferably counts the number of successfully generated quantum random bits 411. Preferably, the finite state machine 404.8 signals the shift register controller 2103 of the time-to-pseudo-random number converter 404.3 (TPRC) the generation of a valid quantum random bit 411 for this purpose. Instead of counting the valid quantum random bits 411, it is also possible to count the successfully generated random data words 418 in the finite state machine 404.8. The shift register controller 2103 of the time to pseudorandom number converter 404.3 (TPRC) preferably loads the new seed value of the one seed reload register in the shift register controller 2103 into the shift register bits SB₁ to SBₙ of the time to pseudorandom number converter 404.3 (TPRC) at one or more of the following events
on reaching a predetermined number of successfully generated quantum random bits 411 and/or
upon reaching a predetermined number of successfully generated random data words 418 and/or
when the value of the feedback polynomial selection register 2112 of the time to pseudorandom number converter 404.3 (TPRC) and thus the selected feedback polynomial of the m feedback polynomials RKN₁ to RKNₘ of the time to pseudorandom number converter 404.3 (TPRC) is changed.

This reliably prevents predictability.

Preferably, the circuit parts of the quantum random number generator 28 are covered with a metal layer 142, 53 to ward off any influence by temperature or electromagnetic radiation or electrostatic fields or magnetic fields. Preferably, the metal layer also comprises a soft magnetic layer to ward off attempts to attack it by means of magnetic fields.

Preferably, by means of a line 2022 for preventing utilization of a quantum random bit 411 by the finite state machine 404.8, the shift register controller 2103 of the time to pseudorandom number converter 404.3 (TPRC) or one of the processors (10-1, 10-2) or any other device prevents a generated quantum random bit 411 from being passed through the finite state machine (finite state machine) 404.8 when that quantum random bit 411 is used for the seed reload register in the shift register controller 2103 in the time to pseudorandom number converter 404.3 (TPRC). This prevents double use and thus increases safety. Instead, preferably the shift register controller 2103 of the time-to-pseudo-random number converter 404.3 (TPRC) or the processor (10-1, 10-2) or the other device use this quantum random bit 411 for generating a random data word to be stored in the seed reload register in the shift register controller 2103. This has the advantage that the seed value of the linear feedback shift register of the n shift register bits SB₁ to SBₙ selected by the seed reload register in the shift register controller 2103 is completely random. Since a linear feedback shift register has two cycles when using simple primitive feedback polynomials, one of which comprises only one shift register value, this one single-cycle shift register value must be prevented. If, by chance, the reload value of the seed reload register in the shift register controller 2103 corresponds to the single-cycle seed value of the linear feedback shift register with the current feedback polynomial or the next scheduled feedback polynomial, the shift register controller 2103 of the time-to-random number converter 404.3 (TPRC) or one of the processors (10-1, 10-2) or another device generates a new random reload value in the seed reload register of the shift register controller 2103.

Preferably, the m feedback polynomials RKN₁ to RKNₘ are selected so that the single-cycle seed values are the same. This reduces the effort required to detect the single-cycle shift register value, as this then no longer depends on the selected feedback polynomial of the feedback polynomials RKN₁ to RKNₘ. In any case, if linear feedback shift registers are used, it is recommended that the time-to-random number converter 404.3 (TPRC) comprises a detection circuit 2113 for detecting an illegal value of the state vector of the n shift register bits SB₁ to SBₙ. If the state vector of the n shift register bits SB₁ to SBₙ is in such an illegal state, the detector 2113 preferably signals this illegal state to the shift register controller 2103 of the time to pseudorandom number converter 404.3 (TPRC) or one of the processors (10-1, 10-2) or another device. The detector 2113 or the shift register controller 2103 of the time-to-pseudo-random number converter 404.3 (TPRC) or the processor (10-1, 10-2) or the other device then resets the value of the state value of the state vector of the n shift register bits SB₁ to SBₙ to a predetermined value and/or the value of the seed reload register in the shift register controller 2103. Preferably, these reload values are different from the single-cycle shift register value. Preferably, this also occurs when the watchdog 404.5 and/or the voltage monitor 413 detect a fault or a suspected or possible attack. Preferably, the shift register controller 2103 of the time to pseudo-random number converter 404.3 (TPRC) counts the number of these faults. Preferably, the shift register controller 2103 of the time-to-pseudo-random number converter 404.3 (TPRC) reduces this counter value again depending on the number of successfully generated random quantum bits 411 and/or random data words 418, in particular since the last perturbation. If this number and/or the event density of such events exceeds a certain predetermined temporal density and/or a certain numerical value, the shift register controller 2103 of the time-to-pseudo-random number converter 404.3 (TPRC) preferably signals to the watchdog 404.5 and/or a processor (10-1, 10-2) a defect of the quantum random number generator 28 or a successful attack on the quantum random number generator 28. Typically, the shift register controller 2103 of the time-to-pseudo-random number converter 404.3 (TPRC) then signals to the finite state machine 404.8 that no more random numbers may be generated. Preferably, a processor (10-1, 10-2) must then reactivate the shift register controller 2103 of the time-to-pseudo-random number converter 404.3 (TPRC) by means of a predetermined reactivation code word. The processor (10-1, 10-2) then writes this reactivation code word via the internal data bus 419 of the quantum random number generator 28 into a special reactivation register of the shift register controller 2103 of the time-to-pseudo-random number converter 404.3 (TPRC), which reactivates the shift register controller 2103 of the time-to-pseudo-random number converter 404.3 (TPRC) and the quantum random number generator 28 and preferably resets all error counters. Preferably, the number of possible reactivations is limited. If the maximum number of reactivations is exceeded, the quantum random number generator 28 can preferably no longer be reactivated. Preferably, the counter for the reactivations of the quantum random number generator 28 can be reset by means of a special reset command before this maximum value is reached. Preferably, the shift register controller 2103 of the time to pseudorandom number converter 404.3 (TPRC) of the quantum random number generator 28 or another device of the quantum random number generator 28 issues a warning before this blocking limit is reached.

When the quantum random number generator 28 is started, the shift register controller 2103 of the time to pseudorandom number converter 404.3 (TPRC) first ensures that the shift register controller 2103 of the time to pseudorandom number converter 404.3 (TPRC) first determines a new seed value based on quantum random numbers 411 and a new value of the feedback polynomial selection register 2112 based on quantum random numbers from quantum random bits 411 by means of a predetermined seed value and a predetermined value of the feedback polynomial selection register 2112. Only when the seed value and the value of the feedback polynomial selection register 2112 are based on quantum random numbers, the initialization phase of the quantum random number generator 28 is completed and the shift register controller 2103 of the time to pseudorandom number converter 404.3 (TPRC) signals the finite state machine 404.8 that it may use and pass the quantum random bits 411 and the quantum random data words 418 (quantum random numbers). Preferably, the finite state machine 404.8 signals this fact to one or more processors (10-1, 10-2). This has the advantage that the device only generates quantum random numbers 418 with full protection.

By using a time to pseudo-random number generator 404.3 (TPRC), it is no longer possible for an attacker to inject a deterministic bit stream in place of the data bit stream of the quantum random bits 411, even if an attack on the entropy source 401 is actually successful for whatever reason.

To prevent this, it is also useful if, for example, the quantum random number generator 28 changes this number m after the complete determination of a number m of quantum random bits 411 as a function of one or more previously determined quantum random bits 411.

Preferably, the finite state machine 404.8 of the quantum random number generator 28 does not output these already used quantum random bits 411 and does not use them to generate quantum random data words 418.

The logic extraction method also includes three borderline cases, which are described below

Typically, the time to pseudorandom number generator 404.3 (TPRC) uses the logic value of the shift register reload value line 2104 of the time to pseudorandom number converter 404.3 (TPRC) as the value of the output 410 of the time to pseudorandom number converter 404.3 (TPRC). If necessary, a buffer amplifier may be provided which detects the logic value of the shift register reload value line 2104 of the time-to-pseudo-random number converter 404.3 (TPRC) and outputs it as the value of the output 410 of the time-to-pseudo-random number converter 404.3 (TPRC).

The entropy extraction 404.4 now compares two different pseudorandom numbers generated by the time to pseudorandom number converter 404.3 (TPRC) from the output 410 of the time to pseudorandom number converter 404.3, a first pseudorandom number 410.1 and a second pseudorandom number 410.2.

If the first pseudorandom number 410.1 and the second pseudorandom number 410.2 are equal, the entropy extraction 404.4 discards one of the two pseudorandom numbers, the first pseudorandom number 410.1 or the second quantum random number 410.2, and replaces it with a new pseudorandom number 410.3 of the time to pseudorandom number converter 404.3 (TPRC). Preferably, the entropy extraction 404.4 uses a counter to count the events for which the two pseudorandom numbers, the first pseudorandom number 410.1 and the second pseudorandom number 410.2, are equal and increments the counter by a first counter increment with each such event. Preferably, the entropy extraction 404.4 also uses this counter to count the events in which the two pseudorandom numbers, the first pseudorandom number 410.1 and the second pseudorandom number 410.2, are not equal and decreases the counter by a second counter increment with each such event, preferably not falling below the value 0. Preferably, the amount of the second counter increment is smaller than the first counter increment of the counter in the entropy extraction 404.4. If the value of this counter exceeds a predetermined value, the control device of the entropy extraction 404.4 assumes that the time-to-random number converter 404.3 (TPRC) is defective. Preferably, the entropy extraction control device 404.4 then signals to a processor (10-1, 10-2) a defect of the quantum random number generator 28 or a successful attack on the quantum random number generator 28. Preferably, the entropy extraction 404.4 of the finite state machine no longer signals successful generation of a quantum random bit 411, so that the finite state machine 404.8 can no longer report successful quantum random number generation to a processor (10-1, 10-2) and no longer generates quantum random numbers 1018.

If the first pseudorandom number 410.1 is smaller than the second pseudorandom number 410.2, the entropy extraction 404.4 generates a quantum random bit of a first logical value, for example a logical ‘1’, and signals the successful generation to the finite state machine 404.8.

If the first pseudorandom number 410.1 is greater than the second pseudorandom number 410.2, the entropy extraction 404.4 generates a quantum random bit of a second logical value, for example a logical ‘0’, which is different from the first logical value, and signals the successful generation to the finite state machine 404.8.

The finite state machine converts the successfully generated quantum random bits 411 into quantum random data words 418, each representing a quantum random number, and makes them available via a RAM or a FIFO 404.9 to the processors (10-1, 10-2) via the internal data bus 419. The finite state machine 404.8 preferably signals the provision of one or more quantum random numbers to one or more processors (10-1, 10-2).

One problem may be a jitter of the system clock 2106. By using a time-to-random number generator 404.3 (TPRC), a mono-frequency or otherwise systematic disturbance of the system clock 2106 is spread in the spectrum with a random spreading code, making detection difficult, if not impossible, for an attacker.

This makes the quantum random number generator 28 even more difficult to attack.

By using quantum random numbers for the seed value of the linear feedback shift register of the time-to-random number converter and a quantum random number for the selection of the single-primitive feedback polynomial, the behavior of the time-to-random number converter 404.3 (TPRC) itself is at a random level of a quantum random number. The regular change of these values makes it even more difficult for an attacker to influence the generated quantum random numbers.

Accordingly, the proposed quantum random number generator 28 thus achieves all the stated objectives.

In particular, the proposal achieves the goal of providing a one-piece, micro-integrated quantum random number generator 28 that allows a high degree of entropy to be guaranteed so that it passes at least the statistical tests defined by NIST.

It is further proposed to provide a one-piece, micro-integrated quantum random number generator 28 that enables a high bit rate to be achieved in the generation of random sequences of quantum random bits 411 and/or quantum random data words 418.

It is also the task of the proposal to provide a one-piece, micro-integrated quantum random number generator 28 which, compared to the quantum random number generators of the prior art, has a more compact, more robust and less complex and, above all, micro-integrated and CMOS-compatible structure which permits one-piece manufacture and co-integration into conventional systems such as memories (such as DRAMS, SRAMS, flash memories and the like) or processors (microprocessors and/or microcontrollers and/or SoCs with a processor on the IC).

Again, the proposal achieves the goal of providing a quantum random number generator 28 with a high degree of security against any attempt to tamper with its internal components. In particular, the use of a time-to-pseudorandom number generator 1004.3 (TRNG) prevents the evaluability of successful attacks on the entropy source 401. Furthermore, the many tests enable secure detection of an attack on the quantum random number generator 28 and thus prevent the use of manipulated numbers as supposedly secure quantum random numbers.

Finally, the proposal also achieves the objective of providing a quantum random number generator 28 which is more economical than the generators of the known prior art, in particular due to its ability to be co-integrated into CMOS circuits.

Another aspect of the present disclosure relates to an integrated quantum random number generator, 28, with an entropy source 401 comprising a photon source 54 and a single photon detector 55, wherein the photon source 54 and the single photon detector 55 are arranged one above the other in a common substrate of a semiconductor material for further compacting the device in the vertical direction with respect to the surface of the semiconductor substrate 49 marking the horizontal direction as defined herein. An entropy source 401 according to the disclosure may also comprise multiple photon sources coupled to a single single photon detector 55 (e.g., to increase photon rate or reliability) 54 or multiple single photon detectors coupled to a single photon source 54 (e.g., for monitoring purposes) 55 or multiple single photon detectors coupled to multiple photon sources 54 (e.g., for monitoring purposes) 55. It is also possible to combine multiple photon sources 54 and single photon detectors 55 to form a single entropy source 401.

In contrast to the prior art, the photon sources 54 and photon detectors 55 are therefore not arranged next to each other, but rather in a compact arrangement of a photon source 54 and a single photon detector 55 on top of each other. This is therefore a particularly compact monolithic 3D integration with minimum area consumption for the entropy source 401. In particular, an arrangement is preferred in which the single photon detector 55 is arranged lower down in the semiconductor material than the photon source 54 (i.e. photon source 54 at the top, single photon detector 55 at the bottom) for improved shielding against external influences. In an alternative embodiment, however, the single photon detector 55 can also be arranged higher than the photon source 54 in the semiconductor material (i.e. photon source 54 at the bottom, single photon detector 55 at the top). For example, in addition to an inversion of the basic structure design during processing the surface of the semiconductor substrate 49, an inverse arrangement of the elements can also be achieved by corresponding structuring the rear side of the semiconductor substrate 49. In particular, structuring can be carried out on both sides both the front and the rear of the semiconductor substrate 49.

Preferably, the photon source 54 is a single photon source (SPS), set up to simultaneously provide only single or a few photons at random time intervals. Such photon sources 54 providing only single or only a few photons at the same time are also referred to as single photon sources 54 in the context of this application. However, these do not have to be genuine single photon emitters, for example based on a single isolated two-level system; rather, conventional light sources can also be designed as SPS 54 by a correspondingly high attenuation of the emission or the supplied current.

In the context of the present disclosure, a semiconductor substrate 54 is understood to be the entire semiconductor chip as a body into which a specific element structure is structured, for example by means of bipolar, BiCMOS, CMOS or other semiconductor technologies, for example by forming differently doped wells or areas in the semiconductor material 49. However, the structure can also formed additively by applying further layers and structures or by a sequence of etching and application steps for such further layers and structures, preferably while forming the analog and digital circuits for evaluating and processing the output signal 404 of the entropy source 401. A corresponding semiconductor substrate 49 can therefore comprise a plurality of such epitaxially grown layers 48 as well as other coatings in addition to a so-called carrier or base substrate (e.g., an unstructured single-crystal semiconductor substrate 49 as a base for epitaxial growth of further semiconductor layers). The semiconductor substrate 49 is therefore understood in this application as a material carrier for the semiconductor structures of an entropy source 401 according to the disclosure and not in the sense of a simple carrier or base substrate for applying these structures. In this respect, the formation of an entropy source 401 according to the disclosure on top of one another in a common semiconductor substrate 49 made of a semiconductor material represents a delimitation in particular with respect to combinations hybrid-integrated by conventional methods (e.g. by means of flip-chip assembly) comprising at least one photon source 54 and at least one single photon detector 55, for example on a common submount as a carrier structure.

Preferably, in the case of the vertical arrangement of photon source 54 and photon detector 55, the photon source 54 is a light-emitting silicon LED 54 operated at an operating point below or close to the breakdown voltage, more preferably an avalanche Zener diode (Zener-avLED) 54. Preferably, the Zener-avLED 54 has a breakdown voltage of <10 V, more preferably a breakdown voltage of <8 V and even more preferably a breakdown voltage of <7 V. The advantages of using a Zener-avLED as a single photon source 54 are explained in more detail below. This new type of single photon source 54 allows a high single photon rate of photons emitted by the single photon source 54 at a relatively low operating voltage even below and in the range of the Zener breakdown voltage and, with a correspondingly desired design, show a preferably directed radiation of the generated photons into the interior of the semiconductor substrate 49 and thus in the direction of the single photon detector 54. The close proximity of the single photon detector 55 to the single photon source 54 outweighs the disadvantage of the increased attenuation in the semiconductor substrate 49, making Zener avLEDs particularly suitable for use as a single photon source 54 in an entropy source 401.

Preferably, the single photon detectors 55 are single photon avalanche diodes (SPADs), i.e. second SPADs 55. For the purposes of the present document, these are understood to be detectors which, due to their particularly high sensitivity with high amplification and low (dark) noise, are in principle capable of detecting and detecting individual photons.

Thus, a main idea of the inventive entropy source 401 of the present disclosure is to a particularly compact and safe integrated entropy source 401 by arranging a Zener avLED as a photon source 54 and a second SPAD 55 as a single photon detector 55 vertically on top of each other in a common semiconductor substrate 49.

One approach to improving the entropy sources 401 known from the prior art in line with the task at hand is to select a correspondingly broad technology platform. For SoC designs with the broadest possible spectrum of possible applications, integrated circuits in bipolar CMOS-DMOS technology (BCD technology) on silicon offer great potential. Silicon LEDs are well known for these technologies. Highly efficient SPADs have already been successfully demonstrated and realized in BCD technology. BCD technology allows particularly effective and optimized integration of these SPADs with a large number of other functional groups such as digital and analogue circuit components, particularly energy-efficient digital memory and switching elements, general power and driver electronics as well as detector and sensor components. The advantage of the availability of DMOS transistors for the necessary voltage-resistant voltage converters for generating the increased supply voltages for operating the entropy source 401 in such a way that the photon sources 54 and/or the photon detectors 55 can be operated in the vicinity of their breakdown voltages, for example in Geiger mode, is particularly pointed out in the document presented here.

The silicon-based PLCs known in the prior art can in principle also be implemented in BCD technologies. However, due to the non-directional emission of photons and the fact that they are usually implemented close to the surface, such silicon LEDs are not ideal for realizing particularly efficient entropy sources 401 that are protected against attacks. The near-surface implementation also usually causes degradation in the case of a silicon LED used in avalanche mode. Since silicon as an indirect semiconductor is only poorly suited for generating photons and these can generally only be generated by further processes via an additional interaction with the crystal lattice, the choice of possible alternative photon sources based on silicon is, however, severely limited.

In the investigation of Zener diodes provided in a BCD technology in different layers by corresponding p-n junctions, which are optimized for a permanent operating point even in the breakdown range, whereby a Zener diode close to the surface was operated as an emitter and a simple p-n diode underneath without bias (zero bias) as a photon detector. “In this configuration, contrary to the general expectation of the skilled person, strong electroluminescence with an efficiency of at least 0.03% can be observed on the Zener diode in avalanche mode at the breakdown voltage. Zener diodes of this type are not normally intended for operation as optoelectronic components (LEDs) in the prior art.

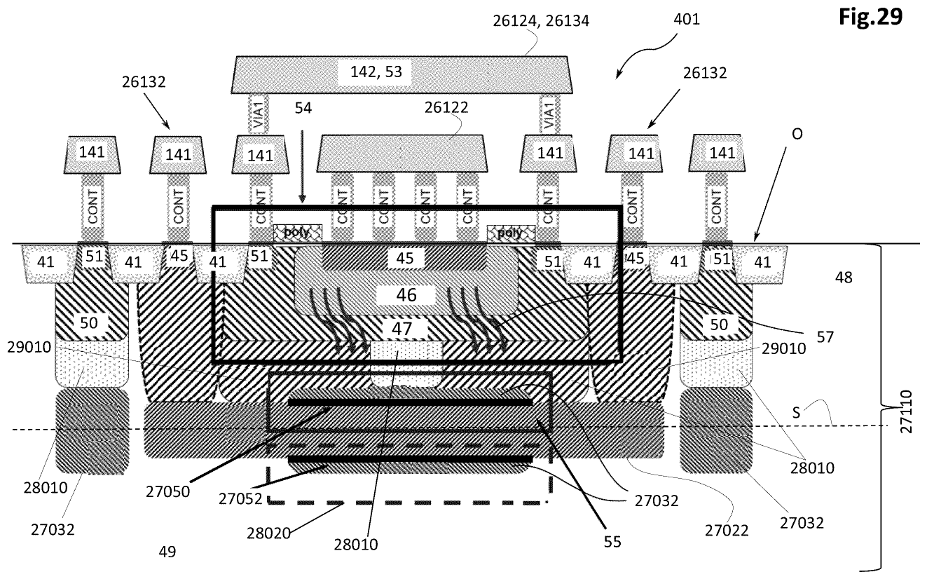

In particular, the generated photons are preferentially emitted in the direction of the lower p-n diode, which can thus detect almost all emitted photons, which can also be demonstrated in the inventive structure via a photocurrent (see FIGS. 29 to 32 with associated figure description). It was thus shown that the investigated Zener diode has a low, but nevertheless quite significant efficiency in the breakdown/zener voltage range (approx. one detected photon per 3000 electrons of the Zener diode current) and therefore appears to be excellently suited as single photon sources for the realization of entropy sources 401 in silicon-based BCD technology. In particular, the preferred radiation in the direction of the photon detector offers significant advantages over the isotropic radiation of conventional photon sources 54 used in entropy sources 401. Here, the silicide commonly used in CMOS technology to represent reduced contact resistances between the metal contacts and the semiconductor silicide is on the one hand light-tight and on the other hand specularly smooth, so that photons originally emitted upwards can also be reflected back into the interior of the semiconductor substrate 49 at the silicide mirror thus formed. Zener diodes designed accordingly and operated as PLCs in avalanche mode are therefore also referred to below as avalanche light emitting Zener diodes (“avLEDs”) 54, in contrast to the silicon LEDs 54 known from the prior art.

When used as photon sources 54, the Zener avLEDs provided in the BCD technology used emit photons with wavelengths from the visible spectral range and have a relatively low Zener operating voltage of usually less than 8 V. This simplifies the design of the charge pumps in the voltage regulators 91 for supplying entropy sources 401 with electrical energy. This simplifies the design of the charge pumps in the voltage regulators 91 for supplying the entropy sources 401 with electrical energy. Furthermore, since the radiation of a Zener avLED when used as a photon source 54 is typically directed in such a way that the photons are preferably emitted in a vertical direction, i.e. away from the surface of the semiconductor substrate 49 into the semiconductor substrate 49, a much stronger isolation of the SPS and the generated photons from the environment of the semiconductor material 49 can also be when used in an entropy source 401 and it much more difficult to tap or inject photons at the surface of the photon detector 55. In addition, if the second SPAD diode 55 belonging to an entropy source 401 is suitably designed, the efficiency of the random number generation of the quantum random number generator 28 can be significantly increased and uncontrolled photon propagation in the semiconductor material 49 with corresponding crosstalk to other circuit parts of the microintegrated circuit 2 can be largely prevented. The present document thus also discloses the idea of minimizing the optical crosstalk between the entropy source 401 to other device parts of the micro-integrated circuit 2 by a vertical arrangement of the photon source 54 and the photon detector 55 in a common substrate with the other device parts of the micro-integrated circuit 2.

The second essential component for constructing a compact entropy source 401 is therefore the selection of an appropriately adapted SPAD design for the second PSPAD diode of the photon detector 55. Typically, the second SPAD diodes 55 in BCD technologies are also realized close to the surface by forming p- or n-wells accordingly. Such near-surface SPADs as second SPAD diodes 55 are quite comparable to the SPADs realized in CMOS technology in the prior art. In principle, the entropy source known from EP 3 529 694 B1 could therefore also be realized in BCD technologies using the Zener-avLEDs described above. However, as already described above, the Zener-avLEDs as photon source 54 preferably emit the photons in the direction the semiconductor substrate 49. A side-by-side arrangement known from the prior art of a Zener-avLED as PLC and when used as photon source 54 and a SPAD close to the surface as second SPAD diode 55 and as photon detector 55 could be implemented in principle, but not necessarily effectively. When using Zener-avLEDs as photon sources 54, it is therefore advisable to arrange the associated second SPAD diode 55 below the Zener-avLED that serves as photon source 54.

In addition to the implementation of conventional n-SPADs and p-SPADs, BCD technology also enables the realization of completely new SPAD concepts, including the use of deep n- or p-doped layers in a BCD substrate.

A method for generating low-lying p-n junctions in a BCD process for providing a corresponding BCD substrate with low-lying p-n junctions, also recently developed by the applicant, made it possible to realize a particularly efficient, low-lying single-photon avalanche diode (“deepSPAD”) based on this method, which can be arranged directly below a Zener-avLED set up as a photon source 54 for providing single photons in a simple manner. In contrast to a horizontal integration of an entropy source 401 based on CMOS technology according to the state of the art, the combination of a Zener-avLED as photon source 54 in combination with a deep SPAD diode 55 as photon detector 55 thus provides the essential components of a fully vertically integrated entropy source 401 in BCD technology.

The vertical arrangement of a Zener avLED as a photon source 54 and a deepSPAD as a second SPAD diode 55 realized by means of extremely low-lying p-n junctions and thus as a photon detector 55 allows a miniaturized quantum random number generator 28 based on a monolithic silicon die as a semiconductor substrate 49 to be implemented in BCD technologies, quantum random number generator 28 based on a monolithic silicon die as semiconductor substrate 49 with an entropy source 401 with highly efficient optical coupling of the photon source 54 and the photon detector 55, high attack security and relatively low operating voltage and thus reduced voltage converter effort can be realized in BCD technologies. Thus, the design of the vertical entropy source 401 on a BCD basis presented here with a photon detector 55 arranged vertically to a photon source 54 in a one-piece micro-integrated circuit 2 represents an optimal solution to the task according to the disclosure. In particular, the vertical 3D integration can further increase the compactness of an entropy source 401 and reduce the chip area consumption compared to conventional lateral 2D designs while simultaneously increasing efficiency. This makes it possible to place the entropy source 401 in the pad edge 2403 of a micro-integrated circuit 2. This reduces the effective chip area consumption for the proposed entropy source 401 to effectively 0, which results in a massive economic advantage.

Preferably, an entropy source 401 according to the disclosure and the associated quantum random number generator 28 are therefore formed in a BCD substrate as a semiconductor substrate 49, which was manufactured using a BCD technology.

Preferably, the BCD substrate comprises a carrier substrate 49 of the vertical entropy source 401 according to the proposal and an epitaxial layer 48 grown on the carrier substrate 49 of the vertical entropy source 401 according to the proposal, wherein a low-lying p-n junction located in the epitaxial layer 48 was generated between the carrier substrate 49 of the vertical entropy source 401 according to the proposal and the epitaxial layer 48 by a diffusion of dopants introduced into a surface of the carrier substrate 49 of the vertical entropy source 401 according to the proposal below the epitaxial layer 48.

The carrier substrate 49 of the vertical entropy source 401 according to the proposal can preferably be a p-substrate. However, n-substrates or intrinsic substrates can also be used. The substrate material of the carrier substrate 49 of the vertical entropy source 401 according to the proposal may in particular be silicon. However, the methods can in principle also be adapted for other semiconductor materials. A typical dopant for forming a p-region is boron. Phosphorus (P), arsenic (As) or antimony (Sb), for example, can be used to form an n-region. In silicon, for example, boron diffuses much further as a dopant than the heavy donors (P, As or Sb). In addition, it can be determined that the generated n-areas are largely dominant due to the higher doses used, i.e. an n-area already doped with phosphorus can retain its existing conduction type even after an additional introduction of boron. Additional masking, lithography and epitaxy steps in the usual BCD process can sometimes be dispensed with for the provision of the low-lying p-n junctions.

Preferably, the first and second dopants have different diffusion properties in the carrier substrate and/or in the epitaxial layer. Preferably, the second dopant has a higher mobility in the carrier substrate and/or in the epitaxial layer than the first dopant. Preferably, the first dopant and/or the second dopant are introduced without a mask or using a masking process. For example, a direct ion beam writing process, for example using focused ion beams, can be used for maskless introduction. In the case of a mask process, the introduction takes place with the aid of a previously provided and/or preferably photolithographically produced mask, whereby the introduction takes place, for example, by means of a chemical or physical deposition process or also by means of an ion beam writing process. Preferably, immediately after the introduction of the second dopant, the first region or the second region completely overlaps the respective other region in a top view of the surface of the carrier substrate. Preferably, the first region is a low-lying n-layer (NBL layer) and the second region is a low-lying p-layer (PBL layer).

Preferably, the single photon detector 55 forms an avalanche region in a region around the low-lying p-n junction and comprises an absorption region for converting photons into electron-hole pairs, wherein the absorption region immediately adjoins the low-lying p-n junction.

It is preferred that the low-lying p-n junction is at least partially formed between a low-lying n-layer as cathode and a low-lying p-layer directly adjacent to the low-lying n-layer. It is also preferable that the absorption region is directly adjacent to the low-lying p-layer and is essentially formed as a p-region. Essentially means that the absorption area can also be partially formed as an intrinsic area. It is also preferable that an anode formed as a p+ region directly adjoins the absorption region.

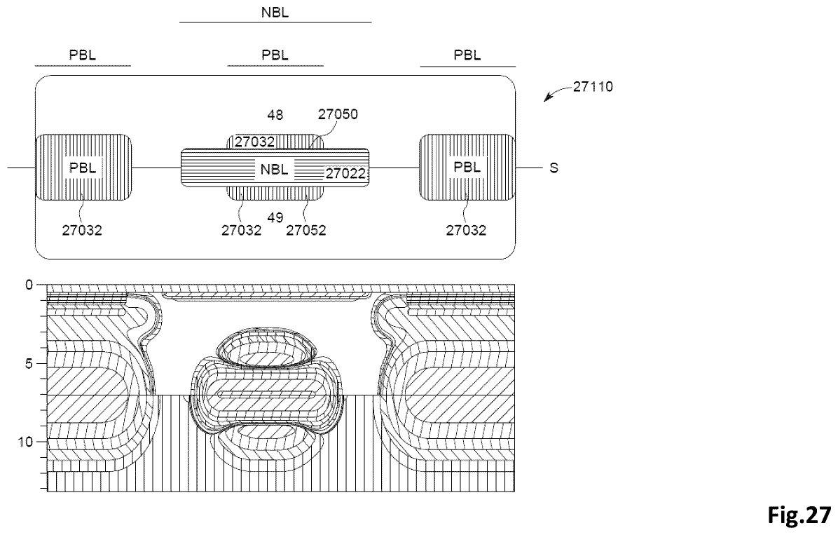

Preferably, a second low-lying p-n junction formed below the low-lying p-n junction of the single photon detector 55 lying in the epitaxial layer 48 (e.g. in the carrier substrate 49) is used as an additional photon detector 55 for monitoring for external attacks. The said method for generating low-lying p-n junctions in a BCD process results in some embodiments in an underlying second p-n junction below the first p-n junction (see FIG. 27 with associated figure description) (observation diode 28040). This second p-n junction can also be configured as a photon detector 55 or single photon avalanche diode 55 due to its largely identical electronic properties. Since this additional photon detector 55 is thus arranged below the actual arrangement of the entropy source 401 deeply buried in the semiconductor material 49, it can provide an additional protective function, unknown in the prior art, against photons injected from the rear side of the semiconductor substrate 49. Preferably, the proposed watchdog 404.5 and/or the proposed voltage monitor 423 use this second p-n junction as a light-sensitive observation diode 28040. Preferably, the proposed watchdog 404.5 and/or the proposal-compliant voltage monitor 423 evaluate the diode voltage of the observation diode 28040 (observation diode voltage) in the form of this second PN junction, detect the diode voltage of this observation diode 28040 as an observation diode voltage value and compare this observation diode voltage value with an allowed observation diode voltage value interval. If the observation diode voltage value is outside the observation diode voltage value interval, the suggestive watchdog 404.5 and/or the suggestive voltage monitor 423 conclude that there is a defect or photonic attack on the entropy source 401. In this case, after detecting such an event, the watchdog signals and/or maintains such information to one of the processors 10-1, 10-2. Preferably, the watchdog 404.5 signals such an incident by means of an interrupt signal via an interrupt line to the intended processor 10-1, 10-2. Preferably, the watchdog 404.5 checks whether there is a correlation between a photon detection of the observation diode 28020 with a signal at the output 405 of the entropy source 401. If this is the case, the photons do not originate externally, but from the entropy source 401. The watchdog 404.5 and the voltage monitor 413 preferably ignore such events. Typically, other circuit parts of the microintegrated circuit 2 and/or the quantum random number generator 28 also emit parasitic photons that can hit the observation diode 28020. Typically, the watchdog diode 28020 also detects some of these parasitic normal mode photons. The watchdog 404.3 can detect the level of these normal operation photons and make it available to the processor 10-1, 10-2 as a measured value for other purposes, for example via the data bus 419. If necessary, the processor 10-1, 10-2 or another device part of the microintegrated circuit 2 can infer an operating state of the microintegrated circuit 2 depending on a transmitted or provided measured value of the level of the normal operating photons. The permitted observation diode voltage value interval is preferably set in such a way that a photonic attack is only detected if the measured value of the level of the normal operating photons is significantly outside the expected measured values of the level of the normal operating photons.

The watchdog 404.3 can thus detect attack photons in the immediate vicinity of the entropy source 401 in a wide angular range by means of the observation diode 28040 and typically with the aid of the voltage monitor 413. This allows the processor 10-1, 10-2 to detect external attacks with a high probability.

Preferably, the top and/or bottom surfaces of the semiconductor substrate 49 in the region of the entropy source 401 are mirrored at one surface. Preferably, the top and/or bottom of the semiconductor substrate 49 in the region of the entropy source 401 may also comprise a light-blocking layer-which may also be mirrored-on one surface. A mirror coating of the surfaces of a semiconductor substrate 49 (e.g. by means of metallization 142, 53 or the application of dichroic layers) as well as the application of a light-blocking layer are known in the prior art and have already been discussed above. In an entropy source 401 according to the proposal, these approaches can also be used to shield against external photons (“shading”) and to increase efficiency by back-reflection of the photons generated by the associated photon source 54. Alternatively or additionally, a corresponding encapsulation in the area of the entropy source 401 or the surrounding of this area with a metal box can also be carried out.

Preferably, the surface of the semiconductor substrate 49 is with a silicide layer in the region of the entropy source 401 and with a metallization 142, 53 above it. Preferably, the metallization 142, 53 is closed in the region of the entropy source 401. The metallization 142, 53 can act as a mirror coating for the inner region and/or as a wavelength-independent shading for outer photons. The same applies to a formed silicide layer.

Preferably, leakage of photons provided by the single photon source 54 at the surface of the semiconductor substrate 49 and/or the rear side of the semiconductor substrate 49 is prevented by a combination of at least one element each of metal covers, sidewall contacts and vias. This prevents the observability of the signal generation by microscopes or the like. By means of the aforementioned elements, a largely complete shielding or encapsulation of the entropy source 401 can be achieved, whereby, in addition to shielding from the outside, a high immunity to external interference can also be obtained. Preferably, this encapsulation also comprises other device parts of the quantum random number generator 28. A second corresponding encapsulation can also comprise the other device parts of the quantum random number generator 28 and the already encapsulated entropy source 401 by means of additional layers and vias.

Preferably, a plurality of entropy sources 401 according to the disclosure or a multi-channel entropy source 401 are realized in a system of a plurality of quantum random number generators 28 as a QRNG system. Such a QRNG system preferably comprises a plurality of entropy sources 401 according to the proposal, preferably realized together on the same semiconductor substrate 49 of a preferably one-piece micro-integrated circuit 2. Together with a compact shielding of the individual entropy sources 401, very high integration densities with a high number of densely packed entropy sources 401 decoupled from each other as a result of the shielding by means of said layers and vias and thus overall high effective random number rates can be achieved. Preferably, in addition to the necessary plurality of shielded entropy sources 401, the necessary plurality of analog-to-digital converters 403, the necessary plurality of time-to-digital pseudorandom number converters 404.3, the plurality of entropy extractions 404.4, such a QRNG system also comprises a device that performs the merging of the plurality of generated quantum random bits 411 into a sequence of quantum random numbers. This is typically a modified FSM 404.8. In prior art entropy sources 401, the integration density is limited primarily by the structural juxtaposition of the individual components.

Preferably, a proposed quantum random number generator 28 comprises an electronic circuit for generating and outputting a digital quantum random number sequence based on the statistical evaluation of the temporal sequence of signals 405 from the single photon detector 55 of the entropy source 401.

Another aspect of the present proposal relates to the integrated microelectronic circuit (IC) comprising at least one proposed entropy source 401. In particular, these may be ICs 2 for applications based on security-related system-on-chip (SoC) systems.

The advantages of a proposed vertical entropy source 401 with a photon source 54 arranged vertically to the photon detector 55 compared to the known horizontal implementations in the prior art are primarily based on the further miniaturization of the entire random number generator structure and the resulting high degree of integration or miniaturization of the generated structures and the resulting increase in the quantum random bit rate. Due to the complete isolation of the SPS (photon source 54) and the associated second SPAD diode 55 from the environment by means of the proposed shielding using layers and vias, the security of the quantum random number generation can be significantly further increased. The directional vertical radiation from the Zener avLED 54 used as SPS (photon source 54) in the proposed vertical entropy source 401 also to the increase in safety as well as to a significant increase in the efficiency of the quantum random number generation of the quantum random number generator 28.

A second low-lying p-n junction provided by means of a novel BCD technology and formed below the p-n junction of the second SPAD 55 of the vertical entropy source 401 can be used as an additional photon detector as an observation diode 28020 for monitoring attacks, in particular starting from the rear side of the semiconductor substrate 49. In the example discussed here, the watchdog diode 28040 is connected between the substrate 49 and the cathode 26132 of the second SPAD diode 55 buried in the semiconductor substrate 49 of the vertical entropy source 401, which operates as a photon detector 55. The watchdog 404.5 and/or the voltage monitor 413 preferably detect the observation diode voltage value of the voltage of the observation diode 28020. The watchdog 404.5 preferably compares the single-synchronized voltage signal 415 with a likewise single-synchronized signal of the observation diode voltage value of the observation diode 28020. If the synchronized signal of the observation diode voltage value of the observation diode 28020 shows a plus that is synchronous with a pulse of the synchronized voltage signal 415, the watchdog 404.5 assumes that it is not an attack but a regular signal and typically does not trigger an alarm. From time to time, however, the watchdog 404.5 and/or the processor 10-1, 10-2 may interrupt the power supply to the entropy source 401, so that the single-synchronized voltage signal 415 of the observation diode voltage value should no longer show any pulses. In this case, the single-synchronized signal of the observation diode voltage value of the observation diode 28020 must also no longer show any pulses. However, if the single-synchronized signal of the observation diode voltage value of the observation diode 28020 continues to show a pulse, the watchdog 404.5 typically concludes that there is an attack or a fault. Preferably, the watchdog 404.5 reports such an attack or such a fault to the processor 10-1, 10-2 via the data bus 419 and/or by means of an interrupt signal via an interrupt line. The watchdog 404.3 can also hold the information about such a suspected attack in a register or memory of the quantum random number generator 28. Typically, the watchdog 404.5 then prevents the generation of random numbers 418 by the FSM 404.8 at least until the processor 10-1, 10-2 explicitly permits this generation again by a corresponding command to the watchdog 404.5, preferably by means of a password via the data bus 419.

The voltage monitor 413 preferably monitors the voltage level of the observation diode voltage value of the voltage of the observation diode 28020. If the observation diode voltage value of the voltage of the observation diode 28020 is outside the predefined observation diode voltage value interval, the voltage monitor 413 preferably reports this to the watchdog 404.5. in the event of such an out-of-spec message from the voltage monitor 413 for the observation diode voltage value of the observation diode 28040, the watchdog 404.5 typically again concludes that there is an attack or a fault. Preferably, the watchdog 404.5 reports such an attack or fault to the processor 10-1, 10-2 via the data bus 419 and/or by means of an interrupt signal via an interrupt line. The watchdog 404.3 can also hold the information about such a suspected attack in a register or memory of the quantum random number generator 28. Typically, the watchdog 404.5 then prevents the generation of random numbers 418 by the FSM 404.8 at least until the processor 10-1, 10-2 explicitly permits this generation again by a corresponding command to the watchdog 404.5, preferably by means of a password via the data bus 419.

The efficiency of the optical coupling into the associated second SPAD diodes 55 as well as the isolation and safety can be further increased by using internal metal and silicide mirrors. For the Zener avLED used as photon source 54, only a relatively low operating voltage of <8 V is required compared to the prior art. This further simplifies the voltage converters 91 required to generate the operating voltages of the entropy source 401. Furthermore, since the absorption length of the emitted visible light in the silicon is low (i.e. the associated absorption coefficient is high), very good optical isolation between neighboring elements can also be achieved. The close proximity of the photon source 54 to the phonon detector 55 in the vertical entropy source 401 prevents this disadvantage of the low absorption length of the emitted visible light in the silicon from becoming effective with regard to the efficiency of photon transport. This enables the vertical entropy sources 401 to be arranged in an array with a high cell density and a correspondingly high generation or entropy rate of the quantum random number generator 28.

Further aspects of the present disclosure are disclosed in the dependent claims or in the following description of the drawings.

### Features of the Disclosed System

The features of the disclosure summarize these once again. Applications of the technical teaching can combine the features with each other, provided that these combinations do not cause objective contradictions. In this respect, the dependencies and references presented here represent only particularly preferred, exemplary embodiments.

Feature 1: Quantum process-based generator (28) for true random numbers (411, 418) (Quantum Random Number Generator: QRNG),
wherein the quantum process-based generator (28) for real random numbers (411, 418) (Quantum Random Number Generator: QRNG) comprises an entropy source (401) and
wherein the quantum process-based generator (28) for true random numbers (411, 418) (Quantum Random Number Generator: QRNG) evaluates a signal (405) of the entropy source (401) by means of a time-to-pseudo-random number converter (TPRC) (404.3) and generates one or more random bits (411).

Feature 2: Quantum process-based generator (28) for true random numbers (411, 418) according to feature 1,
wherein the quantum process-based generator (28) for true random numbers (411, 418) generates and provides or utilizes one or more random numbers (418) from a plurality of random bits (411).

Feature 3: Quantum process-based generator (28) for true random numbers (411, 418) according to feature 1 or 2,
wherein the behavior of the P of a time to pseudorandom number converter (TPRG) (404.3) depends on one or more quantum random bits (411) and/or one or more quantum random numbers (418).

Feature 4: Quantum process-based generator (28) for real random numbers (411, 418) according to one of features 1 to 3,
wherein the quantum process-based generator (28) for true random numbers (411, 418) comprises a watchdog (404.5) which monitors the correct functioning of the quantum process-based generator (28) for true random numbers (411, 418).

Feature 5: Quantum process-based generator (28) for real random numbers (411, 418) according to one of features 1 to 4,
wherein the quantum process-based generator (28) for true random numbers (411, 418) comprises a watchdog (404.5) which monitors the correct functioning of the quantum process-based generator (28) for true random numbers (411, 418) by measuring the randomness of the generated quantum random bits (411) in the form of a measured value and comparing it with a tolerance interval or a threshold value and concluding on an error in the event of a deviation.

Feature 6: Quantum process-based generator (28) for real random numbers (411, 418) according to one of features 1 to 5,
wherein the quantum process-based generator (28) for true random numbers (411, 418) comprises a watchdog (404.5) which monitors the correct functioning of a time-to-pseudo-random number converter (TPRC) (404.3) and detects and/or signals an error in case of deviations from an expected behavior.

Feature 7: Quantum process-based generator (28) for real random numbers (411, 418) according to one of features 1 to 6,
wherein the quantum process-based generator (28) for real random numbers (411, 418) is manufactured in one piece as part of an integrated circuit (2) and
wherein the integrated circuit (2) comprises a voltage converter (91) for supplying the entropy source (401) of the quantum process-based generator (28) for real random numbers (411, 418), and
wherein the voltage converter (91) comprises one or more DMOS transistors.

Feature 8: Quantum process-based generator (28) for true random numbers (411, 418) according to feature 7,
whereby the integrated circuit (2) is manufactured using BCD technology.

Feature 9: Quantum process-based generator (28) for real random numbers (411, 418) according to one of features 1 to 8,
wherein the quantum process-based generator (28) for real random numbers (411, 418) is manufactured in one piece as part of an integrated circuit (2) and
wherein the integrated circuit (2) is one of the following circuits or comprises one of the following circuits:
   A microcontroller,
   a microprocessor,
   a memory,
   a DRAM,
   a SRAM,
   a RAM,
   a volatile memory,
   an OTP memory,
   an EEPROM,
   a flash memory,
   an MRAM,
   a FRAM,
   a sensor evaluation circuit,
   a control circuit for an automotive control circuit,
   a graphics controller,
   an evaluation circuit for a biometric sensor or an input device,
   a control circuit,
   a chip card circuit,
   a material circuit of a cell phone or a smart phone,
   a circuit of an access control system,
   a circuit with a coded recording of operating parameters,
   a circuit of an access control system,
   a circuit of a fuse system of electronic fuses,
   a radio system circuit,
   a communication circuit,
   a circuit of an encryption and/or decryption system,
   a circuit of an individualization system
   a circuit of a gaming device,
   a circuit of a simulation system,
   a circuit of a computer system,
   a circuit of a noise source,
   a circuit with a device for generating and/or using a spreading code.

Feature 10: Quantum process-based generator (28) for real random numbers (411, 418) according to one of features 1 to 9,
wherein the entropy source (401) comprises a photon source (54), and
wherein the entropy source (401) comprises a photon detector (55), and
the photon source (54) emitting photons as a quantum signal when supplied with electrical energy, and
wherein the photon source (54) is optically coupled to the photon detector (55) and
wherein the photon detector (55) receives the quantum signal of the photon source (54) at least in part and generates the output signal (405) of the entropy source (401) or a precursor signal thereof.

Feature 11: Safe microcontroller for controlling devices, especially in automobiles
with a semiconductor crystal and
with storage elements and
with at least one internal bus (419) and
with at least one processor (10-1), in particular an 8/16/32/15-bit microcontroller core, and
with one or more data interfaces and
with at least one quantum process-based generator (28) for real random numbers (411, 418) (Quantum Random Number Generator: QRNG) according to one of the features 1 to 9, and
wherein the memory elements are connected to the internal bus (419) and
wherein the data interface is connected to the internal bus (419) and
wherein in particular the quantum process-based real random number generator (QRNG) (28) may be connected to the internal bus (419), and
wherein the processor (10-1) is connected to the internal bus (419) and
wherein the quantum process-based true random number generator (QRNG) (28) generates or provides a random number (418), in particular on request of the processor (10-1), and
wherein the processor (10-1) generates a key with the aid of a program from one or more of its memory elements and with the aid of the random number, and
wherein the processor (10-1) uses a program from one or more of its memory elements and the key to encrypt and decrypt data which it exchanges with devices outside the secure microcontroller via the data interface, and
wherein the semiconductor crystal integrally comprises these subdevices of the secure microcontroller,
said subdevices of the secure microcontroller comprising the memory elements, the internal bus (419), the at least one processor (10-1), the data interfaces and the quantum random number generator (QRNG) (28),

Feature 12: Safe microcontroller according to feature 11,
wherein the memory elements comprise one or more read/write memories RAM and/or one or more writable non-volatile memories, in particular EEPROM memories and/or flash memories and/or OTP memories, and/or one or more read-only memories and/or one or more non-volatile manufacturer memories, in particular one or more manufacturer ROMs and/or one or more manufacturer EEPROMs and/or one or more manufacturer flash memories.

Feature 13: Safe microcontroller according to feature 12,
whereby the manufacturer ROM includes the boot software.

Feature 14: Secure microcontroller according to feature 12 or 13,
whereby a manufacturer memory firewall is provided between the manufacturer memory and the internal bus (419).

Feature 15: Secure microcontroller according to one or more of features 11 to 14
with one or more of the following components:
   a clock generator (92) (e.g. for the system clock 2106)
   a reset circuit (83) and/or
   one or more voltage transformers (91) which provide the operating voltages, and/or
   a ground circuit in the negative supply voltage line (GND), in particular to prevent attacks via ground offset, and/or
   an input/output circuit and/or
   one or more processing modules,
wherein the processing modules are arranged to communicate with the internal bus (419), and
wherein the processing modules comprise one or more of the following modules:
   a CRC module (Cyclic Redundancy Check),
   a clock generator module,
   with a DES accelerator and/or an AES accelerator
   one or more timer modules,
   a safety monitoring and control circuit,
   a data interface, in particular a Universal Asynchronous Receiver Transmitter (UART).

Feature 16: Secure microcontroller 1 according to one or more of features 11 to 15,
with at least one photon source (54), in particular a silicon LED (54) or a first SPAD diode (54), and
with at least one photon detector (54), in particular a second SPAD diode (55), and
with at least one processing circuit and
with at least one operating circuit,
wherein the quantum process-based true random number generator (QRNG) (28) comprises at least the photon source (54) as a light source for the optical quantum signal, and
wherein the quantum process-based true random number generator (QRNG) (28) comprises at least the photon detector (55) as a photodetector for the optical quantum signal, and
wherein the quantum process-based true random number generator (QRNG) (28) comprises at least the processing circuit, and
wherein the at least one photon source (54) is optically coupled to the at least one photon detector (55), and
wherein the operating circuit supplies electrical power to the photon source (54) such that the photon source (54) emits light and
the processing circuit detecting the signal from the photon detector (55) and forming the random number therefrom and making it available to the processor (10-1).

Feature 17: Secure microcontroller 11 according to feature 16,
with at least one optical fiber (44),
wherein the quantum process-based true random number generator (QRNG) (28) comprises at least the optical fiber (44), and
wherein the at least one optical waveguide (44) optically couples the at least one photon source (54) to the at least one photon detector (55).

Feature 18: Safe microcontroller according to feature 17
wherein the semiconductor crystal a surface (56) and
wherein the semiconductor crystal a semiconducting material below its surface (56), and
wherein the surface (56) of the semiconductor crystal comprises a metallization stack, and
wherein the metallization stack comprises a typically structured and optically transparent and electrically insulating layer (44), and
wherein at least a part of this typically structured, transparent and electrically insulating layer (44) of the surface (56) forms the optical waveguide (44) and
the photon source (54) radiating from the semiconducting material of the semiconductor substrate into this optical waveguide (44), and
wherein the optical waveguide (44) irradiates the photon detector (54) such that the light from within the optical waveguide (44) re-enters the semiconducting material of the semiconductor substrate from the surface and strikes device parts of the photon detector (55) there.

Feature 19: Secure microcontroller according to feature 17 and/or 18,
wherein the at least one operating circuit supplies the at least one photon source (54) at least temporarily with electrical energy, and
wherein the at least one photon source (54) feeds photons into the at least one optical waveguide (44) when supplied with sufficient electrical energy, and
the at least one optical waveguide (44) radiating such photons into the photon detector (55).

Feature 20: Secure microcontroller according to one or more of the preceding features 11 to 19,
wherein a data interface of the one or more data interfaces is a wired automotive data bus interface, and
wherein the wired automotive data bus interface in particular includes
   a CAN data bus interface and/or
   a CAN FD data bus interface and/or
   a Flexray data bus interface and/or
   a PSI5 data bus interface and/or
   a DSI3 data bus interface and/or
   a LIN data bus interface and/or
   an Ethernet data bus interface and/or
   a LIN data bus interface and/or
   a MELIBUS data bus interface.

Feature 21: Secure microcontroller according to one or more of the preceding features 11 to 20,
wherein a data interface of the one or more data interfaces is a wireless data bus interface, and
whereby the wireless data bus interface in particular
   a WLAN interface and/or
   a Bluetooth interface
includes.

Feature 22: Secure microcontroller according to one or more of the preceding features 11 to 21,
wherein a data interface of the one or more data interfaces is a wired data bus interface, and
whereby the wireless data bus interface in particular is
   a KNX data bus interface and/or
   an EIB data bus interface and/or
   a DALI data bus interface and/or
   a PROFIBUS data bus interface.

Feature 23: A device,
wherein the device an integrated circuit (4) with a first processor (10-1) and a non-volatile memory (16), and
wherein the device has a first memory,
whereby the non-volatile memory stores at least one security code;
where the first memory stores data and
wherein the data in the first memory is cryptographically protected in a first format, and
wherein the integrated circuit is arranged to validate the data read from the first memory during a transfer of data from the first memory, and,
wherein the device comprises a quantum random number generator (28) according to any one of features 1 to 9, and
wherein the integrated circuit and the quantum random number generator (28) are fabricated in a semiconductor crystal, and
wherein the semiconductor crystal has a surface (56) and
wherein the semiconductor crystal has a semiconducting material below its surface (56) and
wherein the surface (56) of the semiconductor crystal comprises a metallization stack and
wherein the metallization stack comprises a typically structured and optically transparent and electrically insulating layer (44), and
wherein at least a part of this typically structured, transparent and electrically insulating layer (44) of the surface (56) forms the optical waveguide 44 and
wherein the first SPAD diode (54) emits photons (57) from the semiconducting material of the semiconductor substrate into said optical waveguide (44), and
wherein the at least one optical fiber (44) transports such photons (58) to the second SPAD diode (55) and
wherein the optical waveguide (44) irradiates the second SPAD diode (55) such that the light (59) from within the optical waveguide (44) re-enters the semiconducting material of the semiconductor substrate from the surface (56) and strikes device parts of the second SPAD diode (55) there and
wherein the first SPAD diode (54) and the second SPAD diode (55) and the optical waveguide (44) are part of the quantum random number generator (28).

Feature 24: Device according to feature 23,
wherein the device comprises at least one operating circuit and
wherein the at least one operating circuit supplies the at least one first SPAD diode (54) at least temporarily with electrical energy, and
wherein the at least one first SPAD diode (54) feeds photons (57) into the at least one optical waveguide (44) when supplied with sufficient electrical energy, and
wherein the at least one optical waveguide (44) transports such photons (58) to the second SPAD diode (55) and
wherein the at least one optical waveguide (44) radiates such photons (59) into the second SPAD diode (55).

Feature 25: Device according to feature 24,
wherein the quantum random number generator (28) comprises at least the first SPAD diode (54) as a light source for the optical quantum signal, and
wherein the quantum random number generator (28) comprises at least the second SPAD diode (55) as a photodetector for the optical quantum signal, and
wherein the quantum random number generator (28) comprises at least one processing circuit, and
wherein the quantum random number generator (28) comprises at least the optical fiber (44), and
wherein the at least one optical waveguide (44) optically couples the at least one first SPAD diode (54) to the at least one second SPAD diode (55), and
wherein the operating circuit supplies electrical power to the first SPAD diode (54) such that the first SPAD diode emits light (54) and
wherein the processing circuit detects the signal of the second SPAD diode (55) and forms the random number therefrom and makes it available to the processor (10) or another device part.

Feature 26: Device according to one of the features 23 to 24,
wherein the first memory is located inside or outside the integrated circuit and
wherein the device has a second memory for storing data
and wherein the second memory is located inside or outside the integrated circuit;
whereby the device is set up in this way,
it transfers data from the first memory via the integrated circuit to the second memory so that the processor can access it from the second memory, and
whereby the integrated circuit is set up for this purpose,
during a transfer of data from the first memory to the second memory, validate the data read from the first memory using a security code stored in the non-volatile memory; and,
if the data is validated, applying cryptographic protection in a second format to the validated data using a security code stored in the non-volatile memory; and
save the data protected in the second format in the second memory.

Feature 27: Device according to one of the features 23 to 26,
whereby the first memory has a read-only memory.

Feature 28: Device according to one of the features 26 to 27,
whereby the second memory has a direct access memory.

Feature 29: Device according to one of the features 26 to 28,
wherein the cryptographic protection applied to the data in the first memory is different from the cryptographic protection applied to the data in the second memory.

Feature 30: Device according to one of the features 23 to 29,
wherein the integrated circuit includes a memory for storing data to be processed by the processor, and
whereby the device is set up so that it stores some data of the validated data set in the memory and the rest in the second memory.

Feature 31: Device according to one of the features 26 to 30,
wherein the first memory stores data in a first data format and the second memory is arranged to store data in a second, different data format.

Feature 32: Device according to feature 31,
wherein the data stored in the first memory is protected by a first authentication technique, and
wherein the device is arranged to protect the data in the second memory by a second, different authentication technique.

Feature 33: Device according to one of the features 26 to 32,
wherein the data in the first memory is stored in at least one data set and the or each data set is cryptographically protected as a record, and
wherein the device is arranged to store in the second memory words or groups of words of a validated data set, each word or group of words being separately cryptographically protected.

Feature 34: Device according to feature 33, which is so designed,
that it reads the words or word groups from the second memory, and
it validates the words or groups of words read using a security code stored in the non-volatile memory, and
that it processes the read and validated words or word groups in the processor.

Feature 35: Device according to feature 34,
wherein the integrated circuit comprises a hash calculator, and
where the processor and the hash computer (hash engine) are arranged in this way,
(a) calculating a hash function for each word or group of words in dependence on a security code stored in the non-volatile memory and storing the hash in association with the word or group in the second memory,
b) retrieving a stored word or group from the second memory, recalculating a hash function for the retrieved word or group using the security code, and comparing the recalculated hash with the stored hash; and
c) allow the processing of the retrieved word or group by the data processing system only if the recalculated and stored hashes are in a certain ratio to each other.

Feature 36: Device according to feature 35, wherein the hash calculator is a circuit in the integrated circuit.

Feature 37 Device according to one of the features 23 to 36, whereby the non-volatile memory of the integrated circuit is a one-time programmable memory.

Feature 38 Device according to one of the features 23 to 37, whereby the or each data record stored in the first memory is cryptographically protected by a corresponding digital signature.

Feature 39: Device according to one of the features 23 to 38, wherein the or each data set stored in the first memory is cryptographically protected by a corresponding digital signature with the aid of at least one random number of the quantum random number generator.

Feature 40: Device according to feature 38 or 39, wherein a security code is stored in the non-volatile memory of the integrated circuit, which the device has generated at least partially by means of at least one random number of the quantum random number generator (28).

Feature 41: Device according to one of the features 38 to 39, wherein the device is arranged to validate a digital signature of the data set by reference to or by reference to the security code stored in the non-volatile memory of the integrated circuit.

Feature 42: A data processing device,
wherein the data processing apparatus comprises an integrated circuit and
wherein the integrated circuit comprises a processor and
whereby the integrated circuit contains a non-volatile memory and
wherein the non-volatile memory stores at least one security code and
wherein the integrated circuit comprises a hash calculator and
wherein the integrated circuit has an interface at the boundary of the integrated circuit, and
wherein the integrated circuit a quantum random number generator according to any one of features 1 to 9, and
wherein the integrated circuit and the quantum random number generator are fabricated in a semiconductor crystal, and
wherein the semiconductor crystal has a surface (56) and
wherein the semiconductor crystal has a semiconducting material below its surface (56) and
wherein the surface (56) of the semiconductor crystal comprises a metallization stack, and
wherein the metallization stack comprises a typically structured and optically transparent and electrically insulating layer (44), and
wherein at least a part of this typically structured, transparent and electrically insulating layer (44) of the surface (46) forms the optical waveguide (44) and
wherein the first SPAD diode (54) emits photons (57) from the semiconducting material of the semiconductor substrate into said optical waveguide (44), and
wherein the at least one optical waveguide (44) transports such photons (58) to the second SPAD diode 55 and
wherein the optical waveguide (44) irradiates the second SPAD diode (55) such that the light (59) from within the optical waveguide (44) re-enters the semiconducting material of the semiconductor substrate from the surface (56) and strikes device parts of the second SPAD diode (55) there and
wherein the first SPAD diode (54) and the second SPAD diode (55) and the optical fiber (44) are part of the quantum random number generator (28).

Feature 43: The data processing apparatus according to feature 42, wherein the processor and/or another device part of the data processing apparatus encrypts or decrypts data with the aid of at least one random number of the quantum random number generator.

Feature 44: Data processing device according to feature 42 or 43,
wherein the data processing apparatus comprises a memory and
wherein the memory is used to store data when used by the processor and;
wherein the memory is coupled to the processor to receive words from the processor and deliver words to the processor.

Feature 45: Data processing apparatus according to any one of features 42 to 44,
wherein the memory is external to the integrated circuit and
wherein the memory is coupled to the processor via the interface at the boundary of the integrated circuit to receive words from the processor and supply words to the processor.

Feature 46 Data processing apparatus according to any one of features 42 to 45,
whereby the processor and the hash computer are arranged in such a way that they
   a) calculate a hash function for each word depending on a security code stored in the non-volatile memory and store the hash in conjunction with the word,
   b) retrieving stored words from memory, recalculating a hash function for each retrieved word using the security code and comparing the recalculated hash value with the stored hash value; and
   c) allow the processing of the retrieved word by the data processing system only if the newly calculated and stored hashes have a predetermined relationship.

Feature 47: A device comprising the following:
an integrated circuit comprising a data processing means and a non-volatile memory means which stores at least one security code;
a first means storing data, the data in a first format being cryptographically protected by at least an authentication code; and
a quantum random number generator (28) according to one of the features 1 to 9 as part of the integrated circuit,
wherein the quantum random number generator comprises a photon source (54) and a photon detector (55) which are or can be coupled to each other, in particular via an optical waveguide (44) which is manufactured in particular outside the semiconductor substrate of the integrated circuit on the surface of the integrated circuit, and
wherein the device utilizes at least one random number of the quantum random number generator (28) for encrypting or decrypting a date or the authentication code at least temporarily.

Feature 48 A device according to feature 47,
the device having a second device, in particular outside the integrated circuit, for storing data, and
wherein the apparatus comprises means for transferring data from the first memory via the integrated circuit to the second memory for access by the processor from the second memory, and
wherein the device comprises means for validating the data read from the first memory during transmission using a security code stored in the non-volatile memory, and
wherein the apparatus comprises means for applying cryptographic protection comprising at least one authentication code to the validated data in a second format using a security code stored in the non-volatile memory when the data is validated, and
wherein the device comprises means for storing the protected data in the second memory in the second format.

Feature 49: Device, in particular according to one of the features 23 to 48,
wherein the device comprises a quantum random number generator (28) according to any one of features 1 to 9, and
wherein the quantum random number generator comprises the following device parts:
a photon source (54)
a photon detector (55),
wherein the photon detector (55) is optically coupled to the photon source (55),
an optional fiber optic cable (44), for this optical coupling,
an optional amplifier (404) and/or filter,
an analog-to-digital converter (403),
an optional comparator (404.2),
a time-to-random number converter (404.3),
an entropy extraction device (404.4) which converts output values of the time to pseudorandom number converter (403) into first and second values and generates quantum random bits 411 therefrom.

Feature 50: Device according to feature 49, wherein the device comprises a watchdog (404.5) which monitors device parts of the quantum random number generator (28).

Feature 51: Device according to one of the features 49 to 50, wherein the device comprises a voltage monitor (413) which detects and monitors analog values of analog signals of the quantum random number generator (28) and/or for the operation of the quantum random number generator (28).

Feature 52: Device according to one of the features 49 to 51, wherein the device comprises a further pseudo-random number generator (404.6), in particular in the form of a linear feedback shift register (404.6).

Feature 53: Device according to one of the features 49 to 52, wherein the device comprises a signal multiplexer (404.7) which, in the event of an error, switches from the signal of the output (411) of the entropy extraction device to a signal of a substitute random number generator or a substitute pseudo-random number generator (404.6).

Feature 54: Device according to one of the features 49 to 53, wherein the start value of the additional pseudorandom number generator 404.6 in the event of an error depends on previously correctly generated quantum random bits 411 of the quantum random number generator (28).

Feature 55: Method for generating a random bit comprising:
generating a pulse sequence with random intervals by means of a photon source (54), in particular a silicon LED (54) and/or in particular a first SPAD diode (54), and a photon detector (55), in particular a second SPAD diode (55),
generating (501) a first value in the form of a first pseudorandom number as a function of the time interval between a first pulse and a second pulse which is different from the first pulse;
generating (501) a second value in the form of a second pseudorandom number as a function of the time interval between a third pulse, which is different from the first pulse, and a fourth pulse, which is different from the first pulse and from the second pulse and from the third pulse.
comparing (502) the first value with the second value and
outputting (503) a first logic value as a quantum random bit (411) when the first value is greater than the second value, and
outputting (503) a second logical value different from the first logical value as the random bit when the first value is smaller than the second value.

Feature 56: Method (3700) for generating a quantum random number QZ (418) with m quantum random bits (411) with the steps;
Generation (3710) of a random single photon stream 57, 58, 59, 44 from single photons by means of one or more photon sources, in particular one or more silicon LEDs (54) and/or one or more first SPAD diodes (54);
Transmission (3720) of the random single photon stream (57, 58, 59, 44), in particular by means of an optical waveguide 44 and/or the semiconductor substrate (49, 48) different from the semiconductor substrate or by direct transmission, to one or more photon detectors (55), in particular one or more second SPAD diodes (55);
Conversion (3730) of the random single photon stream (57, 58, 59, 44) into a detection signal by means of the one or more photon detectors (55);
Conditioning (3740) of the detection signal into a conditioned detection signal;
determination (3760) of a first pseudorandom number as a function of a first time interval between a first pulse and a second pulse of a first pair of two successive pulses of the conditioned detection signal produced by coupling the emissions of the photon source (54) and the photon detector (55), and
Determination (3765) of a second pseudorandom number as a function of a second time interval between a third pulse and a fourth pulse of a second pair of two successive pulses of the conditioned detection signal produced by couplings of the emissions of the photon source (54) and the photon detector (55);
Determining (3770) the bit value of a quantum random bit (411) by comparing the value of the first pseudorandom number and the value of the second pseudorandom number;
If the number (3780) n of the determined random bits is less than the desired number m of the random bits of the quantum random number QZ (418) to be generated, repeating the above steps (3710 to 3770) and terminating the process for generating a quantum random number if the number (3780) n of the determined random bits is greater than or equal to the desired number m of the random bits of the quantum random number (418) QZ to be generated.

The monolithically integrable quantum random number generator 28 presented here is robust against external attacks. Even in the event of a successful attack on the entropy source 401, the quantum random numbers 411 are not influenced in such a way that the attacker can break an encryption without considerable additional effort. The secure microcontroller presented here thus has an improved entropy of its random number generator. As a result, the encryption of this secure microcontroller is post quantum secure in contrast to the state of the art. However, the advantages are not limited to this.

DESCRIPTION The figures show simplified examples of essential parts of the proposed devices and methods. By way of illustration, certain examples constructed in accordance with the teachings of the present disclosure will now be described with reference to the accompanying drawings, in which.

Detailed embodiments will now be described, examples of which are shown in the accompanying drawings. The effects and features of these embodiments are described with reference to the accompanying drawings. In the drawings, identical reference numerals, identical elements and redundant descriptions are omitted. The present disclosure may be realized in various forms and is not to be understood as being limited to the embodiments shown herein. Rather, these embodiments are examples so that this disclosure is thorough and complete and fully conveys the aspects and features of the present disclosure to those skilled in the art.

Methods, elements and techniques which are not necessary for the skilled person to fully understand the aspects and features of the present disclosure are therefore not described where appropriate. In the drawings, the relative sizes of elements, layers and areas may be exaggerated for clarity.

As used herein, the term “and/or” includes any combination of one or more of the listed elements. Further, the use of “may” when describing embodiments of the present disclosure refers to “one or more embodiments of the present disclosure”. In the following description of embodiments, the terms in the singular may also include the plural unless the context clearly indicates otherwise.

Although the terms “first” and “second” are used to describe different elements, these elements should not be restricted by these terms. These terms are only used to distinguish one element from another. For example, a first element may be referred to as a second element, and similarly a second element may be referred to as a first element, without departing from the scope of the present disclosure. Expressions such as “at least one of”, when prefixed to a list of elements, modify the entire list and not just the individual elements of the list.

Terms such as “substantially”, “approximately” and the like are used as approximations rather than degrees and are intended to account for inherent variations in measured or calculated values that are recognized by those skilled in the art. When the term “substantially” is used in connection with a characteristic that can be expressed by a numerical value, the term “substantially” means a range of at least +/−5% of the value centered on the value.

In this example, the data processing device is a computer in the form of a monolithic, micro-integrated circuit 2, for example the microcontroller, for controlling a controlled system 26.

The following description first describes the configuration of an exemplary microcontroller as an example of a monolithic, microintegrated circuit 2 with a proposed quantum random number generator 28 and the exemplary contents of its various memories as it would be used after manufacture.

The computer in the form of the monolithic, micro-integrated circuit 2, for example the microcontroller, is connected to a controlled system 26 via a connection 3. The controlled system may be a backup tape drive, for example. With a backup tape drive, it is important that the integrity of the backed up data is maintained. It is therefore important that the integrity of the data and programs used by the computer in the form of the monolithic, micro-integrated circuit 2, for example the microcontroller, is maintained.

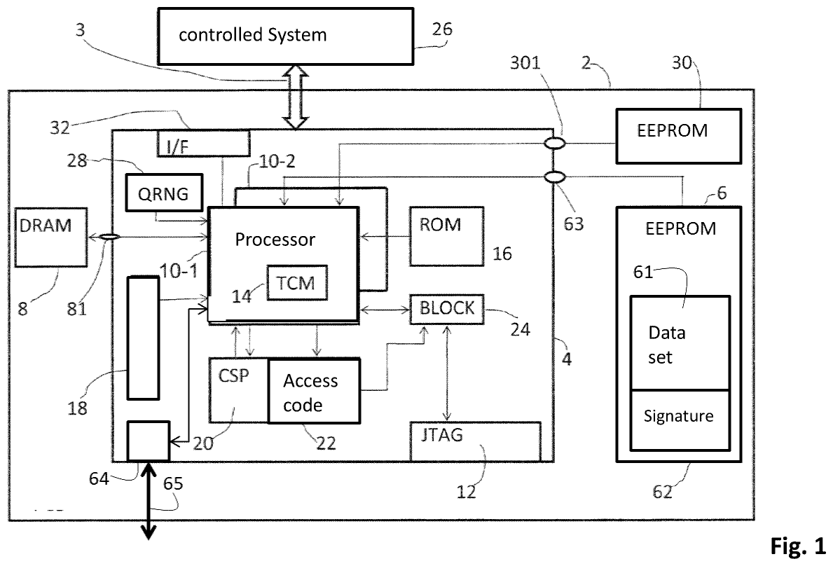

### FIG. 1

In the example of FIG. 1, the computer in the form of the monolithic microintegrated circuit 2, for example the microcontroller, comprises for example the monolithic integrated circuit 2 of an exemplary microcontroller comprising for example a control device 4, a non-volatile memory 6 and a random access memory 8, hereinafter also referred to as RAM (Random Access Memory), 8. The non-volatile memory 6 may comprise any suitable type, such as a flash memory and other types. In this example, it is a read-only memory, e.g. an EEPROM. The microcontroller here is only an exemplary embodiment of a one-piece and monolithic integrated circuit 2 having a monolithic integrated quantum random number generator 28. Other microelectronic integrated circuits 2 are expressly encompassed by the technical teachings of the present document. When this document refers to a “microcontroller integrated circuit 2” or a “microcontroller integrated circuit 2”, the person skilled in the art will automatically read other microelectronic integrated circuits and devices herein. In the sense of the document presented here, these microelectronically integrated circuits and devices also expressly include MEMS (micro-electro-mechanical system), MOEMS (also: MOMS) (micro-optical-electro-mechanical system), optical MEMS, optical microsystems, BioMEMS (stands for the application of MEMS to, for example, cell biology or the field of biology), and bioMEMS. e.g. cell biology or its neighboring fields), micromachines, MEFS (micro-electro-fluidic systems), NEMS (nano-electro-mechanical system), pMEMS (piezo-electric micro-electro-mechanical resonators), RF-MEMS (radio-frequency MEMS).

The document presented here thus regards the term “microcontroller” used here as merely exemplary. The skilled person reads the use of a quantum random number generator 28 with a time-to-pseudorandom number converter 404.3, as proposed herein, in a monolithic co-integration with conventional microintegrated circuits immediately when referring to “microcontroller integrated circuit 2”, and expressly does not limit the technical teaching of this document to the co-integration of the proposed quantum random number generator 28 with a microcontroller.

Such other common integrated circuits 2 may include, for example:
Microcontrollers, microprocessors, memories, DRAMs, SRAMs, RAMs, volatile memories, OTP memories, EEPROMs, flash memories, MRAMs, FRAMs, bus transceivers, sensor evaluation circuits, motor driver circuits, control circuits for an automotive control circuits, Graphics controllers, communication circuits, evaluation circuits for a biometric sensor, evaluation circuits for input devices, control circuits, chip card circuits, circuits for cell phones or a smart phone, circuits for servers. Circuits for PCs, circuits for laptops, circuits for access and/or access control systems, circuits for the coded recording of operating parameters, circuits for electronic fuses, radio system circuits, communication circuits, circuits for encryption and/or decryption systems, circuits for individualization and identification purposes and/or identification systems and/or identification systems, circuits of gaming devices, circuits of simulation systems, circuits of computer systems, circuits of noise and/or signal sources, circuits of modulation systems and/or devices, circuits with a device for generating and/or using spreading codes. The above list is certainly incomplete.

The random access memory 8 may be any suitable memory, such as an SRAM, but in this case it is a DRAM. The non-volatile memory 6 and the random access memory 8 are located outside the control device 4 in the example of FIG. 1. A further non-volatile memory 30 may optionally be provided within the micro-integrated circuit outside the control device 4 and connected to it via an internal interface 301.

The micro-integrated circuit 2 comprising the exemplary control device 4 is preferably a monolithic integrated circuit comprising, for example: one or more processors 10-1, 10-2; a tightly coupled memory 14, which may be, for example, an SRAM; a non-volatile boot ROM 16 containing a preferably non-modifiable code; a hashing engine 18, for example; one or more one-time programmable memories (OTP) 20 and 22; a JTAG test interface 12; an interface 32; internal interfaces 63, 81 and 301 coupled to memories 6, 8 and 30; a quantum random number generator 28, also referred to as QRNG in the present document; and a hardwired circuit for disabling tests 24. The OTP memories 20 and 22 may be separate memories or parts of a memory within the exemplary integrated circuit 2. In this example, they are sections of a single memory. The test disable circuit 24 is preferably located between the test port 12, which in this example is a JTAG port, and the processor(s) 10. The disable circuit 24, which is preferably present, is responsive to data in the OTP memory section 22. The optional hashing engine 18 uses data (one or more keys) in the OTP memory section 20. The OTP memory section 20 preferably stores critical security parameters (CSPs) including a secret key and at least one public key. Additional keys can be stored in the OTP storage section 20. In one embodiment of the proposal of this example application of a quantum random number generator 28, the secret key is preferably unique for each instance of the example microintegrated circuit 2 proposed herein.

The processor(s) 10 preferably executes instructions only from the tightly coupled memory 14 and from the DRAM 8 in the example of FIG. 1 presented herein. The boundary of the control device 4 is a cryptographic virtual boundary, and the data and program execution within this boundary are considered secure in this first proposed application of a proposed quantum random number generator 28, as will be explained further below. The EEPROM 6 and DRAM 8 (and memory 30, if present), are outside the cryptographic boundary, and without security measures, the contents of these memories would not be secure for purposes of the present document. The interfaces 12, 63, 301, 32 and 81 are located at the physical and cryptographic boundary of the control device 4 within the micro-integrated circuit 2. The present document thus discloses a micro-integrated circuit 2 having internal interfaces, 63, 301, 32 and 81 at a cryptographic boundary between a control device 4 and other parts (8, 30, 6) of the micro-electronic integrated circuit 2 that are considered non-secure or less secure. The essential purpose of these internal interfaces, 63, 301, 32 and 81 is thus to securely shield an internal control device 4 within the micro-integrated microelectronic circuit 2.

The contents of the DRAM 8 and the EEPROM 6 are preferably cryptographically protected by authentication codes. In this example, the authentication codes used in the DRAM 8 are preferably of a different type than the authentication codes used in the EEPROM 6. In this example, the content of the EEPROM 6 is protected from undetected malicious modification at least by the use of digital signatures. The format of the data in the EEPROM 6 is also preferably different from that in the DRAM 8.

For example, the EEPROM 6 preferably stores the firmware, which is arranged in one or more data sets 61, each with a digital signature 62. The digital signatures used in this example of the proposal use public and private keys. Therefore, the details of the digital signatures will not be described further as they are known to the person skilled in the art. When a processor (10-1, 10-2) reads a data set from the EEPROM 6, the processor 10 verifies its digital signature. If the digital signature is valid, the data set is processed by the processor(s) 10 using computer-implemented methods of the firmware. The processor(s) 10 thus preferentially executes only validly signed firmware. For signing, the processor(s) 10 preferably use inferences and authentication codes that depend on quantum random numbers 418 of one or more quantum random number generators 28.

As shown in FIG. 1, in one example, the boot ROM 16 contains a code that the processor 10 uses to read a load program S2 from the EEPROM 6 in order to read further data records from the EEPROM 6. A logic in the processor 10 loads a program counter (not shown) in the processor 10 with the start address 15 of the boot ROM 16. The processor 10 then executes the code in the boot ROM 15. This code of the boot ROM 15 can read a computer-implemented load program from the EEPROM 6. The boot code in the boot ROM 15 is considered secure because it is located within the cryptographic boundary 4. The load program is protected by a digital signature, which the processor 10 verifies when executing the boot ROM code S4 in the boot ROM 15 using the public key stored in the first OTP memory 20. Subsequent data records are read using the load program S6. The load program in the EEPROM 6 and the subsequent data records are each provided with a digital signature and have one or more public keys embedded. When executing the load code of the load program in the EEPROM 6 in step S8, the processor 10 checks the signature of the data record newly read from the EEPROM 6 using a public key embedded in a data record previously loaded or stored in the OTP memory 20.

A data set read from the EEPROM 6 may contain too much firmware code/data for the small, tightly coupled memory TCM 14 of the control device 4 within the microelectronic circuit 2 to store. The TCM 14 preferably stores firmware code/data that is immediately required by the processor(s) 10. The remainder of the firmware data set is transferred to the DRAM 8. Since the DRAM 8 is outside the cryptographic boundary 4, the codes/data stored therein are cryptographically protected by authentication codes generated by the processor 10 preferably using quantum random numbers of the quantum random number generator 28.

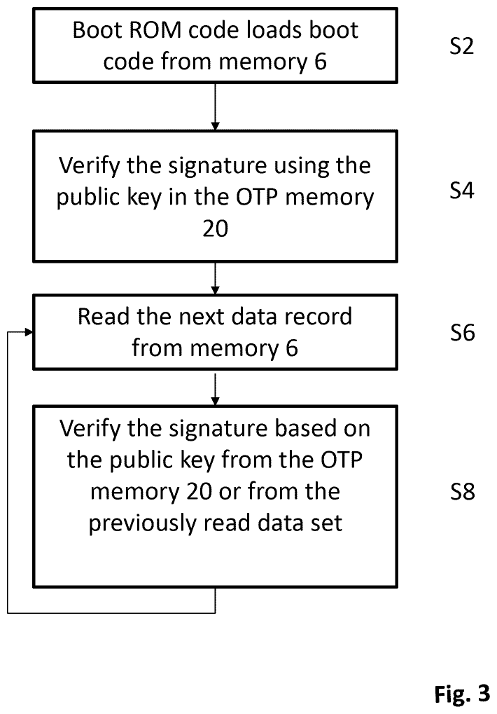

### FIG. 3

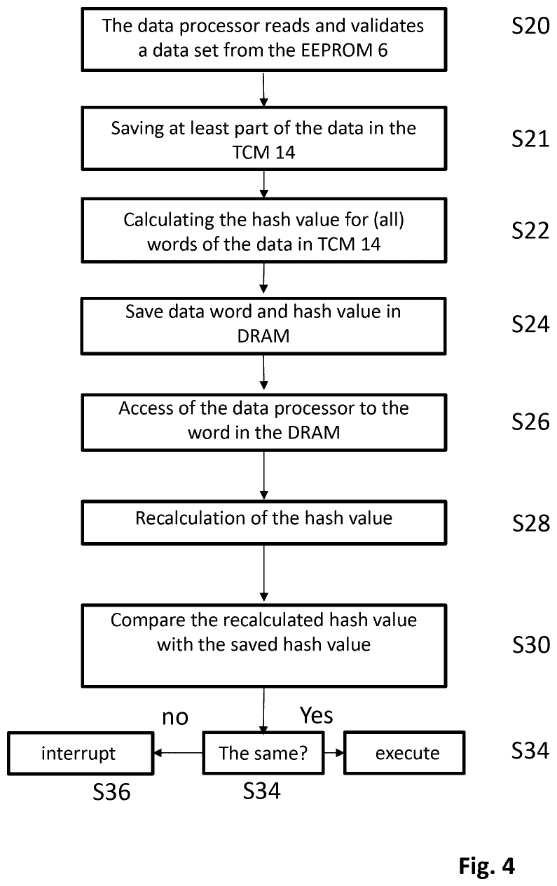

As shown in FIG. 3, the processor 10 reads the data as a data set from the EEPROM 6 and writes it as words to the DRAM 8 or reads these words from this DRAM 8. In this example, when the processor 10 reads a record from the EEPROM in step S20, the processor 10 validates it as described in FIG. 4 and the associated description. The processor 10 stores at least a portion of the data of the record in the TCM 14 in step S21. The processor 10 processes the remaining data of the record, for example, as follows and stores it in the DRAM 8. The processor(s) 10 cooperates with the optional hash engine 18 to calculate a hash value for each word of the remaining data in step S22, for example, and to store the hash value in the DRAM 8 at a location associated with the stored word in step S24. The word size is selected according to the system limitations. It can be as small as one byte. In practice, it can be 32 bits. When the processor 10 reads a word from the DRAM 8 in step S26, the processor 10 and the hash engine 18 preferably recalculate the hash value and compare the recalculated hash value with the corresponding hash value stored in the DRAM 8 in step S30. If the hash values have a predetermined relationship, which is checked in step S34, e.g. are equal, in a step S38 the processor 10 processes the read data. If the hash values do not have the predetermined relationship, the processor 10 interrupts the processing in step S36 and/or the processor 10 generates an error message and/or the processor 10 ignores the data/code.

Storing words in the DRAM 8 with corresponding authentication codes, preferably based on quantum random numbers of the quantum random number generator 28, facilitates random access to the words by the processor(s) 10.

The hash function can be any suitable hash function. One example is the well-known HMAC function. In this example, the HASH function uses the secret key stored in the OTP memory 20. It could also use another key stored in the OTP memory. Preferably, the secret key is based on a quantum random number of the quantum random number generator 28. An example of the hash value is HMAC (address∥data∥secret key), where the character string “∥” here stands for the concatenation. Taking into account the number of bytes that the DRAM 8 can store, the HASH value preferably comprises at least enough bits to avoid or at least reduce duplication of HASH values in the DRAM 8. The number of bits of the HASH value is preferably at least 96 bits and can also be considerably larger. The industry standard is 160 bits, which reduces the probability of duplication of HASH values to a sufficiently low level.

By providing the cryptographic boundary 4 and protecting the data stored in the DRAM 8 and EEPROM 6, the integrated circuit 2, in particular that of the microcontroller, is protected against unauthorized access to the programs and data used by the processor(s) 10 of the computer during normal operation. This is of particular importance in the automotive sector in order to prevent plagiarism and unauthorized spare parts, which usually require knowledge of the firmware of the illegally copied spare parts. However, the JTAG test port 12 could allow access to the processor(s) 10 in a test mode with known EMULATE and TRACE routines and still allow illegal program modifications. The JTAG test port 12 is required for testing at least during the manufacturing process of the integrated circuit 2, such as that of a microcontroller, and can be used for fault diagnosis after manufacturing. Such an analysis capability of an automotive integrated circuit 2, for example an automotive microcontroller, is an indispensable prerequisite for meeting the quality requirements of T16491.

In order to unauthorized and in particular illegal use of the JTAG interface 12, the OTP memory 22 can, for example, comprise at least one security bit which, together with the disabling circuit 24, disables the JTAG interface 12.

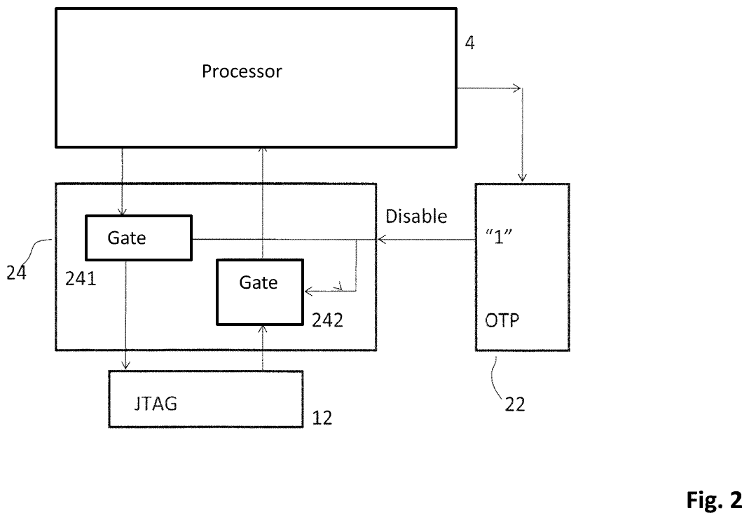

In one example, the OTP memory 22 only contains one bit. The OTP memory 22 allows a bit to be changed only once from one state, e.g. “0”, to the opposite state “1”. During the manufacture of the integrated circuit 2, for example the microcontroller, the bit is “0”, for example, which enables tests. In a final test step, the manufacturer of the exemplary integrated circuit 2, for example the microcontroller, sets the bit to “1” before releasing the integrated circuit 2, for example the microcontroller, for delivery and use. The JTAG port 12 typically has a serial input and a serial output (see FIG. 2). The disabling circuit, which is part of the circuitry of the control device 4 within the integrated circuit 2, for example the microcontroller, preferably comprises a gate 241 located, for example, between the serial output of the JTAG port 10 and the processor(s) 10, and a gate 242 located between the serial input of the JTAG port 10 and the processor(s) 10. The security bit “1” in the OTP memory 22 disables the gates 241 and 242. Since the security bit cannot be changed, the test port is then secured against use after the integrated circuit 2, such as the microcontroller, has been manufactured and delivered.

In another example, the OTP memory 22 has a two-bit security code, which is initially “00”. This enables a check during production, after which the code is set to “01”, i.e. one of the two bits is set to “1”. This code “01” disables the gates 241 and 242. If an error occurs, the integrated circuit 2, for example of the microcontroller, is sent back to its manufacturer, who sets the other bit to “1”, resulting in the code “11”, which enables a test via the connection 12. Such a check is preferably destructive as it does not allow a reset to the original value. The OTP memory 22 can be accessed to change the security code by a suitable access code, preferably generated using a quantum random number generator 28, which is provided with a digital signature that can be verified by a quantum random number-based key stored in the OTP memory 20. The key can, for example, be the standard public key stored in the memory 20. This allows the security code to be changed to “11”, which enables verification via the JTAG interface 12. The original integrated circuit 2, for example the microcontroller, is preferably retained and preferably destroyed by the manufacturer and the user receives a new integrated circuit 2, for example a microcontroller.

In another example, the security code can consist of three or more bits that change when the signed access code is used. During manufacture, the code is “000” and when released to a user it is “001”. If an error occurs, the code is changed to “011” by the manufacturer to enable testing. After testing, the code is changed to “111”, whereby the JTAG interface 12 is secured against use and the integrated circuit 2, for example the microcontroller, can be returned to the user. Only a signed access code, which is provided with a digital signature verified by a key in the OTP memory 20, can be used to change the code stored in the OTP memory 22.

Security codes of two or more bits provide an audit trail for testing (or any unauthorized test attempts) after manufacture.

### Additional Interface and Additional EEPROM

As shown in FIG. 1, the control device 4 of the integrated circuit 2, for example the microcontroller, can optionally have at least one further interface 32 in addition to the connections 3 and 12. This further interface 32 can, for example, be an Ethernet connection or a Fibre Channel connection or an automotive data bus connection for data buses such as CAN, LIN, DSI3 or PSI5. For the purposes of the present document, a fiber channel connection is a data connection that uses an optical fiber or other waveguide for electromagnetic radiation.

The integrated circuit 2, for example the microcontroller, may additionally a further non-volatile memory 30 outside the control device 4 of the integrated circuit 2, for example a microcontroller, which stores data that is cryptographically protected by a security parameter stored in the OTP memory 20. The further non-volatile memory 30 is coupled to the control device 4 via the internal interface 301 of the integrated circuit 2, for example the microcontroller.

The additional non-volatile memory 30 can be an EEPROM, for example. The further memory 30 can store further critical security parameters outside the control device 4. The further parameters are preferably encrypted and provided with digital signatures to make them secure. The further parameters are preferably encrypted with the secret key, which unique to the control device 4 and stored in the OTP memory 20. Preferably, the secret key is based on a quantum random number of a quantum random number generator 28. The digital signatures of the further parameters are generated using the unique secret key stored in the OTP memory 20. This secret key is used to decrypt the further security parameters and to verify the digital signatures read from the further memory 30.

The further non-volatile memory 30 may contain other encrypted and/or digitally signed data.

The other security parameters outside the control device 4 of the integrated circuit 2, for example the microcontroller, can be used to secure the data and codes transmitted via the interface(s) 32.

### Production of the Integrated Circuit 2, for Example the Microcontroller.

During manufacture of the integrated circuit 2, for example the microcontroller, the boot code is preferably hard-coded in the boot ROM 16; the load program and other codes/data are stored in the EEPROM 6 with digital signatures based on the public and private keys generated preferably by means of quantum random numbers of a quantum random number generator 28; and preferably at least one public key is generated by means of a quantum random number of a quantum random number generator and stored in the OTP memory 20.

The secret key is preferably not stored in the OTP 20 until the security code, which is preferably based on a quantum random number of a quantum random number generator 28, is set in the OTP 22 and the test port of the exemplary JTAG interface 12 has been disabled. In the example presented here, the control device 4 of the integrated circuit 2, for example the microcontroller, contains the necessary quantum random number generator QRNG 28. The firmware stored in the tightly coupled memory 14 or in the DRAM 8 reads one or more quantum random numbers of, for example, 256 bits from the quantum random number generator 28 and stores them in the OTP 20 as a secret key without this data leaving the control device 4, preferably within the integrated circuit 2, for example the microcontroller. This is preferably only done after the test connection 12 has been deactivated, in order to prevent access to the secret key even by persons who have access to the manufacturing process. Preferably, the logic gates of the integrated circuit 2, for example of the microcontroller, or at least those of the control device 4 of the integrated circuit 2, for example of the microcontroller, are designed in such a way that the current peaks occurring during changes in logic states within the circuits of the logic gates do not allow any conclusions to be drawn about the processes and/or the data and/or the quantum random numbers and/or the circuit states of the device. This avoids so-called side channels. For this purpose, the proposed device can comprise current sources, complementary switching, complementary dummy circuits, energy reserves (e.g. capacitors), etc.

The hash function of the hashing engine 18 can be any suitable hash function and is not limited to the example of HMAC described above.

The on-chip quantum random number generator 28 QRNG could be omitted from the integrated circuit 2, for example the microcontroller, and instead an off-chip quantum random number generator QRNG could be used to generate the secret key during the manufacturing process. However, a quantum random number generator QRNG on the chip is significantly more secure.

The firmware stored in the EEPROM 6 is preferably cryptographically protected, in this example by digital signatures. During production, the firmware is first compiled. It is then digitally signed with a secret private key of a private-public key system. Preferably, the secret private key of the private-public key system is based on a quantum random number of a quantum random number generator 28. The public key is preferably stored in the OTP memory 20 so that the signature can be verified. The signed firmware is stored in the EEPROM 6. The digital signatures may be created by transmitting the compiled firmware to a secure signature generator during the manufacturing process. The secure signature generator may be the integrated circuit 2, for example of the microcontroller, namely the control device 4 in cooperation with the quantum random number generator 28 itself. The signed firmware can be downloaded to the EEPROM 6 via a communication link, e.g. the Internet, if the signing is done externally. However, the processor 10 can remove the signing of the firmware before it is stored in the EEPROM 6 and replace it with its own quantum random number-based signing based on a quantum random number from its quantum random number generator 28, which then makes it impossible for anyone to read the firmware without exception.

Instead of an EEPROM, the non-volatile memory 6 can be any other suitable memory, for example a FLASH memory.

The other non-volatile memory 30 can be a serial EEPROM memory, for example.

The one-time programmable memory OTP 22, which contains the security code, can be replaced by another reprogrammable, non-volatile memory and the security code can be changed using signed firmware. However, a memory 22 that can only be programmed exactly once is more secure, as its programming is irreversible.

The DRAM 8 can be further protected by making access to the DRAM 8 physically very difficult and detectable in the event of an attempt. For example, the connections between the DRAM 8 and the control device 4 may be buried in layers of the metallization stack of the integrated circuit 2, such as the microcontroller, or otherwise protected against physical sensing (e.g. by e-beam). Preferably, the device parts of the control device 4 also comprise such scanning protection. In particular, it is advantageous if the quantum random number generator 28 has such scanning protection, for example in the form of a metal layer 53, 142 lying at a predefined potential.

The entire integrated circuit 2, for example of the microcontroller, can be provided with such scanning protection, for example in the form of a metal layer 53, 142 at a predefined potential. The entire integrated circuit 2, for example of the microcontroller, can also be housed in a tamper-proof housing with tamper-proof seals.

The safe integrated circuit 2, for example of the microcontroller, preferably has at least one photon source 54 or a silicon LED 54 or a first SPAD diode 54 as photon source for photons of the quantum random number generator 28. The safe integrated circuit 2, for example of the microcontroller, preferably has at least one photon detector 55 or a second SPAD diode 55. Preferably, an optical system optically couples the at least one photon source 54 or the silicon LED 54 or the first SPAD diode 54 to the photon detector 55 or the second SPAD diode 55 by means of these photons. The optical system may include an optical fiber 44. The quantum random number generator 28 is preferably a quantum process-based true random number generator (QRNG) 28. The quantum process-based true random number generator (QRNG) 28 preferably comprises a photon source 54 or a silicon LED 54 or a first SPAD diode 54 as a light source for an optical quantum signal and photon detector 55 or a second SPAD diode 55 as a photodetector for this optical quantum signal. Furthermore, the quantum process-based true random number generator (QRNG) 28 preferably comprises at least the processing circuit and, if present, the optical fiber 44. Preferably, the optical fiber 44, if present, optically couples the photon source 54 or the silicon LED 54 or the first SPAD diode 54 to the photon detector 55 or a second SPAD diode 55. An operating circuit supplies the photon source 54 or the silicon LED 54 or the first SPAD diode 54 with electrical energy in such a way that the photon source 54 or the silicon LED 54 or the first SPAD diode 54 emit light. The emission of light thereby requires that the operating voltage a sufficient electrical bias voltage to the photon source 54 or the silicon LED 54 or the first SPAD diode 54. A processing circuit (402, 403, 404) detects the signal from the photon detector 55 or the second SPAD diode 55 and forms the quantum random number 418 therefrom. The processing circuit then preferably makes the quantum random number 418 thus formed available one or more of the one or more processors 10 via a data bus 419.

Preferably, the semiconductor crystal of the integrated circuit 2, for example of the microcontroller, has a surface 56. Typically, the semiconductor crystal has a semiconducting material below its surface 56. In particular, when using conventional semiconductor circuit manufacturing processes, such as CMOS processes, bipolar processes, BiCMOS processes and BCD processes, the surface 56 of the semiconductor crystal typically has a metallization stack as structured metal layers and electrical insulation layers. The structured metal layers typically form the electrically conductive tracks, which are electrically separated from each other by the insulation layers. Thus, the metallization stack has a typically structured and optically transparent and electrically insulating layer 44. At least part of this typically structured, transparent and electrically insulating layer 44 of the surface 56 preferably forms the optical waveguide 44.

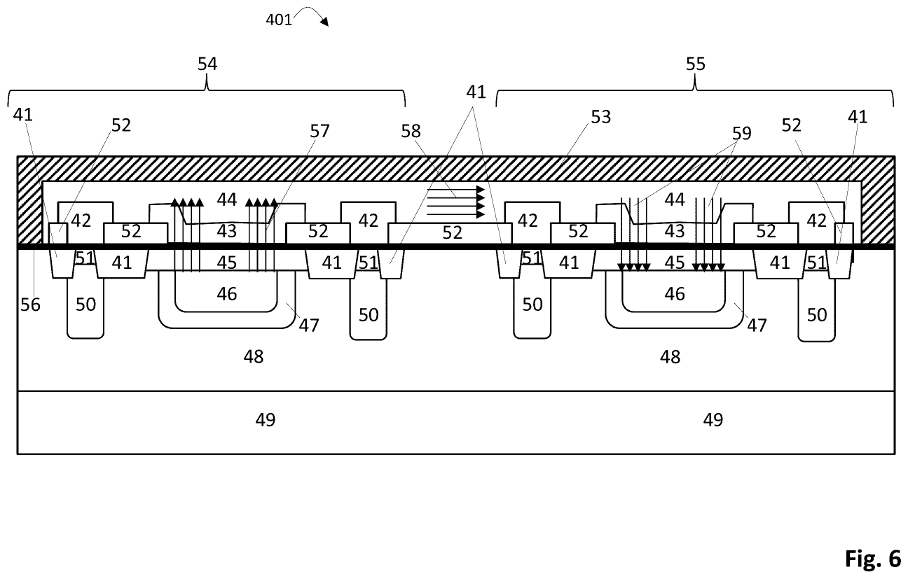

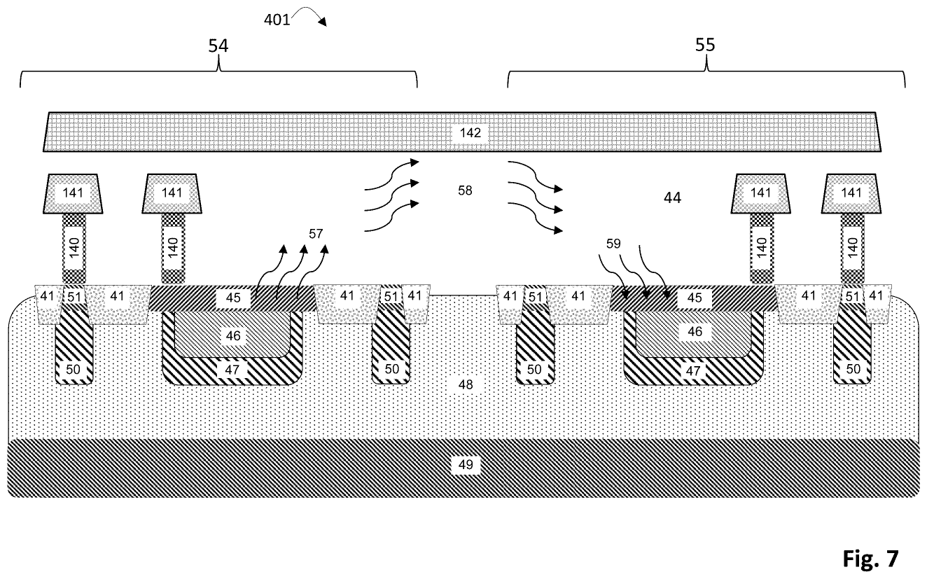

The examples of FIGS. 6 and 7 presented here use a first SPAD diode 54 as the photon source 54. In the examples of FIGS. 6 and 7, the first SPAD diode 54 emits light 57 into this optical waveguide 44 from the semiconducting material of the semiconductor substrate 49, for example. That is generally, the first SPAD diode 54 radiates substantially upwardly perpendicular to the surface 56 and not laterally into the semiconductor substrate 49 of the semiconductor crystal 49. This is because the material of the semiconductor crystal 49 has a high attenuation for this light. Nevertheless, the emission of the photons 57 of the first SPAD diode 54 in the optical waveguide 44 is not directional. In particular, the emission via the substrate 48, 49 is very attenuated, since visible light has a very high absorption. This arrangement enables the device to couple more photons from the first SPAD diode 54 directly to the second SPAD diode 55, which serves here as photon detector 54 in the examples of FIGS. 6 and 7. In the examples of FIGS. 6 and 7, the optical waveguide 44 transports these photons 57, 58, 59 of the first SPAD diode 54 in the optical waveguide 44 to the second SPAD diode 55 with virtually no loss compared to other prior art solutions. In the examples of FIGS. 6 and 7, the optical waveguide 44 irradiates the second SPAD diode 55 with these photons 57, 58, 59 of the first SPAD diode 54 in such a way that the light 59 from within the optical waveguide 44 penetrates back into the semiconducting material of the semiconductor substrate 49 from the surface 56 and strikes device parts of the second SPAD diode 55 there. The second SPAD diode 55 then generates a received signal depending on the irradiation with these photons 59.

Typically, at least one operating circuit in the examples of FIGS. 6 and 7 supplies the at least one first SPAD diode 54 at least temporarily with electrical energy. When supplied with sufficient electrical energy, the at least one first SPAD diode 54 then feeds photons 57 into the optical waveguide 44 provided in FIGS. 6 and 7. The optical waveguide 44 then transports these photons 57, 58, 59 further. The optical waveguide 44 provided in the examples of FIGS. 6 and 7 then radiates the transported photons 58 into the second SPAD diode 55 as essentially vertically moving photons 59. Since this transport of the photons from the first SPAD diode 54 to the second SPAD diode 55 loses significantly fewer photons than in other prior art designs that use the strongly absorbing semiconductor substrate 49, 49 due to the low attenuation in the optical waveguide 44, the quantum efficiency is massively higher. This increases the bit rate of the quantum random bits 411 with which the device can quantum random numbers 418. Therefore, in the construction presented here, a pair of a single first SPAD diode 54 and a single second SPAD diode 55 is sufficient. Other prior art devices typically utilize multiple SPAD diodes.

In a further development of the secure integrated circuit 2 according to the proposal, for example the microcontroller, at least one data interface of the one or more data interfaces 64 is a wired automotive data bus interface 64. In that case, the wired automotive data bus interface 64 can be, for example, a CAN data bus interface or a CAN FD data bus interface or a Flexray data bus interface or a PSI5 data bus interface or a DSI3 data bus interface or a LIN data bus interface or an Ethernet data bus interface or an SPI data bus interface or a MELIBUS data bus interface.

In a further development of the safe integrated circuit 2 according to the proposal, for example the microcontroller, at least one data interface 64 of the one or more data interfaces 64 is a wireless data bus interface. The wireless data bus interface 64 may be, for example, a WLAN interface or a Bluetooth interface.

In a further development of the safe integrated circuit 2 according to the proposal, for example the microcontroller, at least one data interface 64 of the one or more data interfaces 64 is a wired data bus interface 64. The wireless data bus interface 64 can, for example, be a KNX data bus interface or an EIB data bus interface or a DALI data bus interface or a PROFIBUS data bus interface.

Although the proposed device has been described by way of example with reference to a control device 4 and the integrated circuit 2, for example the microcontroller, it is not limited to a control device 4 or the integrated circuit 2, for example the microcontroller. The proposed device can also be applied to other types of integrated circuit processors and other integrated circuits. A microprocessor is only a particularly favorable, because complex, example of an exemplary integrated circuit 2 according to the proposal.

The embodiments of the device according to the proposal store data inside and possibly also outside the integrated circuit 2, for example the microcontroller. The embodiments of the proposal prevent the data to be processed, including the executable code, from being changed by unauthorized persons accessing the data stored outside the integrated circuit 2, for example the microcontroller, or, if such access occurs, prevent such access and/or attempted access from going unnoticed and further prevent the data and/or program codes and/or keys and/or authentication data etc. from being changed without being noticed. Security is further supported by security data, and the security data itself is secure because it is stored within the integrated circuit 2, for example the microcontroller, in a protected area 4 and protected from unauthorized access.

The description provided herein does not purport to be exhaustive and does not limit the present disclosure to the examples shown. Other variations on the disclosed examples may be understood and practiced by those of ordinary skill in the art from the drawings, the disclosure, and the claims. The indefinite articles “one” or “a” and its inflections do not preclude a plurality, while the mention of a specific number of elements does not preclude the possibility of there being more or fewer elements. A single entity can fulfill the functions of several elements mentioned in the revelation, and conversely, several elements can fulfill the function of one entity. Numerous alternatives, equivalents, variations and combinations are possible without departing from the scope of the present disclosure.

Unless otherwise indicated, all features of the present disclosure can be freely combined with one another. This applies to the entire document presented here. The features described in the figure description can also be freely combined with the other features as features of the disclosure, unless otherwise stated. A restriction of individual features of the embodiments to the combination with other features of the embodiments is expressly not intended. In addition, the features of the device can also be reformulated as process features and process features can be reformulated as features of the device. Such a reformulation is thus automatically disclosed.

Reference is made to the accompanying drawings in the preceding detailed description. The examples in the description and drawings should be regarded as illustrative and should not be regarded as limiting the specific example or element described. Several examples may be derived from the foregoing description and/or drawings and/or claims by modifying, combining or varying certain elements. In addition, examples or elements that are not described verbatim may be derived by a person skilled in the art from the description and/or drawings.

### FIG. 6

In the example of FIG. 6, the secure integrated circuit 2, for example of the microcontroller, has at least one first SPAD diode 54 and at least one second SPAD diode 55 and at least one optical fiber 44. The quantum random number generator 28 is preferably a quantum process-based true random number generator (QRNG) 28. In the example of FIG. 6, the quantum process-based true random number generator (QRNG) 28 comprises a first SPAD diode 54 as a light source for an optical quantum signal and a second SPAD diode 55 as a photodetector for the optical quantum signal. Furthermore, the quantum process-based true random number generator (QRNG) 28 in the example of FIG. 6 comprises at least the processing circuit and the optical fiber 44. Preferably, the optical fiber 44 in the example of FIG. 6 optically couples the at least one first SPAD diode 54 to the at least one second SPAD diode 55. In the example of FIG. 6, an operating circuit supplies the first SPAD diode 54 with electrical energy in such a way that the first SPAD diode 54 emits light 57. In the example of FIG. 6, the emission of light 57 requires that the operating voltage provides a sufficient electrical bias voltage to the first SPAD diode 54 (404.1). In the example of FIG. 6, a processing circuit (402, 403, 404) detects the signal of the second SPAD diode 55 (404.3) and forms the quantum random number 418 therefrom. The processing circuit then preferably makes the quantum random number 418 thus formed available to one or more of the one or more processors 10 via a data bus 419.

Preferably, the semiconductor crystal 49 of the control device 4 of the integrated circuit 2, for example the microcontroller, has a surface 56. Typically, the semiconductor crystal 49 has a semiconducting material below its surface 56. In particular, when using conventional semiconductor circuit manufacturing processes, such as CMOS processes, bipolar processes, BiCMOS processes and BCD processes, the surface 56 of the semiconductor crystal 49 typically has a metallization stack as structured metal layers and electrical insulation layers. The structured metal layers typically form the electrically conductive tracks, which are electrically separated from each other by the insulation layers. Thus, the metallization stack has a typically structured and optically transparent and electrically insulating layer 44. At least part of this typically structured, transparent and electrically insulating layer 44 of the surface 56 preferably forms the optical waveguide 44.

In the example of FIG. 6, for example, the first SPAD diode 54 radiates light 57 into this optical waveguide 44 from the semiconducting material of the semiconductor substrate 49. That is, in the example of FIG. 6, unlike other prior art devices, the first SPAD diode 54 radiates substantially upwardly perpendicular to the surface 56 and not laterally into the semiconductor substrate 49 of the semiconductor crystal, which has a high attenuation. Nevertheless, the emission of the photons 57 of the first SPAD diode 54 in the optical waveguide 44 is not directional. In particular, the emission via the substrate 48, 49 is very attenuated, since visible light has a very high absorption. As a result, the device of FIG. 6 can couple more photons of the first SPAD diode 54 directly to the second SPAD diode 55 compared to devices of the prior art. The optical waveguide 44 transports these photons 57, 58, 59 of the first SPAD diode 54 in the example of FIG. 6 in the optical waveguide 44 practically loss-free to the second SPAD diode 55 compared to other prior art devices. The optical waveguide 44 irradiates the second SPAD diode 55 with these photons 57, 58, 59 of the first SPAD diode 54 in the example of FIG. 6 in such a way that the light 59 from within the optical waveguide 44 penetrates again into the semiconducting material of the semiconductor substrate 49 from the surface 56 and strikes device parts of the second SPAD diode 55 there. In the example of FIG. 6, the second SPAD diode 55 then generates a received signal as a function of the irradiation with these photons 59.

Typically, at least one operating circuit in the example of FIG. 6 supplies the at least one first SPAD diode 54 at least temporarily with electrical energy. The at least one first SPAD diode 54 then feeds photons 57 into the at least one optical waveguide 44 in the example of FIG. 6 when it is supplied with sufficient electrical energy. The optical waveguide 44 then transports these photons 57, 58, 59 further in the example of FIG. 6. The at least one optical waveguide 44 then radiates the transported photons 58 into the second SPAD diode 55 as essentially vertically moving photons 59 in the example of FIG. 6. Since this transport of the photons from the first SPAD diode 54 to the second SPAD diode 55 in the example of FIG. 6 loses significantly fewer photons than in other prior art designs that use the strongly absorbing semiconductor substrate 48, 49 due to the low attenuation in the optical waveguide 44, the quantum efficiency is massively higher. This increases the quantum random bit rate that can be generated in a device according to the example of FIG. 6, with which the device can in turn generate quantum random numbers. Therefore, a pair of a single first SPAD diode 54 and a single second SPAD diode 55 is typically sufficient in the construction of FIG. 6 presented here. Prior art devices typically use multiple SPAD diodes.

### FIG. 7

FIG. 7 essentially corresponds to FIG. 6. In contrast to FIG. 6, the semiconductor crystal 49 and the epitaxial layer 48 are now covered with a first optically transparent insulator layer, for example an oxide layer 143. In the example shown in FIG. 7, the vias 140 are filled with electrically conductive metal. The metallization layer 1 with the electrical lines of the first wiring layer 141 contact these vias 140 in the example of FIG. 7. A second optically transparent insulating layer 144, preferably also in the form of an oxide layer, is applied to this first insulating layer 142 and the first metallization layer with the first wiring layer 141 in the example of FIG. 7. This can also be plated through by vias, which are not shown in FIG. 7, so that leads of the first metallization layer can be connected to leads of the second metallization layer in the example of FIG. 7. The interface 145 between the first optically transparent insulating layer 143 and the second optically transparent insulating layer 144, which is shown as a dashed line, is also essentially optically transparent in the example of FIG. 7 and essentially preferably does not reflect and/or absorb the light of the first SPAD diode 55. In the example of FIG. 7, the first optically transparent insulation layer 143 and the second optically transparent insulation layer 144 essentially form the optical waveguide in the region of the first SPAD diode 54 and the second SPAD diode 55. In the optical path between the first SPAD diode 54 and the second SPAD diode 55, there are preferably no vias 140 and no metal leads 141 in the example of FIG. 7, so that the light from the first SPAD diode 54 can reach the second SPAD diode 55 unhindered in the example of FIG. 7. In the example shown in FIG. 7, a metal cover 142 prevents photons from escaping upwards and preferably reflects them back into the optical waveguide 44 in the example shown in FIG. 7. The vias 140 and the metal lines of the first metallization level 141 similarly prevent light from being lost from the optical waveguide 44 in the horizontal in the metallization stack in the example of FIG. 7.

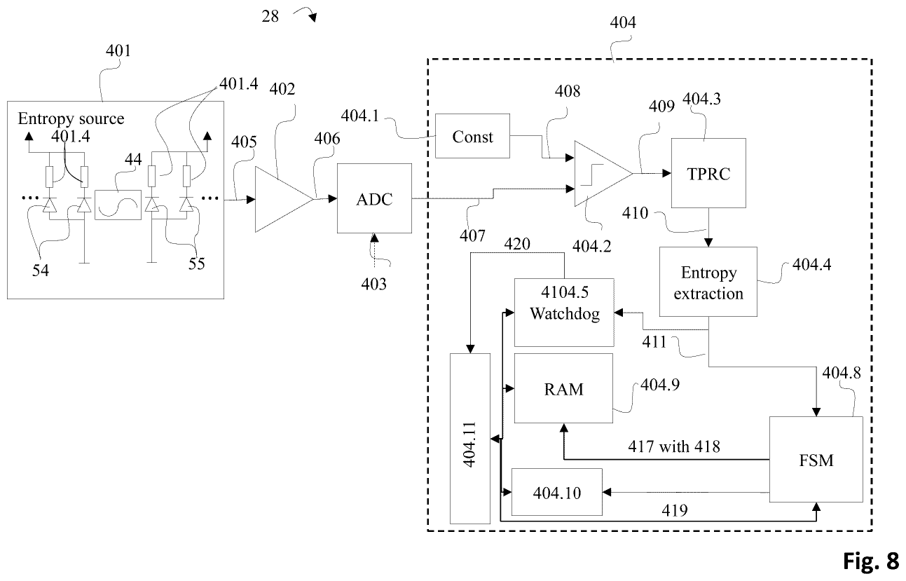

### FIG. 8

FIG. 8 schematically shows the simplified block diagram of a quantum-based random number generator (quantum random number generator 28) as proposed in this document.

A preferably common system clock 2106 preferably clocks the digital circuits of the exemplary device shown in FIG. 8. The quantum random number generator 28 of FIG. 8 is preferably part of the control device 4 and thus of the integrated circuit 2, for example the microcontroller. The structure of the quantum random number generator 28 includes an entropy source 401, in the example of FIG. 8 a broadband 40 dB high-frequency amplifier 402 or the like and an analog-to-digital converter 403, which may also be only an inverter or the like. In experiments, an analog-to-digital converter 403 with a resolution of 14 bits and a sampling rate of 125 MS/s and with an evaluation device 404 was successfully used.

In the example of FIG. 8, the entropy source 401 of the quantum random number generator 28 comprises an array 54 of single photon avalanche diodes (SPAD) 54 as photon sources 54 and an array 55 of single photon avalanche diodes (SPAD) 55 as photon detectors 55. It may also be a single common array. The voltage converters 91 of the integrated circuit 2, for example of the microcontroller, preferably supply the first SPADs 54 of the array 54 of single photon avalanche diodes (SPAD) 54 of the quantum random number generator 28, which serve as photon sources 54, and the second SPADs 55 of the array 55 of single photon avalanche diodes (SPAD) 55 of the quantum random number generator 28, which serve as photon detectors 55, with an operating voltage such that they are preferably in the so-called Geiger mode. The operating voltage of these SPAD diodes 54, 55 is then above the breakdown voltage. The SPAD diodes 54, 55 are then preferably connected in reverse bias. In addition, a quenching resistor 401.4 is preferably connected in series for each SPAD diode 54, 55. The quenching resistor 401.4 prevents thermal destruction of the respective SPAD diode 54, 55 in the event of a triggered charge carrier avalanche. The respective quenching resistor 401.4 of FIG. 8 also serves here as a shunt resistor for detecting the electrical diode current through the SPAD diodes 54, 55. The current signal of the second single photon avalanche diodes 55 of the array 55 of single photon avalanche diodes (SPAD) is measured via a shunt resistor 401.4 for these second SPAD diodes 55. In the example of FIG. 8, the series resistor for limiting the current through the respective SPAD diodes forms the shunt resistor 401.4. However, the shunt resistor 401.4 can be inserted into the lead of the respective SPAD diode 54, 55 independently of the quenching resistor 401.4. In the example of FIG. 8, an exemplary common array of SPAD diodes comprises exemplary four active first SPAD diodes 54 and twelve passive second SPAD diodes 55. The exemplary four active first SPAD diodes 54 and twelve passive second SPAD diodes 55 are preferably coupled via an optical waveguide (optical waveguide 44). The active first SPAD diodes 54 spontaneously and randomly emit individual light pulses 57. They correspond to the first SPAD diode 54 of FIGS. 6 and 7. The active first SPAD diodes 54 are preferably located inside the array of first and second SPAD diodes 54 and 55. The device according to the proposal supplies the active first SPAD diodes 54 with an increased supply voltage by means of its voltage converters. For this purpose, the device according to the proposal preferably uses particularly voltage-resistant DMOS transistors in these voltage converters. Therefore, it is particularly advantageous if the one-piece micro-integrated quantum random number generator 28 is fabricated in a BCD semiconductor technology, which typically allows the fabrication of CMOS circuits, SPADs and DMOS transistors simultaneously in a cost effective and chip area effective manner. The proposed device therefore operates the active, first SPAD diodes 54 in the example of FIG. 8 preferably well above the breakdown voltage of the first SPAD diodes 54. This operation at an increased supply voltage of the first SPAD diodes 54 increases the dark count rate of these first SPAD diodes 54, resulting in a higher number of spontaneously emitted photons 57. The optical waveguide 44 passes some photons 58 of the emitted photons 57 to the passive, second SPAD diodes 55 in the example of FIG. 8. The optical waveguide 44 corresponds to the optical waveguide 44 of FIGS. 6 and 7. The passive, second SPAD diodes 55 correspond to the second SPAD diode 55 of FIGS. 6 and 7. One or more voltage converters of the device according to the proposal supply the passive, second SPAD diodes 55 in the example of FIG. 8 with an increased supply voltage. For this purpose, too, the device according to the proposal preferably uses particularly voltage-resistant DMOS transistors in these voltage converters. Therefore, it is particularly advantageous if the one-piece, micro-integrated quantum random number generator 28 is fabricated in a BCD semiconductor technology, which typically allows the fabrication of CMOS circuits, SPADs and DMOS transistors simultaneously in a cost effective and chip area effective manner. The proposed device operates the passive, second SPAD diodes 55 only just above the breakdown voltage. Preferably, the passive, second SPAD diodes 55 are arranged as a ring around the active, first SPAD diodes 54 in the example of FIG. 8. Other arrangements are conceivable. In particular, it is conceivable to replace the first SPAD diodes 54 with other silicon LEDs and use an arrangement of such other silicon LEDs and second SPAD diodes 55 close to each other, in which case the light transmission takes place directly through the semiconductor substrate 49 as an optical waveguide 44 with an extremely short light transmission distance of only a few μm. In the example of FIG. 8, the passive, second SPAD diodes 55 detect at least some of the photons 59 arriving via the optical waveguide 44. The passive, second SPAD diodes 55 generate a current flow via a shunt resistor, which is assigned to the second SPAD diodes 55, as a function of the arriving photons 59. In the example of FIG. 8, the entropy source 401 preferably comprises the shunt resistors, the operating device of the SPAD diodes, the SPAD diodes 54 and 55 and the optical fiber 44. A voltage signal 405 of the entropy source 401 preferably connects the entropy source 401 to a preferred exemplary broadband 40 dB high frequency amplifier 402. In other embodiments of the proposal, this 40 dB high frequency amplifier 402 is not required. In this respect, the 40 dB high frequency amplifier 402 is optional. Preferably, the voltage signal corresponds to the voltage drop across the quenching resistor 401.4, which acts as shunt resistor 401.4 in the example of the figure. It is conceivable to supply the first SPAD diodes 54 and the second SPAD diodes 55 via a common quenching resistor 401.4, which then also functions as a common shunt resistor. The proposed exemplary high frequency amplifier 402 preferably and exemplarily has a bandwidth of 30 to 4000 MHz and preferably a 1 dB compression point of 20 dBm. The voltage swing of the voltage signal 405 of the entropy source 401 was in the sub-millivolt range in experiments in connection with the elaboration of the technical teaching of the document presented here. The exemplary proposed high-frequency amplifier 402 amplifies, for example, the voltage swing of this voltage signal 405 of the entropy source 401 to exemplary 50 to 150 mV.

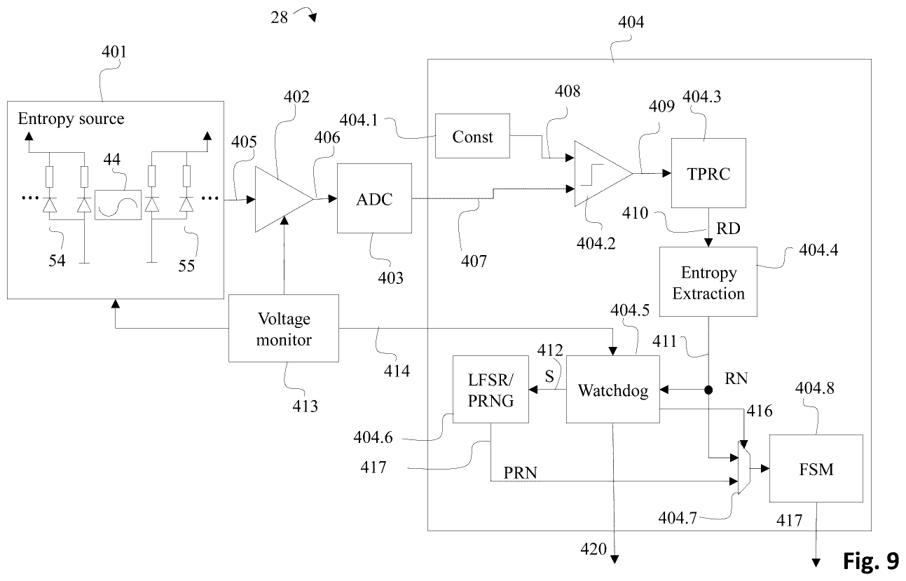

An amplifier output signal 406 of the high-frequency amplifier 402 connects, for example, the exemplary high-frequency amplifier 402 to an exemplary evaluation device 404, which essentially comprises subdevices of the control device 4. The evaluation device 404 of FIG. 8 is only one of many different possible implementations of the technical teaching presented in this document. The evaluation device 404 is preferably part of the integrated circuit 2, for example the microcontroller. Preferably, the integrated circuit 2, for example of the microcontroller, comprises one or more processors 10-1, 10-2. In the examples of FIGS. 8 and 9, the evaluation circuit 404 has an exemplary 14-bit analog-to-digital converter (ADC) 403 with an exemplary sampling rate of 125 mega-samples/s and an exemplary bandwidth of 50 MHz. It has been shown during development that lower bit widths and lower sampling rates are possible. If necessary, analog pre-processing prior to digitization by the analog-to-digital converter 403 by means of pulse widening circuits 2022 is appropriate. The amplified voltage signal of the exemplary high frequency amplifier 402 is the amplifier output signal 406 of the high frequency amplifier 402. The analog-to-digital converter 403 samples the amplifier output signal 406 of the high frequency amplifier 402 at a sampling rate of the analog-to-digital converter 403. Preferably, the sampling rate depends on the system clock 2106. Generally, the sampling rate of the analog-to-digital converter 403 is equal to the frequency of the system clock 2106. For example, the analog-to-digital converter 403 passes the determined samples of the amplifier output signal 406 of the high-frequency amplifier 402 digitally with a bus width of, for example, 14 bits to The evaluation device 404. In the following, a proposal is also described which operates without a high-frequency amplifier 402 and which provides an analog-to-digital converter 403 with a bit width of 1.

The simplified block diagram of the device shown in FIG. 8 includes, for example, a comparator 404.2, a time to pseudo random number converter (TPRC) 404.3, an entropy extraction device 404.4 and a finite state machine 404.8.

In the example of FIG. 8, the comparator 404.2 compares the exemplary digital 14-bit value 407 of the analog-to-digital converter 403 with a constant 404.1, which represents a threshold value, and generates a 1-bit output pulse two clock pulses long on its output signal 409 of the comparator 404.2 if the output value of the analog-to-digital converter 403 is greater than the constant 404.1. in the case of a device without a high-frequency amplifier 402 and with an analog-to-digital converter 403 with a bit width of 1, the comparator 404.2 and the constant 404.1 are omitted and the analog-to-digital converter 403 immediately generates the output signal 409 of the comparator, since the analog-to-digital converter 403 then also performs the function of the comparator 404.2. The disadvantages of such a design include its lower flexibility and the increased design and production requirements. The output signal 409 of the comparator 404.2 connects the comparator 404.2 to the time-to-random number converter 404.3 (TPRC). The time-to-pseudo-random number converter 404.3 (TPRC) preferably comprises, for example, a 32-bit linear feedback shift register that increments with the system clock 2106 of the integrated circuit 2, such as the microcontroller. The oscillator 30 and the clock system of the control device 4 typically provide this clock. The bit width of this linear feedback shift register can vary depending on the application. Preferably, this bit width can be set via a register of the control device 4 of the integrated circuit 2, for example the microcontroller. Preferably, the feedback polynomial of the linear feedback shift register of the time-to-random number converter 404.3 (TPRC) can be set via a register of the control device 4 of the integrated circuit 2, for example of the microcontroller. The system clock 2106 may, for example, have a frequency of 125 MHz. A pulse on the 1-bit output signal of the comparator 404.2 preferably causes the time-to-pseudo-random number converter 404.3 (TPRC) to output the current shift register value of the linear feedback shift register of the time-to-pseudo-random number converter 404.3 (TPRC) as a pseudo-random number at the output 410 of the time-to-pseudo-random number converter 404.3 (TPRC). The pseudorandom numbers typically change with the clock period of the system clock 2106, resulting in a time resolution with respect to the pulses on the 1-bit output signal of the comparator 404.2. For an exemplary 125 MHz system clock 2106, this results in a time resolution of 1/(125 MHz)-8 ns. The output 410 of the time to pseudo-random number converter 404.3 (TPRC) passes the exemplary 32-bit shift register value, also called raw data, of the time to pseudo-random number converter 404.3 (TPRC) to the entropy extraction 404.4 following in the signal path. The entropy extraction 404.4 converts the random raw data RD of the time-to-pseudo-random number converter 404.3 (TPRC) on the signal of the output 410 of the time-to-pseudo-random number converter 404.3 (TPRC) into a 1-bit random number 411 RN. The raw data on the signal of the output 410 of the time-to-pseudo-random number converter 404.3 (TPRC) typically represents the last shift register value at which the output signal 409 of the comparator 404.2 showed a pulse. The output 411 of the entropy extraction 404.4 is connected to the input of the finite state machine FSM 404.8.

The finite state machine 404.8 typically has the task of receiving data in the form of a serial stream of quantum random bits 411 from the entropy extraction 404.4, storing the serial stream of random data bits into random data words and storing these into the block RAM 404.9 of the evaluation device 404, which is typically the volatile memory. Preferably, the finite state machine 404.8 communicates with the processor 404.11 (10-1, 10-2) via an internal data bus 419. After a successful write operation, the finite state machine 404.8 sets a finish flag 404.10. Preferably, the processor 404.11 can write and/or read the finish flag 404.10 via the internal data bus 419. The finish flag 404.10 may be part of the RAM 404.9 or a register of the processor 404.11. The processor 404.11 preferably controls and monitors the finite state machine 404.8 via the internal data bus 419. The finish flag 404.10 is preferably not set at system startup. The processor 404.11 can then access the block RAM 414.9, for example by means of a C program which is started on the embedded processor 404.11, for example a dual-core Arm Cortex-A9 MPCore, and read the random number from the RAM 404.9. The processor 404.11 is preferably identical to the first processor 10-1 of FIG. 1. The processor 404.11 can, for example, be a dual-core Arm Cortex-A9 MPCore. The processor 404.11 can also execute some of the functions of the sub-devices of the evaluation device 404 by means of a suitable program and thus replace these device parts if necessary.

Preferably, the processor 404.11 controls a watchdog 404.5. In the sense of the document presented here, the watchdog 404.5 is not only a watchdog timer which comprises a timer which is clocked with the system clock of the quantum random number generator 28 or the system clock 2106 of the processor 404.11 and which must be reset to a start value by the processor 404.11 at regular time intervals in order to prevent the program execution of the processor 404.11 from being interrupted when a watchdog count threshold value is reached and/or crossed by the count of the timer of the watchdog 405.5. The watchdog 405.5 also performs other monitoring tasks within the quantum random number generator 28. For example, the watchdog 404.5 preferably monitors the entropy of the quantum random bits 411. In particular, the watchdog 404.5 preferably ensures that the quantum random bits 411 preferably have no more than q consecutive random bits of the same logical value. If this is the case, the watchdog 404.5 preferably inserts other bits in place of the quantum random bits 411 in this serial bit data stream from the entropy extraction 404.5 to the finite state machine 407.8. More on this in the following FIG. 9. Preferably in this case, the watchdog 404.5 inserts random bits of another true random number generator and/or another quantum random number generator and/or pseudo-random bits of a pseudo-random number generator whose initial value is determined by valid random bits of a quantum random number generator (QRNG) or a true random number generator (TRNG). Since the time to pseudo-random number converter 404.3 (TPRC) already ensures by design that this case should not occur, the watchdog 404.5 preferably outputs an error message to the processor 404.11 in such a case. Preferably, the watchdog 404.5 is simultaneously also a watchdog of the first processor 10-1. In addition, the watchdog 404.5 monitors, in the sense of the document presented here, possibly further variables, such as the matching of voltage values within the quantum random number generator 28 and/or within the device by means of one or more analog-to-digital converters and/or by means of one or more voltage monitoring devices such as voltage monitors 413, etc., in the sense of the document presented here.

### FIG. 9

FIG. 9 shows the extended exemplary evaluation device 404, which now includes monitoring of the random number 411 RN and has an additional backup system in the event of an error in order to safeguard the security of the application circuit by means of an emergency operation procedure even in the event of a failure of the quantum random number generator. The components processor 404.11 RAM 404.9 and finish flag 404.10 have been omitted to provide a better overview. The reader should continue to regard these device components and functions in FIG. 9 as being present. However, the skilled person can easily copy the connection to the finite state machine 404.8 from FIG. 8 into FIG. 9 and then arrive at the disclosed technical teaching. The watchdog 404.5, an optional further linear feedback shift register 404.6 as a backup pseudorandom number generator PRNG and a signal multiplexer 404.7 extend the device of FIG. 8 to the device of FIG. 9.

The output 411 of the entropy extraction 404.4 is now connected to the watchdog 404.5 and the signal multiplexer 404.7 as an example. The watchdog 404.5 monitors the quantum random number RN at the output 411 of the entropy extraction 404.4. The watchdog 404.5 detects at least three defined error cases as proposed. For example, the watchdog 404.5 transmits valid quantum random bits 411 to the optional additional linear feedback shift register 404.6 while generating a seed value S 412. Preferably, the watchdog 404.5 prevents the use of these valid quantum random bits by the finite state machine 404.8. if an error occurs, the watchdog 404.5 sets error bits in an unsigned error register ER of the processor 404.11. which error bit the watchdog 404.5 sets in the error register of the processor 404.11 is preferably dependent on the respective error case that the watchdog 404.5 detects. In addition, the watchdog .5 is connected to a voltage monitor 413 via one or more, preferably digital, input/output signal lines 414 in the example of FIG. 9. Preferably, the watchdog circuit 404.5 monitors the voltage values determined by the voltage monitor 413. It has proven useful if the voltage monitor 413 not only determines and monitors the voltages in the quantum random number generator 28, but also other voltages within the respective application circuit. The voltage monitor 413 can be the aforementioned analog-to-digital converter.

In the example of FIG. 9, the voltage monitor 413 preferably monitors the operating voltages of the entropy source 401 and/or other voltages generated by voltage converters within the application circuit. For example, if one of the operating voltages of a photon source 54 and/or a silicon LED 54 and/or a first SPAD diode 54 and/or a photon detector 55 and/or a second SPAD diode 55 is too low, i.e. voltage value amount below a lower operating voltage threshold value for these components, or too high, i.e. voltage value amount above an upper operating voltage threshold value for these components, the voltage monitor 413 detects this voltage deviation and reports it to the watchdog 404.5 and/or the processor 10-1, 404.11. Preferably, the processor 404.11 can read out the values of the voltage monitor 413 via the internal data bus 419 of the control device 4 of the integrated circuit 2, for example the microcontroller. In the event of such a voltage deviation, the voltage monitor 413 signals such a deviation to the watchdog 404.5 or directly to the processor 404.11. In the case of signaling to the watchdog 404.5, for example, the watchdog 404.5 can generate an interrupt signal 420 for the processor 404.11. The watchdog 404.5 can, for example, trigger such an interrupt 420 of the microcontroller 404.11 or another subdevice of an application system if the supply voltage of the entropy source 401 or the radio frequency amplifier 402 or another device part of the quantum random number generator QRNG 28 and/or the integrated circuit 2, for example the microcontroller, and/or the application device is faulty. If the watchdog 404.5 has detected a fault in the quantum random number generator 28, it preferably causes the quantum random number generator 28 to switch to an emergency running state. For this purpose, the watchdog 404.5 preferably sets the selection signal 416 of a signal multiplexer 404.7, so that the signal multiplexer 404.7 instead of the output 411 of the entropy extraction 404.4 receives the pseudo-random number PRN of the optional further linear feedback shift register 404.6 in the form of a stream of pseudorandom bits via a pseudorandom signal line 417 as a substitute for the at least potentially erroneous random number RN of the output 411 of the entropy extraction 404.4 to the input of the finite state machine 404.8.

In the example shown in FIG. 9, the optional additional linear feedback shift register 404.6 is connected to the output Seed S 412 of the watchdog 404.5. In the event of an error, the watchdog 404.5 activates the optional, additional, linear feedback shift register 404.6. The optional, additional, linear feedback shift register 404.6 then generates pseudo-random numbers PRN as pseudo-random number generator PRNG. The seed S 412 preferably has the last quantum random bits that are still valid. The watchdog 404.5 preferably applies these last valid quantum random bits 411 to the input of the optional, further linear feedback shift register 404.6. The seed S thus serves as a random PQC safe start value for the generator polynomial of the feedback of the optional, further linear feedback shift register 404.6 for the generation of the pseudorandom number PRN and its signaling via the pseudorandom signal line 417. The generator polynomial and the degree of the generator polynomial are preferably freely selectable.

The signal of the output 411 of the entropy extraction 404.4 with the 1-bit random number RN of the entropy extraction 404.4 or the signal of the pseudo-random signal line 417 with the pseudo-random number PRN of the linear feedback shift register 404.6 are connected to the inputs of the signal multiplexer 404.7. Depending on the value of the selection signal 416 SEL, the signal multiplexer 404.7 forwards one of the two inputs to the finite state machine 404.8. Of course, it is conceivable to use a multiplexer with more than two inputs and a more complex control signal if the application requires this. The number of inputs of the signal multiplexer 404.7 is therefore typically greater than or equal to two.

Here too, the finite state machine 404.8 has the task of receiving the random data RN or the pseudo-random number PRN at the output of the signal multiplexer 404.7 and writing it to the block RAM 404.9, 15 of the evaluation device 404 within the control device 4. If the write operation is successful, the finite state machine 404.8 sets the finish flag 404.10 again. The processor 404.11 can then access the block RAM 404.9, for example by means of a C program, which preferably runs on the embedded processor 404.11, and read out the random number and use it for encryption, for example.

Preferably, time-to-pseudo-random number converter 404.3 detects the time between two pulses on the output signal 409 of comparator 404.2 as a time value. If a time value at the output 410 of the time-to-pseudo-random number converter 404.3 is less than a minimum value, it is a value that is within the dead time of the second SPAD diodes 55. When such a value occurs, the evaluation device 404 preferably discards the generated pseudo-random numbers and preferably increments the error counter by the first error increment, which may also be negative. In this case, the entropy extraction 404.4 waits for the next random number to be determined by the time-to-pseudo-random number converter 404.3. Once the random bit has been extracted in this way, the quantum random number generator 28 starts the process all over again.

If the error counter crosses or reaches the error counter threshold value, an error may be present, for example, in which the time-to-random number converter 404.3 supplies constant numerical values due to an error.

This device is thus capable of detecting a failure of the power supply 5 of the entropy source 401 or other parts of the device (e.g. 4, 28). The processor 404.11 can also detect voltages and currents in the quantum random number generator 28 and/or within the control device 4 of the integrated circuit of a microcontroller and/or within the integrated circuit 2, for example the microcontroller, for testing purposes by means of the analog-to-digital converter 403 and compare the values thus determined with expected value ranges within which these values must lie. Also, the processor 404.11 may detect digital values within the quantum random number generator 28 and/or within the control device 4 of the integrated circuit of a microcontroller and/or within the integrated circuit 2, for example the microcontroller. For example, the processor 404.11 may set the constant const 404.1 low enough for testing purposes such that the noise background substantially controls the time-to-pseudo-random number converter 404.3. Preferably, the processor 404.11 sets an operating state of the time-to-pseudorandom number converter 404.3 for this purpose, in which the time-to-random number converter 404.3 restarts with the last seed value after a pseudorandom number has been generated. The values of the time-to-random number converter 404.3 should then satisfy an expected statistic within a tolerance band. If this is not the case, there is an error. The processor 404.11 can generate these statistics and, if necessary, infer this error if the statistical values determined do not lie within an expected value interval.

The watchdog 404.5 can monitor the entropy of the supplied quantum random bits 411. If the mean entropy of the quantum random bits 411 over an entropy measurement period deviates significantly more than a permitted entropy deviation value from the expected random mean value of 50%, the watchdog 404.5 preferably concludes that there is an error in the quantum random number generator 28 and preferably increments the error counter by the said error counter increment. Preferably, the watchdog 404.5 then stops the use of these quantum random bits of the output 411 of the entropy extraction 404.4 to prevent the sending of plaintext over the data bus by the device. For the purposes of the present document, plaintext means that the sent and/or stored data is in a form that allows a third party to gain unauthorized access to the content of a data message and/or stored data and/or program code directly and/or by using statistical or other methods. It is conceivable that a virtual permanent one or a virtual permanent zero is generated by chance even with functioning sub-devices. The randomness also includes the duration zero and the duration one. It is therefore useful if the maximum length of a bit sequence without changing the logic state at the output 411 of the entropy extraction 404.4 is limited by the watchdog 404.5 to a value that can be programmed by the processor 404.11.

Essentially, the quantum random number generator 28 described above can thus recognize the following errors and catch them by an emergency run using an optional, further pseudorandom number generator 404.6, for example using an optional, further linear feedback shift register 4104.6, with a lower safety level:
Disturbance of supply voltages
Faulty signal generation of the photon sources 54 and/or the silicon LEDs 54 and/or the first SPAD diodes 54,
Faulty signal generation of the photon detectors 55 and/or the second SPAD diodes 55,
Malfunction of the optional fiber optic cable 44,
Disturbance of the coupling of the photon sources 54 and/or the silicon LEDs 54 and/or the first SPAD diodes 54 to the optical waveguide 44,
Disturbance of the coupling of the photon detectors 55 and/or the second SPAD diodes 55 to the optical fiber 44,
Circuit failures in the digital part 404 of the quantum random number generator 28,
Incorrect entropy of the supplied quantum random bits 411.

Instead of the optional additional linear feedback shift register 404.6 or the optional additional pseudorandom number generator 404.6, it is conceivable to use a second complete quantum random number generator 28 whose output 411 whose entropy extraction 404.4 is then used by the multiplexer 404.7 instead of the signal of the optional additional pseudorandom signal line 417 for the emergency run of the quantum random number generator 28. In the event that the output of the optional additional pseudorandom number generator 404.6 depends on one or more true quantum random bits 411 as seed 412, as long as the number of inserted bits is limited, it is again a quantum random number. Preferably, the watchdog 405.5 determines the number q of permitted maximum consecutive quantum random bits 411 by means of a quantum random number. If this quantum random number, which the watchdog 404.5 uses to determine q, only includes quantum random bits 411 with a single logical value, it is possible that there is an error. The number q should then not be maximum in order to avoid sending or storing plain text. Instead, the watchdog 404.5 should then set the number q very small, preferably to a minimum.

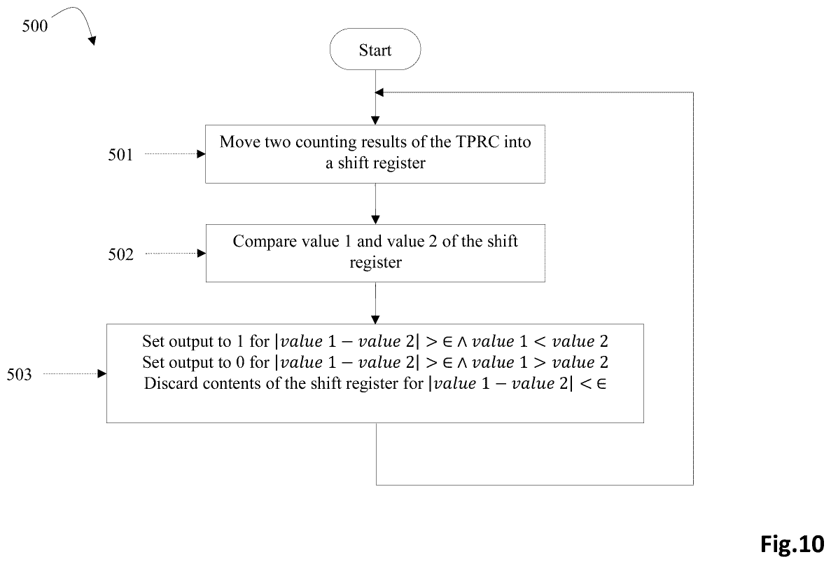

### FIG. 10

FIG. 10 shows the flowchart 500 of the entropy extraction method that performs, for example, the entropy extraction 404.4. The method provides for first determining two values of the output 410 of the time-to-random number converter 404.3 in a first step 501 and storing them in a shift register of the entropy extraction 404.4. If two values are stored in the shift register of the entropy extraction 404.4, the entropy extraction 404.4 compares these two values in a second step 502. The two values in the shift register of the entropy extraction 404.4 thus comprise a first value and a second value, both of which have been determined by the time-to-random number converter 404.3 by means of two different pseudo-random number determinations as a function of the respective time period between two signal pulses of the output signal 409 of the comparator 404.2. In a third step 503, the entropy extraction 404.4 evaluates the two values. If the first value is smaller than the second value and the difference between value 1 and value 2 is greater than a minimum difference e, the entropy extraction 404.4 sets the value of its output 411 to a first logical value. If the first value is greater than the second value and the difference between the first value and the second value is greater than the minimum difference e, entropy extraction 404.4 sets its output to a second logical value that is different from the first logical value. If the difference between the first value and the second value is smaller than the minimum difference e, the entropy extraction discards the first value and the second value. In such a case, the entropy extraction preferably causes the watchdog 404.5 to increment an error counter by a first error counter increment. The first error counter increment can be negative. Conversely, the entropy extraction 404.4 can decrease the error counter of the watchdog 404.5 by a second error counter increment if the difference between the first value and the second value is greater than the minimum difference ∈. The second error counter increment can be equal to the first error counter increment. Typically, the signs of the first error counter increment and the second error counter increment are the same. Preferably, the processor 404.11 can set the error counter increments and the start value of the error counter and an error counter threshold value. If the count of the error counter crosses the error counter threshold value, the watchdog 404.5 preferably signals the presence of a critical error state to the processor 404.11 by means of an interrupt 420 or other signaling. The processor 404.11 then typically starts a self-test program to test the various parts of the quantum random number generator 28. Preferably, the processor 404.11 can, for example, set the analog-to-digital converter 403 to a state in which the processor 404.11 can write test values to an output register of the analog-to-digital converter 403, which the subsequent signal chain then processes like real samples. Since the test values are known in advance, the processor 404.11 can observe and evaluate the correct reaction of the residual system, for example the incrementing of the error counter in the watchdog 404.5. Preferably, the microcontroller 404.11 can therefore monitor as many memory nodes of the evaluation circuit 404 or the control device 4 as possible and read their logical state.

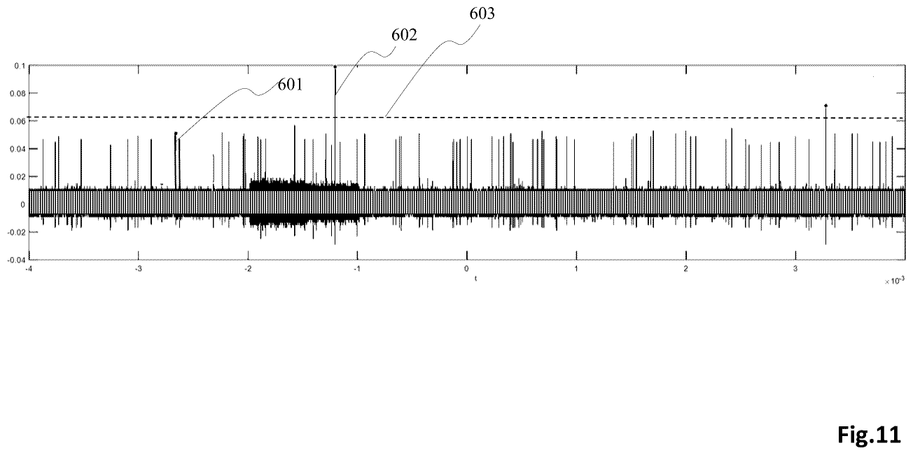

### FIG. 11

FIG. 11 shows an exemplary oscillogram of the voltage signal 404 of the entropy source 401. As can easily be seen, first spikes 601 occur with a first height and second spikes 602 occur with a second height. The dispersion of the first height of the first spikes 601 and the dispersion of the second height of the second spikes 602 is in each case so small that a clear separation of these events 601, 602 is possible by means of an exemplary cutting level 603 via the selection of the constants 404.1. The cutting level 603 corresponds to the value set by the processing location 404.11 by means of the constant 404.1, which is preferably implemented as a register of the processor 404.11.

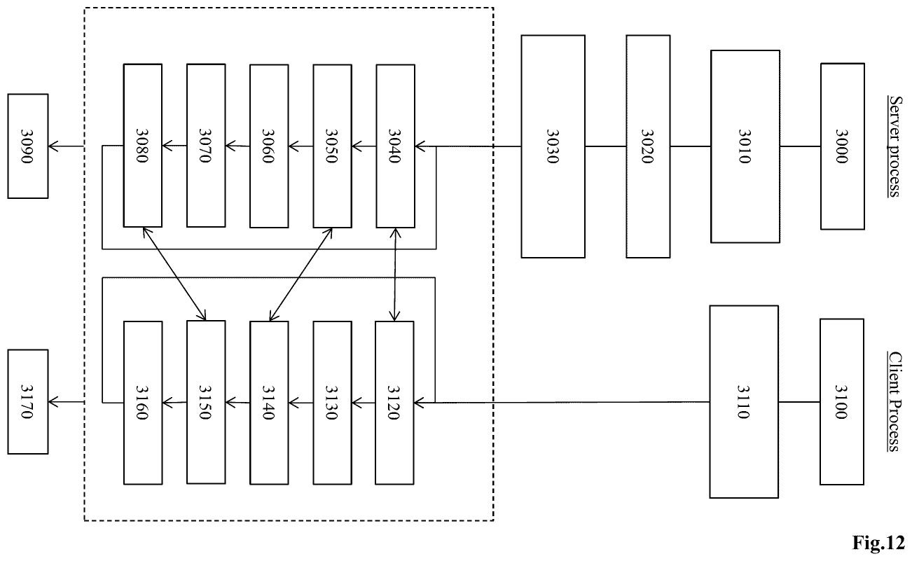

### FIG. 12

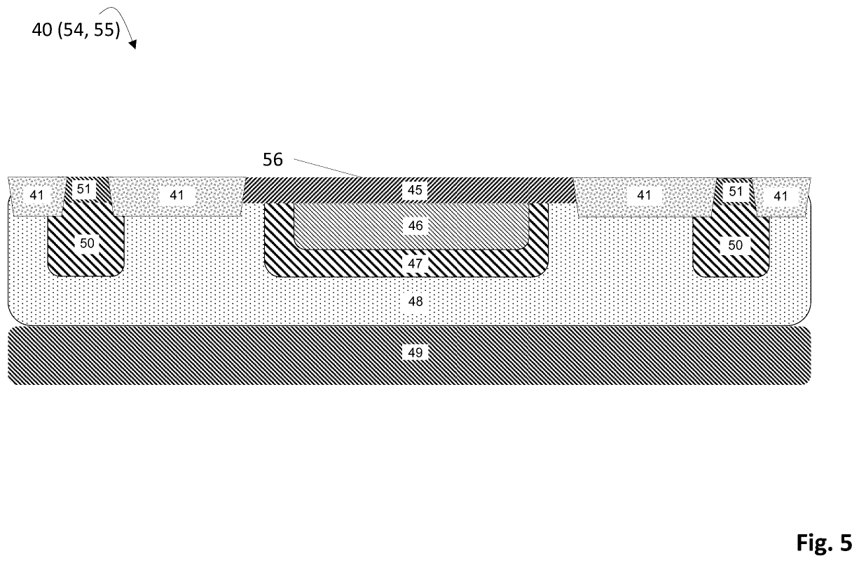

FIG. 12 shows the schematic sequence of a server-client communication using a proposed quantum random number generator. A first device, such as that shown in FIG. 1, is to communicate in encrypted form as a server via a data bus with a second device, such as that shown in FIG. 1, as a client. In a first example, both the first device and the second device should each comprise a quantum random number generator 28, which the respective first processor 10-1 of the computer (here of the exemplary microintegrated circuit 2) uses for encryption. Preferably, the quantum random number generator 28 corresponds in whole or in part to a construction according to one of FIGS. 5 to 9. Very particularly preferably, the quantum random number generators of the first device and of the second device each comprise a quantum random number generator 28, which in each case comprises at least one photon source 54 or a silicon LED 54 or a first SPAD diode 54 and in each case, for example, an optical waveguide 44, for example in the form of the oxide stack 44 on the semiconductor surface of the semiconductor substrate 49 and preferably at least one photon detector 55 or a second SPAD diode 55 as receiver. This increases the data rate of the generated quantum random bits 411 and enables the first processor 10-1 of the computer (here of the exemplary micro-integrated circuit 2) of the respective device to generate and exchange the keys very quickly. The respective first processors 10-1 of the respective computers (here of the exemplary micro-integrated circuit 2) of the respective devices encrypt their mutual communication preferably by means of an RSA encryption method. The exemplary RSA encryption method is known, for example, from R. L. Rivest, A. Shamir, and L. Adleman, “A Method for Obtaining Digital Signatures and Public-Key Cryptosystems” Communications of the ACM, February 1978, Vol. 21, No. 2, pages 120 to 126. The prime numbers, which the respective first processor 10-1 of the respective computer (here of the respective exemplary microintegrated circuit 2) of the respective device preferably uses for generating the public and private keys, are preferably randomly generated by the quantum random number generator 28 QRNG. The communication of the computer (here of the exemplary microintegrated circuit 2) of the server with the respective first processor 10-1 of the respective computer (here of the exemplary microintegrated circuit 2) of the client preferably comprises firstly the process “server process”, which is started on the respective first processor 10-1 of the respective computer (here of the exemplary micro-integrated circuit 2) of the server, i.e. the first device, and, secondly, the “Client Process” process, which is started on the respective first processor 10-1 of the respective computer (here of the exemplary micro-integrated circuit 2) of the client, i.e. the second device. The respective first processor 10-1 of the respective computer (here of the exemplary micro-integrated circuit 2) of the client typically communicates with the respective first processor 10-1 of the respective computer (here of the exemplary micro-integrated circuit 2) of the server via so-called sockets. These are communication points which are provided by the respective operating system of the respective computer (here of the exemplary micro-integrated circuit 2). Preferably, the functions required to establish communication originate, for example, from the standard C library socket.h. The following is an example of the communication according to FIG. 12:

At the beginning, the first processor 10-1 of the computer (here of the exemplary microintegrated circuit 2) of the server generates a socket descriptor in step 3000. A socket descriptor in the sense of the document presented here is an integer-like file handle which, for example, the standard C library function socket( ) of the socket.h library generates. The first processor 10-1 of the computer (here of the exemplary microintegrated circuit 2) of the server can use this socket descriptor in subsequent function calls that use sockets.

The first processor 10-1 of the computer (here of the exemplary microintegrated circuit 2) of the server preferably binds the socket descriptor to a port and an IP address in step 3010. Binding in the sense of this document means that the first processor 10-1 of the computer (here of the exemplary microintegrated circuit 2) of the server uses the standard C function bind( ) from the standard C library socket.h in order to logically link the port and the IP address to the socket descriptor generated in step 3000. For the purposes of this document, a port is a part of the network address that enables the assignment of data packets between server and client programs. For the purposes of the present document, an IP address is a network address that uniquely identifies a subscriber in a network.

In the next step 3020, the first processor 10-1 of the computer (here of the exemplary microintegrated circuit 2) of the server enters a passive wait state 3020 and waits for connection requests from a first processor 10-1 of the computer (here of the exemplary microintegrated circuit 2) of a client. For the purposes of the present document, the first processor 10-1 of the computer (here of the exemplary microintegrated circuit 2) of the server preferably calls the standard C function listen( ) of the socker.h library for this purpose. The function indicates that the first processor 10-1 of the computer (here of the exemplary micro-integrated circuit 2) of the server is ready for the first processor 10-1 of the computer (here of the exemplary micro-integrated circuit 2) to accept connection requests from clients. The first processor 10-1 of the computer (here of the exemplary micro-integrated circuit 2) generates a queue for incoming connection requests of the first processor 10-1 of the computer (here of the exemplary micro-integrated circuit 2) of the client in one of the memories of the computer (here of the exemplary micro-integrated circuit 2) or of the first processor 10-1 of the computer (here of the exemplary micro-integrated circuit 2) or of another device part of the computer (here of the exemplary micro-integrated circuit 2). If the first processor 10-1 of the computer (here of the exemplary micro-integrated circuit 2) of the server detects a connection request from a first processor 10-1 of the computer (here of the exemplary micro-integrated circuit 2) of a client, the first processor 10-1 of the computer (here of the exemplary micro-integrated circuit 2) of the server accepts this connection request from the first processor 10-1 of the computer (here of the exemplary micro-integrated circuit 2) of the client.

The first processor 10-1 of the computer (here of the exemplary microintegrated circuit 2) of the server then establishes a connection to the first processor 10-1 of the computer (here of the exemplary microintegrated circuit 2) of the client 3030 in a subsequent step 3030. The first processor 10-1 of the computer (here of the exemplary microintegrated circuit 2) of the server establishes a connection request of the first processor 10-1 of the computer (here of the exemplary microintegrated circuit 2) of the client in that the first processor 10-1 of the computer (here of the exemplary microintegrated circuit 2) of the server exits the listen( ) function. The first processor 10-1 of the computer (here of the exemplary micro-integrated circuit 2) of the server accepts the connection request, preferably by calling the standard C function accept( ) of the socket.h standard C library. The first processor 10-1 of the computer (here of the exemplary micro-integrated circuit 2) of the server preferably extracts the first connection request from the queue of open connection requests for the server and then uses it to the connection to the first processor 10-1 of the computer (here of the exemplary micro-integrated circuit 2) of the client. If successful, the accept( ) function returns a socket descriptor of the client to the first processor 10-1 of the computer (here of the exemplary micro-integrated circuit 2). For the purposes of this document, a socket descriptor is an integer-like file handle of the standard C library socket.h. This establishes the connection between the first processor 10-1 of the computer (here the exemplary micro-integrated circuit 2) of the server and the first processor 10-1 of the computer (here the exemplary micro-integrated circuit 2) of the client.

If said connection exists, the first processor 10-1 of the computer (here of the exemplary microintegrated circuit 2) of the server preferably starts a function keyExchangeServer( ) in a following step 3040. The first processor 10-1 of the computer (here of the exemplary microintegrated circuit 2) of the server then executes this function keyExchange( ) in this step 3040 in order to provide the first processor 10-1 of the computer (here of the exemplary microintegrated circuit 2) of the client with its public key. However, this function keyExchangeServer( ) is not a standard C function. In this function, in this step 3040, the first processor 10-1 of the computer (here of the exemplary microintegrated circuit 2) of the server generates quantum random numbers by means of a quantum random number generator 28 QRNG. The quantum random number preferably has a bit width n. Here, n is a positive integer including zero. These random numbers of the quantum random number generator 28 of the computer (here of the exemplary microintegrated circuit 2) of the server serve in the example presented in this document as indices for a look-up table of the first 2n prime numbers. This look-up table is preferably located in one of the memories of the computer (here of the exemplary microintegrated circuit 2) or in a memory of subdevices of the computer (here of the exemplary microintegrated circuit 2) of the server. The first processor 10-1 of the computer (here of the exemplary microintegrated circuit 2) of the server then reads the prime number corresponding to this index of the quantum random number of the quantum random number generator 28 of the computer (here of the exemplary microintegrated circuit 2) from the memory of the computer (here of the exemplary microintegrated circuit 2) of the server. Using these prime numbers, the first processor 10-1 of the computer (here of the exemplary microintegrated circuit 2) server generates both a public and a private key according to the aforementioned RSA encryption method.

The first processor 10-1 of the computer (here of the exemplary micro-integrated circuit 2) then transmits a public key to the first processor 10-1 of the computer (here of the exemplary micro-integrated circuit 2) of the client via the data interface 64 of the computer (here of the exemplary micro-integrated circuit 2) of the server and the data bus 95 and the data interface 64 of the computer (here of the exemplary micro-integrated circuit 2) of the client.

Thereafter, the first processor 10-1 of the computer (here of the exemplary micro-integrated circuit 2) of the server waits for a message from the first processor 10-1 of the computer (here of the exemplary micro-integrated circuit 2) of the client via the data interface 64 of the computer (here of the exemplary micro-integrated circuit 2) of the client and the data bus 65 and the data interface 64 of the first processor 10-1 of the computer (here of the exemplary micro-integrated circuit 2) of the server. Preferably, this message of the first processor 10-1 of the computer (here of the exemplary micro-integrated circuit 2) of the client comprises a public key of the first processor 10-1 of the computer (here of the exemplary micro-integrated circuit 2) of the client. Thus, the first processor 10-1 of the computer (here of the exemplary microintegrated circuit 2) of the client typically transmits the private key of the first processor 10-1 of the computer (here of the exemplary microintegrated circuit 2) of the client via the data interface 64 of the computer (here of the exemplary microintegrated circuit 2) of the client and the data bus 95 and the data interface 64 of the computer (here of the exemplary microintegrated circuit 2) of the server to the first processor 10-1 of the computer (here of the exemplary microintegrated circuit 2) of the server. Once the first processor 10-1 of the computer (here of the exemplary microintegrated circuit 2) of the server has received the public key of the first processor 10-1 of the computer (here of the exemplary microintegrated circuit 2) of the client, the first processor 10-1 of the computer (here of the exemplary microintegrated circuit 2) of the server stores this public key in a memory of the computer (here of the exemplary microintegrated circuit 2) of the server.

Subsequently, the first processor 10-1 of the computer (here of the exemplary micro-integrated circuit 2) of the server sends, for example, its public key via its data bus interface 64 and the data bus 65 and the data bus interface 64 of the computer (here of the exemplary micro-integrated circuit 2) of the client to the first processor 10-1 of the computer (here of the exemplary micro-integrated circuit 2) of the client.

Thus, the server is typically prepared for the exchange of encrypted data between the first processor 10-1 of the computer (here of the exemplary micro-integrated circuit 2) of the client and the first processor 10-1 of the computer (here of the exemplary micro-integrated circuit 2) of the server.

After the keys have now been exchanged, the first processor 10-1 of the computer (here of the exemplary microintegrated circuit 2) of the server then preferably executes the function recv( ) 3050 and waits for an encrypted message from the first processor 10-1 of the computer (here of the exemplary microintegrated circuit 2) of the client. If the first processor 10-1 of the computer (here of the exemplary microintegrated circuit 2) of the server receives a message, the first processor 10-1 of the computer (here of the exemplary microintegrated circuit 2) of the server preferably first stores this encrypted message in a temporary buffer of the computer (here of the exemplary microintegrated circuit 2) of the server. For the purposes of the present document, the recv( ) function is preferably a standard C function of the standard C library socket.h. The recv( ) function typically reads incoming data from a socket descriptor, in this case the socket descriptor of the first processor 10-1 of the computer (here of the exemplary microintegrated circuit 2) of the client from step 3030 of the method. The function recv( ) which the first processor 10-1 of the computer (here of the exemplary microintegrated circuit 2) of the server typically executes, typically stores the received data in the temporary cache of the computer (here of the exemplary microintegrated circuit 2) of the server.

If the first processor 10-1 of the computer (here of the exemplary microintegrated circuit 2) of the server has received an encrypted message in this way, the first processor 10-1 of the computer (here of the exemplary microintegrated circuit 2) of the server preferably executes the function Decrypt( ) 3060 in a further step 3060. This Decrypt( ) function is not a standard C function. In this step 3060, the Decrypt( ) function decrypts the message of the server from step 3040 using the private key of the server temporarily stored in the memory of the computer (here of the exemplary microintegrated circuit 2) according to the RSA method. Thereby, the first processor 10-1 of the computer (here of the exemplary microintegrated circuit 2) of the server decrypts the received encrypted message of the client by means of the private key cached in the memory of the computer (here of the exemplary microintegrated circuit 2) from the step 3040 according to the RSA method. The first processor 10-1 of the computer (here of the exemplary microintegrated circuit 2) of the server preferably stores the then decrypted message in a temporary cache of the computer (here of the exemplary microintegrated circuit 2) of the server.

If the first processor 10-1 of the computer (here of the exemplary microintegrated circuit 2) of the server does not receive a message from the first processor 10-1 of the computer (here of the exemplary microintegrated circuit 2) of the client within a predetermined period of time, the first processor 10-1 of the computer (here of the exemplary microintegrated circuit 2) of the server jumps to the step now described. The first processor 10-1 of the computer (here of the exemplary micro-integrated circuit 2) of the server checks whether a message is to be sent to the first processor 10-1 of the computer (here of the exemplary micro-integrated circuit 2) of the client. Typically, such a message is stored in a memory of the computer (here of the exemplary microintegrated circuit 2) of the server for sending in such a case. If necessary, the first processor 10-1 of the computer (here of the exemplary microintegrated circuit 2) of the server can also pick up or receive such a message from another memory or system before it is sent. Preferably, the first processor 10-1 of the computer (here of the exemplary microintegrated circuit 2) of the server then temporarily stores such a message in a buffer memory of the computer (here of the exemplary microintegrated circuit 2) of the server. If such a message to be sent is pending for sending in a memory or buffer of the computer (here of the exemplary micro-integrated circuit 2) of the server, the first processor 10-1 of the computer (here of the exemplary micro-integrated circuit 2) of the server preferably executes the Encrypt( ) function in a further step 3070. In this step 3070 in this case, the first processor 10-1 of the computer (here of the exemplary microintegrated circuit 2) of the server encrypts its own message using the public key of the client from 3040 in accordance with the RSA method. This Encrypt( ) function is not a standard C function. The server stores its now encrypted message in a temporary cache of the server's computer (in this case the exemplary micro-integrated circuit 2).

The first processor 10-1 of the computer (here of the exemplary microintegrated circuit 2) of the server now executes the send( ) function in a step 3080. In the step 3080 and, the first processor 10-1 of the computer (here of the exemplary microintegrated circuit 2) of the server sends its encrypted message stored in the cache of the computer (here of the exemplary microintegrated circuit 2) to the first processor 10-1 of the server, encrypted message stored in the cache of the computer (here of the exemplary micro-integrated circuit 2) to the first processor 10-1 of the computer (here of the exemplary micro-integrated circuit 2) of the client via the data bus interface 64 of the first processor 10-1 of the computer (here of the exemplary micro-integrated circuit 2) of the server and via the data bus 65 and via the data interface 64 of the first processor 10-1 of the computer (here of the exemplary micro-integrated circuit 2). For the purposes of the present document, the send( ) function is a standard C function of the standard C library socket.h. The send( ) function sends data via a socket descriptor, in this case the socket descriptor of the client from step 3030. At the end of the transmission, the typical cycle is completed.

Thereafter, the encrypted communication for the first processor 10-1 of the computer (here of the exemplary microintegrated circuit 2) of the server restarts at step 3040.

If the communication is terminated by the first processor 10-1 of the computer (here of the exemplary micro-integrated circuit 2) of the server or the first processor 10-1 of the computer (here of the exemplary micro-integrated circuit 2) of the client, the first processor 10-1 of the computer (here of the exemplary micro-integrated circuit 2) of the server executes the function close( ) 3090. The close( ) function is a standard C function of the standard C library socket.h. By executing the close( ) function, the first processor 10-1 of the computer (here of the exemplary micro-integrated circuit 2) of the server closes the open connection to a socket, here the socket of the client, and thus terminates the communication.

Similarly, the first processor 10-1 of the computer (here of the exemplary micro-integrated circuit 2) of the client executes a client process.

At the beginning of the “client process”, the first processor 10-1 of the computer (here of the exemplary micro-integrated circuit 2) of the client generates a socket descriptor in a step 3100. A socket descriptor in the sense of this document is again an integer-like file handle, for example the standard C library function socket( ) of the socket.h library, which the first processor 10-1 of the computer (here of the exemplary micro-integrated circuit 2) of the client can use in later function calls that use sockets. The first processor 10-1 of the computer (here of the exemplary micro-integrated circuit 2) of the client makes a connection request to the first processor 10-1 of the computer (here of the exemplary micro-integrated circuit 2) of the server using the port and IP address defined in the step 3010.

For this purpose, the first processor 10-1 of the computer (here of the exemplary microintegrated circuit 2) of the client preferably executes the standard C function connect( ) of the standard C library socket.h. This function establishes a connection between the server socket from step 3010 and the client socket from step 3100.

If the connection was accepted by the first processor 10-1 of the computer (here the exemplary micro-integrated circuit 2) of the server according to step 3030, the first processor 10-1 of the computer (here the exemplary micro-integrated circuit 2) of the client executes the function KeyExchangeClient( ) in a step 3120. This function is not a standard C function. By executing this function, the first processor 10-1 of the computer (here of the exemplary microintegrated circuit 2) of the client generates one or more QRNG quantum random numbers by means of the quantum random number generator 28. This quantum random number has a bit width n. Here n is a positive integer including zero. These random numbers of the quantum random number generator 28 of the computer (here of the exemplary microintegrated circuit 2) of the client preferably serve as indices for a look-up table of the first 2ⁿ prime numbers. Using these prime numbers or other prime numbers, the first processor 10-1 of the computer (here of the exemplary microintegrated circuit 2) of the client generates both a public and a private key according to RSA encryption (APPENDIX). The first processor 10-1 of the computer (here of the exemplary microintegrated circuit 2) of the client preferably stores its thus generated public key and its thus generated private key in a memory of the computer (here of the exemplary microintegrated circuit 2) of the client. Thereafter, the first processor 10-1 of the computer (here of the exemplary micro-integrated circuit 2) of the client sends its public key to the first processor 10-1 of the computer (here of the exemplary micro-integrated circuit 2) of the server via the data interface 64 of the computer (here of the exemplary micro-integrated circuit 2) of the client and via the data bus 65 and via the data interface 54 of the computer (here of the exemplary micro-integrated circuit 2) of the server. Subsequently, the first processor 10-1 of the computer (here of the exemplary microintegrated circuit 2) of the client waits for a message from the first processor 10-1 of the computer (here of the exemplary microintegrated circuit 2) of the server. This message from the first processor 10-1 of the computer (here the exemplary microintegrated circuit 2) of the server typically contains the public key of the first processor 10-1 of the computer (here the exemplary microintegrated circuit 2) of the server.

Subsequently, the first processor 10-1 of the computer (here of the exemplary microintegrated circuit 2) of the client executes the function Encrypt( ) 3130. By executing the Encrypt( ) function in step 3130, the first processor 10-1 of the computer (here of the exemplary microintegrated circuit 2) of the client encrypts its own message using the public key of the first processor 10-1 of the computer (here of the exemplary microintegrated circuit 2) of the server from step 3040 using the RSA method. This function is not a standard C function. The client stores the encrypted message in a temporary cache.

The first processor 10-1 of the computer (here of the exemplary microintegrated circuit 2) of the client now executes the send( ) function in step 3140 and sends its encrypted message to the first processor 10-1 of the computer (here of the exemplary microintegrated circuit 2) of the server. For the purposes of the present document, the send( ) function is a standard C function of the standard C library socket. i.e. by executing the send( ) function, the first processor 10-1 of the computer (here of the exemplary microintegrated circuit 2) of the client sends data via a socket descriptor, in this case the socket descriptor of the client from 3100.

Subsequently, the first processor 10-1 of the computer (here of the exemplary microintegrated circuit 2) of the client executes the function recv( ) 3150. Here, the first processor 10-1 of the computer (here of the exemplary microintegrated circuit 2) of the client waits in step 3150 for an encrypted message from the first processor 10-1 of the computer (here of the exemplary microintegrated circuit 2) of the server. If the first processor 10-1 of the computer (here of the exemplary microintegrated circuit 2) of the client receives a message, the first processor 10-1 of the computer (here of the exemplary microintegrated circuit 2) of the client stores this received and typically encrypted message in a temporary cache. For the purposes of the present document, the recv( ) function is preferably a standard C function of the standard C library socket, i.e. the first processor 10-1 of the computer (here of the exemplary microintegrated circuit 2) of the client reads incoming data from a socket descriptor, in this case from the socket descriptor of the first processor 10-1 of the computer (here of the exemplary microintegrated circuit 2) of the client from step 3100, by executing the recv( ) function. The first processor 10-1 of the computer (here of the exemplary microintegrated circuit 2) of the client preferably stores the read data in a temporary buffer memory of the computer (here of the exemplary microintegrated circuit 2) of the client.

If the first processor 10-1 of the computer (here of the exemplary microintegrated circuit 2) of the client has received an encrypted message in this way, the first processor 10-1 of the computer (here of the exemplary microintegrated circuit 2) of the client preferably executes the Decrypt( ) function in a step 3160. This DeCrypt( ) function is not a standard C function. By executing the Decrypt( ) function, the first processor 10-1 of the computer (here of the exemplary microintegrated circuit 2) of the client decrypts an encrypted message received by the first processor 10-1 of the computer (here of the exemplary microintegrated circuit 2) of the client from the first processor 10-1 of the computer (here of the exemplary microintegrated circuit 2) of the server by means of the private key of the first processor 10-1 of the computer (here of the exemplary microintegrated circuit 2) of the client from step 3120 by means of the RSA method. Thereafter, the first processor 10-1 of the computer (here of the exemplary microintegrated circuit 2) of the client stores the thus decrypted message in a temporary cache of the computer (here of the exemplary microintegrated circuit 2) of the client.

Thereafter, the communication between the first processor 10-1 of the computer (here of the exemplary micro-integrated circuit 2) of the server and the first processor 10-1 of the computer (here of the exemplary micro-integrated circuit 2) of the client restarts at step 3120.

If the communication is terminated by the first processor 10-1 of the computer (here of the exemplary micro-integrated circuit 2) of the client or the first processor 10-1 of the computer (here of the exemplary micro-integrated circuit 2) of the server, the first processor 10-1 of the computer (here of the exemplary micro-integrated circuit 2) of the client executes the close( ) function in step 3170. The close( ) function is a standard C function of the standard C library socket. i.e. by the first processor 10-1 of the computer (here of the exemplary microintegrated circuit 2) of the client executing the close( ) function, the first processor 10-1 of the computer (here of the exemplary microintegrated circuit 2) of the client closes the open connection to a socket and thus terminates the communication with the first processor 10-1 of the computer (here of the exemplary microintegrated circuit 2) of the server.

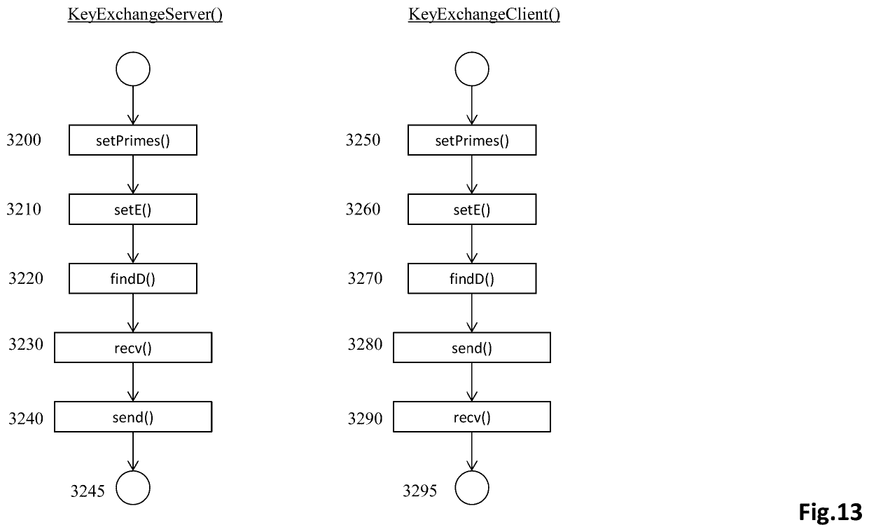

### FIG. 13

FIG. 13 shows the schematic sequence of the KeyExchangeServer( ) and KeyExchangeClient( ) functions.

When the KeyExchangeServer( ) function is started, the first processor 10-1 of the computer (in this case of the exemplary micro-integrated circuit 2) of the server first calls the setPrimes( ) function in step 3200. This KeyExchangeServer( ) function is not a standard C function. The first processor 10-1 of the computer (here of the exemplary microintegrated circuit 2) of the server generates two different prime numbers p and q, the product n=p*q and the Euler phi function phi=(p−1)(q−1) in step 3200 by means of the function KeyExchangeServer( ).

The first processor 10-1 of the computer (here of the exemplary micro-integrated circuit 2) of the server then calls the function setE( ) in step 3210. This function setE( ) in step 3210 is not a standard C function. When the setE( ) function is called in step 3210, the first processor 10-1 of the computer (here of the exemplary microintegrated circuit 2) of the server generates a number e which is not related to phi, the number phi being that from step 3200. In the sense of the present document, divisor-independent means that there is no natural number other than the number one which simultaneously divides the number e and phi.

Subsequently, the first processor 10-1 of the computer (here of the exemplary micro-integrated circuit 2) of the server executes the function findD( ) in step 3220. This function findD( ) is not a standard C function. The first processor 10-1 of the computer (here of the exemplary microintegrated circuit 2) of the server calculates the multiplicative inverse of e by means of the function findD( ) so that (e*d) mod phi=1.

Now the first processor 10-1 of the computer (here of the exemplary microintegrated circuit 2) of the server calls the function recv( ) in step 3230. The first processor 10-1 of the computer (here of the exemplary microintegrated circuit 2) of the server now waits for an incoming message from the first processor 10-1 of the computer (here of the exemplary microintegrated circuit 2) of the client, which should typically comprise the public key of the client. For the purposes of the present document, the function recv( ) is a standard C function of the standard C library socket. i.e. By calling the function recv( ) the first processor 10-1 of the computer (here of the exemplary microintegrated circuit 2) of the server reads the incoming data from a socket descriptor, in this case the socket descriptor of the client. The first processor 10-1 of the computer (here of the exemplary micro-integrated circuit 2) of the server preferably stores the read data in a temporary buffer of the computer (here of the exemplary micro-integrated circuit 2).

Now the first processor 10-1 of the computer (here of the exemplary microintegrated circuit 2) of the server calls the function send( ) in step 3240. In this step 3240, the first processor 10-1 of the computer (here of the exemplary microintegrated circuit 2) of the server sends its public key (d,n) from steps 3200 and 3220 to the first processor 10-1 of the computer (here of the exemplary microintegrated circuit 2) of the client. For the purposes of the present document, the send( ) function is a standard C function of the standard C library socket, i.e. the first processor 10-1 of the computer (here of the exemplary microintegrated circuit 2) of the server uses the send( ) function to send data via a socket descriptor, in this case the socket descriptor of the client from step 3030.

Subsequently, the first processor 10-1 of the computer (here of the exemplary micro-integrated circuit 2) of the server exits the KeyExchangeServer( ) function in step 3245.

When the KeyExchangeClient( ) function is started, the first processor 10-1 of the computer (in this case of the exemplary micro-integrated circuit 2) of the client first calls the setPrimes( ) function in step 3250. This function is not a standard C function. The first processor 10-1 of the computer (here of the exemplary microintegrated circuit 2) of the client generates the prime number p and the prime number q, which is different from q, using the function KexExchangeClient( ). The first processor 10-1 of the computer (here of the exemplary microintegrated circuit 2) of the client generates the product n=p*q by means of the function KexExchangeClient( ). The first processor 10-1 of the computer (here of the exemplary microintegrated circuit 2) of the client generates the Euler phi function phi=(p−1)(q−1) by means of the function KexExchangeClient( ).

The first processor 10-1 of the computer (here of the exemplary micro-integrated circuit 2) of the client then calls the function setE( ) in step 3260. This function is not a standard C function. The first processor 10-1 of the computer (here of the exemplary microintegrated circuit 2) of the client uses the setE( ) function to generate an integer e which is divisor-insensitive to the number phi from step 3250. Divisor-insensitive in the sense of the present document means that there is no natural number other than the number one which simultaneously divides the number e and the phi without remainder.

Subsequently, the first processor 10-1 of the computer (here of the exemplary micro-integrated circuit 2) of the client calls the function findD( ) 3270. This function is not a standard C function. The first processor 10-1 of the computer (here of the exemplary microintegrated circuit 2) of the client calculates the multiplicative inverse of the number e using the findD( ) function, so that (e*d) mod phi=1.

Now the first processor 10-1 of the computer (here of the exemplary microintegrated circuit 2) of the client calls the function send( ) 3280 and sends its public key (d,n) from the steps 3250 and 3270 to the first processor 10-1 of the computer (here of the exemplary microintegrated circuit 2) of the server. For the purposes of the present document, the send( ) function is a standard C function of the standard C library socket, i.e. the first processor 10-1 of the computer (here of the exemplary microintegrated circuit 2) of the client uses the send( ) function to send data via a socket descriptor, in this case the socket descriptor of the client from step 3100.

Now the first processor 10-1 of the computer (here of the exemplary microintegrated circuit 2) of the client calls the function recv( ) in step 3290. The first processor 10-1 of the computer (here of the exemplary microintegrated circuit 2) of the client now waits for an incoming message from the first processor 10-1 of the computer (here of the exemplary microintegrated circuit 2) of the server with the public key of the first processor 10-1 of the computer (here of the exemplary microintegrated circuit 2) of the server. For the purposes of the present document, the recv( ) function is a standard C function of the standard C library socket.h. The first processor 10-1 of the computer (here of the exemplary microintegrated circuit 2) of the client reads incoming data of the first processor 10-1 of the computer (here of the exemplary microintegrated circuit 2) of the server from a socket descriptor, in this case from the socket descriptor of the client from step 3100, by means of the recv( ) function and stores the data in a temporary buffer of the computer (here of the exemplary microintegrated circuit 2) of the client.

Subsequently, the first processor 10-1 of the computer (here of the exemplary microintegrated circuit 2) of the client exits the KeyExchangeClient( ) function in step 3295.

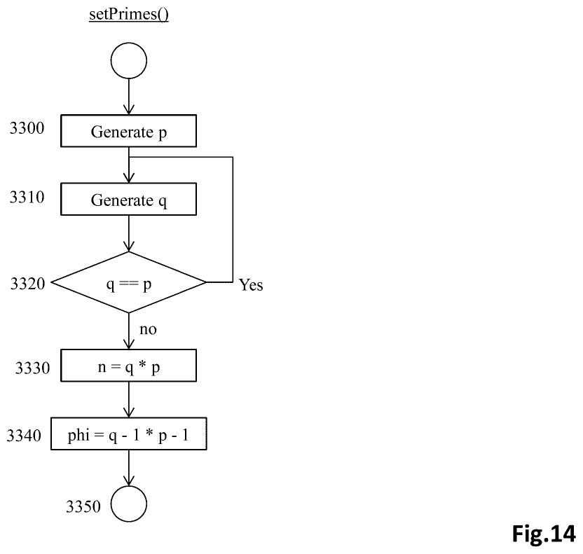

### FIG. 14

FIG. 14 shows the schematic sequence of the setPrimes( ) function.

The first processor 10-1 of the computer (here of the exemplary microintegrated circuit 2) of the client and the first processor 10-1 of the computer (here of the exemplary microintegrated circuit 2) of the server each call this function at the given time. If one of these first processors 10-1 calls the function setPrimes( ) the calling processor 10-1, in the case of the present document the first processor 10-1 of the computer (here of the exemplary microintegrated circuit 2) of the server or the first processor 10-1 of the computer (here of the exemplary microintegrated circuit 2) of the client, generates a quantum random number by means of a quantum random number generator QRNG 28 in step 3300. This quantum random number has a bit width n. Here n is a positive integer including zero. In the technical teaching of the present document, these quantum random numbers serve as indices for a look-up table of the first 2ⁿ prime numbers. The calling first processor 10-1 stores the prime number indexed by the quantum random number as a variable p

Thereafter, the calling first processor 10-1 generates a further quantum random number in step 3310 with the preferred bit width n by means of the quantum random number generator 28 QRNG. These quantum random numbers preferably serve the calling first processor 10-1 again as indices for a look-up table of the first 2ⁿ prime numbers. The calling first processor 10-1 stores the prime number, which is indexed by the random number, as variable q in a buffer of the computer (here of the exemplary microintegrated circuit 2), of which the first processor 10-1 is preferably a part.

Now the calling first processor 10-1 checks in step 3320 whether the logical statement q==p applies. If this statement is true, step 3310 is repeated.

The calling processor 10-1 then calculates the product n=p*q in step 3330.

The calling process location 10-1 then calculates the Euler phi function phi=(q−1)*(p−1) in step 3340.

The calling processor 10-1 then exits the setPrimes( ) function in step 3350.

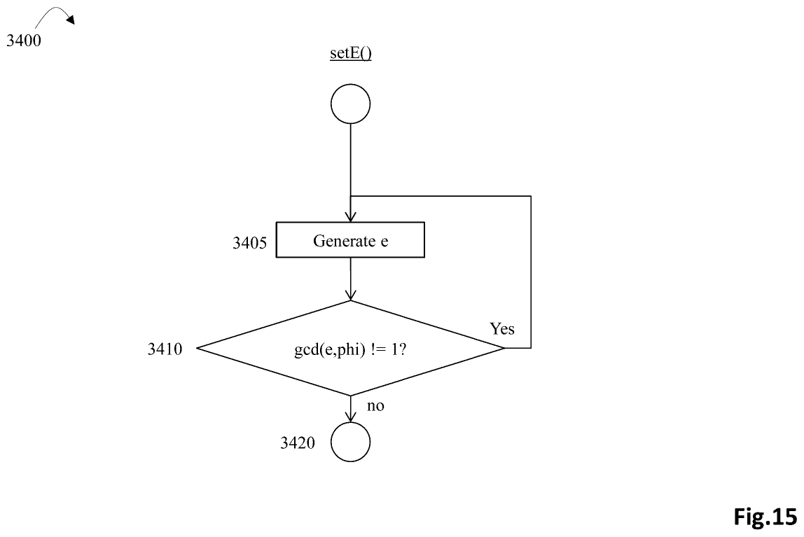

### FIG. 15

FIG. 15 shows the schematic sequence of the function setE( ) 3400. When the function setE( ) is called in step 3400, the caller, in the case of the present document the first processor 10-1 of the computer (here of the exemplary microintegrated circuit 2) of the server or the first processor 10-1 of the computer (here of the exemplary microintegrated circuit 2) of the client, generates a random number e for which it applies that it is divisor-unrelated to the number phi. In the sense of the present document, divisor-unique means that there is no natural number other than the number one which simultaneously divides the number e and phi. The calling processor 10-1 can generate the number e both by a random number of the quantum random number generator 28 QRNG and by a pseudo-random number generator PRNG as well as by up-iterating an integer number starting with 2. However, generation using the quantum random number generator 28 QRNG is preferred.

The calling processor 10-1 then checks in step 3410 whether the logical statement gcd(e,phi)!=1 is fulfilled.

If the logical statement is fulfilled, the calling processor 10-1 repeats step 3400.

If the logical statement is not fulfilled, the calling processor 10-1 exits the setE( ) function and returns the current value of e as the return value to the calling processor 10-1. The function gcd (a,b) is not a standard C function. The calling processor 10-1 uses this function gcd (a,b) to calculate the greatest common divisor of the transfer parameters a, b and the result to the calling processor 10-1.

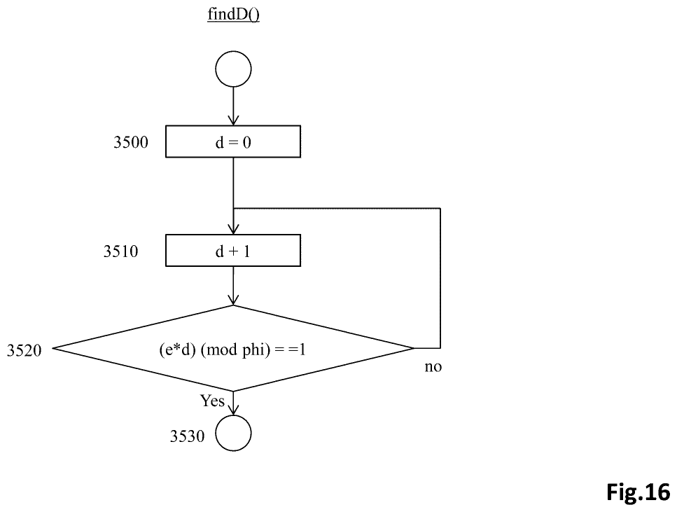

### FIG. 16

FIG. 16 shows the schematic sequence of the findD( ) function. If the calling processor 10-1 calls the findD( ) function in step 3500, the calling processor 10-1 initializes a variable d with 0 in step 3500.

In the following step 3510, the calling processor 10-1 adds the number 1 to the number d.

Now, in step 3520, the calling processor 10-1 checks whether the logical statement (e*d)(mod phi)==1 is fulfilled. If the logical statement (e*d)(mod phi)==1 is not fulfilled, the calling processor repeats the steps from step 3510.

If the logical statement (e*d) (mod phi)==1 is fulfilled, then in the step 3530 the calling processor 10-1 exits the function findD( ) and the calling processor 10-1 returns the current value of d as a return value to the calling processor 10-1, in the case of the present document the first processor 10-1 of the computer (here the exemplary microintegrated circuit 2) of the server or the first processor 10-1 of the computer (here the exemplary microintegrated circuit 2) of the client.

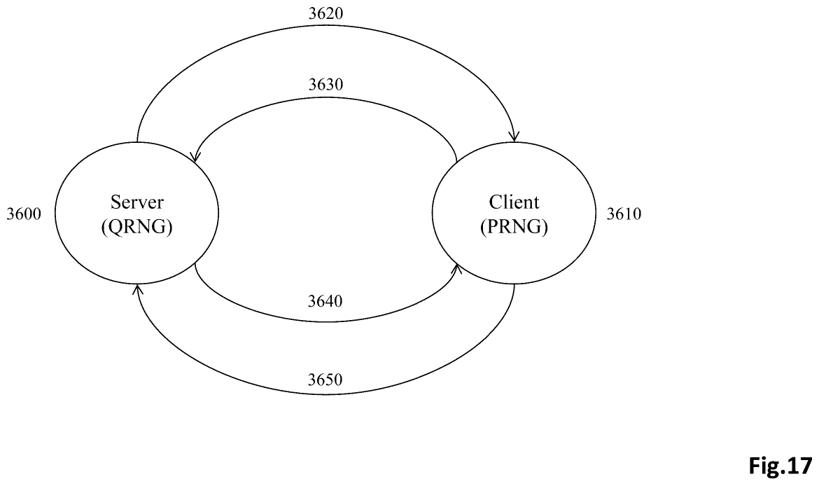

### FIG. 17

FIG. 17 shows the schematic sequence of a secure transmission of quantum-based random numbers between a first processor 10-1 of the computer (here of the exemplary micro-integrated circuit 2) of a server 3600 and a first processor 10-1 of the computer (here of the exemplary micro-integrated circuit 2) of a client 3610.

In the case of the present document, the server 3600 is a first processor 10-1 of a computer (here of the exemplary microintegrated circuit 2), wherein the computer (here of the exemplary microintegrated circuit 2) of this server 3600 comprises a quantum random number generator 28 QRNG. In the case of the present document, the client 3610 is a further first processor 10-1 of a computer 2, wherein now this computer (here of the exemplary microintegrated circuit 2) of the client 3610 should NOT have a quantum random number generator 28 QRNG.

Initially, the first processor 10-1 of the computer (here of the exemplary microintegrated circuit 2) of the server 3600 generates quantum random numbers QZ1. The quantum random numbers QZ1 serve the first processor 10-1 of the computer (here of the exemplary microintegrated circuit 2) of the server 3600 as a basis for generating a private key and a public key of the server 3600 according to an asymmetric encryption method.

The asymmetric encryption method can be the RSA method, for example.

In a step 3620, the first processor 10-1 of the computer (here of the exemplary micro-integrated circuit 2) of the server 3600 sends the public key of the server 3600 to the first processor 10-1 of the computer (here of the exemplary micro-integrated circuit 2) of the client 3610 via a non-tap-proof channel.

Subsequently, the first processor 10-1 of the computer (here of the exemplary microintegrated circuit 2) of the client 3610 generates a pseudorandom number PZ or a random number generated in another way. The first processor 10-1 of the computer (here of the exemplary microintegrated circuit 2) of the client 3610 stores the pseudorandom number PZ or the otherwise generated random number in a memory of the computer (here of the exemplary microintegrated circuit 2) of the client 3610. The first processor 10-1 of the computer (here of the exemplary micro-integrated circuit 2) of the client 3610 generates a first private key of the client 3610 and a first public key of the client 3610 using this pseudo-random number PZ or this differently generated random number.

The first processor 10-1 of the computer (here of the exemplary microintegrated circuit 2) of the client 3610 encrypts the first public key of the client 3610 using the public key of the server 3600.

Thereafter, the first processor 10-1 of the computer (here of the exemplary micro-integrated circuit 2) of the client 3610 sends the encrypted first public key of the client 3610 to the first processor 10-1 of the computer (here of the exemplary micro-integrated circuit 2) of the server 3600.

The first processor 10-1 of the computer (here of the exemplary microintegrated circuit 2) of the server 3600 now decrypts this message with its first private key. As a result, the first processor 10-1 of the computer (here of the exemplary microintegrated circuit 2) of the server 3600 now has the first public key of the client 3610 without this being known to third parties.

Subsequently, the first processor 10-1 of the computer (here of the exemplary microintegrated circuit 2) of the server 3600 generates a further, second quantum random number QZ2 by means of the quantum random number generator 28. The bit width of this second quantum random number is preferably equal to the bit width of the random number PZ of the client 3610.

The first processor 10-1 of the computer (here of the exemplary microintegrated circuit 2) of the server 3600 now encrypts the second quantum random number QZ2 with the first public key of the client 3610. For example, the first public key of the client 3610 may be the client. In that case, the first processor 10-1 of the computer (here of the exemplary microintegrated circuit 2) of the server 3600 can encrypt the second quantum random number QZ2, for example by bitwise XORing the second quantum random number QZ2 with PZ to form an encrypted second quantum random number QZ2′. The first processor 10-1 of the computer (here of the exemplary microintegrated circuit 2) of the server 3600 then preferably sends the encrypted second quantum random number QZ2′ to the first processor 10-1 of the computer (here of the exemplary microintegrated circuit 2) of the client 3610 in a step 3640.

The first processor 10-1 of the computer (here of the exemplary microintegrated circuit 2) of the client 3610 decrypts the encrypted second quantum random number QZ2′ using its first private key to the second quantum random number QZ2. Once the first processor 10-1 of the computer (here of the exemplary microintegrated circuit 2) has determined the second encrypted quantum random number QZ2′ by bitwise XORing the random number PZ with the second quantum random number QZ2, the first processor 10-1 of the computer (here of the exemplary microintegrated circuit 2) of the client 3610 can, for example, decrypt the encrypted second quantum random number QZ2′ to the second quantum random number QZ2 by bitwise XORing the encrypted second quantum random number QZ2′ with the random number PZ known to it.

Preferably, the first processor 10-1 of the computer (here of the exemplary microintegrated circuit 2) of the client 3610 uses the second quantum random number QZ2 now available to it as the basis for generating a second private key and a second public key in accordance with an asymmetric encryption method. The asymmetric encryption method may, for example, be the RSA method (APPENDIX). The first processor 10-1 of the computer (here of the exemplary microintegrated circuit 2) of the client 3610 now sends its second public key to the server 3600 via the non-tap-proof channel, preferably encrypting this second public key of the client 3610 with the public key of the server 3600. The server 3600 decrypts the encrypted second public key of the client 3610 and then uses this second public key of the client for the encryption of further messages to the first processor 10-1 of the computer (here of the exemplary microintegrated circuit 2) of the client 3610. Preferably, after a predetermined time or after sending a predetermined amount of data to the processor 10-1 of the computer (here of the exemplary microintegrated circuit 2) of the server 3600, the first processor 10-1 of the computer (here of the exemplary microintegrated circuit 2) of the client 3610 generates and sends a new public key based on a new quantum random number of its quantum random number generator 28 QRNG encrypted with the second public key of the client 3610. Preferably, the first processor 10-1 of the computer (here of the exemplary microintegrated circuit 2) of the server 3600 and the first processor 10-1 of the computer (here of the exemplary microintegrated circuit 2) of the client then perform the previously described procedure again, so that the keys change permanently. This also makes it impossible for a quantum computer to break the keys.

Once these keys have been exchanged, communication can be carried out on the basis of the selected asymmetric encryption method.

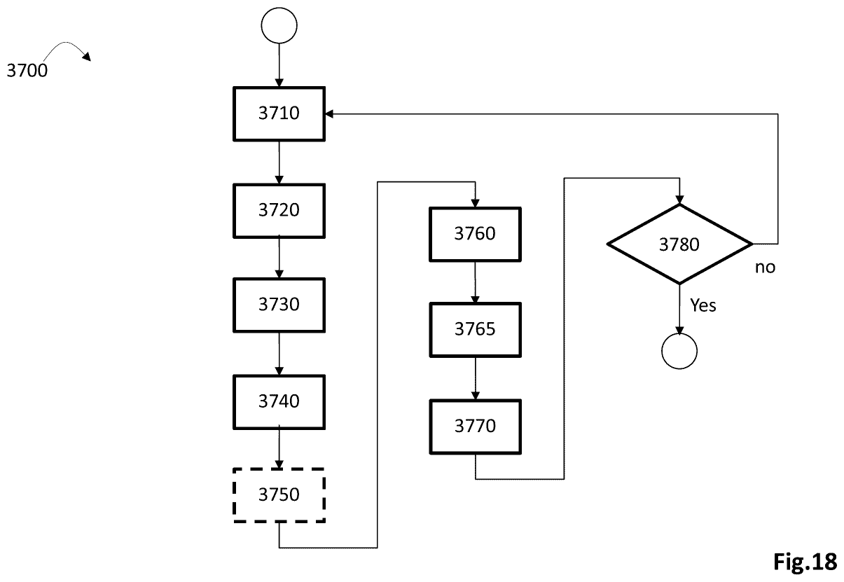

### FIG. 18

FIG. 18 schematically shows the proposed method 3700 for generating a quantum random number.

The method 3700 begins by generating 3710 a random single photon stream (57, 58, 59, 44) using one or more photon sources 54 or one or more silicon LEDs 54 or one or more first SPAD diodes (54), preferably integrally fabricated in a semiconductor material 49.

The method 3700 continues with the transmission 3720 of the random single photon stream (57, 58, 59, 44) for example by means of an optical waveguide 44 different from the semiconductor substrate (49, 48) or by means of the semiconductor substrate 49 as an optical waveguide or by means of direct irradiation to one or more photon detectors 55 or one or more second SPAD diodes 55.

This is followed in the method 3700 by the conversion 3730 of the random single photon stream (57, 58, 59, 44) into a detection signal in the form of a voltage signal 405 of the entropy source 401, which preferably comprises the photon sources 54 or the silicon LEDs 54 or the first SPAD diodes 54 and the optical system for optical coupling and the photon detectors 55 or the second SPAD diodes 55. The optical system may comprise a direct optical coupling of these components and/or comprise an optical fiber 44.

This is followed in the method 3700 by conditioning 3740, in particular amplification and/or filtering and/or analog-to-digital conversion, of the detection signal into a conditioned detection signal, in particular a digital 14-bit value 407 of the analog-to-digital converter 403 or a 1-bit analog-to-digital converter.

The method 3700 then optionally separates 3750 the pulses of the conditioned detection signal generated by coupling the emissions of a photon source 54 or a silicon LED 54 or a first SPAD diode 54 on the one hand and a photon detector 55 or a second SPAD diode 55 on the other hand from the pulses of the conditioned detection signal generated by spontaneous emission by comparing the conditioned detection signal with a threshold value, in particular in a comparator 404.2, and generating a corresponding output signal 409, in particular of the comparator 404.2.2 and generating a corresponding output signal 409, in particular of the comparator 404.2. If necessary, the analog-to-digital converter 403 can generate the output signal 409 directly if it is a 1-bit analog-to-digital converter 403. In this respect, this step 3750 is optional and is therefore only shown as a dashed line.

Then follows the determination 3760 of a first pseudo-random number as a function of a first time interval between the first pulse and the second pulse of a first pair of two successive pulses of the processed detection signal produced by optical coupling of the emissions of a photon source 54 or a silicon LED 54 or a first SPAD diode 54, on the one hand, and of a photon detector 55 or a second SPAD diode 55, on the other hand, as the first value of the output 410 of the time-to-pseudo-random number converter 404.3.

Then follows the determination 3765 of a second first pseudorandom number as a function of a second time interval between the third pulse and the fourth pulse of a second pair of two successive pulses of the processed detection signal, which are produced by optical coupling of the emissions of a photon source 54 or a silicon LED 54 or a first SPAD diode 54 on the one hand and a photon detector 55 or a second SPAD diode 55 on the other hand, as the second value of the output 410 of the time-to-pseudorandom-number converter 404.3

On this basis, the bit value of a quantum random bit 411 is then determined 3670 by comparing the value of the first pseudorandom number and the value of the second pseudorandom number.

In a final check 3680, the first processor 10-1 of the computer (here of the exemplary microintegrated circuit 2) and/or a finite state machine 404.8 check whether the number n of random bits determined is still smaller than the desired number m of random bits of the desired quantum random number. If this is not the case, the first processor 10-1 of the computer (here of the exemplary microintegrated circuit 2) and/or finite-state machine 404.8 repeat the above steps 3710 to 3770. Otherwise, the processor 10-1 of the computer (here of the exemplary microintegrated circuit 2) and/or finite-state machine 404.8 terminate the process for generating a quantum random number. If necessary, the finite state machine 404.8 makes the quantum random number available to the processor 10-1 and preferably signals this availability to the processor 10-1, for example by an interrupt via an interrupt signal 420 or by setting a flag.

Preferably, the processor 10-1 and/or the finite state machine 404.8 control this process of generating a quantum random number.

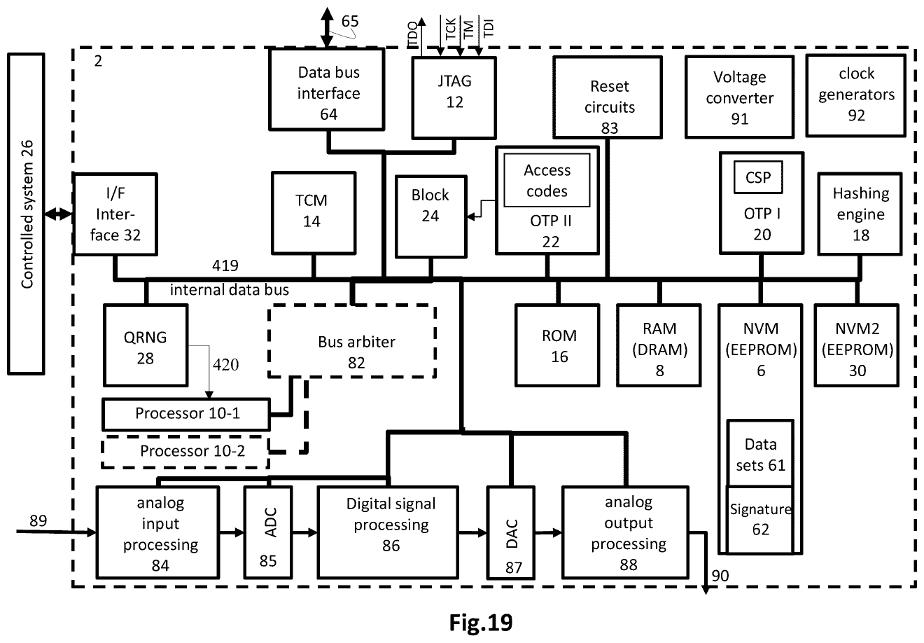

### FIG. 19

FIG. 19 shows a further exemplary proposal for a one-piece, monolithic integrated circuit 2, for example a microcontroller.

The exemplary one-piece monolithic integrated circuit 2, for example the microcontroller, comprises here one or more processors 10-1, 10-2; a bus arbiter 82; an internal data bus 419; a read-only memory ROM 19; a volatile read-write memory RAM 8; a first non-volatile, multiply programmable memory NVM 6; a second non-volatile, multiply programmable memory NVM 30; a first non-volatile, only once programmable memory OTP I 20; a second non-volatile, only once programmable memory OTP II 22; a test controller 12, in particular a JTAG test controller; a circuit (block) 24 for deactivating tests; one or more data bus interfaces 64; a tightly coupled memory TCM 14; an interface 32 to a system 32 controlled by the integrated circuit 2, for example by the microcontroller; a quantum random number generator 28; a reset circuit 83; analog input processing 84, an analog-to-digital converter 85; digital signal processing 86; one or more digital-to-analog converters 87; analog output processing 88; one or more voltage converters 91;

The one voltage converter 91 or the multiple voltage converters 91 generate the necessary internal operating voltages of the integrated circuit 2, for example the microcontroller, from the external supply voltages. Since the entropy source 401 in particular generally requires a higher operating voltage than the supply voltages provided externally, preferably at least one of the voltage converters of the voltage converters 91 comprises a charge pump or the like. Typically, such voltage converters 91 here comprise DMOS transistors.

An analog input processing 84 acquires one or more external analog signals 89 and prepares them for analog-to-digital conversion. For example, the analog input processing 84 may include one or more amplifiers, filters, analog adders, analog multipliers, logarithmizers, exponentiators, voltage sources, current sources, and/or other analog circuitry for adjusting, enhancing, or modifying the external analog signals 89.

An analog-to-digital converter 85 may then convert the external analog signals 89 processed in this manner to a data stream of digital samples of the external analog signals 89 at, for example, a sampling frequency that typically depends on the system clock 2106.

Digital signal processing 86 may then convert the digitized and conditioned external analog signals 89 to digital output signals using circuits that perform circuit-implemented methods and/or computer-implemented methods. The digital signal processing 86 may also regenerate digital output signals. Typically, the digital signal processing 86 operates on the system clock 2106. In generating these two sets of output signals, the digital signal processing 86 may utilize quantum random numbers from the quantum random number generator 28. If, for example, the digital signal processing 86 is to generate a modulated excitation signal for a sensor and is to evaluate a response signal of this sensor as an external analog signal 89 after processing and digitization, it is useful in some applications, for example, if the digital signal processing 86 uses such a quantum random number as a spreading code for generating the excitation signal of the sensor and then searches for and detects this spreading code in the external analog signal 89, for example by means of a synchronous demodulator.

The digital-to-analog converter(s) 87 converts the digital output signals of the digital signal processing 86 to internal analog output signals.

The one analog output processing 88 processes the analog internal output signals into analog output signals 90. For example, the analog output processing 88 may include filters, amplifiers and output stages

The rest circuit 83 brings the integrated circuit 2, for example the microcontroller, into a predefined state. Such a reset can occur, for example, when the operating voltage is switched on or when the operating voltage collapses or when one of the processors 10-1, 10-2 requests such a reset from the reset circuit 83, for example via the data bus 419 or a SW rest signaling line, or when a means for monitoring the correct functioning of the quantum random number generator 28 (watchdog 404.5, voltage monitor 2013) detects an error of a predefined set of errors. This allows the system to be restarted.

The quantum random number generator 28 preferably has the features presented here. Most preferably, the quantum random number generator 28 comprises a time-to-random pseudorandom number generator 404.3.

Preferably, the quantum random number generator 28 comprises means for monitoring the correct functioning of the quantum random number generator 28. Such means may be, for example, a voltage monitor 413 and/or a watchdog 404.5. These means typically generate an interrupt signal 420 in the event of an error and/or a suspected attack.

Other circuit components of the integrated circuit 2, for example the microcontroller, can also trigger interrupts by means of further interrupt lines. An interrupt logic in the processors controls the behavior of the processors 10-1, 10-2.

Preferably, the processors 10-1, 10-2 execute computer-implemented methods whose program code they retrieve and execute from memories of the device during execution. In one or more of these computer-implemented methods, the processors 10-1, 10-2 utilize quantum random numbers of the quantum random number generator 28. If said means of the quantum random number generator 28 for monitoring the correct functioning of the quantum random number generator 28 signal an error of the quantum random number generator 28, for example by means of the interrupt line 420, the processors 10-1, 10-2 preferably execute other computer-implemented substitute methods in place of these computer-implemented methods or modify parameters of these computer-implemented methods or no longer execute these computer-implemented methods at all, preferably at least as long as the error exists.

test deactivation circuit (block) 24, also referred to herein as a deactivation circuit, is preferably capable of controlling and preventing or allowing access to circuit parts and contents of memories of the integrated circuit 2, for example the microcontroller, by metacustomers of the customers of the semiconductor manufacturer and the customers of the semiconductor manufacturer and the analysis department of the semiconductor manufacturer of the integrated circuit 2, for example the microcontroller. Typically, the deactivation circuit 24 can, for example, allow or prevent the activation of predetermined test modes. This can include, for example, the enabling of scan paths and access to memory contents.

Preferably, the processor 10-1, 10-2 can only influence some of the accesses by reconfiguring the deactivation circuit 24. Thus, certain circuit and memory areas are not accessible for access after processor activation by a processor 10-1, 10-2. These switching and memory areas are thus protected against processor activation of access. It may be provided that no processor activation by a processor 10-1, 10-2 is possible at all.

Preferably, the test interface (JTAG interface) 12 can only influence some of the accesses by reconfiguring the deactivation circuit 24. Thus, certain circuit and memory areas are not accessible for access after test controller activation by the test interface (JTAG interface) 12. These switching and memory areas are thus protected against test controller activation of access. It may be provided that no test controller activation by the test interface (JTAG interface) 12 is possible at all.

Accesses can be activated, for example, by writing access codes to the second non-volatile memory OTP II 22, which can only be programmed once.

The content of the first, non-volatile memory OTP I 20, which can only be programmed once, can include critical system parameters (CSPs), for example.

The content of the second, non-volatile memory OTP II 22, which can only be programmed once, can include access codes, for example.

The first volatile, multi-programmable memory NVM 6 may comprise an EEPROM and/or a flash memory or the like. The memory content of the first volatile, multiply programmable memory NVM 6 may comprise, for example, data records 61 and signatures 61.

The volatile random access memory RAM 8 may comprise an SRAM and/or a DRAM or the like.

The second processor 10-2 should be optional in FIG. 19.

The bus arbiter 82 regulates the access of the device components of the exemplary one-piece, monolithic integrated circuit 2, for example the microcontroller, to obtain active write access to the internal data bus 419. In the case of FIG. 19, these are the two processors 10-1, 10-2.

The above description is not intended to be exhaustive and does not limit the present disclosure to the examples shown. Other variations on the disclosed examples may be understood and practiced by those of ordinary skill in the art from the drawings, the disclosure, and the claims. The indefinite articles “one” or “a” and its inflections do not preclude a plurality, while the mention of a specific number of elements does not preclude the possibility of there being more or fewer elements. A single entity can fulfill the functions of several elements mentioned in the revelation, and conversely, several elements can fulfill the function of one entity. Numerous alternatives, equivalents, variations and combinations are possible without departing from the scope of the present disclosure.

Unless otherwise indicated, all features of the present disclosure can be freely combined with one another. This applies to the entire document presented here. The features described in the figure description can also be freely combined with the other features as features of the disclosure, unless otherwise stated. A restriction of individual features of the embodiments to the combination with other features of the embodiments is expressly not intended. In addition, object features of the device can also be reformulated as process features and process features can be reformulated as object features of the device. Such a reformulation is thus automatically disclosed.

Reference is made to the accompanying drawings in the preceding detailed description. The examples in the description and drawings should be regarded as illustrative and should not be regarded as limiting the specific example or element described. Several examples may be derived from the foregoing description and/or drawings and/or claims by modifying, combining or varying certain elements. In addition, examples or elements that are not described verbatim may be derived by a person skilled in the art from the description and/or drawings.

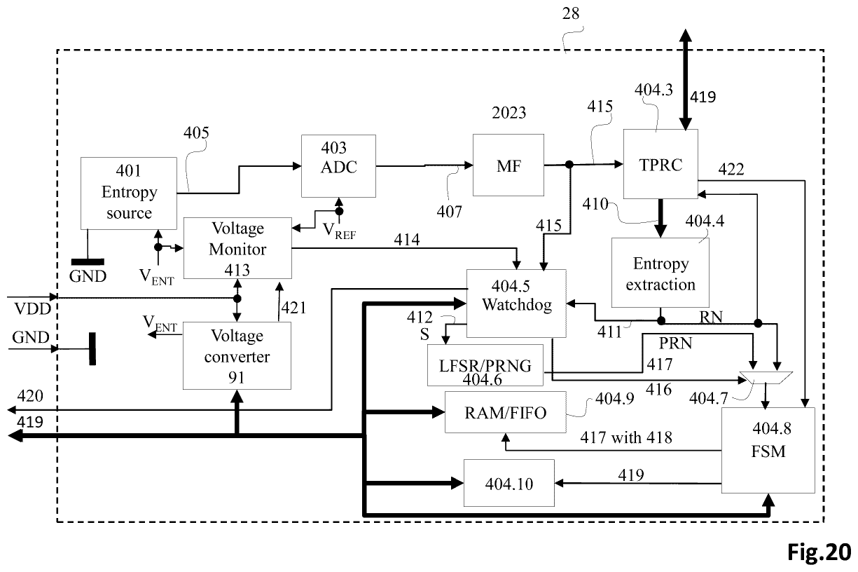

### FIG. 20

FIG. 20 shows a device similar to the device of FIGS. 8 and 9. In contrast to FIGS. 8 and 9, the quantum random number generator 28 in FIG. 20 does not comprise a high-frequency amplifier 402 and an analog-to-digital converter (ADC) 403 with a width of 14 bits and no comparator 404.1 and no constant 404.1. The device of FIG. 20 is suitable for forming a quantum random number generator 28 in which the photon source 54 and the photon detector 55 are electrically connected in series. In this case, the stimulated emissions can no longer be distinguished from the dark count.

One problem is that the pulses on the voltage signal 405 of the entropy source 401 are generally shorter than the frequency of the system clock 2106. As a result, a direct sampling of the voltage signal 405 of the entropy source 401 with a sampling frequency equal to the frequency of the system clock 2106 no longer fulfills the Nyquist condition. Therefore, a pulse extension circuit 2023 is connected downstream of the exemplary 1-bit analog-to-digital converter (ADC) 403, which extends a pulse on the voltage signal 405 of the entropy source 401 to a temporal length greater than a clock period of the system clock 2106 and preferably terminates the generated pulse synchronously with the system clock 2106, so that the pulse on the voltage signal 405 of the entropy source 401 can be safely synchronized by a subsequent flip-flop. The processor 10-1, 10-2 generated in this way can preferably access the registers of the watchdog 404.5, the memory RAM 404.9 or the FIFO 404.9 and the finish flag 404.10 via the internal data bus 419 and read them and, if permitted or possible, write to them. Preferably, the finish flag 404.10 signals to the processor 10-1, 10-2 via an interrupt line that is not drawn in that a new quantum random number is available in the RAM/FiFo 404.9. Preferably, reading the contents of the RAM/FiFo deletes this finish flag 404.10 again. In order to save energy, it is useful to switch off device parts of the quantum random number generator 28 when the finish flag 404.10 is set. Preferably, the processor 10-1, 10-2 can access device parts of the quantum random number generator 28 via the data bus 419 and switch certain parts of the quantum random number generator 28 on and off by setting or deleting flags in the registers of these device parts. These device parts can be, for example: The voltage monitor 419, a voltage converter 91 of the quantum random number generator 28, in particular a charge pump for supplying the entropy source 401, the ADC 403, the pulse stretching circuit 2023, the time-to-pseudo-random number converter (TPRC) 404.3, the entropy extraction 404.4, the finite state machine 404.8. Preferably, the watchdog 404.5 also evaluates these register bits and checks whether an enable register in its interior has a permissible authentication code for these activations or deactivations. The finite state machine 404.8 preferably also evaluates these flags and preferably only allows the generation of quantum random numbers 418 if all parts of the quantum random number generator 28 are working.

The synchronized voltage signal 415 can then be processed as described above.

With regard to the other parts of the device, this document refers to the preceding descriptions.

### FIG. 21

FIG. 21 shows an example of a time-to-pseudorandom number converter 404.3. The key idea here is to use a pseudorandom number generator 404.3 in the quantum random number generator 28 instead of a digital counter as in the prior art, which generates the first and second values for the entropy extraction 404.4. The present document refers here to FIG. 18 with respect to the corresponding process. The advantage is that even if a disturbance is successfully imprinted in the single-synchronized voltage signal 415, the randomness of the quantum random bit 411 is only marginally disturbed, since the attacker would also have to know the feedback polynomial. However, this is also selected randomly according to the proposal. The same applies to the seed value of the pseudo-random number generator, which the attacker would also have to determine. Another advantage of a pseudo-random number generator instead of a counter is the smaller area required for the feedback logic of a simple primitive feedback polynomial compared to a binary counter. If the linear feedback shift register of the pseudorandom number generator is long enough, each clock pulse between two pulses of the voltage signal 405 of the entropy source 401 is typically assigned a unique pseudorandom number. Preferably, the shift register controller 2103 of the time to pseudorandom number converter 404.3 (TPRC) starts the generation of a pseudorandom number by the shift register of the time to pseudorandom number converter 404.3 (TPRC) with a first pulse on the voltage signal 405 of the entropy source 401 and ends the generation of the pseudorandom number with a subsequent second pulse on the voltage signal 405 of the entropy source 401.

To further complicate taps, it is useful if, for example, the quantum random number generator 28 changes the feedback polynomial of the linear feedback shift register of the pseudorandom number generator of the time to pseudorandom number converter 404.3 (TPRC) after a number m of random quantum bits 411 has been fully determined as a function of one or more previously determined random quantum bits 411.

The following simple primitive feedback polynomials are known from the literature, for example:

| No. | XNOR from |
|---|---|
| 3 | 3, 2 |
| 4 | 4, 3 |
| 5 | 5, 3 |
| 6 | 6, 5 |
| 7 | 7, 6 |
| 8 | 8, 6, 5, 4 |
| 9 | 9, 5 |
| 10 | 10, 7 |
| 11 | 11, 9 |
| 12 | 12, 6, 4, 1 |
| 13 | 13, 4, 3, 1 |
| 14 | 14, 5, 3, 1 |
| 15 | 15, 14 |
| 16 | 16, 15, 13, 4 |
| 17 | 17, 14 |
| 18 | 18, 11 |
| 19 | 19, 6, 2, 1 |
| 20 | 20, 17 |
| 21 | 21, 19 |
| 22 | 22, 21 |
| 23 | 23, 18 |
| 24 | 24, 23, 22, 17 |
| 25 | 25, 22 |
| 26 | 26, 6, 2, 1 |
| 27 | 27, 5, 2, 1 |
| 28 | 28, 25 |
| 29 | 29, 27 |
| 30 | 30, 6, 4, 1 |
| 31 | 31, 28 |
| 32 | 32, 22, 2, 1 |
| 33 | 33, 20 |
| 34 | 34, 27, 2, 1 |
| 35 | 35, 33 |
| 36 | 36, 25 |
| 37 | 37, 5, 4, 3, 2, 1 |
| 38 | 38, 6, 5, 1 |
| 39 | 39, 35 |
| 40 | 40, 38, 21, 19 |
| 41 | 41, 38 |
| 42 | 42, 41, 20, 19 |
| 43 | 43, 42, 38, 37 |
| 44 | 44, 43, 18, 17 |
| 45 | 45, 44, 42, 41 |
| 46 | 46, 45, 26, 25 |
| 47 | 47, 42 |
| 48 | 48, 47, 21, 20 |
| 49 | 49, 40 |
| 50 | 50, 49, 24, 23 |
| 51 | 51, 50, 36, 35 |
| 52 | 52, 49 |
| 53 | 53, 52, 38, 37 |
| 54 | 54, 53, 18, 17 |
| 55 | 55, 31 |
| 56 | 56, 55, 35, 34 |
| 57 | 57, 50 |
| 58 | 58, 39 |
| 59 | 59, 58, 38, 37 |
| 60 | 60, 59 |
| 61 | 61, 60, 46, 45 |
| 62 | 62, 61, 6, 5 |
| 63 | 63, 62 |
| 64 | 64, 63, 61, 60 |
| 65 | 65, 47 |
| 66 | 66, 65, 57, 56 |
| 67 | 67, 66, 58, 57 |
| 68 | 68, 59 |
| 69 | 69, 67, 42, 40 |
| 70 | 70, 69, 55, 54 |
| 71 | 71, 65 |
| 72 | 72, 66, 25, 19 |
| 73 | 73, 48 |
| 74 | 74, 73, 59, 58 |
| 75 | 75, 74, 65, 64 |
| 76 | 76, 75, 41, 40 |
| 77 | 77, 76, 47, 46 |
| 78 | 78, 77, 59, 58 |
| 79 | 79, 70 |
| 80 | 80, 79, 43, 42 |
| 81 | 81, 77 |
| 82 | 82, 79, 47, 44 |
| 83 | 83, 82, 38, 37 |
| 84 | 84, 71 |
| 85 | 85, 84, 58, 57 |
| 86 | 86, 85, 74, 73 |
| 87 | 87, 74 |
| 88 | 88, 87, 17, 16 |
| 89 | 89, 51 |
| 90 | 90, 89, 72, 71 |
| 91 | 91, 90, 8, 7 |
| 92 | 92, 91, 80, 79 |
| 93 | 93, 91 |
| 94 | 94, 73 |
| 95 | 95, 84 |
| 96 | 96, 94, 49, 47 |
| 97 | 97, 91 |
| 98 | 98, 87 |
| 99 | 99, 97, 54, 52 |
| 100 | 100, 63 |
| 101 | 101, 100, 95, 94 |
| 102 | 102, 101, 36, 35 |
| 103 | 103, 94 |
| 104 | 104, 103, 94, 93 |
| 105 | 105, 89 |
| 106 | 106, 91 |
| 107 | 107, 105, 44, 42 |
| 108 | 108, 77 |
| 109 | 109, 108, 103, 102 |
| 110 | 110, 109, 98, 97 |
| 111 | 111, 101 |
| 112 | 112, 110, 69, 67 |
| 113 | 113, 104 |
| 114 | 114, 113, 33, 32 |
| 115 | 115, 114, 101, 100 |
| 116 | 116, 115, 46, 45 |
| 117 | 117, 115, 99, 97 |
| 118 | 118, 85 |
| 119 | 119, 111 |
| 120 | 120, 113, 9, 2 |
| 121 | 121, 103 |
| 122 | 122, 121, 63, 62 |
| 123 | 123, 121 |
| 124 | 124, 87 |
| 125 | 125, 124, 18, 17 |
| 126 | 126, 125, 90, 89 |
| 127 | 127, 126 |
| 128 | 128, 126, 101, 99 |
| 129 | 129, 124 |
| 130 | 130, 127 |
| 131 | 131, 130, 84, 83 |
| 132 | 132, 103 |
| 133 | 133, 132, 82, 81 |
| 134 | 134, 77 |
| 135 | 135, 124 |
| 136 | 136, 135, 11, 10 |
| 137 | 137, 116 |
| 138 | 138, 137, 131, 130 |
| 139 | 139, 136, 134, 131 |
| 140 | 140, 111 |
| 141 | 141, 140, 110, 109 |
| 142 | 142, 121 |
| 143 | 143, 142, 123, 122 |
| 144 | 144, 143, 75, 74 |
| 145 | 145, 93 |
| 146 | 146, 145, 87, 86 |
| 147 | 147, 146, 110, 109 |
| 148 | 148, 121 |
| 149 | 149, 148, 40, 39 |
| 150 | 150, 97 |
| 151 | 151, 148 |
| 152 | 152, 151, 87, 86 |
| 153 | 153, 152 |
| 154 | 154, 152, 27, 25 |
| 155 | 155, 154, 124, 123 |
| 156 | 156, 155, 41, 40 |
| 157 | 157, 156, 131, 130 |
| 158 | 158, 157, 132, 131 |
| 159 | 159, 128 |
| 160 | 160, 159, 142, 141 |
| 161 | 161, 143 |
| 162 | 162, 161, 75, 74 |
| 163 | 163, 162, 104, 103 |
| 164 | 164, 163, 151, 150 |
| 165 | 165, 164, 135, 134 |
| 166 | 166, 165, 128, 127 |
| 167 | 167, 161 |
| 168 | 168, 166, 153, 151 |

As can be seen, the number of XNOR links is very limited, which makes the linear feedback shift registers very fast. The longest chain listed has a length of 2¹⁶⁸-1 cycles with a shift register length of n=168 shift register bits. At a GHz=10⁹ Hz, a period lasts 2¹⁵⁹ seconds or otherwise approx. 2¹⁵³ minutes or otherwise approx. 2¹⁴⁷ hours or otherwise approx. 2¹⁴² days or otherwise (already very roughly) approx. 2¹³¹ years. Obviously it takes too long to solve the problem in finite time with a normal computer. This, in combination with a permanent quantum random number key change, makes it almost impossible for an attacker to break the corresponding barrier.

In order to prevent the protection of the quantum random number generator 28 from breaking, it is also useful if, for example, the quantum random number generator 28 changes the shift register length n of the linear feedback shift register of the pseudorandom number generator of the time-to-pseudorandom number converter 404.3 (TPRC) after a number k of random quantum bits 411 has been completely determined as a function of one or more previously determined random bits. For this purpose, it is useful if the shift register controller 2103 of the time to pseudorandom number converter 404.3 (TPRC) or a processor (10-1, 10-2) rewrites the value of the feedback polynomial selection register 2112 for this purpose. The value stored in the feedback polynomial selection register 2112 preferably controls the feedback multiplexer 2102 of the time to pseudorandom number converter 404.3 (TPRC). Thus, the value stored in the feedback polynomial selection register 2112 preferably selects which feedback polynomial of the m feedback polynomial circuits RKN₁ to RKNₘ determines the logic value of the shift register reload value line 2104 of the time-to-pseudo-random number converter 404.3 (TPRC). Preferably, by means of a line 2022 for preventing the utilization of a quantum random bit 411 by the finite state machine 404.8, the shift register controller 2103 of the time-to-pseudo-random number converter 404.3 (TPRC) or one of the processors (10-1, 10-2) or any other device prevents the finite state machine (finite state machine) 404.8 from passing a generated quantum random bit 411 when that random bit 411 is used for the feedback polynomial selection register 2112. This prevents double use and thus increases security. Instead, preferably the shift register controller 2103 of the time to pseudorandom number converter 404.3 (TPRC) or the processor (10-1, 10-2) or the other device use this random bit 411 for generating a random data word to be stored in the feedback polynomial selection register 2112. This has the advantage that the feedback polynomial of the m feedback polynomial circuits RKN₁ to RKNₘ selected by the feedback polynomial selection register 2112 is completely random. Thus, it is no longer possible for an attacker to inject a deterministic bit data stream in place of the data bit stream of the quantum random bits 411, even if an attack on the entropy source 401 is successful.

In order to further harden the proposed micro-integrated quantum random number generator 28, it is also useful if, for example, the quantum random number generator 28 changes the seed value of the linear feedback shift register of the pseudorandom number generator of the time-to-pseudorandom number converter 404.3 (TPRC) after a number p of random quantum bits 411 has been fully determined as a function of one or more previously determined random bits. For this purpose, it is useful if the shift register controller 2103 of the time to pseudorandom number converter 404.3 (TPRC) or a processor (10-1, 10-2) rewrites the value of a seed reload register in the shift register controller 2103 of the time to pseudorandom number converter 404.3 (TPRC) with random bits for this purpose. The bit width of the one seed reload register in the shift register controller 2103 of the time-to-pseudo-random number converter 404.3 (TPRC) preferably corresponds to the number n of shift register bits SB₁ to SBₙ of the time-to-pseudo-random number converter 404.3 (TPRC). The shift register controller 2103 of the time-to-pseudo-random number converter 404.3 (TPRC) preferably counts the number of successfully generated quantum random bits 411. Preferably, the finite state machine 404.8 signals the shift register controller 2103 of the time-to-pseudo-random number converter 404.3 (TPRC) to generate a valid random bit for this purpose. Instead of counting the valid quantum random bits 411, it is also possible to count the successfully generated random data words 418 in the finite state machine 404.8. The shift register controller 2103 of the time to pseudorandom number converter 404.3 (TPRC) preferably loads the new seed value of the one seed reload register in the shift register controller 2103 into the shift register bits SB₁ to SBₙ of the time to pseudorandom number converter 404.3 (TPRC) at one or more of the following events
on reaching a predetermined number of successfully generated quantum random bits 411 and/or
upon reaching a predetermined number of successfully generated random data words 418 and/or
when the value of the feedback polynomial selection register 2112 of the time to pseudorandom number converter 404.3 (TPRC) and thus the selected feedback polynomial of the m feedback polynomials RKN₁ to RKNₘ of the time to pseudorandom number converter 404.3 (TPRC) is changed.

This reliably prevents any kind of predictability.

Preferably, the circuit parts of the quantum random number generator 28 are covered with a metal layer 142, 53 to ward off any influence by temperature or electromagnetic radiation or electrostatic fields or magnetic fields. Preferably, the metal layer also comprises a soft magnetic layer to ward off attempts to attack it by means of magnetic fields.

Preferably, by means of a line 2022 for preventing utilization of a quantum random bit 411 by the finite state machine 404.8, the shift register controller 2103 of the time to pseudorandom number converter 404.3 (TPRC) or one of the processors (10-1, 10-2) or another device, prevents the finite state machine (finite state machine) 404.8 from passing a generated quantum random bit 411 when that random bit 411 is used for the seed reload register in the shift register controller 2103 in the time to pseudorandom number converter 404.3 (TPRC). This prevents double use and thus increases safety. Instead, preferably the shift register controller 2103 of the time-to-pseudo-random number converter 404.3 (TPRC) or the processor (10-1, 10-2) or the other device use this random bit 411 for generating a random data word to be stored in the seed reload register in the shift register controller 2103. This has the advantage that the seed value of the linear feedback shift register of the n shift register bits SB₁ to SBₙ selected by the seed reload register in the shift register controller 2103 is completely random. Since a linear feedback shift register using simple primitive feedback polynomials has two cycles, one of which comprises only one shift register value, this one-cycle shift register value must be prevented. If, by chance, the reload value of the seed reload register in the shift register controller 2103 corresponds to the one-cycle seed value of the linear feedback shift register with the current feedback polynomial or the next scheduled feedback polynomial, then the shift register controller 2103 of the time-to-random number converter 404.3 (TPRC) or one of the processors (10-1, 10-2) or another device generates a new random reload value in the seed reload register of the shift register controller 2103.

Preferably, the m feedback polynomials RKN₁ to RKNₘ are selected so that the one-cycle seed values are the same. This reduces the effort required to detect the one-cycle shift register value, as this then no longer depends on the selected feedback polynomial of the feedback polynomials RKN₁ to RKNₘ. In any case, if linear feedback shift registers are used, it is recommended that the time-to-random number converter 404.3 (TPRC) comprises a detection circuit 2113 for detecting an illegal value of the state vector of the n shift register bits SB₁ to SBₙ. If the state vector of the n shift register bits SB₁ to SBₙ is in such an illegal state, the detector 2113 preferably signals this illegal state to the shift register controller 2103 of the time to pseudorandom number converter 404.3 (TPRC) or one of the processors (10-1, 10-2) or another device. The detector 2113 or the shift register controller 2103 of the time-to-pseudo-random number converter 404.3 (TPRC) or the processor (10-1, 10-2) or the other device then resets the value of the state value of the state vector of the n shift register bits SB₁ to SBₙ to a predetermined value and/or the value of the seed reload register in the shift register controller 2103. Preferably, these reload values are different from the one-cycle shift register value. Preferably, this also occurs when the watchdog 404.5 and/or the voltage monitor 413 detect a fault or a suspected or possible attack. Preferably, the shift register controller 2103 of the time to pseudo-random number converter 404.3 (TPRC) counts the number of these faults. Preferably, the shift register controller 2103 of the time-to-pseudo-random number converter 404.3 (TPRC) reduces this counter value again depending on the number of successfully generated random quantum bits 411 and/or random data words 418, in particular since the last disturbance. If this number and/or the event density of such events exceeds a certain predetermined temporal density and/or a certain numerical value, the shift register controller 2103 of the time-to-pseudo-random number converter 404.3 (TPRC) preferably signals to the watchdog 404.5 and/or a processor (10-1, 10-2) a defect of the quantum random number generator 28 or a successful attack on the quantum random number generator 28. Typically, the shift register controller 2103 of the time-to-pseudo-random number converter 404.3 (TPRC) then signals to the finite state machine 404.8 that no more random numbers may be generated. Preferably, a processor (10-1, 10-2) must then reactivate the shift register controller 2103 of the time-to-pseudo-random number converter 404.3 (TPRC) by means of a predetermined reactivation code word. The processor (10-1, 10-2) then writes this reactivation code word via the internal data bus 419 of the quantum random number generator 28 into a special reactivation register of the shift register controller 2103 of the time-to-pseudo-random number converter 404.3 (TPRC), which reactivates the shift register controller 2103 of the time-to-pseudo-random number converter 404.3 (TPRC) and the quantum random number generator 28 and preferably resets all error counters. Preferably, the number of possible reactivations is limited. If the maximum number of reactivations is exceeded, the quantum random number generator 28 can preferably no longer be reactivated. Preferably, the counter for the reactivations of the quantum random number generator 28 can be reset by means of a special reset command before this maximum value is reached. Preferably, the shift register controller 2103 of the time to pseudorandom number converter 404.3 (TPRC) of the quantum random number generator 28 or another device of the quantum random number generator 28 issues a warning before this blocking limit is reached.

When the quantum random number generator 28 is started, the shift register controller 2103 of the time to pseudorandom number converter 404.3 (TPRC) first ensures that the shift register controller 2103 of the time to pseudorandom number converter 404.3 (TPRC) first determines a new seed value based on quantum random numbers 411 and a new value of the feedback polynomial selection register 2112 based on quantum random numbers from quantum random bits 411 by means of a predetermined seed value and a predetermined value of the feedback polynomial selection register 2112. Only when the seed value and the value of the feedback polynomial selection register 2112 are based on quantum random numbers, the initialization phase of the quantum random number generator 28 is completed and the shift register controller 2103 of the time to pseudorandom number converter 404.3 (TPRC) signals the finite state machine 404.8 that it may use and pass the quantum random bits 411 and the quantum random data words 418 (quantum random numbers). Preferably, the finite state machine .8 signals this fact to one or more processors (10-1, 10-2). This has the advantage that the device only generates quantum random numbers 418 with full protection.

By using a time-to-pseudo-random number generator 404.3 (TPRC), it is no longer possible for an attacker to feed a deterministic bit data stream in place of the data bit stream of the quantum random bits 411, even if an attack on the entropy source 401 is actually successful for whatever reason.

In order to prevent this, it is also useful if, for example, the quantum random number generator 28 changes this number m after the complete determination of a number m of quantum random bits 411 as a function of one or more previously determined random bits.

Preferably, the finite state machine 404.8 of the quantum random number generator 28 does not output these already used quantum random bits 411 and does not use them to generate quantum random data words 418.

The logic extraction method also includes three borderline cases, which are described below.

Typically, the time to pseudorandom number generator 404.3 (TPRC) uses the logic value of the shift register reload value line 2104 of the time to pseudorandom number converter 404.3 (TPRC) as the value of the output 410 of the time to pseudorandom number converter 404.3 (TPRC). If necessary, a buffer amplifier may be provided which detects the logic value of the shift register reload value line 2104 of the time-to-pseudo-random number converter 404.3 (TPRC) and outputs it as the value of the output 410 of the time-to-pseudo-random number converter 404.3 (TPRC).

The entropy extraction 404.4 now compares two different pseudorandom numbers generated by the time to pseudorandom number converter 404.3 (TPRC) from the output 410 of the time to pseudorandom number converter 404.3, a first pseudorandom number 410.1 and a second pseudorandom number 410.2.

If the first pseudorandom number 410.1 and the second pseudorandom number 410.2 are equal, the entropy extraction 404.4 discards one of the two pseudorandom numbers, the first pseudorandom number 410.1 or the second quantum random number 410.2, and replaces it with a new pseudorandom number 410.3 of the time to pseudorandom number converter 404.3 (TPRC). Preferably, the entropy extraction 404.4 uses a counter to count the events for which the two pseudorandom numbers, the first pseudorandom number 410.1 and the second pseudorandom number 410.2, are equal and increments the counter by a first counter increment with each such event. Preferably, the entropy extraction 404.4 also uses this counter to count the events in which the two pseudorandom numbers, the first pseudorandom number 410.1 and the second pseudorandom number 410.2, are not equal and decreases the counter by a second counter increment with each such event, preferably not falling below the value 0. Preferably, the amount of the second counter increment is smaller than the first counter increment of the counter in the entropy extraction 404.4. If the value of this counter exceeds a predetermined value, the control device of the entropy extraction 404.4 assumes that the time to pseudo-random number converter 404.3 (TPRC) is defective. Preferably, the entropy extraction control device 404.4 then signals to a processor (10-1, 10-2) a defect of the quantum random number generator 28 or a successful attack on the quantum random number generator 28. Preferably, the entropy extraction 404.4 of the finite state machine no longer signals successful generation of a quantum random bit 411, so that the finite state machine 404.8 can no longer report successful quantum random number generation to a processor (10-1, 10-2) and no longer generates quantum random numbers 418.

If the first pseudorandom number 410.1 is smaller than the second pseudorandom number 410.2, the entropy extraction 404.4 generates a quantum random bit of a first logical value, for example a logical ‘1’, and signals the successful generation to the finite state machine 404.8.

If the first pseudorandom number 410.1 is greater than the second pseudorandom number 410.2, the entropy extraction 404.4 generates a quantum random bit of a second logical value, for example a logical ‘0’, which is different from the first logical value, and signals the successful generation to the finite state machine 404.8.

The finite state machine converts the successfully generated quantum random bits 411 into quantum random data words 418, each representing a quantum random number, and makes them available via a RAM or a FIFO 404.9 to the processors (10-1, 10-2) via the internal data bus 419. The finite state machine 404.8 preferably signals the provision of one or more quantum random numbers to one or more processors (10-1, 10-2).

One problem may be a jitter of the system clock 2106. By using a time-to-random number generator 404.3 (TPRC), a mono-frequency or otherwise systematic disturbance of the system clock 2106 is spread in the spectrum with a random spreading code, making detection difficult, if not impossible, for an attacker.

This makes the quantum random number generator 28 even more difficult to attack.

By using quantum random numbers from quantum random bits 411 for the seed value of the linear feedback shift register of the time-to-pseudorandom number converter and a quantum random number for the selection of the single-primitive feedback polynomial, the behavior of the time-to-pseudorandom number converter 404.2 (TPRC) is itself at a random level of a quantum random number. The regular change of these values makes it even more difficult for an attacker to influence the generated quantum random numbers.

Accordingly, the proposed quantum random number generator 28 thus achieves all the stated objectives.

In particular, the proposal achieves the goal of providing a one-piece, micro-integrated quantum random number generator 28 that allows a high degree of entropy to be guaranteed so that it passes at least the statistical tests defined by NIST.

It is further proposed to provide a one-piece, micro-integrated quantum random number generator 28 that enables a high bit rate to be achieved in the generation of random sequences of quantum random bits 411 and/or quantum random data words 418.

It is also the task of the proposal to provide a one-piece, micro-integrated quantum random number generator 28 which, compared to the quantum random number generators of the prior art, has a more compact, more robust and less complex and, above all, micro-integrated and CMOS-compatible structure which permits one-piece manufacture and co-integration into conventional systems such as memories (such as DRAMS, SRAMS, flash memories and the like) or processors (microprocessors and/or microcontrollers and/or SoCs by means of a processor on the IC).

Again, the proposal achieves the goal of providing a quantum random number generator 28 with a high degree of security against any attempt to tamper with its internal components. In particular, the use of a time-to-pseudorandom number generator 1004.3 (TRNG) prevents the evaluability of successful attacks on the entropy source 401. Furthermore, the many tests enable secure detection of an attack on the quantum random number generator 28 and thus prevent the use of manipulated numbers as supposedly secure quantum random numbers.

Finally, the proposal also achieves the objective of providing a quantum random number generator 28 which is more economical than the generators of the known prior art, in particular due to its ability to be co-integrated into CMOS circuits.

### FIG. 22

The diagram shown in FIG. 22 represents the detection of the pulses (2201, 2202, 2203, 2204) on the voltage signal 405 of the entropy source 401. The entropy source 401 preferably comprises the one or more photon sources 54 or the one or more silicon LEDs 54 or the one or more SPAD diodes 54 and the light transmission path 44 therebetween. The entropy source 401 is preferably fabricated in or on the semiconductor substrate 49 and thus preferably part of the micro-integrated circuit of the quantum random number generator 28. The output signal 405 of the entropy source 401 is typically said voltage signal 405 of the entropy source 401. The voltage signal 405 of the entropy source 401 is preferably the signal of one or more photon detectors 55 and/or one or more second SPAD diodes 55 of the entropy source 401.

The voltage signal 405 shows exemplary pulses 2201, 2202, 2203, 2104 for random events of the voltage signal 405. These may be spontaneous voltage pulses of the photon detector 55 or the second SPAD diode 55 of the entropy source 401, which are not related to the activity of the photon source 54 or the silicon LED 54 or the first SPAD diode 54 of the entropy source 401. However, the pulses 2201, 2202, 2203, 2204 of the photon detector 55 or the second SPAD diode 55 of the entropy source 401 may also be based on stimulated emission that causes the detection of a photon of the one or more photon sources 54 or the one or more silicon LEDs 54 or the one or more SPAD diodes 54 by the photon detector 55 or by the second SPAD diode 55 of the entropy source 401.

The time interval is random. However, after a photon has been received by the photon detector 55 or by the second SPAD diode 55 of the entropy source 401, a dead time occurs in which the photon detector 55 or the second SPAD diode 55 of the entropy source 401 is no longer capable of receiving. If the magnitude of the voltage signal 405 of the entropy source 401 exceeds a threshold value 2105, an analog-to-digital converter (ADC, 403), here an exemplary one-bit analog-to-digital converter 403, generates a signal,

pulse stretching circuit, which is preferably part of the one-piece microelectronic circuit, on a single-synchronized voltage signal 415, a pulse having a minimum length of n clocks of a system clock 2106 of the quantum random number generator 28, which is preferably one of the system clocks of the one-piece microintegrated circuit.

In the example of FIG. 22, for example, the pulse extension circuit 2023 is constructed such that it goes to a first logic level for at least three subsequent clock pulses of the system clock 2106 and then falls back to the second logic level until the next event, here exemplified with the falling edge of the third clock pulse. Instead of three clock pulses, a to n clock pulses can be used, whereby a positive integer is greater than 0.

In the example of FIG. 22, the falling edges of the pulses 2211, 2212, 2213, 2214 of the single-synchronized voltage signal 415 represent the single-synchronized signals of the entropy source 401.

With a falling edge of a first pulse 2211 of the single-synchronized voltage signal 415, the time-to-pseudorandom number converter (TPRC) resets a pseudorandom number generator, for example, to a predefined seed value. For example, the pseudo-random number generator of the time-to-pseudo-random number converter (TPRC) can be a feedback shift register that shifts its values one place to the left or right with each clock pulse of the system clock 2106, depending on the design, and feeds the feedback value of the feedback polynomial back into the released bit.

It is important that, starting with the start value of the pseudo-random number generator (seed value), exactly one pseudo-random number of the pseudo-random number generator is bijectively assigned to each clock pulse of the system clock 2106 from the falling edge. In other words, it must be possible to infer the temporal position of the relevant clock of the system clock 2106 after the falling edge of the single-synchronized voltage signal 415 from the value of the pseudorandom number.

With the next falling edge of the second pulse 2212 synchronized voltage signal 415, a first pseudorandom number register takes over the last state of the pseudorandom number generator and the time to pseudorandom number converter (TPRC) preferably resets the pseudorandom number generator to the predefined seed value.

With the next falling edge of the third pulse 2213 synchronized voltage signal 415, a second pseudorandom number register takes over the last state of the pseudorandom number generator and the time to pseudorandom number converter (TPRC) preferably resets the pseudorandom number generator to the predefined seed value. The entropy extraction 401 compares the value in the first pseudorandom number register with the value in the second pseudorandom number register. For example, if the first value in the first pseudorandom number register is greater than the second value in the second pseudorandom number register, entropy extraction 404.4 may generate a random bit with a first logic level. If the second value in the first pseudorandom number register is greater than the second value in the second pseudorandom number register, entropy extraction 404.4 can, for example, generate a random bit with a second logic level that is different from the first level.

With the next falling edge of the fourth pulse 2214 of the single-synchronized voltage signal 415, the first pseudorandom number register takes over the previous value of the second pseudorandom number register and the second pseudorandom number register instead takes over the last state of the pseudorandom number generator and the time to pseudorandom number converter (TPRC) preferably resets the pseudorandom number generator to the predefined seed value. The entropy extraction 401 then again compares the value in the first pseudo-random number register with the value in the second pseudo-random number register. If the first value in the first pseudorandom number register is greater than the second value in the second pseudorandom number register, entropy extraction 404.4 can, for example, generate a further new and here second quantum random bit 411 with a first logic level. If the second value in the first pseudorandom number register is greater than the second value in the second pseudorandom number register, the entropy extraction 404.4 can, for example, generate a further new and here second quantum random bit 411 with a second logical level that is different from the first level.

In this way, the quantum random number generator 28 can continue this process of quantum random bit generation and thus generate a continuous stream of quantum random bits 411, albeit with a phase noise.

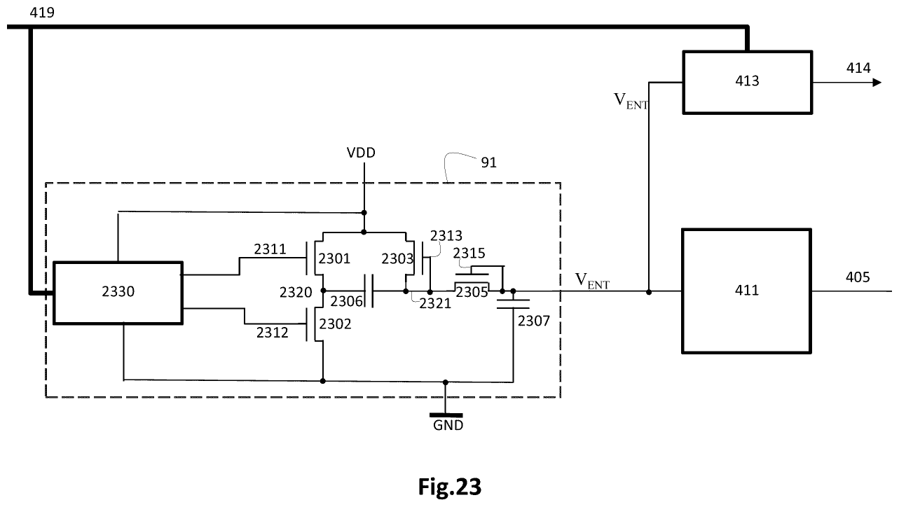

### FIG. 23

FIG. 23 shows an exemplary voltage transformer 91 for supplying the entropy source 411 with a sufficient operating voltage of the supply voltage line V_{ENT} of the entropy source 411 with respect to the reference potential line GND at the reference potential. The voltage transformer 91 corresponds to that of FIG. 20. In this respect, FIG. 23 is a section of FIG. 20, whereby only the most essential parts are shown for better clarity.

The voltage converter 91 of FIG. 23 is only one example of several possible voltage converter designs. The voltage converter is intended only as an example to explain the possible use of DMOS transistors in a proposed quantum random number generator 28 or an integrated circuit 2, such as a microcontroller, with such a quantum random number generator 28.

The voltage converter 91 of FIG. 23 comprises a first half-bridge. In the example of FIG. 23, the reference potential line GND and the positive supply voltage line VDD supply the voltage converter for supplying the entropy source 411 with a sufficient operating voltage of the supply voltage line V_{ENT} of the entropy source 411 with respect to the reference potential line GND at the reference potential with electrical energy.

In the example shown in FIG. 23, the first half-bridge of the exemplary voltage transformer 91 is connected between the reference potential line GND and the positive supply voltage line VDD.

The first half-bridge of the exemplary voltage converter 91 of FIG. 23 comprises the high-side transistor 2301 of the first half-bridge of the charge pump for the entropy source 411 and the low-side transistor 2302 of the first half-bridge of the charge pump for the entropy source 411.

The second high-side transistor 2303 of the charge pump for the entropy source 411 is electrically connected to the positive supply voltage line VDD.

The control device 2330 of the voltage converter 91 controls the high-side transistor 2301 of the first half-bridge via the control contact (gate) 2311 of the high-side transistor 2301 of the first half-bridge.

The control device 2330 of the voltage converter 91 controls the low-side transistor 2302 of the first half-bridge via the control contact (gate) 2312 of the low-side transistor 2302 of the first half-bridge.

The control contact (gate) 2311 of the second high-side transistor 2303 is electrically connected to the output node 2321 of the charge pump. As a result, the high-side transistor 2303 of the second half-bridge forms a MOS diode that becomes conductive when the potential of the output node 2321 of the charge pump below the positive potential of the positive supply voltage line VDD minus the threshold voltage of the second high-side transistor 2303. The second high-side transistor 2303 then charges the first energy store, in this case a first capacitor 2306.

In the example of FIG. 23, the first capacitor 2306 is electrically connected with its second connection of the first capacitor 2306 to the output node 2321 of the charge pump. In the example of FIG. 23, the first capacitor 2306 is electrically connected with its first connection of the first capacitor 2306 to the output node 2320 of the first half-bridge of the charge pump.

The control device 2330 of the voltage converter 91 initially disables the high-side transistor 2301 of the first half-bridge and the low-side transistor 2302 of the first half-bridge. In the example shown in FIG. 23, a transfer transistor 2305 of the charge pump for the entropy source 411 is connected between the output node 2321 of the charge pump and the positive supply voltage line V_{EXT} of the entropy source 411. In the example of FIG. 23, the transfer transistor 2305 of the charge pump for the entropy source 411 is connected as a MOS diode. As a result, the transfer transistor 2305 forms an MOS diode that becomes conductive when the potential of the output node 2321 of the charge pump falls below the positive potential of the positive supply voltage line V_{EXT} of the entropy source 411 minus the threshold voltage of the transfer transistor 2305. The transfer transistor 2305 then charges the second energy store, in this case a second capacitor 2307.

In the example of FIG. 23, the second capacitor 2307 is electrically connected with its second connection of the second capacitor 2307 to positive supply voltage line V_{EXT} of the entropy source 411. In the example of FIG. 23, the second capacitor 2307 is electrically connected with its first connection of the second capacitor 2307 to the reference potential line GND.

Preferably, the control device 2330 of the voltage converter 91 switches the low-side transistor 2302 of the first half-bridge conductive for a short time in an initialization phase.

This connects the first terminal of the first capacitor 2306 to the reference potential line GND. If the first capacitor 2306 is not charged or is charged with a reversed polarity, the second high-side transistor 2303 then charges the first capacitor 2306 to the voltage between the positive supply voltage terminal VDD and the reference potential line GND minus the threshold voltage of the second high-side transistor 2303.

In a subsequent step, the control device 2330 of the voltage converter 91 disables the low-side transistor 2302 of the first half-bridge. This ends the charging process of the first capacitor 2306.

In a subsequent step, the control device 2330 of the voltage converter 91 switches the high-side transistor 2301 of the first half-bridge conductive. As a result, the output potential of the output 2321 of the charge pump shifts to a potential with a voltage that corresponds to twice the voltage between the positive supply voltage line VDD and the reference potential line GND minus the threshold voltage of the second high-side transistor 2303. This means that the potential of the output 2321 of the charge pump is above the potential of the positive supply voltage line V_{EXT} of the entropy source 411 if the second capacitor 2307 is not charged, is insufficiently charged or has the wrong polarity. If the voltage difference between the potential of the output 2321 of the charge pump and the potential of the supply voltage line V_{EXT} of the entropy source 411 is greater than the threshold voltage of the transfer transistor 2305, the transfer transistor 2305 switches on and connects the output 2321 of the charge pump to the supply voltage line V_{EXT} of the entropy source 411. This causes charge to transfer from the first capacitor 2306 to the second capacitor 2307, which raises the potential of the supply voltage line V_{EXT} of the entropy source 411 until the voltage drops across the first capacitor 2306 and the second capacitor 2307 have equalized.

The control device 2330 of the voltage transformer 91 repeats these steps until no more charge transfer takes place.

If necessary, the processor 10-1 or the voltage monitor 413 can detect this state of a charge transfer that is no longer taking place, for example by means of an analog-to-digital converter or a comparator, and then interrupt the charging process, for example by means of a corresponding signaling to the control device 2330 of the voltage converter 91, until they detect that the potential of the supply voltage line V_{EXT} of the entropy source 411 has fallen below a minimum potential. If this is the case, the processor 10-1 or the voltage monitor 413 preferably restart the charge pump of the voltage converter 91 by means of a further signaling to the control device 2330 of the voltage converter 91 and keep it in operation until no significant charge transfer takes place again.

If the processor 10-1 or the voltage monitor 413 do not detect this state of the charge transfer essentially no longer taking place within a predefined period of time after the restart of the charge transfer, a defect or a fault or an attack is presumably present. Preferably, the processor 10-1 and/or the voltage monitor 413 signal this fault. For example, the voltage monitor 413 can signal such a fault to the watchdog 404.5 via a signal line 414.

In this way, the voltage converter 91 and the second capacitor 2307 can supply the entropy source 411 with a sufficient operating voltage on the supply voltage line V_{EXT} of the entropy source 411.

The first capacitor 2306 and/or the second capacitor 2307 can be manufactured externally by the integrated circuit 2, for example the microcontroller, and connected via terminals of the housing of the integrated circuit 2, for example the microcontroller. This enables very high capacitance values for the first capacitor 2306 and/or the second capacitor 2307 at low cost.

However, it is advantageous if the first capacitor 2306 and/or the second capacitor 2307 are silicon capacitors. In one embodiment, when the first capacitor 2306 and/or the second capacitor 2307 are integrated into the integrated circuit 2, for example into the microcontroller, the first capacitor 2306 and/or the second capacitor 2307 may each comprise, for example, an interconnection of trench capacitors fabricated in the semiconductor substrate 49 of the quantum random number generator 28. In a further additional or alternative embodiment, when the first capacitor 2306 and/or the second capacitor 2307 are integrated into the integrated circuit 2, for example into the microcontroller, the first capacitor 2306 and/or the second capacitor 2307 may each comprise, for example, an interconnection of MIM capacitors fabricated in the metallization stack on the semiconductor substrate 49 of the quantum random number generator 28. MIM stands for metal-insulator-metal. Preferably, an insulating layer of the metallization stack then comprises a high-K material, such as hafnium oxide.

Of course, it is also conceivable, for example, to provide gate capacitances of additional transistors as device components of the first capacitor 2306 and/or the second capacitor 2307.

In the example in FIG. 23, an increased voltage is then present at least temporarily during operation between gate 2313 and the substrate of the second high-side transistor 2303 and between gate 2315 and the substrate of the transfer transistor 2305. These transistors must therefore be particularly voltage-resistant. Preferably, the second high-side transistor 2303 and/or the transfer transistor 2305 are therefore each designed as a DMOS transistor. It is therefore advantageous to manufacture the integrated circuit 2, for example the microcontroller, or the monolithically integrated quantum random number generator 28 in a BCD technology.

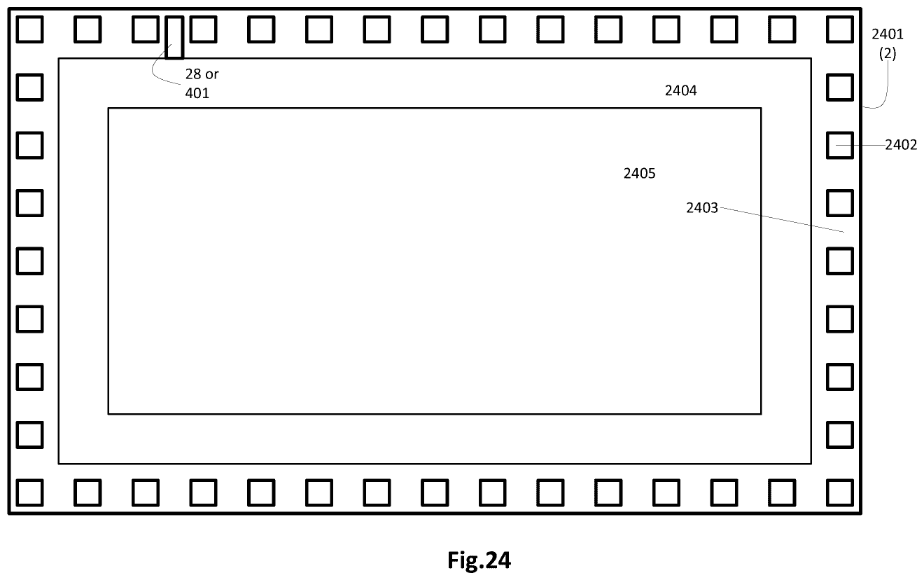

### FIG. 24

FIG. 24 shows an example of a rough layout of an imaginary integrated circuit 2, for example a microcontroller, with a proposed quantum random number generator 28 in top view.

The integrated circuit 2, for example a microcontroller, has an inner region 2405 of the integrated circuit 2 in which the essential sub-circuits of the integrated circuit 2, for example the microcontroller, are located. Typically, this inner region 2405 of the integrated circuit 2, for example the microcontroller, is surrounded by a wiring region 2404 in which supply voltage lines, data bus lines and other lines are typically routed.

The wiring area 2404 and the inner area 2405 of the integrated circuit 2, for example the microcontroller, are surrounded by the pad frame 2403, which comprises the connection pads (connection surfaces) 2402 for the electrical bonding connections or other electrical connection terminals.

The document presented here now proposes to place the quantum random number generator 28, as shown for example in FIG. 20, entirely or at least in substantial parts in the pad frame 2403, since the gaps between the connection pads 2402 are often not filled with electronic circuit parts, but nevertheless have to be processed during manufacture and therefore cause unnecessary costs. This placement of the quantum random number generator 28 entirely or at least in substantial parts in the pad frame 2403 therefore significantly reduces the additional costs for such a quantum random number generator 28. The document presented herein proposes, most preferably, to place at least the entropy source 401 in the pad frame between two connection pads 2402. The document presented herein also suggests, most preferably, placing the analog-to-digital converter 403 in the pad frame between two connection pads 2402 as well. The document presented herein also proposes preferably to place the voltage converter 91 for powering the entropy source 401 also in the pad frame between two connection pads 2402. The document presented herein also preferably proposes to place the pulse extender circuit 2023 also in the pad frame between two connection pads 2402. The document presented herein also preferably proposes to place other analog portions of the quantum random number generator 28 (e.g., the amplifier 402) also in the pad frame between two connection pads 2402.

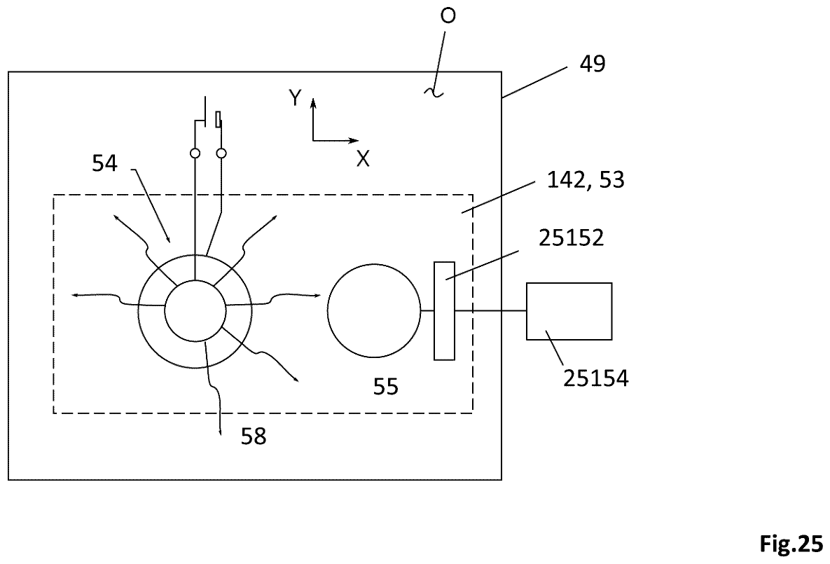

### FIG. 25

FIG. 25 shows a schematic top view of a first embodiment of a quantum random number generator 28 according to the prior art. The illustration is based on a corresponding figure of EP 3 529 694 B1 and shows the surface O of an associated substrate 49, in which the entropy source 401 is integrated. A circular photon source 54 with a p-n junction set up to provide photons is supplied with current via a corresponding contact and thereby stimulated to emit individual horizontally propagating photons 58. To detect the emitted photons 58, an associated single photon detector 55 in the form of a SPAD diode 55 is arranged next to the photon source 54. However, as in conventional hybrid approaches for photonic entropy sources 401, the photon source 54 and the single photon detector 55 are still structurally and functionally separate elements, which are merely arranged next to each other for integration in a common semiconductor substrate 49 and in which the transport of the photons 58 through the semiconductor substrate 49 takes place with high attenuation. This results in a low data rate.

A current pulse generated by the single photon detector 55 upon absorption of a photon 58 may then first be registered and analyzed in an associated electronic sampling means 25152, in particular to generate a bit sequence based on the number of photons detected in the single photon detector 55. Furthermore, an electronic post-processing means 25154 is provided, which is to be configured to process the binary sequences of the electronic acquisition means 55 so as to perform a so-called “whitening” operation. This shall comprise a plurality of compression operations which serve to improve the statistical properties of the generated binary sequences. The post-processing step is intended to increase the entropy level of the bit stream of the entropy source 401. However, it must be ensured that the compression operations used do not in turn lead to a fundamental predictability of the random numbers generated by introducing deterministic dependencies in the application.

In order to increase the efficiency of the random number generation, i.e. the effective entropy rate, the photonic part, i.e. the entropy source 401, of the QRNG at the surface O of the semiconductor substrate 49 is preferably protected by a light-blocking layer 142, 53 (“light inhibitor filter”), which serves to shade against an external incidence of light. The light-blocking layer 142, 53 can be provided in particular by a metallization layer, which can be applied directly during the production process, for example by the CMOS technique, as the last metallization layer. This is intended to shield the photon detector 55 from external light and make it sensitive only to photons that pass through the semiconductor substrate 49 due to crosstalk from the photon source 54. In addition, the metallization layer 142, 53 is also intended to improve the optical coupling of the photons 58 emitted by photon source 54 by reflecting them inwards and thus preventing them from exiting the surface O of semiconductor substrate 49.

A disadvantage of such an arrangement of the optical components next to each other is the distance between the components, which reduces the coupling strength due to the low illumination angle and the potential photon absorption in the different materials. In addition, despite the partially applied light-blocking layer 142, 53, there is still the potential for optical access and thus an attack from the surface O of the substrate 49 or even from the rear side of the semiconductor substrate 49. For example, additional photons can be selectively injected or extracted via this, so that ultimately the counting statistics and thus the entropy of the random numbers generated can be influenced and compromised. Furthermore, it can also be seen in the illustration that the individual photons 58 are emitted isotropically distributed in all spatial directions, so that only a fraction of the photons 58 can be detected by the photon detector 55 and thus statistically evaluated. On the one hand, this considerably reduces the efficiency of the random number generation and, on the other hand, leads to a large number of photons 58 being emitted unused into the semiconductor substrate 49, where they may also be extracted elsewhere by observers or attackers or may lead to interference.

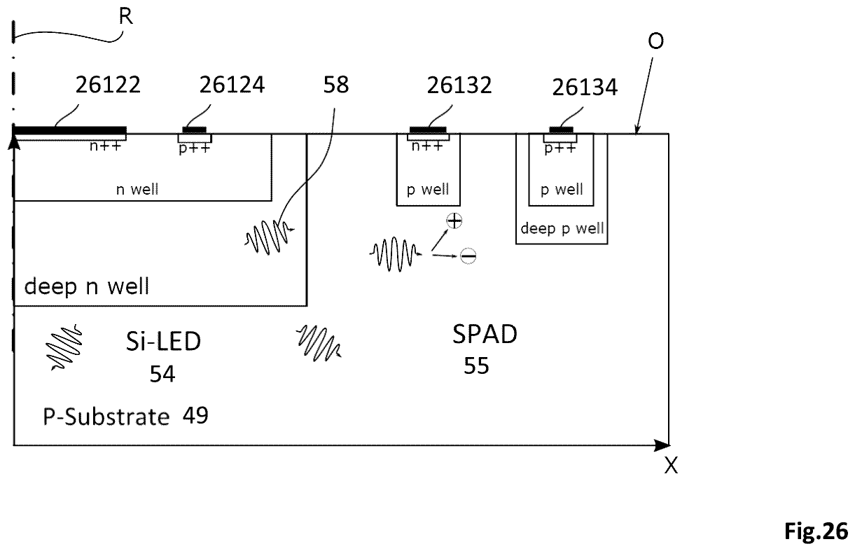

### FIG. 26

FIG. 26 shows a schematic representation of a second embodiment of an entropy source 401 according to the prior art in a side view. The illustration is based on a corresponding figure from Khanmohammadi et al. (A. Khanmohammadi, R. Enne, M. Hofbauer and H. Zimmermann, “A Monolithic Silicon Quantum Random Number Generator Based on Measurement of Photon Detection Time,” in IEEE Photonics Journal, vol. 7, no. 5, pp. 1-13, October 2015, Art no. 7500113). In this example, too, the basic structure of a side-by-side arrangement of a photon source 54 (Si LED), which is set up to emit individual photons 58, and a single photon detector 55 (SPAD) can be clearly recognized. In contrast to the arrangement shown in FIG. 25, however, the photon source 54 is provided here as a circular central element, which is essentially completely surrounded by a correspondingly adapted circularly shaped single photon detector 55. The common radial axis of symmetry R lies correspondingly in the center of the entropy source 401 formed in this way. The photon source 54 is thereby realized by an n-well (“n-well”) formed in a deep n-well, which is supplied with current via an n++ region introduced into the surface O of the substrate 49 (“p-substrate”) centrally around the radial axis of symmetry R as cathode 26122 and a p++ region arranged next to it as anode 26124. Outside the low-lying n-well, the single-photon detector 55 is also contacted to the surface O via an n++ region introduced as cathode 26132 and a p++ region arranged further away from the radial axis of symmetry R as anode 26134. A p-well is connected below the cathode 26132. Below the anode 26134, on the other hand, a p well is formed in a deep p well. The photon source 54 is provided here as an element within the structure of the photon detector 55, so that, in contrast to FIG. 25, these form a structural and functional unit.

In this example of an entropy source 401 according to the prior art, the photons 58 are also emitted into the semiconductor substrate 49 essentially on all sides, so that the disadvantages already described for the embodiment according to FIG. 25 with regard to security against observers or attackers and reduced efficiency also apply. However, the integration density can be further increased compared to FIG. 25 due to the specific design as a circular ring-shaped arrangement and the structural linking of the single photon detector 55 with the photon source 54. In addition to a lower area consumption for the formation of the entropy source 401, this also includes an increase in security against attacks and an increased efficiency in random number generation or the entropy rate as advantages. This is due in particular to the fact that the reduction in all distances reduces the loss of photons 58 due to material absorption and unfavorable emission directions. This also reduces the area for possible attacks. Apart from this, however, it is still possible in principle to couple out or inject individual photons 58, particularly at the surface O and also at other points of the semiconductor substrate 49, in order to influence the counting statistics by attackers. Such a side-by-side arrangement of the two optical components of an optical entropy source 401 therefore has some disadvantages that have so far stood in the way of particularly secure, compact and reliable random number generation for SoC applications.

### FIG. 27

FIG. 27 shows a schematic representation of a BCD substrate 27110 provided by a method for providing low-lying p-n junctions 27050 and 27052 in a BCD process and a TCAD representation of the resulting dopant distribution. An embodiment of a method for generating low-lying p-n junctions 27050 and 27052 in a BCD process comprises providing a support substrate 49; introducing a first dopant to form a first region 27022 (e.g., NBL) of the first conductivity type (negative for NBL) into a surface S of the support substrate 49; introducing a second dopant to form a second region 27032 (e.g., PBL) of the second conductivity type (negative for NBL) into a surface S of the support substrate 49; introducing a second dopant to form a first region 27022 (e.g., NBL) of the second conductivity type (negative for NBL) into a surface S of the support substrate 49; and introducing a second dopant to form a second region 27032 (e.g., PBL) of the second conductivity type (negative for NBL) into a surface S of the support substrate 49. PBL) of the second conductivity type (positive for PBL) into the surface S of the carrier substrate 49, wherein the first region 27022 (NBL) and the second region 27032 (PBL) are at least partially superimposed; growing an epitaxial layer 48 onto the surface S of the carrier substrate 49, wherein the first region 27022 (NBL) and the second region 27032 (PBL) spread in the epitaxial layer 48 by diffusion of the first dopant and the second dopant, thereby forming a p-n junction 27050 located in the epitaxial layer 48.

In the embodiment, the first region 27022 is a low-lying NBL layer and the second region 27032 is a low-lying PBL layer. However, the order can be interchanged, so that the first region 27022 can also be a low-lying PBL layer and the second region 27032 a low-lying NBL layer. The layer sequence of the p-n junctions 27050 and 27052 can also be reversed by adjusting the diffusion lengths of the individual dopants accordingly, e.g. the NBL and PBL layers at the p-n junction 27050 and 27052 in FIG. 27 could also be interchanged.

The method described differs from the conventional methods for providing BCD substrates 27110 according to the prior art in particular in that the first region 27022 (NBL) and the second region 27032 (PBL) are at least partially superimposed. In particular, immediately after the introduction of the second dopant, the first region 27022 or the second region 27032 can completely overlap the respective other region (27032, 27022) in a top view of the surface S of the carrier substrate 49. Therefore, in the embodiment shown, immediately after the introduction of the second dopant to form the second region 27032 (PBL), the latter lies completely in the first region 27022 (NBL) in a top view of the surface S of the carrier substrate 49. In order to form a p-n junction 27050 located in the epitaxial layer, the first and the second dopant preferably have different diffusion properties in the carrier substrate 49 and/or in the epitaxial layer 48. In particular, as shown, the second dopant in the second region 27032 (PBL) may have a higher diffusion mobility (and thus diffusion length) in the support substrate 49 and in the epitaxial layer 48 than the first dopant in the first region 27022 (NBL).

To increase the diffusion, the carrier substrate 49 can be heated after the introduction of the first dopant and/or the second dopant. Furthermore, after the epitaxial layer 48 has grown, the carrier substrate 49 can be heated to increase the diffusion of the dopant. In the method presented, the first dopant and/or the second dopant can be introduced either without a mask or via a mask process. In the BCD wafer shown, a complete superposition of the first region 27022 (NBL) with a single second region 27032 (PBL) can be assumed. Conventionally, however, the first and second regions 27022 and 27032 are formed spatially separated from each other. In particular, the distance between them is generally chosen to be at least so large that no overlapping regions are produced even after the individual dopants have diffused out.

The TCAD (Technology Computer-Aided Design, TCAD) representation shown below the schematic illustration shows the dopant distribution within the contacted BCD substrate 27110 for simulating a corresponding integrated diode structure. Due to the double structure shown in this embodiment with an upper p-n junction 27050 in the epitaxial layer 48 and a lower p-n junction 27052 in the carrier substrate 49, the side view shown results in an effective constriction of the n-region NBL enclosed in the area of the p-n junctions 27050 and 27052 by the two p-regions PBL surrounding this n-region NBL. Both p-n junctions 27050 and 27052 can be formed to provide independent SPADs with a doping density and field strength distribution suitable for generating an avalanche effect.

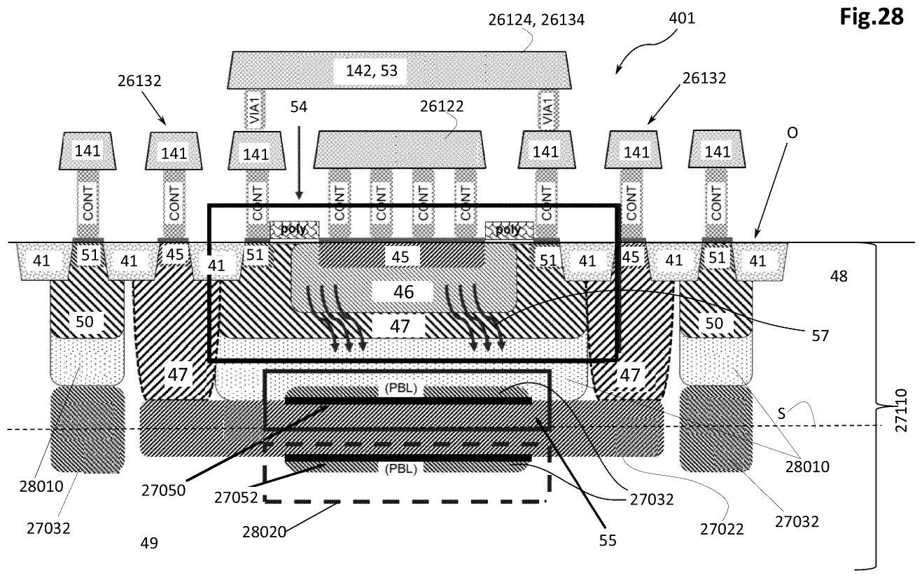

Using corresponding BCD substrates 27110 for further use in BCD technologies, particularly deep SPADs (“deepSPADs”) can thus be created. In particular, sufficient installation space remains above the SPADs provided for the integration of further optoelectronic components. According to the disclosure, a Zener avLED formed above the deep SPAD can therefore be used in particular to realize a particularly compact, vertically constructed entropy source 401, in which individual photons 58 are emitted vertically downwards by the Zener avLED as photon sources 55 preferably in the direction of the upper p-n junction 27050 and are thus provided for detection by a SPAD formed directly below the Zener avLED as photon detector 54 at the upper p-n junction 27050 as single photon detector 55 (see FIG. 28 with associated figure description).

### FIG. 28

FIG. 28 shows a schematic representation of an exemplary first embodiment of a vertical entropy source 401 according to the proposal. A vertical entropy source 401 in the sense of the document presented here is characterized by a vertical arrangement of the photon source 54 relative to the photon detector 55. The horizontal is defined by the surface O of the semiconductor substrate 48 with the epitaxial layer 48. The connecting line of the centers of gravity of the vertical arrangement of the photon source 54 and the photon detector 55 is thus arranged vertically with respect to the surface O of the substrate 49 with the epitaxial layer 48, whereby vertical is to be understood here relatively softly as an angle of more than 30°, optimally 90° of this line with respect to the surface O. The monolithically integrated entropy source 401 shown comprises a photon source 54 and a single photon detector 55, wherein the photon source 54 and the single photon detector 55 are arranged one above the other in the vertical direction in a common substrate 49 made of a semiconductor material. Preferably, the photon source 54 is a single photon source (SPS) 54, configured to provide only single or a few vertical photons 57 at a time. Preferably, the photon source 54 is a light-emitting avalanche Zener diode (Zener-avLED) 54 operated at an operating point below or close to the breakdown voltage. Preferably, the single photon detector 55 is a single photon avalanche diode (second SPAD 55).

The entropy source 401 is preferably formed in a BCD substrate 27110 using BCD technology. Preferably, the BCD substrate 27110 comprises a carrier substrate 49; and an epitaxial layer 48 grown on the carrier substrate 49, wherein a low-lying p-n junction 27050 located in the epitaxial layer was generated between the carrier substrate 49 and the epitaxial layer 48 by a diffusion of dopants introduced into a surface S of the carrier substrate 49 below the epitaxial layer 48 (see FIG. 27). Preferably, the single photon detector 55 forms an avalanche region in a region around the low-lying p-n junction 27050 and comprises an absorption region 47/28010 with a high-voltage p-type well 28010 and a p-type well 47 for converting the p-type junction 27050. “p-type well”) for converting photons into electron-hole pairs, with the absorption region 47/28010 directly adjoining the regions NBL (27022) and PBL (27032) forming the low-lying p-n junction 27050. The fully developed high-voltage p-well 28010 enables optimum connection of the low-lying p-n junction 27050 from the anode.

Preferably, the low-lying p-n junction 27050 is formed at least partially between a low-lying n-layer NBL (27022) as cathode 26132 and a low-lying p-layer PBL (27032) directly adjoining the low-lying n-layer NBL (27022), the absorption region 47/28010 directly adjoins the low-lying p-layer PBL (27032) and is formed essentially as a p-region (optionally comprising an intrinsic region), and an anode 26134 formed as a p+-region directly adjoins the absorption region 47/28010.

In the embodiment example shown, the respective anodes 26124 and 26134 of the photon source 54 and the single photon detector 55 are combined. These can then be electrically contacted, for example, via a common second metallization 142, 53 on the surface S of the BCD substrate 27110. A common and continuous metallization 142, 53 (here exemplified by a second metallization) can also be used to achieve shading for shielding the entire installation space below from electromagnetic wave irradiation from above. The associated cathodes 26122 and 26132 are exemplarily each designed individually and can be electrically contacted via a first associated first metallization 141. The proposed vertical entropy source 401 can be designed as a circular structure (corresponds to a spatial rotation of the illustration plane shown about an imaginary central axis in the vertical direction). However, other configurations of the structure shown are also possible.

### FIG. 29

FIG. 29 shows a schematic representation of an exemplary second embodiment of an entropy source 401 according to the disclosure. The embodiment shown corresponds largely to the first embodiment shown in FIG. 28. The reference signs and their respective assignment to individual features therefore apply accordingly. Compared to FIG. 28, however, the high-voltage p-well 28010 has been structurally replaced by a tapered high-voltage p-well 28010 and a weakly n-doped or intrinsic epitaxial region 29010. Here, the high-voltage p-well 28010 of the absorption region 47/28010 merely forms a narrow channel between the overlying p-well 47, also shown in FIG. 2, and the low-lying p-layer PBL of the low-lying p-n junction 27050. The vicinity of the channel is defined by the weakly n-doped or intrinsic epitaxial region 29010. Through the channel, the low-lying p-n junction 27050 can be connected from the anode without an additional penetration/punch through the weakly n-doped or intrinsic epitaxial region 29010.

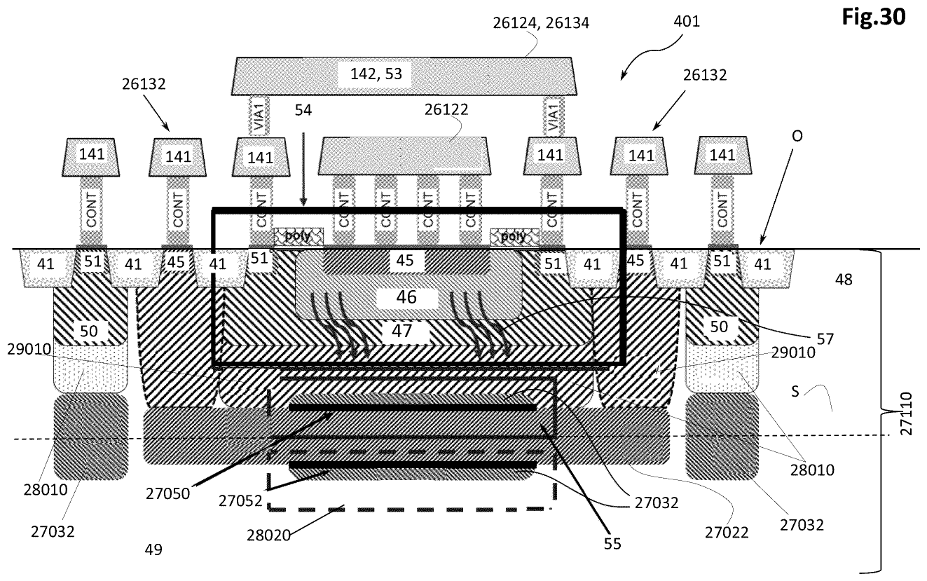

### FIG. 30

FIG. 30 shows a schematic representation of an exemplary third embodiment of an entropy source 401 according to the disclosure. The embodiment shown corresponds largely to the embodiment shown in FIG. 29. The reference signs and their respective assignment to individual features therefore apply accordingly. Compared to FIG. 29, the channel-shaped high-voltage p-well 28010 in the absorption region 47/28010 has been omitted and the weakly n-doped or intrinsic epitaxial region 29010 extends over the entire lower region. In this respect, compared to FIG. 28, the high-voltage p-well 28010 has been structurally replaced by a weakly n-doped or intrinsic epitaxial region 29010. The low-lying p-n junction 27050 is thus only connected from the anode after an additional penetration/punch through the weakly n-doped or intrinsic epitaxial region 29010, which results in a decoupling of possibly several cells arranged next to each other in parallel.

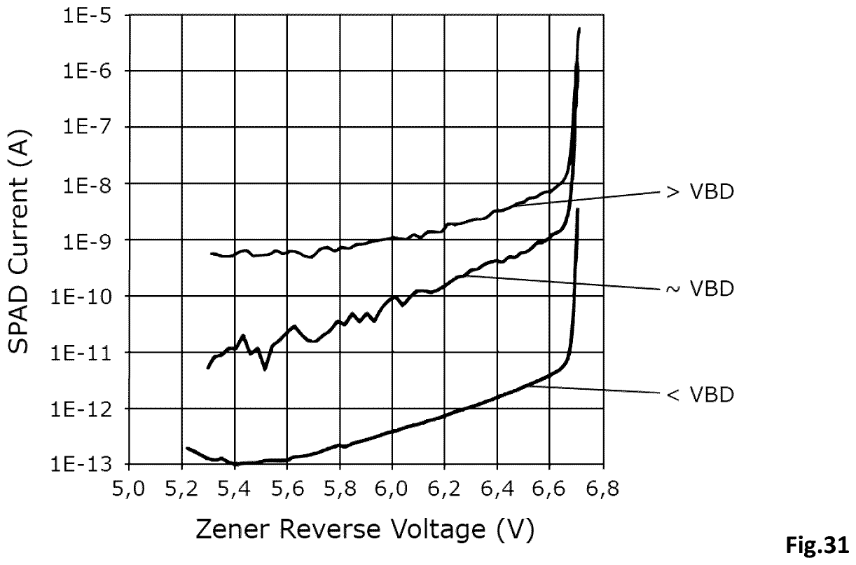

### FIG. 31

FIG. 31 shows a graphical representation of the dependence of the SPAD current as a function of the Zener blocking voltage at different SPAD blocking voltages (less than, equal to, greater than the breakdown voltage) within an entropy source 401 according to the disclosure. The dependence shown clearly shows that the SPAD current increases exponentially with the Zener blocking voltage in the range from 5.6 V to 6.6 V. This applies to all operating modes of the second SPAD 55, i.e. below its own breakdown voltage (<VBD, linear range), close to the breakdown voltage (~ VBD, avalanche range) as well as above the breakdown voltage (>VBD) and therefore also in Geiger mode.

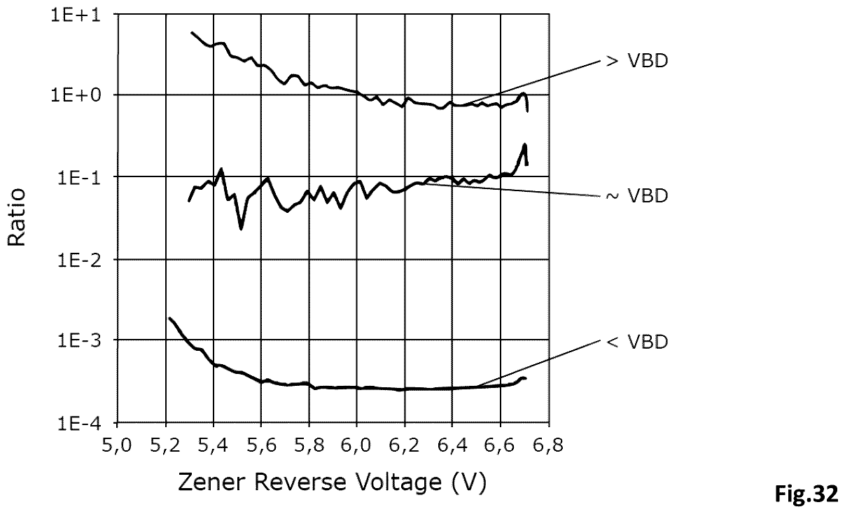

### FIG. 32

FIG. 32 shows a graphical representation of the dependence of the ratio between SPAD current and Zener current as a function of the Zener blocking voltage at different SPAD blocking voltages (less than, equal to, greater than the breakdown voltage) within an entropy source 401 according to the disclosure. The lower curve shown (<VBD) shows that the measured current ratio between the SPAD current and the Zener current for different Zener blocking voltages in the range 5.8 to 6.6 V is approximately 1:4000. In the range of the breakdown voltage (~ VBD) of the second SPAD diode 55, the ratio increases to values around 1:10. This is due to the so-called multiplication factor of the SPAD diode 55, which leaves the linear range in the range of the breakdown voltage. Finally, the upper curve shows the corresponding ratio for the second SPAD diode 55 operated above the associated breakdown voltage (>VBD) (approximately 1:1). This means that when the second SPAD diode 55 is operated above the associated breakdown voltage (>VBD), the generated photocurrent and the Zener current of the Zener avLED (as photon source 55) are approximately equal and a clear measurement signal can be measured by means of the coupling of photons on the second SPAD 55.

### LIST OF REFERENCE SYMBOLS

### Numerical Reference Symbols

### Reference Symbols from 0 to 1000

2 integrated circuit, for example of a microcontroller;
3 Connection;
4 Control device. Preferably, the control device 4 is part of a microelectronic circuit;
6 non-volatile memory, internal and/or external EEPROM and/or external non-volatile memory via a data interface;
8 Random access memory and/or external read/write memory accessible via a data interface;
10-1 first processor 10-1;
10-2 second processor 10-2;
11 Concatenation 11;
12 JATG test interface with JTAG test controller 12 and with JTAG test connections (TDI, TDO, TCK, TM);
14 tightly coupled memory TCM 14;
15 Start address 15 of the boot ROM 16;
16 Non-volatile boot memory (boot ROM) 16;
18 Hashing engine 18 (device for generating a hash from data received by a processor (10-1, 10-2) via the data bus 419);
20 First one-time programmable memory (OTP) (first one-time programmable memory) (OTP) 20;
22 Second one-time programmable memory (OTP) 22 (second one-time programmable memory (OTP));
24 Circuit 24 for deactivating tests, deactivation circuit;
26 Controlled system 26 (e.g. controlled system, controlled system);
28 Quantum random number generator 28;
30 further internal non-volatile memory 30 and/or further external non-volatile memory accessible via a data interface;
32 Interface 32 to a controlled system 26;
40 Exemplary first SPAD diode 40 for use as a sensor element of a single photon detector;
41 Insulation, for example Shallow Trench Insulation STI 41 of the exemplary SPAD diode 40 or LOCOS insulation;
42 Anode contact 42 of the exemplary SPAD diode 40;
43 Cathode contact 43 of the exemplary SPAD diode 40. The cathode contact 43 of the exemplary SPAD diode 40 is preferably made of indium tin oxide (ITO) or another transparent and electrically conductive material;
44 Optical waveguide 44 for transporting the photons from the first SPAD diode 54 to the second SPAD diode 55. The optical waveguide 44 is made of a covering oxide 44 or optically transparent insulating layer 44 of the exemplary SPAD diode 40;
45 highly doped first junction region 45 of a first conductivity type, also referred to as n+S/D implantation. For example, in a CMOS technology with a p-doped wafer material, it may be an n+ doped region in the semiconducting substrate material of the SPAD diode 54;
46 first doped well 46 of a second conductivity type. For example, in a CMOS technology with a p-doped wafer material, it may be a p−-doped region in the semiconducting substrate material of the first SPAD diode 40;
47 second doped well 47 of a second conductivity type. For example, in a CMOS technology with a p-doped wafer material, it may be a p−-doped region in the semiconducting substrate material 49. It may be a portion of a SPAD diode 40 used as a photon source 54 or photon detector 55 in a horizontal entropy source 401. In the examples of FIGS. 28 to 30, it is a p-well of the Zener diode that serves as the photon source 54 of the vertical entropy source 401;
48 epitaxial layer 48 of a second conductivity type. For example, in a CMOS technology with a p-doped wafer material, it may be a p-doped epitaxial layer in the semiconducting substrate material of the SPAD diode 40;
49 Base material 49 and/or semiconductor substrate 49 of the exemplary semiconducting monocrystalline wafer or wafer piece, which preferably has a second conductivity type. In a CMOS technology with a p-doped wafer material, this is, for example, a p-doped single-crystalline semiconductor wafer or a p-doped single-crystalline semiconductor wafer piece (die);
50 second doped well of a second conductivity type (i.e. a p-doped region in the 50 case of a p-doped substrate) below the anode contact. In a CMOS technology with a p-doped wafer material, for example, this may be a p-doped region in the semiconducting substrate material of the SPAD diode 40;
51 highly doped second junction region of a second conductivity type, also referred to as p+S/D implantation. In a CMOS technology with a p-doped wafer material, for example, this can be a p+-doped region in the semiconducting substrate material of the SPAD diode 40;
52 insulation, for example an oxide or similar;
53 Metal cover of the fiber optic cable 44;
54 First SPAD diode. The first SPAD diode 55 serves at least temporarily as a light source for irradiating the second SPAD diode 45 with photons from the first SPAD diode 54;
55 Second SPAD diode 55. The second SPAD diode 55 serves, for example, at least temporarily as a photodetector for the light of the first SPAD diode 54.
56 Surface 56 of the wafer as defined in this document;
57 light 57 of the first SPAD diode 54 emitted vertically upwards (or downwards in FIGS. 28 to 30) in a direction perpendicular to the surface 56;
58 light 58 transported horizontally in the optical waveguide 44, which is a part of the light 57 radiated vertically from the first SPAD diode 54 into the optical waveguide 44;
59 light 59 of the first SPAD diode 54, which was emitted by the first SPAD diode 54 as vertical light 57 into the optical waveguide 44 and then transported horizontally from the optical waveguide 44 to the second SPAD diode 55;
61 Data records;
62 digital signature;
63 Interface;
64 Data bus interface;
65 external data bus. For the purposes of the present document, the external data bus may be a wired data connection or a wireless data connection;
81 Interface 81;
82 Bus arbiter 82;
83 Reset circuit 83;
84 Analog input processing 84;
85 Analog-to-digital converter 85;
86 Digital signal processing 86;
87 Digital-to-analog converter 87
88 Analog output processing 88;
89 one or more external analog signals 89
90 Analog output signals 90;
91 Voltage transformer 91;
92 Preferably, the clock generator 92 generates the system clock 2106. Preferably, the watchdog 404.5 monitors the system clock 2106 for too low or too high speed and for clock jitter. If the system clock 2106 of the clock generator 92 shows a clock jitter, the watchdog 404.5 reports an error to the processor 10-1 via the data bus 419 or via the interrupt line 420;
140 Contact;
141 Metal 1 cables;
142 Metal 2 pipes/metal 2 covers;
241 Gates
242 Gates
301 Interface
401 Entropy source 401;
402 High-frequency amplifier 402;
403 Analog-Digital-Converter (ADC) 403;
404 Evaluation circuit 404;
404.1 Constant 404.1;
404.2 Comparator 404.2;
404.3 Time to pseudo-random number converter 404.3 (TPRC);
404.4 Entropy extraction device 404.4;
404.5 Watchdog 404.5;
404.6 optional, additional, linear feedback shift register. The feedback is preferably a simple primitive polynomial to generate pseudo-random bit sequences;
404.7 Signal multiplexer 404.7;
404.8 Finite State Machine (finite automata);
404.9 RAM or FIFO;
404.10 Finish Flag;
404.11 Processor 10-1, 10-2;
405 Voltage signal of the entropy source 401;
406 Amplifier output signal 406 of the high-frequency amplifier 402;
407 Output signal 407 of the analog-to-digital converter 403. of the digital bit value 407 of the analog-to-digital converter 403. Bit widths other than 1 bit are conceivable;
408 Signal of the constants 404.1;
409 Output signal 409 of the comparator 404.2;
410 Output 410 of the time-to-random number converter 404.3 (TPRC); Output of entropy extraction 404.4;
412 Seed S;
413 Voltage monitor;
414 Signal lines;
415 The pulse stretching circuit 2023 (MF) generates the single-synchronized voltage signal 415 from the output signal 407 of the analog-to-digital converter 403 as a function of the system clock 2106;
416 Selection signal;
417 Pseudo-random signal line;
418 Quantum random data words;
419 internal data bus 419 of the quantum random number generator 28. Preferably, this is the internal data bus of the control device 4;
420 Interrupt signal 420 of the watchdog 404.5 of the quantum random number generator 28 or the control device 4;
500 Flowchart 500 of the entropy extraction process;
501 first step 501 with determination of the first value of the output 410 of the time-to-pseudo-random number converter 404.3 and the second value of the output 410 of the time-to-pseudo-random number converter 404.3 and storage in a shift register of the entropy extraction 404.4;
502 second step of comparing the first value with the second value;
503 third step of evaluating the first value and the second value and generating the quantum random bit 411;
601 first spikes;
602 second spikes;
603 Cutting level;

### Numerical Reference Symbols from 1001 to 2999

2021 monitored internal voltages 2021;
2022 Line 2022 to prevent the use of a quantum random bit 411 by the finite state machine (finite state machine) 404.8;
2023 Pulse extension circuit 2023, typically in the form of a monoflop MF. The monoflop MF extends a pulse on the line of the digital bit value 407 of the analog-to-digital converter 403 to a temporal length of at least one clock period of the system clock 2106;
2101 Shift register bus 2101 of the time to pseudo-random number converter 404.3 (TPRC);
2102 Feedback multiplexer 2102 of the time-to-random number converter 404.3 (TPRC);
2103 Shift register controller 2103 of the time-to-pseudo-random number converter 404.3 (TPRC). The shift register controller 2103 of the time to pseudo-random number converter 404.3 (TPRC) switches the n shift register bits (SB₁ to SBₙ) from the serial shift register operation mode to the parallel shift register operation mode via the internal data bus 419 by means of a parallel to serial shift register mode switching line 2107 at the instigation of a processor (10-1, 10-2), for example, so that the shift register bits (SB₁ to SBₙ) of the shift register use the current logic value of the TPRG data bus 2110 of the time-to-random number converter 404.3 (TPRC) as the seed of the linear feedback shift register. The shift register controller 2103 of the time-to-pseudo-random number converter 404.3 (TPRC), for example, activates the n shift register bits (SB₁ to SBₙ) from the serial shift register operation mode to the serial shift register operation mode at the instigation of a processor (10-1, 10-2) via the internal data bus 419 by means of a parallel to serial shift register mode switching line 2107, so that the first shift register bit SB₁ of the n shift register bits (SB₁ to SBₙ) is the current logic value of the shift register reload value line 2104 of the time to pseudo-random number converter 404.3 (TPRC) with the next clock pulse of the system clock 2106 and the other shift register bits SBⱼ of the shift register bits (SB₁ to SBₙ) of the shift register accept the respective logic value of their predecessor shift register bit SB₍ⱼ₋₁₎ with the next clock pulse of the system clock 2106.
   One or more processors (10-1, 10-2) can write and/or read one or more registers of the shift register controller 2103 of the time to pseudorandom number converter 404.3 (TPRC) via the internal data bus 419.
   Preferably, the processors (10-1, 10-2) can write to one or more registers of the shift register controller 2103 of the time-to-pseudo-random number converter 404.3 (TPRC) via the internal data bus 419 to determine the logical value of the TPRG data bus 2110 of the time-to-pseudo-random number converter 404.3 (TPRC) that the shift register uses as the next seed value. This function may be blocked by an access code in the OPT II memory 22 by means of the disable circuit 24.
   Preferably, however, the shift register controller 2103 of the time to pseudorandom number converter 404.3 (TPRC) generates from the data stream of quantum random bits 411 in a special internal register of the shift register controller 2103 of the time to pseudorandom number converter 404.3 (TPRC) the logical value of the TPRG data bus 2110 of the time-to-pseudo-random number converter 404.3 (TPRC), which the shift register uses as the next seed value. This has the advantage that the behavior of the circuit then depends on a quantum process and is therefore unpredictable. If the detection circuit 2113 detects an illegal value of the state vector of the n shift register bits SB₁ to SBₙ, it reports this to the shift register controller 2103 of the time-to-random number converter 404.3 (TPRC), which then takes action. One such typical action is to reset the state vector of the n shift register bits SB₁ to SBₙ to a predetermined value, for example the seed value of the current value of the TPRG data bus 2110 of the time-to-pseudo-random number converter 404.3 (TPRC) or another predefined value.
   Preferably, the shift register controller 2103 of the time-to-pseudo-random number converter 404.3 (TPRC) activates or deactivates the data transfer of the n shift register bits (SB₁ to SBₙ) at the next clock edge of the clock edge direction used typically bit-selectively via the shift register bit activation bus 2109.
   Preferably, however, the shift register controller 2103 of the time to pseudorandom number converter 404.3 (TPRC) generates the logic reload value of the feedback polynomial selection register 2112 from the data stream of the quantum random bits 411 in a special internal register of the shift register controller 2103 of the time to pseudorandom number converter 404.3 (TPRC) and loads this reload value into the feedback polynomial selection register 2112
   By means of a line 2022 for the utilization of a quantum random bit 411 by the finite state machine 404.8, the shift register controller 2103 of the time to pseudorandom number converter 404.3 (TPRC) preferably prevents finite state machine 404.8 from using such quantum bits 411 that shift register controller 2103 of time-to-pseudo-random number converter 404.3 (TPRC) has already used;
2104 A shift register reload value line 2104 of the time to pseudorandom number converter 404.3 (TPRC) which selects the next serial reload value for the first shift register bit SB₁ of the time to pseudorandom number converter 404.3 (TPRC) when a feedback network of the m feedback networks (RKN₁ to RKNₘ) of the time to pseudorandom number converter 404.3 (TPRC) is selected by the feedback multiplexer 2102 and when the serial shift mode is set by the shift register controller 2103 as n, which is loaded into the first shift register bit SB₁ of the time to pseudorandom number converter 404.3 (TPRC) with the next clock pulse of the system clock 2106;
2105 Threshold value 2105;
2106 System clock 2106 of the quantum random number generator 28 and the time to pseudo-random number converter 404.3 (TPRC) of the quantum random number generator 28;
2107 Parallel-to-serial shift register mode switching line 2107, which can switch the n shift register bits (SB₁ to SBₙ) from the serial shift register operating mode to the parallel shift register operating mode depending on their logical value;
2109 Shift register bit activation bus 2109 with typically n shift register bit activation lines of the respectively associated n shift register bits (SB₁ to SBₙ) for the respective, preferably bit-selective activation of the data transfer of the n shift register bits (SB₁ to SBₙ) at the next clock edge of the clock edge direction used, wherein the respective data source of the data transfer is determined by the respective shift register bit of the respective associated n shift register bits (SB₁ to SBₙ) by one or more parallel-to-serial shift register mode switching lines 2107 of the shift register controller 2103 of the time-to-random number converter 404.3 (TPRC) is determined;
2110 TPRG data bus 2110 of the time-to-pseudo-random number converter 404.3 (TPRC), which typically preferably comprises one data line for each shift register bit of the shift register bits (SB₁ to SBₙ) of the time-to-pseudo-random number converter 404.3 (TPRC), the logical content of which represents a bit of the TPRG data bus 2110. These bits of the TPRG data bus 2110 of the time to pseudorandom number converter 404.3 (TPRC) typically form the seed of the time to pseudorandom number converter 404.3 (TPRC), which the shift register controller 2103 of the time-to-pseudo-random number converter 404.3 (TPRC) loads into the shift register cells of the shift register bits (SB₁ to SBₙ) via the internal data bus 1901 at the command of a processor (10-1, 10-2);
2111 Control register 2111 of the feedback multiplexer 2102 of the time to pseudo-random number converter 404.3 (TPRC). Preferably, the shift register controller 2103 of the time to pseudorandom number converter 404.3 (TPRC) loads the control register 2111 of the feedback multiplexer 2102 of the time to pseudorandom number converter 404.3 (TPRC) and thereby selects the feedback polynomial by selecting the current feedback network of the feedback networks (RKN₁ to RKNₘ). Preferably, shift register controller 2103 of time to pseudorandom number converter 404.3 (TPRC) changes the value of control register 2111 of feedback multiplexer 2102 only when a quantum random bit 411 has been successfully generated or when shift register controller 2103 of time to pseudorandom number converter 404.3 (TPRC) receives at least one start pulse for the
2112 Feedback polynomial selection register 2112;
2113 Detection circuit 2113 for detecting an illegal value of the state vector of the n shift register bits SB₁ to SBₙ;
2201 First exemplary pulse 2201 of the entropy source 401 on the voltage signal 405 of the entropy source 401;
2202 Second exemplary pulse 2202 of the entropy source 401 on the voltage signal 405 of the entropy source 401;
2203 third exemplary pulse 2203 of the entropy source 401 on the voltage signal 405 of the entropy source 401;
2204 fourth exemplary pulse 2204 of the entropy source 401 on the voltage signal 405 of the entropy source 401;
2211 First exemplary pulse of the single-synchronized voltage signal 415 generated from the first exemplary pulse 2201 of the entropy source 401;
2212 second exemplary pulse of the single-synchronized voltage signal 415 2212 generated from the second exemplary pulse 2202 of the entropy source 401;
2213 third exemplary pulse of the single-synchronized voltage signal 415 generated from the third exemplary pulse 2203 of the entropy source 401;
2214 fourth exemplary pulse of the single-synchronized voltage signal 415 generated from the fourth exemplary pulse 2204 of the entropy source 401;
2301 High-side transistor 2301 of the first half-bridge of the charge pump for the entropy source 411;
2302 Low-side transistor 2302 of the first half-bridge of the charge pump for the entropy source 411;
2303 second high-side transistor 2303 of the second half-bridge of the charge pump for the entropy source 411. In the example shown in FIG. 23, the second high-side transistor 2301 of the charge pump for the entropy source 411 is connected as a MOS diode;
2305 Transfer transistor 2305 of the charge pump for the entropy source 411. In the example shown in FIG. 23, the transfer transistor 2305 of the charge pump for the entropy source 411 is connected as a MOS diode;
2306 first energy store, here in the example of FIG. 23 a first capacitor 2306;
2307 second energy store, here in the example of FIG. 23 a second capacitor 2307;
2311 Control contact (gate) 2311 of the high-side transistor 2301 of the first half-bridge of the charge pump for the entropy source 411;
2312 Control contact (gate) 2311 of the low-side transistor 2302 of the first half-bridge of the charge pump for the entropy source 411;
2313 Control contact (gate) 2311 of the second high-side transistor 2303 of the charge pump for the entropy source 411;
2320 Output node 2320 of the first half-bridge of the charge pump for the entropy source 411;
2321 Output node 2321 of the charge pump for the entropy source 411;
2330 Control device 2330 of the voltage transformer 91 for supplying the entropy source 411 with a sufficient operating voltage of the supply voltage line V_{ENT} of the entropy source 411 with respect to the reference potential line GND at the reference potential.
2401 Exemplary imaginary semiconductor die 2401 of the integrated circuit 2, for example the microcontroller, for explaining the optimum placement of a quantum random number generator in an exemplary layout of a microintegrated circuit 2;
2402 Connection pads (connection surface) of a line of the micro-integrated circuit 2;
2403 Pad frame of the micro-integrated circuit 2;
2404 Wiring range of the micro-integrated circuit 2;
2405 inner area of the micro-integrated circuit 2;

### Numerical Reference Symbols from 3000 to 3999

3000 Creation of a socket descriptor;
3010 Binding the socket descriptor to a port and an IP address;
3020 passive waiting state and waiting for connection requests from an integrated circuit 2, for example a microcontroller, of a client;
3030 Establishing a connection from the first processor 10-1 of the computer (here of the exemplary micro-integrated circuit 2) of the server to the first processor 10-1 of the computer (here of the exemplary micro-integrated circuit 2) of the client by the first processor 10-1 of the computer (here of the exemplary micro-integrated circuit 2) of the server;
3040 Generation of a quantum random number 411 and generation of a public key and a private key by means of an RSA method by the first processor 10-1 of the computer (here of the exemplary microintegrated circuit 2) of the server by means of a quantum random number generator 28 QRNG and an RSA method.
3050 Waiting for an encrypted message of the first processor 10-1 of the computer (here of the exemplary microintegrated circuit 2) client by the first processor 10-1 of the computer (here of the exemplary microintegrated circuit 2) of the server;
3060 Decrypting the message of the private key cached in a memory of the computer (here the exemplary microintegrated circuit 2) from step 3040 according to the RSA method
3070 Encryption of the message of the first processor 10-1 of the computer (here of the exemplary microintegrated circuit 2) of the server by means of the public key of the first processor 10-1 of the computer (here of the exemplary microintegrated circuit 2) of the client from step 3040 according to the RSA method by the first processor 10-1 of the computer (here of the exemplary microintegrated circuit 2) of the server;
3080 Sending the encrypted message stored in the buffer memory of the computer (here of the exemplary microintegrated circuit 2) of the server encrypted message stored in the cache of the computer (here of the exemplary microintegrated circuit 2) of the server to the first processor 10-1 of the computer (here of the exemplary microintegrated circuit 2) of the client via the data bus interface 64 of the first processor 10-1 of the computer (here of the exemplary microintegrated circuit 2) of the server and via the data bus 65 and via the data interface 64 of the first processor 10-1 of the computer by the first processor 10-1 of the computer (here of the exemplary microintegrated circuit 2) of the server;
3090 Execution of the close( ) function and closing of the open connection to a socket, in this case the client's socket, and termination of communication with the client by the first processor 10-1 of the computer (in this case of the exemplary microintegrated circuit 2) of the server;
3100 generating a socket descriptor by the first processor 10-1 of the computer (here the exemplary micro-integrated circuit 2) of the client and making a connection request to the first processor 10-1 of the computer (here the exemplary micro-integrated circuit 2) of the server using the port and IP address determined in the step 3010 by the first processor 10-1 of the computer (here the exemplary micro-integrated circuit 2) of the client;
3110 Establish a connection between the server socket from step 3010 and the client socket from step 3100;
3120 Generating a quantum random number based on quantum random bits 411 and generating a public key and a private key by means of an RSA method by the first processor 10-1 of the computer (here of the exemplary microintegrated circuit 2) of the client by means of a quantum random number generator 28 QRNG and an RSA method.
3130 Encrypting the client's own message using the public key of the first processor 10-1 of the computer (here of the exemplary microintegrated circuit 2) of the server from step 3040 using the RSA method by the first processor 10-1 of the computer (here of the exemplary microintegrated circuit 2) of the client;
3140 Sending the encrypted message of the client to the first processor 10-1 of the computer (here of the exemplary micro-integrated circuit 2) of the server by the first processor 10-1 of the computer (here of the exemplary micro-integrated circuit 2) of the client;
3150 Waiting for an encrypted message of the first processor 10-1 of the computer (here of the exemplary microintegrated circuit 2) of the server by the first processor 10-1 of the computer (here of the exemplary microintegrated circuit 2) of the client and receiving a message of the first processor 10-1 of the server the first processor 10-1 of the computer (here of the exemplary microintegrated circuit 2) of the client and storing the thus received and typically encrypted message of the first processor 10-1 of the server in a temporary buffer of the computer (here of the exemplary microintegrated circuit 2) by the first processor 10-1 of the computer (here of the exemplary microintegrated circuit 2) of the client and reading the incoming data of the first processor 10-1 of the server by the first processor 10-1 of the computer (here of the exemplary microintegrated circuit 2) of the client by executing the function recv( ) from a socket descriptor, in this case from the socket descriptor of the first processor 10-1 of the computer (here of the exemplary microintegrated circuit 2) of the client from step 3100 and store the read data preferably in a temporary cache of the computer (here of the exemplary microintegrated circuit 2) of the client by the first processor 10-1 of the computer (here of the exemplary microintegrated circuit 2) of the client;
3160 Decryption of an encrypted message received by the first processor 10-1 of the computer (here of the exemplary microintegrated circuit 2) of the client, encrypted message of the first processor 10-1 of the computer (here of the exemplary microintegrated circuit 2) of the server by the first processor 10-1 of the computer (here of the exemplary microintegrated circuit 2) of the client by means of the execution of the function Decrypt( ) by the first processor 10-1 of the computer (here of the exemplary microintegrated circuit 2) of the client using the private key of the first processor 10-1 of the computer (here of the exemplary microintegrated circuit 2) of the client from step 3120 by means of the RSA method and subsequent storage of the message thus decrypted in a temporary buffer of the computer (here of the exemplary microintegrated circuit 2) of the client by the first processor 10-1 of the computer (here of the exemplary microintegrated circuit 2) of the client;
3170 Closing of the open connection to the socket by the first processor 10-1 of the computer (here of the exemplary microintegrated circuit 2) of the client and termination of the communication with the first processor 10-1 of the computer (here of the exemplary microintegrated circuit 2) of the server by the first processor 10-1 of the computer (here of the exemplary microintegrated circuit 2) of the client
3200 Generation of two different prime numbers p and q and the product n=p*q and the result of the Euler phi function phi=(p−1)(q−1) by the first processor 10-1 of the computer (here of the exemplary microintegrated circuit 2) of the server using the KeyExchangeServer( ) function;
3210 Generation of a number e which is different from phi by calling the function setE( ) by the first processor 10-1 of the computer (here of the exemplary microintegrated circuit 2) of the server, wherein the number phi is that from step 3200 and wherein different from phi in the sense of the present document means that there is no natural number other than the number one which simultaneously divides the number e and the number phi simultaneously by an integer;
3220 Calculation of the multiplicative inverse of the number e by means of the first processor 10-1 of the computer (here the exemplary microintegrated circuit 2) of the server using the function findD( ) so that (e*d) mod phi=1;
3230 Waiting for an incoming message from the first processor 10-1 of the computer (here of the exemplary microintegrated circuit 2) of the client, which should typically comprise the public key of the client, by the first processor 10-1 of the computer (here of the exemplary microintegrated circuit 2) of the server and reading the incoming data from a socket descriptor, in this case, the socket descriptor of the client by the first processor 10-1 of the computer (here of the exemplary microintegrated circuit 2) of the server and storing the read data preferably in a temporary buffer of the computer (here of the exemplary microintegrated circuit 2) by the first processor 10-1 of the computer (here of the exemplary microintegrated circuit 2) of the server;
3240 Sending the public key (d,n) of the first processor 10-1 of the computer (here of the exemplary microintegrated circuit 2) of the server from steps 3200 and 3220 by the first processor 10-1 of the computer (here of the exemplary microintegrated circuit 2) of the server to the first processor 10-1 of the computer (here of the exemplary microintegrated circuit 2) of the client via a socket descriptor, in this case the socket descriptor of the client from step 3030;
3245 Exit of the KeyExchangeServer( ) function by the first processor 10-1 of the computer (here of the exemplary micro-integrated circuit 2) of the server;
3250 Generation of the prime number p and generation of the prime number q different from q and generation of the product n=p*q and generation of the Euler phi function phi=(p−1)(q−1) in each case by the first processor 10-1 of the computer (here of the exemplary microintegrated circuit 2) of the client by means of the function KexExchangeClient( );
3260 Generating an integer e which is divisively different from the number phi 3260 from step 3250 by the first processor 10-1 of the computer (here of the exemplary microintegrated circuit 2) of the client by means of the function setE( ) where divisively different in the sense of the present document means that there is no natural number other than the number one which simultaneously divides the number e and the phi without remainder;
3270 Calculation of the multiplicative inverse of the number e by the first processor 10-1 of the computer (here of the exemplary microintegrated circuit 2) of the client using the function findD( ) so that (e*d) mod phi=1;
3280 Sending the public keys (d,n) of the first processor 10-1 of the computer (here of the exemplary microintegrated circuit 2) of the client from steps 3250 and 3270 to the first processor 10-1 of the computer (here of the exemplary microintegrated circuit 2) of the server by the first processor 10-1 of the computer (here of the exemplary microintegrated circuit 2) of the client, wherein the first processor 10-1 of the computer (here of the exemplary microintegrated circuit 2) of the client sends data via a socket descriptor, in this case the socket descriptor of the client from step 3100, by means of the send( ) function;
3290 Waiting for an incoming message of the first processor 10-1 of the computer (here of the exemplary microintegrated circuit 2) of the server with the public key of the first processor 10-1 of the computer (here of the exemplary microintegrated circuit 2) of the server by the first processor 10-1 of the computer (here of the exemplary microintegrated circuit 2) of the client and reading incoming data of the first processor 10-1 of the computer (here of the exemplary microintegrated circuit 2) of the server from a socket descriptor, in this case from the socket descriptor of the client from step 3100, by the first processor 10-1 of the computer (here of the exemplary microintegrated circuit 2) of the client by means of the recv( ) function and storing this data in a temporary buffer of the computer (here of the exemplary microintegrated circuit 2) of the client by the first processor 10-1 of the computer (here of the exemplary microintegrated circuit 2) of the client;
3295 Exit of the KeyExchangeClient( ) function by the first processor 10-1 of the computer (here of the exemplary micro-integrated circuit 2) of the client;
3300 Generation of a random number by means of a quantum random number generator 28 QRNG by the calling first processor 10-1 and determination of a prime number as a function of this random number by the calling first processor 10-1 and storage of this prime number as a variable p in the memory of the computer (here of the exemplary microintegrated circuit 2), of which the calling first processor 10-1 is a part;
3110 Generation of a second random number by means of a quantum random number generator 28 QRNG by the calling first processor 10-1 and determination of a prime number as a function of this random number by the calling first processor 10-1 and storage of this prime number as a variable q in the memory of the computer (here of the exemplary microintegrated circuit 2), of which the calling first processor 10-1 is a part;
3320 Checking whether the logical statement q==p is valid by the calling first 3320 processor 10-1 and repeating the steps from step 3310 by the calling processor 10-1 if this statement is valid;
3330 Calculate the product n=p*q by the calling process location 10-1;
3340 Calculate the Euler phi function phi=(q−1)*(p−1) by the calling process location 10-1;
3350 Exit of the setPrimes( ) function by the calling processor 10-1;
3400 Sequence of the function setE( ) When the function setE( ) is called in step 3400, the caller, in the case of the present document the first processor 10-1 of the computer (here of the exemplary microintegrated circuit 2) of the server or the first processor 10-1 of the computer (here of the exemplary microintegrated circuit 2) of the client, generates a random number e for which it is the case that it is divisor-insensitive to the number phi. In the sense of the present document, divisor-unique means that there is no natural number other than the number one which simultaneously divides the number e and phi. The calling processor 10-1 can generate the number e both by a random number of the quantum random number generator 28 QRNG and by a pseudo-random number generator PRNG as well as by up-iterating an integer number starting with 2. However, generation using the quantum random number generator 18 QRNG is preferred;
3410 Check whether the logical statement gcd (e,phi)!=1 is fulfilled by the calling processor 10-1 and repeat step 3400 by the calling processor 10-1 if the logical statement is fulfilled. The calling processor 10-1 uses this function gcd(a,b) to calculate the greatest common divisor of the transfer parameters a, b and returns the result to the calling processor 10-1;
3420 Exit the setE( ) function and return the current value of e as the return value to the calling processor 10-1 by the calling processor 10-1 if the logical statement gcd (e,phi)!=1 is not fulfilled;
3500 Initialization of a variable d with 0 by the calling processor 10-1, here the first processor 10-1 of the computer (here of the exemplary micro-integrated circuit 2) of the client or the first processor 10-1 of the computer (here of the exemplary micro-integrated circuit 2) of the server;
3510 Adding the number 1 to the number d by the calling processor 10-1;
3520 Check whether the logical statement (e*d)(mod phi)==1 is fulfilled by the calling processor 10-1 and repeat the steps from step 3510 if the logical statement (e*d)(mod phi)==1 is not fulfilled;
3530 Exit of the function findD( ) by the calling processor 10-1, if the logical statement (e*d)(mod phi)==1 is fulfilled, and return of the current value of d as return value to the calling processor 10-1, in the case of the present document the first processor 10-1 of the computer (here of the exemplary micro-integrated circuit 2) of the server or the first processor 10-1 of the computer (here of the exemplary micro-integrated circuit 2) of the client;
3600 Server;
3610 Client;
3620 Sending the public key of the server 3600 based on a first quantum random number of the quantum random number generator 28 QRNG of the computer (here of the exemplary micro-integrated circuit 2) of the server 3600 via a non-tap-proof channel to the first processor 10-1 of the computer (here of the exemplary micro-integrated circuit 2) of the client 3610 by the first processor 10-1 of the computer (here of the exemplary micro-integrated circuit 2) of the server 3600;
3630 Generating a pseudorandom number PZ or a random number generated in another way by the first processor 10-1 of the computer (here of the exemplary microintegrated circuit 2) of the client 3610 and storing the pseudorandom number PZ or the random number generated in another way in a memory of the computer (here of the exemplary microintegrated circuit 2) of the client 3610. the differently generated random number in a memory of the computer (here of the exemplary microintegrated circuit 2) of the client 3610, the first processor 10-1 of the computer (here of the exemplary microintegrated circuit 2) of the client 3610 and generating a first private key of the client 3610 and a first public key of the client 3610 using this pseudorandom number PZ and this differently generated random number, respectively. this differently generated random number by the first processor 10-1 of the computer (here of the exemplary microintegrated circuit 2) of the client 3610 and encryption of this first public key of the client 3610 by means of the public key of the server 3600 by the first processor 10-1 of the computer (here of the exemplary microintegrated circuit 2) of the client 3610 and sending the encrypted first public key of the client 3610 to the first processor 10-1 of the computer (here of the exemplary microintegrated circuit 2) of the server 3600 by the first processor 10-1 of the computer (here of the exemplary microintegrated circuit 2) of the client 3610;
3640 Decrypting the message of the first processor 10-1 of the computer (here of the exemplary microintegrated circuit 2) of the client 3610 with the first private key of the first processor 10-1 of the computer (here of the exemplary microintegrated circuit 2) of the client 3610, so that the first processor 10-1 of the computer (here of the exemplary microintegrated circuit 2) of the server 3600 has the first public key of the client 3610, without this being known to third parties, and generating a further, second quantum random number QZ2 by the first processor 10-1 of the computer (here of the exemplary microintegrated circuit 2) of the server 3600 by means of the quantum random number generator 28 QRNG, wherein the bit width of this second quantum random number is preferably equal to the bit width of the random number PZ of the client 3610, and encrypting the second quantum random number QZ2 with the first public key of the first processor 10-1 of the computer (here of the exemplary microintegrated circuit 2) of the client 3610 to form an encrypted second quantum random number QZ2′ by the first processor 10-1 of the computer (here of the exemplary microintegrated circuit 2) of the server 3600, wherein, for example, the first public key of the client 3610 may be the random number PZ of the client and wherein, in that case, the first processor 10-1 of the computer (here of the exemplary microintegrated circuit 2) of the server 3600 may encrypt the second quantum random number QZ2, for example by bitwise XORing the second quantum random number QZ2 with PZ to form an encrypted second quantum random number QZ2′, and sending the encrypted second quantum random number QZ2′ to the first processor 10-1 of the computer (here of the exemplary microintegrated circuit 2) of the client 3610 by the first processor 10-1 of the computer (here of the exemplary microintegrated circuit 2) of the server 3600.
3650 Decryption of the encrypted second quantum random number QZ2′ using the first private key of the first processor 10-1 of the computer (here the exemplary microintegrated circuit 2) of the server 3600 to the second quantum random number QZ2 by the first processor 10-1 of the computer (here the exemplary microintegrated circuit 2) of the client 3610. If the first processor 10-1 of the computer (here of the exemplary microintegrated circuit 2) has determined the second encrypted quantum random number QZ2′ by bitwise XORing of the random number PZ with the second quantum random number QZ2, the first processor 10-1 of the computer (here of the exemplary microintegrated circuit 2) of the client 3610 can decrypt, for example, by bitwise XORing the encrypted second quantum random number QZ2′ with the random number PZ known to it to form the second quantum random number QZ2. Preferably, the first processor 10-1 of the computer (here of the exemplary microintegrated circuit 2) of the client 3610 uses the second quantum random number QZ2 now available to it as the basis for generating a second private key and a second public key in accordance with an asymmetric encryption method. The asymmetric encryption method may, for example, be the RSA method (APPENDIX). The first processor 10-1 of the computer (here of the exemplary microintegrated circuit 2) of the client 3610 now sends its second public key to the server 3600 via the non-tap-proof channel, preferably encrypting this second public key of the client 3610 with the public key of the server 3600. The server 3600 decrypts the encrypted second public key of the client 3610 and then uses this second public key of the client for the encryption of further messages to the first processor 10-1 of the computer (here of the exemplary microintegrated circuit 2) of the client 3610. Preferably, the first processor 10-1 of the computer (here of the exemplary microintegrated circuit 2) of the server 3600 generates and sends a new public key based on a new quantum random number of its quantum random number generator 28 QRNG encrypted with the second public key of the client 3610 after a predetermined time or after sending a predetermined amount of data to the processor 10-1 of the computer (here of the exemplary microintegrated circuit 2) of the client 3610. Preferably, the first processor 10-1 of the computer (here of the exemplary microintegrated circuit 2) of the server 3600 and the first processor 10-1 of the computer (here of the exemplary microintegrated circuit 2) of the client then perform the previously described procedure again, so that the keys change permanently. This also makes it impossible for a quantum computer to break the keys;
3700 Method for generating a quantum random number QZ 418 with m quantum random bits 411;
3710 Generation of a random single photon current (57, 58, 59, 44) by means of one or more photon sources 54 and/or one or more silicon LEDs 54 and/or one or more first SPAD diodes (54), wherein preferably the photon sources 54 and/or the silicon LEDs 54 and/or the first SPAD diodes (54) are manufactured integrally in a common semiconductor substrate 49;
3720 Transmission of the random single photon current (57, 58, 59, 44) by means of the semiconductor substrate (49, 48) and/or by means of an optical waveguide 44 different from the semiconductor substrate (49, 48) and/or directly between the components to one or more photon detectors 55 and/or one or more second SPAD diodes (55);
3730 Conversion of the random single photon current (57, 58, 59, 44) into a detection signal in the form of a voltage signal 405 of the entropy source 401, which preferably comprises photon sources 54 and/or one or more silicon LEDs 54 and/or one or more first SPAD diodes (54) and the means for light transmission, such as the semiconductor substrate (49, 48) and/or the optical waveguide 44, and the photon detectors 55 and/or the second SPAD diodes 55;
3740 Conditioning, in particular amplifying and/or filtering and/or analog-to-digital conversion, of the detection signal into a conditioned detection signal, in particular a digital 14-bit value 407 of the analog-to-digital converter 403 or of a 1-bit analog-to-digital converter 403;
3750 optionally separating the pulses of the conditioned detection signal produced by optical coupling of the emissions of a photon source 54 and/or a silicon LED 54 and/or a first SPAD diode 54 on the one hand and a photon detector 55 and/or a second SPAD diode 55 on the other hand from the pulses of the conditioned detection signal produced by spontaneous emission by comparing the conditioned detection signal with a threshold value, in particular in a comparator 404.2, and generating a corresponding output signal 409, in particular of the comparator 404.2.2 and generating a corresponding output signal 409, in particular of the comparator 404.2. If necessary, the analog-to-digital converter 403 can generate the output signal 409 directly if it is a 1-bit analog-to-digital converter 403. In this respect, this step 3750 is optional and is therefore only shown as a dashed line;
3760 Determination 3760 of a first pseudorandom number as a function of a first time interval between the first pulse and the second pulse of a first pair of two successive pulses of the conditioned detection signal produced by optical coupling of the emissions of a photon source 54 or a silicon LED 54 or a first SPAD diode 54, on the one hand, and of a photon detector 55 or a second SPAD diode 55, on the other hand, as a first value of the output 410 of the time-to-pseudorandom number converter 404.3;
3765 Determination 3760 of a second pseudorandom number as a function of a second time interval between the third pulse and the fourth pulse of a first pair of two successive pulses of the conditioned detection signal, produced by optical coupling of the emissions of a photon source 54 or a silicon LED 54 or a first SPAD diode 54 on the one hand and a photon detector 55 or a second SPAD diode 55 on the other hand, as the first value of the output 410 of the time-to-random number converter 404.3. The third pulse can be identical to the second pulse (see step 3760);
3670 Determining the bit value of a quantum random bit 411 by comparing the value of the first pseudorandom number and the value of the second pseudorandom number;
3680 Check 3680. In the check 3680, the first processor 10-1 of the computer (here of the exemplary microintegrated circuit 2) and/or a finite state machine 404.8 check whether the number n of the determined quantum random bits 411 is still smaller than the desired number m of the random bits of the desired quantum random number 418. If this is not the case, the first processor 10-1 of the computer (here of the exemplary microintegrated circuit 2) and/or finite state machine 404.8 repeat the above steps 3710 to 3770. Otherwise, the processor 10-1 of the computer (here of the exemplary microintegrated circuit 2) and/or finite state machine 404.8 terminate the process for generating a quantum random number. If necessary, the finite state machine 404.8 makes the quantum random number available to the processor 10-1 and preferably signals this availability to the processor 10-1, for example by means of an interrupt or by setting a flag.
15152 Means for electronic recording 25152 (“electronic sampling means”);
25154 Means for electronic post-processing 25154 of the photons 55 in the prior art;
26122 Cathode 26122;
26(27022) 124 Anode 26124;
26132 Cathode 26132;
26134 Anode 26134;
27022 first area 27022 (e.g. NBL) of the first line type (negative for NBL);
27032 second area 27032 (e.g. PBL) of the second line type (positive for PBL);
27050 p-n junction 27050 located in the epitaxial layer 48;
27052 pn-transition 27052;
27110 BCD substrate 27110;
28010 High-voltage p-type well 28010;
28020 Observation diode 28020;
29010 weakly n-doped or (approximately) intrinsic epitaxial region 29010;

### Non-Numeric Reference Symbols

GND Reference potential line GND to reference potential;
O surface O of the semiconductor substrate 49;
R Symmetry axis R of the structure in FIG. 26;
S Surface S of the carrier substrate 49;
S2 Read a load program from the EEPROM 6;
S4 Verification of the digital signature of the boot ROM code using the public key stored in the first OTP 20;
S6 Reading subsequent data records using the load program
S8 check the signature of the new data set read from the EEPROM 6 using a public key embedded in a data set previously loaded or stored in the OTP-I memory 20 by the load code;
S20 Read a data record from the EEPROM 6;
S21 Save at least part of the record data in TCM 14;
S22 Calculate a hash value for each word of the remaining data;
S24 Storing the calculated hash value in the DRAM 8 at a location associated with the stored word by means of cooperation of the processor 10-1 or the processors 10-1, 10-2 on the one hand with the hash engine 18 on the other hand;
S26 Recalculation of the hash value when a word is read from the DRAM 8 by the processor 10-1, 10-2 and the hash engine 18;
S30 Comparison of the newly calculated hash value with the corresponding hash value stored in the DRAM 8, using the processor 10-1, 10-2 and the hash engine 18;
S34 Check whether the hash values have a predetermined relationship, e.g. are the same;
S36 Interrupt processing and/or generate an error message and/or ignore data/code if they do not have the specified relationship;
S38 Processing of the read data using the processor or processors 10-1, 10-2 if the hash values have a predetermined relationship, e.g. are the same;
RKN₁ first feedback network RKN₁ of the time to pseudorandom number converter 404.3 (TPRC), which typically generates the logical feedback value that the first shift register bit SB₍₁
   1. when the first feedback network RKN₁ of the time-to-random number converter 404.3 (TPRC) is selected by the feedback multiplexer 2102 and
   2. when the serial shift mode is set by the shift register controller 2103 via parallel-to-serial shift register mode switching line 2107 a parallel-to-serial shift register mode switching line 2107 and
   3. on activation of the shift register bit activation line of the first shift register bit SB₁ of the shift register bit activation bus 2109 for activating the data transfer of the first shift register bit SB₁ at the next clock edge of the clock edge direction signal used
   as the next serial reload value for the first shift register bit SB₁ of the time to pseudo-random number converter 404.3 (TPRC). The first shift register bit SB₁ then loads this next serial reload value into the first shift register bit SB₁ of the time to pseudo-random number converter 404.3 (TPRC) with the next clock pulse of the system clock 2106. Preferably, the first feedback network RKN₁ of the time-to-pseudo-random number converter 404.3 (TPRC) is different from the other feedback networks of the time-to-pseudo-random number converter 404.3 (TPRC). Preferably, the first feedback network RKN₁ of the time-to-pseudo-random number converter 404.3 (TPRC) realizes a logical connection of the logical content of the shift register bus 2101 of the time-to-pseudo-random number converter 404.3 (TPRC) to the logical value of the shift register reload value line 2104 of the time to pseudo-random number converter 404.3 (TPRC), which is the next reload value under the above conditions. Preferably, the logic operation of the first feedback network RKN₁ of the time to pseudorandom number converter 404.3 (TPRC) realizes a simple primitive polynomial;
RKN₂ second feedback network RKN₂ of the time to pseudorandom number converter 404.3 (TPRC), which typically generates the logical feedback value which the first shift register bit SB₍₁ is to generate from the logical data word present on the shift register bus 2101 of the time to pseudorandom number converter 404.3 (TPRC).
   1. when the second feedback network RKN₂ of the time-to-random number converter 404.3 (TPRC) is selected by the feedback multiplexer 2102 and
   2. when the serial shift mode is set by the shift register controller 2103 via parallel-to-serial shift register mode switching line 2107 a parallel-to-serial shift register mode switching line 2107 and
   3. on activation of the shift register bit activation line of the first shift register bit SB₁ of the shift register bit activation bus 2109 for activating the data transfer of the first shift register bit SB₁ at the next clock edge of the clock edge direction signal used
   as the next serial reload value for the first shift register bit SB₁ of the time to pseudo-random number converter 404.3 (TPRC). The first shift register bit SB₁ then loads this next serial reload value into the first shift register bit SB₁ of the time to pseudo-random number converter 404.3 (TPRC) with the next clock pulse of the system clock 2106. Preferably, the second feedback network RKN₂ of the time-to-pseudo-random number converter 404.3 (TPRC) is different from the other feedback networks of the time-to-pseudo-random number converter 404.3 (TPRC). Preferably, the second feedback network RKN₂ of the time-to-pseudo-random number converter 404.3 (TPRC) realizes a logical connection of the logical content of the shift register bus 2101 of the time-to-pseudo-random number converter 404.3 (TPRC) to the logical value of the shift register reload value line 2104 of the time to pseudo-random number converter 404.3 (TPRC), which is the next reload value under the above conditions. Preferably, the logic operation of the second feedback network RKN₂ of the time-to-pseudo-random number converter 404.3 (TPRC) realizes a single primitive polynomial, which is preferably different from the single primitive polynomials of the logic operations of the other feedback networks of the time-to-pseudo-random number converter 404.3 (TPRC);
RKN₃ third feedback network RKN₃ of the time to pseudorandom number converter 404.3 (TPRC), which typically generates the logical feedback value which the first shift register bit SB₍₁ is to generate from the logical data word present on the shift register bus 2101 of the time to pseudorandom number converter 404.3 (TPRC).
   1. when the third feedback network RKN₃ of the time-to-random number converter 404.3 (TPRC) is selected by the feedback multiplexer 2102 and
   2. when the serial shift mode is set by the shift register controller 2103 via parallel-to-serial shift register mode switching line 2107 a parallel-to-serial shift register mode switching line 2107 and
   3. on activation of the shift register bit activation line of the first shift register bit SB₁ of the shift register bit activation bus 2109 for activating the data transfer of the first shift register bit SB₁ at the next clock edge of the clock edge direction signal used
   as the next serial reload value for the first shift register bit SB₁ of the time to pseudo-random number converter 404.3 (TPRC). The first shift register bit SB₁ then loads this next serial reload value into the first shift register bit SB₁ of the time to pseudo-random number converter 404.3 (TPRC) with the next clock pulse of the system clock 2106. Preferably, the third feedback network RKN₃ of the time-to-pseudo-random number converter 404.3 (TPRC) is different from the other feedback networks of the time-to-pseudo-random number converter 404.3 (TPRC). Preferably, the third feedback network RKN₃ of the time-to-pseudo-random number converter 404.3 (TPRC) realizes a logical connection of the logical content of the shift register bus 2101 of the time-to-pseudo-random number converter 404.3 (TPRC) to the logical value of the shift register reload value line 2104 of the time to pseudo-random number converter 404.3 (TPRC), which is the next reload value under the above conditions. Preferably, the logic operation of the third feedback network RKN₃ of the time-to-pseudo-random number converter 404.3 (TPRC) realizes a single primitive polynomial, which is preferably different from the single primitive polynomials of the logic operations of the other feedback networks of the time-to-pseudo-random number converter 404.3 (TPRC);
RKNₘ m-th feedback network RKNₘ of the time to pseudo-random number converter 404.3 (TPRC), which typically generates the logical feedback value that the first shift register bit SB (1
   1. when the m-th feedback network RKNₘ of the time-to-random number converter 404.3 (TPRC) is selected by the feedback multiplexer 2102 and
   2. when the serial shift mode is set by the shift register controller 2103 via parallel-to-serial shift register mode switching line 2107 a parallel-to-serial shift register mode switching line 2107 and
   3. on activation of the shift register bit activation line of the first shift register bit SB₁ of the shift register bit activation bus 2109 for activating the data transfer of the first shift register bit SB₁ at the next clock edge of the clock edge direction signal used
   as the next serial reload value for the first shift register bit SB₁ of the time to pseudo-random number converter 404.3 (TPRC). The first shift register bit SB₁ then loads this next serial reload value into the first shift register bit SB₁ of the time to pseudorandom number converter 404.3 (TPRC) with the next clock pulse of the system clock 2106. Preferably, the m-th feedback network RKNₘ of the time to pseudo-random number converter 404.3 (TPRC) is different from the other feedback networks of the time to pseudo-random number converter 404.3 (TPRC). Preferably, the m-th feedback network RKNₘ of the time-to-pseudo-random number converter 404.3 (TPRC) realizes a logical connection of the logical content of the shift register bus 2101 of the time-to-pseudo-random number converter 404.3 (TPRC) to the logical value of the shift register reload value line 2104 of the time to pseudo-random number converter 404.3 (TPRC), which is the next reload value under the above conditions. Preferably, the logic operation of the m-th feedback network RKNₘ of the time-to-pseudo-random number converter 404.3 (TPRC) realizes a single primitive polynomial which is preferably different from the single primitive polynomials of the logic operations of the other feedback networks of the time-to-pseudo-random number converter 404.3 (TPRC);
SB₁ first shift register cell with the first shift register bit SB₁. The first shift register bit SB₁ preferably feeds its logical content into the first shift register bus line of the shift register bus 2101 of the time to pseudo-random number converter 404.3 (TPRC). Depending on the logical value of the parallel-to-serial shift register mode switching line 2107, the first shift register bit SB₁ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logic value of the shift register reload value line 2104 of the time-to-pseudo-random number converter 404.3 (TPRC) as its next logic value after and
   b) at a second logic value of the parallel-to-serial shift register mode switching line 2107, the parallel shift register operation mode, for example, at the next rising clock edge of the system clock 2106 of the quantum random number generator 28 and the time-to-random number converter 404.3 (TPRC) of the quantum random number generator 28, the logic value of the first bit of the TPRG data bus 2110 as its next logic value, if the first shift register bit activation line of the shift register bit activation bus 2109 is active (e.g. high) at the same time.
SB₂ second shift register cell with the second shift register bit SB₂. The second shift register bit SB₂ feeds its logical content into the second shift register bus line of the shift register bus 2101 of the time-to-random number converter 404.3 (TPRC). Depending on the logic value of the parallel-to-serial shift register mode switching line 2107, the second shift register bit SB₂ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logical value of the first shift register bit SB₁ of the time-to-pseudo-random number converter 404.3 (TPRC) as its next logical value after and
   b) at a second logic value of the parallel-to-serial shift register mode switching line 2107, the parallel shift register operating mode, for example, at the next rising clock edge of the system clock 2106 of the quantum random number generator 28 and the time-to-random pseudorandom number converter 404.3 (TPRC) of the quantum random number generator 28, the logic value of the second bit of the TPRG data bus 2110 as its next logic value,
   if the first shift register bit activation line of the shift register bit activation bus 2109 is active (e.g. high) at the same time;
SB₃ third shift register cell with the third shift register bit SB₃. The third shift register bit SB₃ feeds its logic content into the third shift register bus line of the shift register bus 2101 of the time to pseudo-random number converter 404.3 (TPRC). Depending on the logic value of the parallel-to-serial shift register mode switching line 2107, the third shift register bit SB₃ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logical value of the second shift register bit SB₂ of the time-to-pseudo-random number converter 404.3 (TPRC) as its next logical value after and
   b) at a second logic value of the parallel-to-serial shift register mode switching line 2107, the parallel shift register operation mode, for example, with the next rising clock edge of the system clock 2106 of the quantum random number generator 28 and the time-to-random pseudorandom number converter 404.3 (TPRC) of the quantum random number generator 28, the logic value of the third bit of the TPRG data bus 2110 as its next logic value, if the first shift register bit activation line of the shift register bit activation bus 2109 is active (e.g. high) at the same time;
SB₄ fourth shift register cell with the fourth shift register bit SB₄. The fourth shift register bit SB₄ feeds its logical content into the fourth shift register bus line of the shift register bus 2101 of the time-to-random number converter 404.3 (TPRC). Depending on the logical value of the parallel-to-serial shift register mode switching line 2107, the fourth shift register bit SB₄ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logical value of the third shift register bit SB₃ of the time-to-pseudo-random number converter 404.3 (TPRC) as its next logical value after and
   b) at a second logic value of the parallel-to-serial shift register mode switching line 2107, the parallel shift register operation mode, for example, at the next rising clock edge of the system clock 2106 of the quantum random number generator 28 and the time-to-random number converter 404.3 (TPRC) of the quantum random number generator 28, the logic value of the fourth bit of the TPRG data bus 2110 as its next logic value, if the first shift register bit activation line of the shift register bit activation bus 2109 is active (e.g. high) at the same time;
SB₅ fifth shift register cell with the fifth shift register bit SB₅. The fifth shift register bit SB₅ feeds its logical content into the fifth shift register bus line of the shift register bus 2101 of the time-to-random number converter 404.3 (TPRC). Depending on the logic value of the parallel-to-serial shift register mode switching line 2107, the fifth shift register bit SB₅ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logical value of the fourth shift register bit SB₄ of the time-to-pseudo-random number converter 404.3 (TPRC) as its next logical value after and
   b) at a second logic value of the parallel-to-serial shift register mode switching line 2107, the parallel shift register operating mode, for example, at the next rising clock edge of the system clock 2106 of the quantum random number generator 28 and the time-to-random pseudorandom number converter 404.3 (TPRC) of the quantum random number generator 28, the logic value of the fifth bit of the TPRG data bus 2110 as its next logic value, if the first shift register bit activation line of the shift register bit activation bus 2109 is active (e.g. high) at the same time;
SB₆ sixth shift register cell with the sixth shift register bit SB₆. The sixth shift register bit SB₆ feeds its logical content into the sixth shift register bus line of the shift register bus 2101 of the time-to-random number converter 404.3 (TPRC) Depending on the logical value of the parallel-to-serial shift register mode switching line 2107, the sixth shift register bit SB₆ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logical value of the fifth shift register bit SB₅ of the time-to-pseudo-random number converter 404.3 (TPRC) as its next logical value after and
   b) at a second logic value of the parallel-to-serial shift register mode switching line 2107, the parallel shift register operation mode, for example, at the next rising clock edge of the system clock 2106 of the quantum random number generator 28 and the time-to-random number converter 404.3 (TPRC) of the quantum random number generator 28, the logic value of the sixth bit of the TPRG data bus 2110 as its next logic value, if the first shift register bit activation line of the shift register bit activation bus 2109 is active (e.g. high) at the same time;
SB₇ seventh shift register cell with the seventh shift register bit SB₇. The seventh shift register bit SB₇ feeds its logical content into the seventh shift register bus line of the shift register bus 2101 of the time-to-random number converter 404.3 (TPRC). Depending on the logical value of the parallel-to-serial shift register mode switching line 2107, the seventh shift register bit SB₇ preferentially loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logical value of the sixth shift register bit SB₆ of the time-to-pseudo-random number converter 404.3 (TPRC) as its next logical value after and
   b) at a second logic value of the parallel-to-serial shift register mode switching line 2107, the parallel shift register operation mode, for example, with the next rising clock edge of the system clock 2106 of the quantum random number generator 28 and the time-to-random pseudorandom number converter 404.3 (TPRC) of the quantum random number generator 28, the logic value of the seventh bit of the TPRG data bus 2110 as its next logic value,
   if the first shift register bit activation line of the shift register bit activation bus 2109 is active (e.g. high) at the same time;
SB₈ eighth shift register cell with the eighth shift register bit SB₈. The eighth shift register bit SB₈ feeds its logical content into the eighth shift register bus line of the shift register bus 2101 of the time-to-random number converter 404.3 (TPRC) Depending on the logical value of the parallel-to-serial shift register mode switching line 2107, the eighth shift register bit SB₈ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-pseudo-random number converter 404.3 (TPRC) of the quantum random number generator 28 the logic value of the seventh shift register bit SB₇ of the time-to-pseudo-random number converter 404.3 (TPRC) as its next logic value after and
   b) at a second logic value of the parallel-to-serial shift register mode switching line 2107, the parallel shift register operating mode, for example, at the next rising clock edge of the system clock 2106 of the quantum random number generator 28 and the time-to-random pseudorandom number converter 404.3 (TPRC) of the quantum random number generator 28, the logic value of the eighth bit of the TPRG data bus 2110 as its next logic value,
   if the first shift register bit activation line of the shift register bit activation bus 2109 is active (e.g. high) at the same time;
SB₍ₙ₋₆₎ (n−6)th shift register cell with the (n−6)th shift register bit SB₍ₙ₋₆₎. The (n−6)th shift register bit SB₍ₙ₋₆₎ feeds its logical content into the (n−6)th shift register bus line of the shift register bus 2101 of the time-to-random number converter 404.3 (TPRC). Depending on the logic value of the parallel-to-serial shift register mode switching line 2107, the (n−6)th shift register bit SB₍ₙ₋₆₎ preferentially loads, for example
   a) at a first logic value of the parallel-to-serial shift register mode switching line 2107, the serial shift register operation mode, for example at the next rising clock edge of the system clock 2106 of the quantum random number generator 28 and the time-to-random number converter 404.3 (TPRC) of the quantum random number generator 28, the logic value of the (n−7)th shift register bit SB₍ₙ₋₇₎ of the time-to-pseudo-random number converter 404.3 (TPRC) as its next logic value after and
   b) at a second logic value of the parallel-to-serial shift register mode switching line 2107, the parallel shift register mode of operation, for example, at the next rising clock edge of the system clock 2106 of the quantum random number generator 28 and the time-to-random pseudorandom number converter 404.3 (TPRC) of the quantum random number generator 28, the logic value of the (n−6)th bit of the TPRG data bus 2110 as its next logic value,
   if the first shift register bit activation line of the shift register bit activation bus 2109 is active (e.g. high) at the same time;
SB₍ₙ₋₅₎ (n−5)th shift register cell with the (n−5)th shift register bit SB₍ₙ₋₅₎. The (n−5th) shift register bit SB₍ₙ₋₅₎ feeds its logical content into the (n−5th) shift register bus line of the shift register bus 2101 of the time-to-random number converter 404.3 (TPRC). Depending on the logical value of the parallel-to-serial shift register mode switching line 2107, the (n−5)th shift register bit SB₍ₙ₋₆₎ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-random number converter 404.3 (TPRC) of the quantum random number generator 28, the logic value of the (n−6)th shift register bit SB₍ₙ₋₇₎ of the time-to-pseudo-random number converter 404.3 (TPRC) as its next logic value after and
   b) at a second logic value of the parallel-to-serial shift register mode switching line 2107, the parallel shift register operation mode, for example, at the next rising clock edge of the system clock 2106 of the quantum random number generator 28 and the time-to-random pseudorandom number converter 404.3 (TPRC) of the quantum random number generator 28, the logic value of the (n−5)th bit of the TPRG data bus 2110 as its next logic value,
   if the first shift register bit activation line of the shift register bit activation bus 2109 is active (e.g. high) at the same time;
SB₍ₙ₋₄₎ (n−4th) shift register cell with the (n−4th) shift register bit SB₍ₙ₋₄₎. The (n−4th) shift register bit SB₍ₙ₋₄₎ feeds its logical content into the (n−4th) shift register bus line of the shift register bus 2101 of the time-to-random number converter 404.3 (TPRC). Depending on the logic value of the parallel-to-serial shift register mode switching line 2107, the (n−4)th shift register bit SB₍ₙ₋₆₎ preferentially loads, for example
   a) at a first logic value of the parallel-to-serial shift register mode switching line 2107, the serial shift register operation mode, for example at the next rising clock edge of the system clock 2106 of the quantum random number generator 28 and the time-to-random number converter 404.3 (TPRC) of the quantum random number generator 28 the logical value of the (n−5)th shift register bit SB₍ₙ₋₇₎ of the time-to-pseudo-random number converter 404.3 (TPRC) as its next logical value after and
   b) at a second logic value of the parallel-to-serial shift register mode switching line 2107, the parallel shift register operating mode, for example, at the next rising clock edge of the system clock 2106 of the quantum random number generator 28 and the time-to-random pseudorandom number converter 404.3 (TPRC) of the quantum random number generator 28, the logic value of the (n−4)th bit of the TPRG data bus 2110 as its next logic value,
   if the first shift register bit activation line of the shift register bit activation bus 2109 is active (e.g. high) at the same time;
SB₍ₙ₋₃₎ (n−3)th shift register cell with the (n−3)th shift register bit SB₍ₙ₋₃₎. The (n−3)th shift register bit SB₍ₙ₋₃₎ feeds its logical content into the (n−3)th shift register bus line of the shift register bus 2101 of the time-to-random number converter 404.3 (TPRC). Depending on the logic value of the parallel-to-serial shift register mode switching line 2107, the (n−3)th shift register bit SB₍ₙ₋₆₎ preferentially loads, for example
   a) at a first logic value of the parallel-to-serial shift register mode switching line 2107, the serial shift register operation mode, for example at the next rising clock edge of the system clock 2106 of the quantum random number generator 28 and the time-to-random number converter 404.3 (TPRC) of the quantum random number generator 28 the logical value of the (n−4)th shift register bit SB₍ₙ₋₇₎ of the time-to-pseudo-random number converter 404.3 (TPRC) as its next logical value after and
   b) at a second logic value of the parallel-to-serial shift register mode switching line 2107, the parallel shift register operation mode, for example, at the next rising clock edge of the system clock 2106 of the quantum random number generator 28 and the time-to-random pseudorandom number converter 404.3 (TPRC) of the quantum random number generator 28, the logic value of the (n−3)th bit of the TPRG data bus 2110 as its next logic value,
   if the first shift register bit activation line of the shift register bit activation bus 2109 is active (e.g. high) at the same time;
SB₍ₙ₋₂₎ (n−2)th shift register cell with the (n−2)th shift register bit SB₍ₙ₋₂₎. The (n−2)th shift register bit SB₍ₙ₋₂₎ feeds its logical content into the (n−2)th shift register bus line of the shift register bus 2101 of the time-to-random number converter 404.3 (TPRC). Depending on the logical value of the parallel-to-serial shift register mode switching line 2107, the (n−2)th shift register bit SB₍ₙ₋₆₎ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-random number converter 404.3 (TPRC) of the quantum random number generator 28, the logic value of the (n−3)th shift register bit SB₍ₙ₋₇₎ of the time-to-pseudo-random number converter 404.3 (TPRC) as its next logic value after and
   b) at a second logic value of the parallel-to-serial shift register mode switching line 2107, the parallel shift register operation mode, for example, with the next rising clock edge of the system clock 2106 of the quantum random number generator 28 and the time-to-random pseudorandom number converter 404.3 (TPRC) of the quantum random number generator 28, the logic value of the (n−2)th bit of the TPRG data bus 2110 as its next logic value,
   if the first shift register bit activation line of the shift register bit activation bus 2109 is active (e.g. high) at the same time;
SB₍ₙ₋₁₎ (n−1)th shift register cell with the (n−1)th shift register bit SB₍ₙ₋₁₎. The (n−1)th shift register bit SB₍ₙ₋₁₎ feeds its logical content into the (n−1)th shift register bus line of the shift register bus 2101 of the time-to-random number converter 404.3 (TPRC) Depending on the logical value of the parallel-to-serial shift register mode switching line 2107, the (n−1)th shift register bit SB₍ₙ₋₆₎ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-random number converter 404.3 (TPRC) of the quantum random number generator 28, the logic value of the (n−2)th shift register bit SB₍ₙ₋₇₎ of the time-to-pseudo-random number converter 404.3 (TPRC) as its next logic value after and
   b) at a second logic value of the parallel-to-serial shift register mode switching line 2107, the parallel shift register operating mode, for example, at the next rising clock edge of the system clock 2106 of the quantum random number generator 28 and the time-to-random pseudorandom number converter 404.3 (TPRC) of the quantum random number generator 28, the logic value of the (n−1)th bit of the TPRG data bus 2110 as its next logic value,
   if the first shift register bit activation line of the shift register bit activation bus 2109 is active (e.g. high) at the same time;
SBₙ n-th shift register cell with the n-th shift register bit SBₙ. The n-th shift register bit SBₙ feeds its logical content into the n-th shift register bus line of the shift register bus 2101 of the time-to-random number converter 404.3 (TPRC). Depending on the logic value of the parallel-to-serial shift register mode switching line 2107, the n-th shift register bit SB₍ₙ₋₆₎ preferably loads, for example
   a) at a first logic value of the parallel-to-serial shift register mode switching line 2107, the serial shift register operation mode, for example at the next rising clock edge of the system clock 2106 of the quantum random number generator 28 and the time-to-random number converter 404.3 (TPRC) of the quantum random number generator 28, the logic value of the (n−1)th shift register bit SB₍ₙ₋₇₎ of the time-to-pseudo-random number converter 404.3 (TPRC) as its next logic value after and
   b) at a second logic value of the parallel-to-serial shift register mode switching line 2107, the parallel shift register operation mode, for example, at the next rising clock edge of the system clock 2106 of the quantum random number generator 28 and the time-to-random number converter 404.3 (TPRC) of the quantum random number generator 28, the logic value of the nth bit of the TPRG data bus 2110 as its next logic value, if the first shift register bit activation line of the shift register bit activation bus 2109 is active (e.g. high) at the same time;
VDD positive supply voltage line VDD at a positive electrical potential in relation to the reference potential of the reference potential line GND;
V_{ENT} positive supply voltage line V_{EXT} of the entropy source 411.

What is claimed is:

1-23. (canceled)

24. A quantum random number generator, comprising:
a vertical entropy source;
wherein:
the quantum random number generator is integrally formed in a semiconductor substrate, the semiconductor substrate including a surface;
the vertical entropy source includes a photon source and a photon detector;
the surface of the semiconductor substrate defines a horizontal plane having a first direction in the horizontal plane (1st plane vector) and a second direction in the horizontal plane (2nd plane vector) different from the first direction in the horizontal plane;
the photon source and the photon detector are arranged in the horizontal plane of the surface of the semiconductor substrate in a vertical direction with respect to the first and second directions in the horizontal plane in the semiconductor substrate;
the photon source and the photon detector are arranged one above another in the semiconductor substrate in the vertical direction; and
the quantum random number generator is arranged to generate one or more quantum random bits based on a signal of the vertical entropy source.

25. The quantum random number generator according to claim 24, further comprising a watchdog.

26. The quantum random number generator according to claim 25, wherein the watchdog is configured to monitor the quantum random number generator for an attack or a disturbance by detecting an attack on the vertical entropy source based on photons detected by an observation diode.

27. The quantum random number generator according to claim 24, further comprising a voltage monitor.

28. The quantum random number generator according to claim 27, wherein the voltage monitor is configured to monitor the quantum random number generator for an attack or a disturbance by detecting an attack on the vertical entropy source based on photons detected by an observation diode.

29. The quantum random number generator according to claim 24:
a. wherein a quantum random number generator is formed in one piece on a common semiconductor substrate;
b. wherein the quantum random number generator comprises:
at least an entropy source or the vertical entropy source, and a time-to-pseudorandom number converter; or
at least the entropy source or the vertical entropy source, and the time-to-pseudorandom number converter or a time-to-digital converter instead of the time-to-pseudorandom number converter; or
at least the entropy source or the vertical entropy source, and an observation diode for detecting an attack on the entropy source based on detected photons; or
at least the time-to-pseudorandom number converter or a time-to-digital converter instead of the time-to-pseudorandom number converter and an observation diode for detecting an attack on the entropy source based on detected photons; and
c. wherein the quantum random number generator may further comprise:
an integrated circuit; and/or
one or more photon sources; and/or
one or more photon detectors; and/or
one or more optical functional elements; and/or
one or more optical fibers; and/or
a time-to-random number converter; and/or
an observation diode for detecting an attack on the entropy source based on detected photons; and/or
one or more monitoring diodes; and/or
a watchdog; and/or
one or more voltage monitors; and/or
one or more voltage transformers; and/or
one or more amplifiers; and/or
one or more comparators; and/or
an entropy extraction device; and/or
a finite state machine; and/or
a signal multiplexer; and/or
one or more RAMs and/or FIFOs; and/or
one or more finish flags; and/or
an internal data bus, and/or one or more signal lines; and/or
one or more interrupt signals; and/or
a pulse extender circuit; and/or
a feedback multiplexer, of the time-to-random number converter; and/or
a control register of the feedback multiplexer; and/or
one or more feedback polynomial selection registers; and/or
a detection circuit; and/or
a shift register controller; and/or
one or more feedback networks, of the time-to-random number converter; and/or
one or more shift register bits; and/or
one or more second high-side transistors, in particular in a form of DMOS transistors; and/or
one or more transfer transistors, in particular in the form of DMOS transistors; and/or
one or more first energy storage devices; and/or
one or more second energy storage devices; and/or
one or more control devices of the one or more voltage transformers; and/or
a pad frame of a microelectronic-integrated circuit; and/or
at least one of a finite state machine or a time-to-pseudorandom number converter or an entropy extraction for electronic post-processing; and/or
one or more monitoring diodes; and/or
an encapsulation with one or more metal layers and/or one or more silicide layers and vias; and/or
one or more data bus interfaces; and/or
a JTAG test interface and/or another test interface; and/or
a control device; and/or
one or more non-volatile memories and/or one or more EEPROMs; and/or
one or more random access memories (volatile read/write memories); and/or
one or more processors; and/or
one or more closely coupled memories, (TCM); and/or
a non-volatile boot memory (boot ROM); and/or
a hashing engine; and/or
one or more one-time programmable (OTP) memories; and/or
a deactivation circuit; and/or
one or more further internal non-volatile memories; and/or
one or more interfaces to one or more controlled systems; and/or
one or more clock generators (including any necessary PLLs); and/or
one or more voltage transformers; and/or
one or more reset circuits; and/or
one or more data bus interfaces; and/or
one or more internal interfaces; and/or
one or more optical functional elements; and/or
one or more analog input processing units; and/or
one or more analog-to-digital converters; and/or
one or more digital signal processing units; and/or
one or more digital-to-analog converters; and/or
one or more analog output processing units.

30. The quantum random number generator according to claim 24,
wherein the quantum random number generator is arranged to generate at least one random number from a plurality of random bits; and
wherein the quantum random number generator is further arranged to provide or utilize the at least one random number.

31. The quantum random number generator according to claim 24,
wherein logical values in a temporal order of pseudorandom bits of a time-to-pseudorandom number converter of the quantum random number generator depend on one or more quantum random bits and/or one or more quantum random numbers.

32. The quantum random number generator according to claim 24, further comprising a watchdog;
wherein the watchdog is arranged to monitor a correct functioning of the quantum random number generator.

33. The quantum random number generator according to claim 32,
wherein the watchdog is set up to measure randomness of the generated one or more quantum random bits in a form of one or more measured values and to compare each with a respective tolerance interval or a respective threshold value; and
wherein the watchdog is set up to infer a respective error in event of a respective deviation of a respective measured value from a respective tolerance interval or a respective threshold value.

34. The quantum random number generator according to claim 24, further comprising:
a watchdog; and
a time-to-pseudorandom number converter;
wherein the watchdog is configured to:
monitor a correct function of a time-to-pseudorandom number converter of the quantum random number generator, and/or
monitor a behavior in a form of temporal statistics of logical values in a temporal sequence of pseudorandom bits of the time-to-pseudorandom number converter and to record it in a form of statistical measured values and to detect and/or indicate an error if the statistical measured values deviate from an expected behavior in the form of these measured values leaving permitted measured value ranges.

35. The quantum random number generator according to claim 34,
a. wherein a quantum random number generator is formed in one piece on a common semiconductor substrate;
b. wherein the quantum random number generator comprises:
at least an entropy source or the vertical entropy source, and the time-to-pseudorandom number converter; or
at least the entropy source or the vertical entropy source, and the time-to-pseudorandom number converter or a time-to-digital converter instead of the time-to-pseudorandom number converter; or
at least the entropy source or the vertical entropy source, and an observation diode for detecting an attack on the entropy source based on detected photons; or
at least the time-to-pseudorandom number converter or a time-to-digital converter instead of the time-to-pseudorandom number converter and an observation diode for detecting an attack on the entropy source based on detected photons; and
c. wherein the quantum random number generator can further comprise:
an integrated circuit; and/or
one or more photon sources; and/or
one or more photon detectors; and/or
one or more optical functional elements; and/or
one or more optical fibers; and/or
a time-to-random number converter; and/or
an observation diode for detecting an attack on the entropy source based on detected photons; and/or
one or more monitoring diodes; and/or
a watchdog; and/or
one or more voltage monitors; and/or
one or more voltage transformers; and/or
one or more amplifiers; and/or
one or more comparators; and/or
an entropy extraction device; and/or
a finite state machine; and/or
a signal multiplexer; and/or
one or more RAMs and/or FIFOs; and/or
one or more finish flags; and/or
an internal data bus, and/or one or more signal lines; and/or
one or more interrupt signals; and/or
a pulse extender circuit; and/or
a feedback multiplexer, of the time-to-random number converter; and/or
a control register of the feedback multiplexer; and/or
one or more feedback polynomial selection registers; and/or
a detection circuit; and/or
a shift register controller; and/or
one or more feedback networks, of the time-to-random number converter; and/or
one or more shift register bits; and/or
one or more second high-side transistors implemented as DMOS transistors;
and/or
one or more transfer transistors implemented as DMOS transistors; and/or
one or more first energy storage devices; and/or
one or more second energy storage devices; and/or
one or more control devices of the one or more voltage transformers; and/or
a pad frame of a microelectronic-integrated circuit; and/or
at least one of a finite state machine or a time to-pseudorandom-number converter or an entropy extraction for electronic post-processing; and/or
one or more monitoring diodes; and/or
an encapsulation with one or more metal layers and/or one or more silicide layers and vias; and/or
one or more data bus interfaces; and/or
a JTAG test interface and/or another test interface; and/or
a control device; and/or
one or more non-volatile memories and/or one or more EEPROMs; and/or
one or more random access memories (volatile read/write memories); and/or
one or more processors; and/or
one or more closely coupled memories, (TCM); and/or
a non-volatile boot memory (boot ROM); and/or
a hashing engine; and/or
one or more one-time programmable (OTP) memories; and/or
a deactivation circuit; and/or
one or more further internal non-volatile memories; and/or
one or more interfaces to one or more controlled systems; and/or
one or more clock generators (including any necessary PLLs); and/or
one or more voltage transformers; and/or
one or more reset circuits; and/or
one or more data bus interfaces; and/or
one or more internal interfaces; and/or
one or more optical functional elements; and/or
one or more analog input processing units; and/or
one or more analog-to-digital converters; and/or
one or more digital signal processing units; and/or
one or more digital-to-analog converters; and/or
one or more analog output processing units.

36. The quantum random number generator according to claim 35,
wherein the integrated circuit is manufactured in a BCD technology.

37. The quantum random number generator according to claim 35,
wherein the integrated circuit further comprises a voltage converter for supplying an entropy source; and
wherein the voltage converter further comprises one or more DMOS transistors.

38. The quantum random number generator according to claim 35,
wherein the integrated circuit further comprises at least one of:
a microcontroller;
a microprocessor;
a memory;
a DRAM;
a SRAM;
a RAM;
a volatile memory;
an OTP memory;
an EEPROM;
a flash memory;
one MRAM;
a FRAM;
a sensor evaluation circuit;
a control circuit for an automotive control circuit;
a graphics controller;
an evaluation circuit for a biometric sensor or an input device;
a control circuit;
a chip card circuit;
an RFID circuit;
a material circuit of a cell phone or a smartphone;
a circuit of an access control system;
a circuit with a coded recording of operating parameters;
a circuit of an access control system;
a circuit of a fuse system of electronic fuses;
a radio system circuit;
a communication circuit;
a circuit of an encryption and/or decryption system;
a circuit of an individualization system;
a circuit of a gaming device;
a circuit of a simulation system;
a circuit of a computer system;
a circuit of a noise source;
a circuit with a device for generating and/or using a spreading code;
a circuit with a device for generating and/or using a random number for individualizing the circuit; or
a circuit with a device for generating and/or using a random number for test purposes, in particular for self-test purposes and/or in particular for purposes of testing an application circuit of which the circuit is a part.

39. The quantum random number generator according to claim 35,
wherein the integrated circuit further comprises internal interfaces as special circuits at a cryptographic boundary between a control device and other parts of the integrated circuit which are classified as non-secure or less secure; and
wherein the quantum random number generator is located within the cryptographic boundary between the control device and the other parts of the integrated circuit.

40. The quantum random number generator according to claim 24, wherein:
the vertical entropy source comprises a photon source;
the vertical entropy source comprises a photon detector;
the photon source is set up to emit photons as a quantum signal when supplied with electrical energy;
the photon source is optically coupled to the photon detector; and
the photon detector is arranged to receive the quantum signal of the photon source at least partially and to generate an output signal of the vertical entropy source or a precursor signal thereof.

41. The quantum random number generator according to claim 40,
wherein the photon source further comprises a silicon LED, in particular a Zener-av LED.

42. The quantum random number generator according to claim 40,
wherein the photon source further comprises a SPAD diode.

43. The quantum random number generator according to claim 24,
wherein the quantum random number generator is placed in whole or in part in a pad frame between connection pads of an integrated circuit on a die of the integrated circuit; and
wherein at least the vertical entropy source is placed in the pad frame between the connection pads of the integrated circuit on the die of this integrated circuit.

44. The quantum random number generator according to claim 42,
wherein the vertical entropy source of the quantum random number generator is encapsulated by metal layers and/or silicide layers and vias, except for signal feedthroughs through this encapsulation from at least one side, optionally at least two sides, optionally at least three sides, optionally at least four sides, optionally at least five sides.

45. The quantum random number generator according to claim 24, further comprising an electronic post-processing circuit configured to perform a whitening operation, thereby increasing an entropy level of bit stream of an entropy source.
